(19) United States
(12) Patent Application Publication
(10) Pub. No.: US 2024/0298667 A1
(43) Pub. Date: Sep. 12, 2024

(54) PLANT-BASED MEAT ALTERNATIVE FOOD PRODUCTS

(71) Applicant: Motif Foodworks, Inc., Boston, MA (US)

(72) Inventors: DILEK UZUNALIOGLU, Boston, MA (US); COLLEEN COTTRELL, Boston, MA (US); ADAM YEE, Boston, MA (US)

(21) Appl. No.: 18/280,438

(22) PCT Filed: Mar. 7, 2022
(86) PCT No.: PCT/US22/19134

§ 371 Date: Sep. 5, 2023

Related U.S. Application Data
(60) Provisional application No. 63/157,305, filed on Mar. 5, 2021.

(51) Int. Cl. A23J 3/16; A23J 3/04; A23J 3/22

(52) U.S. Cl. CPC A23J 3/16; A23J 3/04; A23J 3/227

(57) ABSTRACT

The present disclosure provides meat alternative formulations and methods of producing the meat alternative formulations. The meat alternative formulations can include heme protein, plant-based protein, plant-based fiber, plant-based connective tissue analog, fat, and other ingredients which impart meat-like qualities. The meat alternative formulations may also exclude species, such as free cysteine, which can mask or otherwise alter these meat-like qualities. Some meat alternative formulations disclosed herein lack free amino acids, such as those containing sulfur, and free sugars above certain threshold amounts.

### CROSS REFERENCE TO RELATED APPLICATIONS

This application claims priority from U.S. Provisional Application No. 63/157,305, filed on Mar. 5, 2021, which is hereby incorporated by reference in its entirety.

### FIELD OF THE DISCLOSURE

The present disclosure generally relates to meat alternative formulations and meat substitutes, as well as methods of preparing the meat alternative formulations and meat substitutes.

### BACKGROUND OF THE INVENTION

With the increasing world population, increasing demands on the supply of food, especially food with a sufficient supply of protein has increased. Suitable sources of proteins such as cows, chickens, pigs, fish, etc. take time and utilize vast supplies of feed to grow and stay healthy before being converted into a usable protein source. Additionally, during the growth of these protein sources, these protein sources impact the global atmosphere by expelling large amounts of carbon dioxide and methane. The production and consumption of meat as a protein source is also becoming increasingly unsustainable. The high price of meat means that its availability in many parts of the world is limited, if not non-existent in some areas.

Consumers' health is also a concern. Even with a high source of proteins, meat can affect the health of the consumer associated with an increased risk of total mortality, cardiovascular disease, colorectal cancer, and type 2 diabetes.

The high price of meat means its availability in many parts of the world is limited, if not non-existent in some areas. Most of the world's less expensive protein sources originate from a variety of pulses, grains, and lentils. These sources usually have a high concentration of protein, but also have drawbacks in respect of digestibility and anti-nutritional factors. Moreover, for many people, these cheaper protein sources do not have a very pleasant taste or texture compared with meat products. In order to increase the nutritional quality and palatability of these less expensive protein sources, many people add additional nutrients (amino acids, vitamins, and minerals) and sugars to these less expensive protein sources.

Even with the increased additional nutrients (amino acids, vitamins, and minerals) and sugars to these less expensive protein sources, these products can still cause health issues such as nausea, diarrhea, stomach cramps, irritability, fatigue, high blood pressure, acne, wrinkles, joint pain, and sleep issues. While animal-derived meats are often complex and variegated mixtures of tissues, cells, biomolecules and inorganic species, previous attempts to replicate meat-like qualities with similarly complex mixtures (for example with whole legumes or fungal thallic tissues) have typically proven ineffective, instead yielding products with qualities reflective of their ingredients, rather than of meat. Such endeavors are not only challenged by the proper selection of meat-mimetic ingredients, but also the omission of species which detract from meat profiles. For example, while certain mushrooms contain many categories of red meat-flavored molecules, trace quantities of lactones, aliphatic ketones, heavy alcohols, free amino acids, free sugars, and free vitamins in these mushrooms typically mask their otherwise robust meat flavors.

What is needed is a meat alternative formulation that utilizes sources of plant proteins, is sustainable, is flavorful, and does not cause additional health concerns to meet consumer satisfaction.

### SUMMARY OF THE INVENTION

Provided herein is a meat alternative formulation comprising a bovine myoglobin and a plant-based protein comprising a bovine myoglobin and a plant-based protein. The meat alternative formulation may not include free amino acids containing sulfur, which may be selected from the group consisting of cysteine, cystine, selenocysteine, and methionine. The meat alternative formulation may also not include free added thiamin. The meat alternative formulation may also not include free sugars in an amount exceed 1.5 weight percent (wt %). At least 20% of heme moieties of the heme protein may be metmyoglobin or metheme. The heme protein may have a purity of at least 20%. At least 95% of the heme protein may be in a holo-form. The heme protein may have a dissociation constant (K_{d}) of at least 500 μM for molecular oxygen. The heme protein may be 0.2 wt % to 2 wt % of the meat alternative formulation, on a dry basis (d.b.). The heme protein may be about 1 wt % of the meat alternative formulation.

The plant-based protein may be isolated or derived from wheat, pea, soy, canola, potato, chickpea, lentil, chickpea, fava bean, mung bean, rice, corn, sorghum, quinoa, vegetables, seaweed, bacteria, yeast, mushrooms, or any combination thereof. The plant-based protein may comprise soy protein, rice protein, pea protein, canola protein, or any combination thereof. The plant-based protein may comprise less than 30% fats and carbohydrates by weight. The plant-based protein may be about 0.5 wt % to about 40 wt %, or about 0.5 wt % to about 30 wt % of the meat alternative formulation.

The meat alternative formulation may comprise a hydrocolloid. The hydrocolloid may comprise konjac gum, gum Arabic, carrageenan, agar-agar, pectin, alginate, gellan, konjac glucomannan, xanthan, modified starch, methyl cellulose, hydroxypropyl methyl cellulose, carboxymethyl cellulose, guar gum, locust bean gum, tara gum, gum tragacanth, gum ghatt, their derivatives, or any combination thereof. The hydrocolloid may comprise konjac flour, methyl cellulose, gum Arabic, carrageenan, or any combination thereof. The hydrocolloid may be about 1 wt % to about 5 wt % of the meat alternative formulation.

The meat alternative formulation may comprise a plant-based fiber. The plant-based fiber may comprise konjac flour, guar gum, xantham gum, psyllium, chitin, inulin, pectin, dextrin, a starch, a cellulose, a hemicellulose, a starch, a lignin, a citrus fiber extract, or any combination thereof. The plant-based fiber may comprise inulin, gum Arabic, citrus fiber, maltodextrin, or any combination thereof. The plant-based fiber may be at least 5 wt %, or about 0.5 wt % to about 8.0 wt % of the meat alternative formulation.

The meat alternative formulation may comprise a fat. The fat may be isolated from a plant. The fat may be selected from the group consisting of algal oil, fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, alpha linoleic acid, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, rice bran oil; margarine, and other hydrogenated fats, and any combination thereof. The fat may comprise sunflower oil, coconut oil, or a combination thereof. The fat may be about 8 wt % to about 18 wt %, or about 1 wt % to about 30 wt % of the meat alternative formulation.

The meat alternative formulation may comprise a binder. The binder may comprise starch, gum, methyl cellulose, lecithin, or any combination thereof. The binder may be about 0.25 wt % to about 1.5 wt % of the meat alternative formulation.

The meat alternative formulation may comprise about 30 wt % to about 60 wt % water. The meat alternative formulation may comprise a polyunsaturated fatty acid. The meat alternative formulation may not comprise an ingredient isolated or purified from an animal, animal tissue, or animal cell.

Prior to cooking, the meat alternative formulation may have a viscosity of at least 1000 cP. Subsequent to cooking, the meat alternative formulation may have a hardness of at least 8000 g, which may be determined by texture profile analysis. Subsequent to cooking, the meat alternative formulation may have an elasticity of at least 0.8 cm. Subsequent to cooking, the meat alternative formulation may have a cohesion of at least 0.7%. The meat alternative formulation may be homogenous. The meat alternative formulation may comprise a gel, paste, or emulsion.

Provided herein is a meat alternative formulation comprising a heme protein, a plant-based protein, a plant-based fiber, a fat, and water. Further provided herein is a meat alternative formulation comprising a heme protein, a plant-based protein, a plant-based fiber, a plant-based connective tissue analog, a fat, and water. Also provided herein is a meat alternative formulation comprising a heme protein, a first plant-based protein, a second plant-based protein, wherein the first and second plant-based proteins are from different plants, a plant-based connective tissue analog, a plant-based fiber, a fat, a binder, and water. The meat alternative formulation may not include free amino acids contain sulfur, which may be selected from the group consisting of cysteine, cystine, selenocysteine, and methionine. The meat alternative formulation may also not include free added thiamin. The meat alternative formulation may not include free sugars in an amount exceeding 1.5 wt %. The meat alternative formulation may not include free sugars in an amount exceeding 0.2 wt %.

The heme protein may be a bovine myoglobin. The heme protein may be about 0.2 wt % to about 2 wt % of the meat alternative formulation, on a dry basis. The first plant-based protein may be about 0.5 wt % to about 25 wt % of the total weight of the meat alternative formulation. The second plant-based protein may be about 0.5 wt % to about 1.5 wt % of the meat alternative formulation.

The plant-based connective tissue analog may be about 1 wt % to about 3 wt %, or about 1 wt %, of the meat alternative formulation. About 0.50 wt % of the meat alternative formulation may be a cartilage analog, about 0.3 wt % may be a perimysium analog, and about 0.2 wt % may be a tendon analog. The binder may be about 0.3 wt % to about 0.7 wt % of the meat alternative formulation. The fat may be about 12 wt % to about 17 wt % of the meat alternative formulation. The water may be about 40 wt % to about 60 wt % of the meat alternative formulation. The meat alternative formulation may comprise a mineral, a polyunsaturated fatty acid (PUFA), or a combination thereof.

Provided herein is a meat alternative nugget formulation comprising a plant-based fiber, a plant-based protein, a fat, and a heme protein. The meat alternative nugget formulation may not include free amino acids containing sulfur, which may be selected from the group consisting of cysteine, cystine, selenocysteine, and methionine. The meat alternative nugget formulation may also not include free added thiamin. The meat alternative nugget formulation may not include free sugars in an amount exceeding 1.5 wt %. The meat alternative nugget formulation may comprise about 0.3 wt % to about 1.5 wt % of a plant-based connective tissue analog (PBCT). The meat alternative nugget formulation may comprise 0.38 wt % PBCT, and about 0.08 wt % of the formulation may be a perimysium analog and about 0.3 wt % may be a tendon analog. The meat alternative formulation may comprise 1.5 wt % PBCT, and about 0.3 wt % of the formulation may be a cartilage analog, about 0.6 wt % may be a tendon analog. At least a portion of the PBCT may be desiccated, and may be rehydrated, prior to addition to the meat alternative nugget formulation.

The plant-based fiber may be about 20 wt % to about 60 wt % of the meat alternative nugget formulation. The plant-based protein may be about 3 wt % to about 12 wt % of the meat alternative nugget formulation. The fat may be about 0.5 wt % to about 4.5 wt % of the meat alternative nugget formulation.

Provided herein is a meat alternative sausage formulation comprising a plant-based protein, a fat, a plant-based connective tissue analog, and a heme. The meat alternative sausage formulation may not include free amino acids containing sulfur, which may be selected from the group consisting of cysteine, cystine, selenocysteine, and methionine. The meat alternative sausage formulation may also not include free added thiamin. The meat alternative formulation may not include free sugars in an amount exceeding 1.5 wt %.

The plant-based protein may be about 12 wt % to about 30 wt % of the meat alternative sausage formulation. The fat may be about 7 wt % to about 22 wt % of the meat alternative sausage formulation. The fat may have a melting point above about 20° C. The fat may comprise at least two different fats. The meat alternative sausage formulation may not comprise a plant-based fiber. The meat alternative sausage formulation may comprise about 35 wt % to about 60 wt % water. The meat alternative sausage formulation may comprise about 1.5 wt % PBCT, and about 0.25 wt % of the formulation may be a cartilage analog, about 0.25 wt % may be a perimysium analog, and about 1 wt % may be a tendon analog.

Provided herein is a method of producing a meat alternative formulation. The method may comprise a step (a), which may comprise combining a plant-based connective tissue analog, a plant-based fiber, a plant-based protein, or any combination thereof, with water to form a hydrated composition. The method may also comprise a step (b), which may comprise combining a plant-based connective tissue analog, a plant-based protein, a plant-based fiber, a fat, a mineral, water, or any combination thereof, with a heme protein comprising a bovine myoglobin, to form a heme protein composition. The method may comprise a step (c), which may comprise combining the hydrated composition and the heme protein composition. The method may not include adding free amino acids containing sulfur, which may be selected from the group consisting of cysteine, cystine, selenocysteine, and methionine. The method may not include adding free thiamin. The method may not include adding free sugars. The method may comprise not adding free sugars in excess of 1.5 wt % of the final meat alternative formulation produced by the method.

Water may comprise between about 25% and about 75% of the mass of the hydrated composition. Step (b) may comprise solubilizing the heme protein. Step (b) may comprise forming a gel from the fat and the plant-based connective tissue analog prior to combining with the heme protein. Step (c) may comprise adding a second fat.

Provided herein is a meat alternative formulation comprising a bovine myoglobin, at least one plant-based protein, a plant-based connective tissue analog, and at least one fat. The meat alternative formulation may not include free amino acids containing sulfur, which may be selected from the group consisting of cysteine, cystine, selenocysteine, and methionine. The meat alternative formulation may also not include free added thiamin. The meat alternative formulation may not include free sugars in an amount exceeding 1.5 wt %. The meat alternative formulation may not include free sugars in an amount exceeding 0.2 wt %.

Provided herein is a meat alternative burger formulation comprising 0.5-2 wt % bovine myoglobin, 0.5-40 wt % plant-based protein, 10-20 wt % plant-based fat, and 1-3 wt % plant-based connective tissue (PBCT). The meat alternative burger formulation may not include free amino acids containing sulfur, which may be selected from the group consisting of cysteine, cystine, selenocysteine, and methionine. The meat alternative burger formulation may also not include free added thiamin. The plant-based protein may be textured soy protein, which may be minced. The plant-based protein may be 19.5 wt % of the formulation. The plant-based fat may comprise sunflower oil, which may be high oleic sunflower oil, and coconut oil. The sunflower oil may be 8 wt % of the formulation and the coconut oil may be 7 wt % of the formulation.

The PBCT may comprise one or more of a cartilage analog, a perimysium analog, and a tendon analog. The meat alternative burger formulation may comprise 0-1.5 wt % cartilage analog, 0-1 wt % perimysium analog, and 0-3 wt % tendon analog. The meat alternative burger formulation may comprise 0.5 wt % cartilage analog, 0.3 wt % perimysium analog, and 0.2 wt % tendon analog. The PBCT may be hydrated with twice as much water as PBCT, as measured by wt % of the formulation. The meat alternative burger formulation may not include free sugars in an amount exceeding 1.5 wt % or 0.2 wt %. The meat alternative burger formulation may comprise 1 wt % bovine myoglobin, 19.5 wt % textured soy protein, 8 wt % sunflower oil, which may be high oleic sunflower, 7 wt % coconut oil, 0.5 wt % cartilage analog, 0.3 wt % perimysium analog, and 0.2 wt % tendon analog.

### BRIEF DESCRIPTION OF THE FIGURES

The patent or application file contains at least one drawing executed in color. Copies of this patent or patent application publication with color drawing(s) or photograph(s) will be provided by the Office upon request and payment of the necessary fee. A better understanding of the features and advantages of the present disclosure will be obtained by reference to the following detailed description that sets forth illustrative embodiments, in which the principles of the disclosure are utilized, and the accompanying drawings of which:

FIG. 1A provides an image of a non-animal-based cartilage analog (PBA) in dry form.

FIG. 1B provides an image of a non-animal-based perimysium analog (PBB) in dry form.

FIG. 1C provides an image of a non-animal-based tendon analog (PBC) in dry form.

FIG. 2A provides an image of the non-animal-based cartilage analog of FIG. 1A in hydrated form.

FIG. 2B provides an image of the non-animal-based perimysium analog of FIG. 1B in hydrated form.

FIG. 2C provides an image of the non-animal-based tendon analog of FIG. 1C in hydrated form.

FIG. 3A provides a ternary plot of PBA, PBB, and PBC ratios used in various meat alternative burger formulations.

FIG. 3B provides a table of PBA, PBB, and PBC ratios used in various meat alternative burger formulations.

FIGS. 4A-E provide images of cooked meat alternative burgers comprising no connective tissue analog content (FIG. 4A); 3 weight % PBA (FIG. 4B); 3 weight % PBB (FIG. 4C); 3 weight % PBC (FIG. 4D); and equal parts PBA, PBB, and PBC (each 1 weight %, FIG. 4E).

FIG. 5 provides relative springiness levels for ten connective tissue analog-containing meat alternative burgers.

FIG. 6 provides relative hardness levels for ten connective tissue analog-containing meat alternative burgers.

FIG. 7 provides relative particulate levels for ten connective tissue analog-containing meat alternative burgers.

FIG. 8 provides relative juiciness levels for ten connective tissue analog-containing meat alternative burgers.

FIG. 9 provides relative densities for ten connective tissue analog-containing meat alternative burgers.

FIG. 10 summarizes sensory panel descriptions for multiple meat alternative burger formulations varying in connective tissue analog content.

FIGS. 11A-B provide 2-dimensional (2D, FIG. 11A) and 3-dimensional (3D, FIG. 11B) ternary plots summarizing cook loss for meat alternative burgers with varying connective tissue analog contents and stored for one week prior to cooking.

FIG. 12 summarizes cook loss values for meat alternative burgers with varying connective tissue analog contents and stored for one week prior to cooking.

FIGS. 13A-B provide 2-dimensional (2D, FIG. 13A) and 3-dimensional (3D, FIG. 13B) ternary plots summarizing cook loss for meat alternative burgers with varying connective tissue analog contents and stored for two weeks prior to cooking.

FIG. 14 summarizes cook loss values for meat alternative burgers with varying connective tissue analog contents and stored for two weeks prior to cooking.

FIGS. 15A-B provide 2D (FIG. 15A) and 3D (FIG. 15B) ternary plots summarizing hardness at first texture profile analysis (TPA) stroke for meat alternative burgers containing variable connective tissue analog contents.

FIG. 16 provides hardness levels at first TPA stroke for meat alternative burgers with varying Appetex™ contents following one week of storage.

FIGS. 17A-B provide 2D (FIG. 17A) and 3D (FIG. 17B) ternary plots summarizing hardness at ninth TPA stroke for meat alternative burgers made with variable Appetex™ formulations.

FIG. 18 provides hardness levels at ninth TPA stroke for meat alternative burgers with varying Appetex™ contents following one week of storage.

FIGS. 19A-B summarize changes in hardness between the first and ninth TPA strokes for the meat alternative burgers made with one-week stored Appetex™—containing formulations.

FIG. 20A-B provide 2D (FIG. 20A) and 3D (FIG. 20B) ternary plots summarizing hardness at first TPA stroke for meat alternative burgers made with variable Appetex™ formulations.

FIG. 21 provides hardness levels at first TPA stroke for meat alternative burgers made with Appetex™—containing and Appetex™—free formulations stored for two weeks prior to cooking.

FIG. 22A-B provide 2D (FIG. 22A) and 3D (FIG. 22B) ternary plots summarizing hardness at ninth TPA stroke for meat alternative burgers made with variable Appetex™ formulations following two weeks of storage.

FIG. 23 provides hardness levels at ninth TPA stroke for meat alternative burgers made with Appetex™—containing and Appetex™—free formulations stored for two weeks prior to cooking.

FIGS. 24A-B summarize changes in hardness between the first and ninth TPA strokes for the meat alternative burgers made with two-week stored Appetex™—containing meat alternative burger formulations.

FIGS. 25A-B provide 2D (FIG. 25A) and 3D (FIG. 25B) ternary plots summarizing resilience at first TPA stroke for meat alternative burgers with variable connective tissue analog contents.

FIG. 26 provides resilience values at first TPA stroke for meat alternative burgers made with multiple Appetex™—containing and Appetex™—free formulations stored for one week prior to cooking.

FIG. 27A-B provide 2D (FIG. 27A) and 3D (FIG. 27B) ternary plots summarizing resilience at ninth TPA stroke for meat alternative burgers with variable connective tissue analog contents.

FIG. 28 provides resilience values at first TPA stroke for meat alternative burgers made with multiple Appetex™—containing and Appetex™—free formulations, each stored for one week prior to cooking.

FIGS. 29A-B provide 2D (FIG. 29A) and 3D (FIG. 29B) ternary plots summarizing resilience at first TPA stroke for meat alternative burgers with variable connective tissue analog contents, and stored for two weeks prior to cooking.

FIG. 30 provides first TPA stroke resilience values for meat alternative burgers made with multiple Appetex™—containing and Appetex™—free formulations stored for two weeks prior to cooking.

FIGS. 31A-B provide 2D (FIG. 31A) and 3D (FIG. 31B) ternary plots summarizing resilience at ninth TPA stroke for meat alternative burgers with variable connective tissue analog contents which had been stored for two weeks prior to cooking.

FIG. 32 provides ninth TPA stroke resilience values for meat alternative burgers made with multiple Appetex™—containing and Appetex™—free formulations stored for two weeks prior to cooking.

FIGS. 33A-B provide 2D (FIG. 33A) and 3D (FIG. 33B) ternary plots summarizing cohesion at first TPA stroke for meat alternative burgers with varying connective tissue analog contents and which had been stored for one week prior to cooking.

FIG. 34 provides first TPA stroke cohesion values for meat alternative burgers made with multiple Appetex™—containing and Appetex™—free formulations stored for one week prior to cooking.

FIGS. 35A-B provide 2D (FIG. 35A) and 3D (FIG. 35B) ternary plots summarizing cohesion at ninth TPA stroke for meat alternative burgers made with formulations varying in connective tissue analog content, and stored for one week prior to cooking.

FIG. 36 provides ninth TPA stroke cohesion values for meat alternative burgers made with multiple Appetex™—containing and Appetex™_free formulations stored for one week prior to cooking.

FIGS. 37A-B provide 2D (FIG. 37A) and 3D (FIG. 37B) ternary plots summarizing cohesion at first TPA stroke for meat alternative burgers with varying in terms of PBA, PBB, and PBC content, and stored for two weeks prior to cooking.

FIG. 38 provides first TPA stroke cohesion values for meat alternative burgers made with Appetex™—containing and Appetex™—free formulations stored for two weeks prior to cooking.

FIGS. 39A-B provide 2D (FIG. 39A) and 3D (FIG. 39B) ternary plots summarizing cohesion at ninth TPA stroke for meat alternative burgers made with variable Appetex™ formulations which had been stored for two weeks prior to cooking.

FIG. 40 provides ninth TPA stroke cohesion values for multiple meat alternative burgers made with Appetex™—containing and Appetex™—free formulations stored for two weeks prior to cooking.

FIGS. 41A-G provide images of meat alternative nugget cross sections for a 0.5 wt % Appetex™ nugget (FIG. 41A), a 1 wt % Appetex™ nugget (FIG. 41B), a 1.5 wt % Appetex™ nugget (FIG. 41C), a 2 wt % Appetex™ nugget (FIG. 41D), a 3 wt % Appetex™ nugget (FIG. 41E), a 4 wt % Appetex™ nugget (FIG. 41F), and a 5 wt % Appetex™ nugget (FIG. 41G).

FIG. 42 provides stiffness values of multiple spongy meat alternative nugget formulations varying in connective-tissue analog content and four commercial chicken nuggets.

FIG. 43 provides toughness values of multiple spongy meat alternative nugget formulations varying in connective-tissue analog content and four commercial chicken nuggets.

FIG. 44 provides firmness values of multiple spongy meat alternative nugget formulations varying in connective-tissue analog content and four commercial chicken nuggets.

FIGS. 45A-H provide images which illustrate a method of making a meat alternative sausage. FIG. 45A depicts hydration of a soy protein. FIG. 45B depicts gel formation with a hydrocolloid. FIG. 45C depicts dry ingredient homogenization through mixing. FIG. 45D depicts blending of the soy protein of FIG. 45A, the gel of FIG. 45B, and the dry ingredients of FIG. 45C. FIG. 45E shows a meat alternative sausage formed from the composition resulting from the blending of FIG. 45D. FIG. 45F shows the meat alternative sausage of FIG. 45E coated in a sodium alginate solution. FIG. 45G shows gelling of the sodium alginate solution on the surface of the meat alternative sausage with a calcium spray. FIG. 45H shows the meat alternative sausage of FIG. 45G under vacuum seal.

FIG. 46 summarizes physical properties of multiple pea protein-containing meat alternative sausages against Johnsonville brand pork sausages and Beyond Meat brand Beyond Sausages.

FIG. 47 summarizes physical properties of multiple soy protein-containing meat alternative sausages against Johnsonville brand pork sausages and Beyond Meat brand Beyond Sausages.

FIG. 48 overviews a method for preparing connective tissue analogs.

FIG. 49 illustrates the general process and steps of producing a Heme protein through microbial fermentation.

FIG. 50 illustrates a process for heme protein isolation and purification from fermentation products.

FIG. 51 depicts a process for making soy-based meat alternative burgers with heme proteins.

FIG. 52 is a series of color photographs of hydrated TVP (Textured Vegetable Protein) with either the control formula, or with 0.5% or 1.0% heme inclusion in the TVP.

FIG. 53 is a series of color photographs of hydrated TVPs (top) with no heme (control), 0.5% heme and 1.0% heme, and meat alternative burgers formed from the hydrated TVPs (bottom).

FIG. 54 is a photograph showing the color gradient of a meat alternative burger formed from a meat alternative formulation including 1% heme, after cooking sufficiently to produce searing on each side.

FIG. 55 is a series of photographs of cooked meat alternative burgers, revealing meat-like color retention after cooking.

FIG. 56 is a series of photographs comparing appearance of frozen, meat alternative burgers of the present disclosure (left panel), and a frozen commercially available, consumer branded meat alternative burger (right panel).

FIG. 57A provides a graph of L-values (providing measures of color along a black to white (dark/light) axis) of meat alternative burgers containing no heme (left) 0.5% heme (middle) and 1.0% heme (right), and frozen for either 3, 10 and 17 days.

FIG. 57B provides a graph of a-values (providing measures of redness) of meat alternative burgers containing no heme (left) 0.5% heme (middle) and 1.0% heme (right), and frozen for either 3, 10 and 17 days.

FIG. 57C provides a graph of b-values (providing measures along a yellow to blue axis) of meat alternative burgers containing no heme (left) 0.5% heme (middle) and 1.0% heme (right), and frozen for either 3, 10 and 17 days.

FIG. 58A provides a graph of cook loss values of meat alternative burgers containing no heme (left) 0.5% heme (middle) and 1.0% heme (right), and frozen for either 3, 10 and 17 days.

FIG. 58B provides a graph of pH values of meat alternative burgers containing no heme (left) 0.5% heme (middle) and 1.0% heme (right), and frozen for either 3, 10 and 17 days.

FIG. 58C provides a graph of water activity (aw) values of meat alternative burgers containing no heme (left) 0.5% heme (middle) and 1.0% heme (right), and frozen for either 3, 10 and 17 days.

FIG. 59 shows the peak forces of meat alternative burgers containing no heme (0.0%) vs those containing 1.0% heme (total 10 samples, five samples each), assessed following either 3 (left panel) or 17 (right panel) days of storage.

FIG. 60 illustrates a process for making a soy-based meat alternative burger.

FIG. 61 provides photographs of soy-based meat alternative burgers containing no Soy LegH (left panel), soy-based meat alternative burgers containing Soy LegH (right panel), and a beef burger (control, middle panel).

FIG. 62A provides a graph of L-values of meat alternative burgers frozen for 1, 3, or 6 days, or immediately thawed upon freezing.

FIG. 62B provides a graph of a-values of meat alternative burgers frozen for 1, 3, or 6 days, or immediately thawed upon freezing.

FIG. 62C provides a graph of b-values of meat alternative burgers frozen for 1, 3, or 6 days, or immediately thawed upon freezing.

FIG. 63 provides graphs of water activity (aw, left graph) and pH (right graph) of a beef burger with 80:20 protein/fat ratio (‘Control’, leftmost value on each graph), a soy-based meat alternative burger lacking heme (middle value on each graph), and a soy-based meat alternative burger with 0.5% Soy LegH (rightmost value on each graph).

FIG. 64 provides a graph of cook loss (%) of a beef burger with 80:20 protein/fat ratio (‘Control’, leftmost value on each graph), a soy-based meat alternative burger lacking heme (middle value on each graph), and a soy-based meat alternative burger with 0.5% Soy LegH (rightmost value on each graph) following 1, 3, or 6 days of frozen storage, or following immediate thawing following freezing.

FIG. 65 provides photographs of pea-based meat alternative burgers which lack heme (left panel) or with Soy LegH (right panel), and of a beef burger (control, middle panel). Within each cluster of photographs, the top-left photograph is of the raw form of the burger, the top-right photograph is of the cooked form of the burger, and the bottom photograph is of a center cut view of the cooked form of the burger.

FIG. 66A provides a series of graphs of L-, a- and b-values of a heme-free pea-based meat alternative burger following 1, 3, or 6 days of frozen storage, or following immediate thawing following freezing.

FIG. 66B provides a series of graphs of L-, a- and b-values of a beef burger with 80:20 protein/fat ratio following 1, 3, or 6 days of frozen storage, or following immediate thawing following freezing.

FIG. 66C provides a series of graphs of L-, a- and b-values of a pea-based meat alternative burger containing 0.5% Soy LegH following 1, 3, or 6 days of frozen storage, or following immediate thawing following freezing

FIG. 67 provides graphs of water activity (aw, left graph) and pH (right graph) of a beef burger with 80:20 protein/fat ratio (‘Control’, leftmost value on each graph), a pea-based meat alternative burger lacking heme (middle value on each graph), and a pea-based meat alternative burger with 0.5% Soy LegH (rightmost value on each graph).

FIG. 68 provides a graph of cook loss (%) of a beef burger with 80:20 protein/fat ratio (‘Control’, leftmost value on each graph), a pea-based meat alternative burger lacking heme (middle value on each graph), and a pea-based meat alternative burger with 0.5% Soy LegH (rightmost value on each graph) following 1, 3, or 6 days of frozen storage, or following immediate thawing following freezing.

FIG. 69A provides photographs of raw soy-based meat alternative burgers containing 0% (left panel), 0.5% (middle panel), or 1% (right panel) bovine myoglobin.

FIG. 69B provides photographs of cooked soy-based meat alternative burgers containing 0% (left panel), 0.5% (middle panel), or 1% (right panel) bovine myoglobin.

FIG. 70A provides graphs of L-values for soy-based meat alternative burgers containing 0% (left), 0.5% (middle), or 1% (right) bovine myoglobin following 3, 10 or 17 days of frozen storage.

FIG. 70B provides graphs of a-values for soy-based meat alternative burgers containing 0% (left), 0.5% (middle), or 1% (right) bovine myoglobin following 3, 10 or 17 days of frozen storage.

FIG. 70C provides graphs of b-values for soy-based meat alternative burgers containing 0% (left), 0.5% (middle), or 1% (right) bovine myoglobin following 3, 10 or 17 days of frozen storage.

FIG. 71A provides the peak forces of soy-based meat alternative burgers containing 0% or 1% bovine myoglobin following 3 days of frozen storage.

FIG. 71B provides the peak forces of soy-based meat alternative burgers containing 0% or 1% bovine myoglobin following 17 days of frozen storage.

FIG. 72A provides a graph which shows cook loss (%) of soy-based meat alternative burgers containing 0% (left), 0.5% (middle), or 1% (right) bovine myoglobin following 3, 10 or 17 days of frozen storage.

FIG. 72B provides a graph of pH-values of soy-based meat alternative burgers containing 0% (left), 0.5% (middle), or 1% (right) bovine myoglobin following 3, 10 or 17 days of frozen storage.

FIG. 72C provides a graph which shows water activity-values of soy-based meat alternative burgers containing 0% (left), 0.5% (middle), or 1% (right) bovine myoglobin following 3, 10 or 17 days of frozen storage.

FIG. 73A provides a spider graph of multiple sensory characteristics of a soy-based meat alternative burger containing no heme and a beef burger with 80:20 protein/fat ratio.

FIG. 73B provides a spider graph of multiple sensory characteristics of a soy-based meat alternative burger containing 1.0% bovine myoglobin and a beef burger with 80:20 protein/fat ratio.

### DETAILED DESCRIPTION OF THE INVENTION

The present disclosure provides meat alternative formulations and meat substitutes that are free of ingredients isolated or purified from animals (e.g., the ingredients may not be naturally produced by animal cells), but which nonetheless bear similar flavor, color, taste, textural and nutritional profiles as the animal meat counterparts which they are designed to mimic. Contrasting previous approaches to reproduce meat complexity, aspects of the present disclosure provide meat alternative formulations that recreate meat-like qualities with simple, and in some cases minimal, sets of ingredients. These meat alternative formulations not only reflect careful selection of ingredients to impart essential meat-like characteristics, but also include selective omission of ingredients which detract from or otherwise alter meat profiles.

The meat alternative formulations of the present disclosure can include a heme protein, which in particular may be a bovine myoglobin, and at least one plant-based protein, and may not include one or more, or any free amino acids (e.g., sulfur-containing amino acids), and optionally may also not include one or more free sugars at all or at amounts above certain threshold levels recited herein, thereby providing balanced flavor profiles from which meat qualities are more readily discernible. In some cases, the meat alternative formulation comprises multiple plant-based proteins. The meat alternative formulation may also comprise one or more of minerals, a polyunsaturated fatty acid (PUFA), a hydrocolloid, a plant-based fiber, a salt, a binder, a fat, a flavor enhancer, a starch, a gelling agent, a thickener, an emulsifier, or any combination thereof.

Added free amino acids—particularly those containing sulfur—and free sugars have been thought to be necessary to impart desirable meat flavor and aroma characteristics to meat substitutes. Surprisingly, the inventors have discovered that although such ingredients are not added to the meat alternative formulations disclosed herein, or are present in very limited amounts, the meat alternative formulations maintain favorable meat flavor and aroma characteristics, while eliminating ingredients that can cause unwanted negative effects on health. The meat alternative formulation may also be free of animal products, which may be isolated or purified from an animal. For clarity, an animal protein that is recombinantly expressed in a cell culture, tissue culture, or produced synthetically is not an animal product. The meat alternative may include little or no non-protein bound iron.

The meat alternative formulations described herein differ from some previous meat alternative formulations in which amino acids and sugars have been used as flavor precursor additives. Certain past formulations rely on specific heme-mediated reactions of these compounds during cooking to generate recognizable meat flavors in their products. While these conversions can yield desirable flavors, the heme oxidative chemistry required for these processes is typically uncontrolled and promiscuous, thereby often generating undesirable side products with off flavors. For example, some previous formulations have included cysteine in formulations, with the goal of oxidizing the cysteine to disulfides (e.g., cystine) during cooking. However, heating cysteine in the presence of heme and free iron can also form sulfoxide, sulfone, and sulfinic acid derivatives which can impart sharp and cabbage-like flavors not generally desired in meat and alternative meat products. Furthermore, many flavor precursors, including cysteine, can, by themselves, impart strong flavors which detract from or mute essential meat flavors. The meat alternative formulation may also not include free added thiamin.

Paralleling a typical cut of meat, which includes muscle, fat, and a collection of connective tissues, the meat alternative formulations disclosed herein can include components that collectively mimic the varied components of animal meat. Connective tissues are often visible as pale elastic materials disposed between layers of muscle and bone, and can be important for flavor, texture, and cooking profile. Connective tissues include tendons, ligaments, cartilage, perimysium, elastin-like connective tissue, and collagen-containing sheets, each varying in size, density, and physical form. Although typically tough in raw form, some connective tissues (such as collagen) break down during cooking to provide a tender, silky mouthfeel, while others (such as elastin) retain their physical properties to confer recognizable toughness and cohesion to cooked meat. As recreating a connective tissue-like consortia can be crucial for generating meat-like texture, cooking profile, and flavor, the present disclosure provides connective tissue mimetic compositions for meat alternative formulations. By varying the types, bulk amounts, and ratios of these constituents, a wide range of sensory and textural profiles can be recreated with the meat alternative formulations disclosed herein.

The meat alternative formulation described herein may be formed as any real meat product, such ground meat, ground meat patties, ground meat meatballs, meat steaks, meat sausage, meat jerky strips, or any combination thereof. The meat alternative formulation described herein may be formed as any such product formed from real beef or poultry. The present disclosure contemplates, for example, plant-based meat alternative formulations in the form of ground beef, a ground beef burger or slider, a ground beef meatball, a beef or pork sausage or hot dog, a cut of beef, corned beef, or a dried beef strip. The meat alternative formulation described herein may alternatively be prepared in the form of other real meat products such as meat (beef, chicken, pork or turkey) nuggets or strips, meat loaf or meat cake forms, canned seasoned meat, sliced meat, sausage of any size, or processed meats such as salami, bologna, lunch meat and the like. The meat alternative formulation, after cooking, may provide the color, the flavor, and the texture of cooked meat which is pleasurable and palatable to the consumer.

### I. Formulations

The meat alternative formulations of the present disclosure comprise a heme protein and a plant-based protein. The meat alternative formulations do not include one or more, or any, free amino acids, which may not be added free amino acids. In some cases, the meat alternative formulation further does not include one or more, or any free sugars, which may not be added free sugars. In some examples, the meat alternative formulation does not include free sugars in excess of 1.5 wt %. In addition to providing meat-like flavor and color to the meat alternative formulations, the heme protein may mediate chemical conversions (e.g., starch hydrolysis) during cooking which further enhance meat profiles. The heme may be provided in solution, in crystalline or microcrystalline form, as a powder, or in admixture with other ingredients. In some cases, the meat alternative formulation includes little or no non-protein bound iron.

The heme protein and plant-based protein may collectively comprise at least 10%, at least 15%, at least 20%, at least 25%, or at least 30% of the weight of the formulation. The heme protein and plant-based protein may collectively comprise at least 10%, at least 20%, at least 30%, at least 40%, or at least 50% of the dry weight of the formulation. In addition to the heme protein and the plant-based protein, the meat alternative formulations may comprise at least one, at least two, at least three, at least four, at least five, at least six, at least seven, or all eight further species selected from the group consisting of a second plant-based protein, a hydrocolloid, a plant-based fiber, a fat, a binder, a flavor enhancer, water, and a mineral. The meat alternative formulation may optionally comprise a mineral, a polyunsaturated fatty acid (PUFA), or a combination thereof.

In some aspects, the meat alternative formulation comprises a heme protein, a plant-based protein, a hydrocolloid, a plant-based fiber, an additional plant-based protein, and a second additional plant-based protein. In another aspect, the meat alternative formulation comprises a heme protein, a plant-based protein, a hydrocolloid, a plant-based fiber, and an additional plant-based protein. In a further aspect, the present disclosure provides meat alternative formulations which include a heme protein, a plant-based protein, an additional plant-based protein, a hydrocolloid, and a plant-based fiber. In another aspect, the meat alternative formulation comprises a heme protein, a plant-based protein, a hydrocolloid, a plant-based fiber, an additional plant-based protein, a second additional plant-based protein, and a fat. In another aspect, the meat alternative formulation comprises a heme protein, a plant-based protein, a hydrocolloid, a plant-based fiber, an additional plant-based protein, a second additional plant-based protein, a fat, and a binder. In an additional aspect of the present disclosure, the meat alternative formulation consisting of (a) a heme protein; (b) a plant-based protein; (c) a hydrocolloid; (d) a plant-based fiber; (e) an additional plant-based protein; (f) a second additional plant-based protein; (g) a fat; (h) a binder; (i) a flavor enhancer; and (j) water.

### (a) Animal-Free Products and Formulations

The term “meat alternative” as used herein can denote that a formulation or product (e.g., a burger, nugget, or sausage) comprises ingredients devoid of any animal components, such as animal cells, tissues, organs, blood, or intracellular liquids. In other words, ingredients may be isolated or derived from plants, yeasts, bacteria, or any combination thereof. The ingredients may also be obtained from animal eggs or milks, such as ovalbumin, casein, whey, cheese, or other proteins or fats from egg or milk. Suitable plant sources from which ingredients may be isolated or derived include but are not limited to, fruits, vegetables, nuts, seeds, oils, grains, wheats, legumes, beans, peas, and other edible materials obtained from plant leaves, flowers, roots, barks, and branches. The disclosure also expressly contemplates plant-based ingredients obtained from transgenic or genetically modified fungi and plants, i.e., genetically engineered fungi and plants containing one or more exogenous genes introduced into the genome, to create plants with new characteristics and traits.

### (b) Properties of the Meat Alternative Formulation

With the meat alternative formulation, noted above, the meat alternative formulation, after cooking, provides some unique properties such as rich umami flavors, aromas, color, mouthwatering, meaty, juicy, the ability to turn red to brown-grey when heat is applied, and the texture of cooked meat, as compared to authentic cooked meat that engages the senses and is very palatable.

The meat alternative formulation of the present disclosure may comprise a strength, chewiness, or viscosity similar to an animal meat. In some cases, the viscosity is primarily controlled by the ratio of binder, hydrocolloid, and plant-based fiber present in the formulation. The meat alternative formulation may comprise sufficient tensile strength, when cooked or raw, to withstand undesirable breaking during cooking, handling, or consuming. Prior to or subsequent to cooking, the meat alternative formulation may comprise a viscosity of at least 600 centipoise (cP), at least 1000 cP, at least 1400 cP, at least 1800 cP, at least 2200 cP, at least 2600 cP, at least 3000 cP, at least 4000 cP, at least 5000 cP, at least 6000 cP, at least 8000 cP, or at least 10000 cP. Subsequent to cooking, the meat alternative formulation may comprise a cohesion of at least 50%, at least 60%, at least 70%, at least 75%, at least 85%, at most 80%, at most 75%, at most 70%, at most 60%, or at most 50% as determined by texture profile analysis at first stroke. Subsequent to cooking, the meat alternative formulation may comprise a resilience of at least 20%, at least 25%, at least 30%, at least 35%, at least 40%, at most 40%, at most 35%, at most 30%, at most 25%, or at most 20% as measured by texture profile analysis at first or ninth stroke. Subsequent to cooking, the meat alternative formulation may comprise a cohesion of at least 0.7, at least 0.75, at least 0.8%, at least 0.85%, at least 0.9%, at least 0.95%, at most 0.95%, at most 0.9%, at most 0.85%, at most 0.8%, at most 0.75%, or at most 0.7%, as determined by texture profile analysis at ninth stroke.

Subsequent to cooking, the meat alternative formulation can comprise a hardness of at least 8,000 g, at least 10,000 g, at least 12,000 g, at least 14,000 g, at least 16,000 g, at least 18,000 g, at least 2,0000 g, at least 22,000 g, at least 24,000 g, at most 24,000 g, at most 22,000 g, at most 2,0000 g, at most 18,000 g, at most 16,000 g, at most 14,000 g, at most 12,000 g, at most 1,0000 g, or at most 8,000 g as determined by first texture profile analysis (TPA) stroke. Subsequent to cooking, the meat alternative formulation can comprise a hardness of at least 13,000 g, at least 15,000 g, at least 17,000 g, at least 19,000 g, at least 21,000 g, at least 23,000 g, at least 25,000 g, at least 27,000 g, at least 29,000 g, at least 31,000 g, at most 31,000 g, at most 29,000 g, at most 27,000 g, at most 25,000 g, at most 23,000 g, at most 21,000 g, at most 19,000 g, at most 17,000 g, at most 15,000 g, or at most 13,000 g as determined by ninth texture profile analysis (TPA) stroke.

The meat alternative formulation may be homogenized or may comprise heterogeneity. As the meat alternative formulation can comprise immiscible species, such as plant fat and water, the meat alternative formulation may comprise distinct phases, a suspension, an emulsion, a multiphase colloid or gel, a paste, or any combination thereof. In one example, the meat alternative formulation may comprise a dough or hydrated textured protein embedded in a multiphase colloid gel.

### (c) Meat Alternative Burger Formulations

The meat alternative formulation can be a meat alternative burger formulation, with physical, sensory, and cooking properties reminiscent of animal meat-based hamburgers. The meat alternative burger formulation may be mimetic for beef, bison, goat, sheep, deer, elk, moose, ostrich, chicken, or turkey hamburgers. In many cases, the meat alternative burger formulation is imitative of beef hamburgers. The meat alternative hamburger formulations can mimic the juicy, reddish appearance of beef burgers prior to cooking, and adopt the glistening brown appearance, soft and chewable texture conducive to bolus formation, and meaty flavor of animal meat-based burgers upon cooking. To achieve these properties, the meat alternative burger formulation can optionally comprise relatively high heme protein, plant-based protein, and fat content.

The meat alternative burger formulation can comprise a heme protein and a plant-based protein. In some cases, the meat alternative burger formulation further comprises a fat. In some cases, the meat alternative burger formulation further comprises a plant-based fiber. In some cases, the plant-based protein and fat content of the meat alternative burger formulation may be about 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %. In some examples the plant-based protein and fat are about 10-20 wt %. In some cases, the meat alternative burger formulation comprises at least about 1.25-times, at least about 1.5-times, at least about 2-times, or at least about 2.5-times as much plant-based protein as plant-based fiber. In some cases, the meat alternative burger formulation comprises a hydrocolloid. For example, the meat alternative burger formulation can comprise a heme protein, a plant-based protein, a fat, a plant-based fiber, and a hydrocolloid. In some cases, at least a portion of the hydrocolloid or plant-based fiber are provided as a plant-based connective tissue analog. In some cases, the meat alternative burger formulation comprises at least 1 or 2 or at least 3 connective tissue analogs. In some cases, the meat alternative burger comprises at least 1 or 2 connective tissue analogs selected from the group consisting of a cartilage analog, a perimysium analog, and a tendon analog.

Generally, the weight % (wt %) of the heme protein on a dry basis (d.b.) in the meat alternative burger formulation ranges from about 0.2 wt % to about 2 wt % based on the total weight of the meat alternative formulation. In various embodiments, the wt % of the heme protein (d.b.) in the meat alternative burger formulation ranges from about 0.5 wt % to about 3 wt %, from about 1 wt % to about 3 wt %, from about 0.5 wt % to about 2 wt %, from about 0.2 wt % to about 1.5 wt %, from about 0.2 wt % to about 1 wt %, or from about 0.5 wt % to about 1 wt % based on the total weight of the meat alternative burger formulation. In one embodiment, the wt % of the heme protein (d.b.) is about 1 wt % based on the total weight of the meat alternative formulation.

When heme protein is formulated into solution form as heme protein prep, the heme protein prep may be from about 1.0% to about 10.0%, about 1.0% to about 15.0%, about 1.0% to about 20.0%, about 5.0% to about 15.0%, or about 5.0% to about 20.0%, in the solution. For example, the heme protein content may be from about 1% to 1.5%, from about 1.5% to 2.0%, from about 2.0% to 2.5%, from about 2.5% to 3.0%, from about 3.0% to 3.5%, from about 3.5% to 4.0%, from about 4.0% to 4.5%, from about 4.5% to 5.0%, from about 5.0% to 5.5%, from about 5.5% to 6.0%, from about 6.0% to 6.5%, from about 6.5% to 7.0%, from about 7.0% to 7.5%, from about 7.5% to 8.0%, from about 8.0% to 8.5%, from about 8.5% to 9.0%, from 9.0% to 9.5%, from 9.5% to 10.0%. In one example, the heme protein is contained in HEMAMI™ HEMAMI™ may be a solution of bovine myoglobin. The meat alternative burger formulation may comprise about 11.1 or 11.2 wt % HEMAMI™prep when it is 9% heme protein in heme prep.

The protein content in the meat alternative burger formulation may be from about 0.5 wt to about 100%. For example, the protein content may be from about 40 wt % to about 100 wt %, from about 40 wt % to about 45 wt %, from about 45 wt % to about 50 wt %, from about 50 wt % to about 55 wt %, from about 55 wt % to about 60 wt %, from about 60 wt % to about 65 wt %, from about 65 wt % to about 70 wt %, from about 70 wt % to about 75 wt %, from about 75 wt % to about 80 wt %, from about 80 wt % to about 85 wt %, from about 85 wt % to about 90 wt %, from about 90 wt % to about 95 wt %, or from about 95 wt % to about 100 wt %. In typical embodiments of the meat alternative burger formulation, the plant-based protein (e.g., a single protein, a single protein composition, or a plurality of protein compositions from a plurality of plant sources) in the meat alternative formulation ranges from about 0.5 wt % to about 40 wt % based on the total weight of the meat alternative formulation. In various embodiments, the amount of the plant-based protein in the meat alternative formulation ranges from about 0.5 wt % to about 30 wt %, from about 15 wt % to about 25 wt %, from about 17.5 wt % to about 22.5 wt %, or from 19 wt % to about 21 wt % based on the total weight of the meat alternative formulation. In one embodiment, the wt % of the plant-based protein is about 19.5 wt % based on the total weight of the meat alternative formulation. In one example, the meat alternative formulation comprises between 15 wt % and 25 wt % soy protein concentrate, rice protein concentrate in an amount less than 1 wt %, and canola protein in an amount less than 1 wt %. In certain cases, the soy protein concentrate is a soy protein isolate. In one example, the soy protein is textured soy protein, which may be minced.

The meat alternative burger formulation can comprise at most 5 wt % hydrocolloids (e.g., wt %). In some cases, the meat alternative burger formulation comprises at most 3 wt % hydrocolloids. In some cases, the meat alternative burger formulation comprises between 0.5 wt % and 5 wt % hydrocolloids. In some cases, the meat alternative burger formulation comprises between 1.5 wt % and 3.5 wt % hydrocolloids. In some cases, the meat alternative burger formulation comprises between 2 wt % and 3 wt % hydrocolloids.

The meat alternative formulation may comprise between 0 wt % and 8 wt % plant-based fiber. The meat alternative formulation may comprise between 1 wt % and 6 wt % plant-based fiber. The meat alternative formulation may comprise between 2 wt % and 4 wt % plant-based fiber. The meat alternative formulation may comprise at least 4 wt % plant-based fiber. The meat alternative formulation may comprise at least 5 wt % plant-based fiber. The meat alternative formulation may comprise at least 6 wt % plant-based fiber. The meat alternative formulation may comprise at least 8 wt % plant-based fiber.

In general, the amount of the fat in the meat alternative burger formulation ranges from about 1 wt % to about 30 wt % based on the total weight of the meat alternative formulation. In various embodiments, the amount of the fat in the meat alternative formulation ranges from about 1 wt % to about 30 wt %, from about 5 wt % to about 20 wt %, from 8 wt % to about 18 wt %, or from 12 wt % to about 17.5 wt % based on the total weight of the meat alternative formulation. In one embodiment, the amount of the fat in the meat alternative formulation is about 15 wt % based on the total weight of the meat alternative formulation.

When present, the amount of the binder in the meat alternative burger formulation generally ranges from about 0.1 wt % to about 5 wt % based on the total weight of the meat alternative burger formulation. In various embodiments, the amount of the binder in the meat alternative burger formulation ranges from about 0.1 wt % to about 5 wt %, from about 0.2 wt % to about 2 wt %, from about 0.25 wt % to about 1.5 wt %, or from 0.3 wt % to about 0.7 wt % based on the total weight of the meat alternative burger formulation. In one embodiment, the amount of the binder in the meat alternative burger formulation is about 0.5 wt % based on the total weight of the meat alternative burger formulation. The binder may comprise methyl cellulose, citrus fiber, corn starch, and maltodextrin.

The amount of the flavor enhancer in the meat alternative burger formulation, when present, typically ranges from about 1 wt %, 2 wt %, 3 wt %, 4 wt %, 5 wt %, or 6 wt %, or a range thereof, based on the total weight of the meat alternative burger formulation, and particularly about 6 wt %. In various embodiments, the amount of the flavor enhancer in the meat alternative burger formulation ranges from about 0.01 wt % to about 1 wt %, from about 0.05 wt % to about 0.5 wt %, or from 0.1 wt % to about 0.2 wt % based on the total weight of the meat alternative burger formulation. In one embodiment, the amount of the flavor enhancer in the meat alternative burger formulation is about 0.15 wt % based on the total weight of the meat alternative formulation.

Generally, the amount of water in the meat alternative burger formulation ranges from about 10 wt % to about 90 wt % based on the total weight of the meat alternative burger formulation. In various embodiments, the amount of the water in the meat alternative burger formulation ranges from about 10 wt % to about 80 wt %, from about 20 wt % to about 70 wt %, from about 30 wt % to about 60 wt %, or from 40 wt % to about 50 wt % based on the total weight of the meat alternative burger formulation. In one embodiment, the amount of the water in the meat alternative burger formulation is about 44 wt % based on the total weight of the meat alternative formulation.

The meat alternative burger formulation may comprise one or more connective tissue analogs disclosed herein. The connective tissue analog may comprise ingredients of the meat alternative burger formulation, such as the hydrocolloid, the plant-based fiber, and the plant-based protein, as well as portions and combinations thereof. The connective tissue analog may be processed (e.g., comminuted to form desiccated gel particles) to adopt physical and sensory properties reminiscent of animal-based connective tissues. As these properties may be retained upon incorporation into the meat alternative burger formulation, the connective tissue analog can impact the flavor, appearance, texture, and cooking behavior of the meat alternative burger formulation, even when present in relatively low amounts (e.g., 1 wt %). The meat alternative burger formulation may comprise at least about 0.25% (weight/weight), at least about 0.5% (weight/weight), at least about 0.75% (weight/weight), at least about 1%, at least about 1.5%, at least about 2%, at least about 2.5%, at least about 3%, at least about 3.5%, at least about 4%, at least about 4.5%, or at least about 5% of a connective tissue analog, or a plurality of connective tissue analogs thereof. The meat alternative burger formulation may comprise at most about 5%, at most about 4.5%, at most about 4%, at most about 3.5%, at most about 3%, at most about 2.5%, at most about 2%, at most about 1.5%, at most about 1%, at most about 0.75%, at most about 0.5%, or at most about 0.25% of a connective tissue analog, or a plurality of connective tissue analogs thereof. The meat alternative burger formulation can comprise from about 0.1 to about 10 wt %, about 0.2 to about 5 wt %, about 0.3 to about 4 wt %, about 0.4 to about 3 wt %, about 0.5 to about 2 wt %, about 0.5 to about 1.5 wt %, about 1.0 to about 2.0 wt %, about 1.0 to about 3.0 wt %, about 1.5 to about 2.0 wt %, about 1.5 to about 2.5 wt %, about 2.0 to about 3.0 wt %, about 2.5 to about 3.0 wt %, about 2.5 to about 3.5 wt %, about 3.0 to about 4.0 wt %, about 3.5 to about 4.5 wt %, about 4.0 to about 5.0 wt %, about 0.1 to about 0.5 wt %, about 0.5 to about 1.0 wt %, about 1.0 to about 1.5 wt %, about 1.5 to about 2.0 wt %, about 2.0 to about 2.5 wt %, about 2.5 to about 3.0 wt %, about 3.0 to about 3.5 wt %, about 3.5 to about 4.0 wt %, about 4.0 to about 4.5 wt %, about 4.5 to about 5.0 wt %, less than about 5.0 wt % of the meat analog product, less than about 4.0 wt %, less than about 3.0 wt %, less than about 2.5 wt %, less than about 2.0 wt %, less than about 1.5 wt %, less than about 1.0 wt %, or less than about 0.5 wt % of the meat analog product. Specifically, the inclusion rate may be about 0.1 wt %, about 0.2 wt %, about 0.3 wt %, about 0.4 wt %, about 0.5%, about 0.6 wt %, about 0.7 wt %, about 0.8 wt %, about 0.9 wt %, about 1.0 wt %, about 1.2 wt %, about 1.5 wt %, about 1.7 wt %, about 2.0 wt %, about 2.5 wt % or about 3.0 wt %. For example, in some specific aspects the inclusion rate is between about 0.5 wt % to about 2 wt % or about 0.5 wt % to about 3 wt %. The meat alternative burger formulation can comprise at least 1, at least 2, at least 3, at least 4, or at least 5 connective tissue analogs. The meat alternative burger formulation may comprise at most 5, at most 4, at most 3, at most 2, or at most 1 connective tissue analog. It is noted that including too high a percentage of a connective tissue analog in a meat alternative composition may provide an undesirably chewy effect for ground meat alternative, whereas in other meat alternative compositions such as in steak, sausage or jerky analogs, a relatively high degree of toughness or chewiness may be desirable.

The meat alternative burger formulation may also comprise a mineral, a polyunsaturated fatty acid, or a combination thereof.

In specific embodiments, the meat alternative burger formulation comprises combinations of ingredients as outlined in TABLES 1-10 below.

TABLE 1
EXAMPLE OF MEAT ALTERNATIVE
BURGER FORMULATION

| | Amount |
|---|---|
| INGREDIENT | (weight %) |
| Heme protein (d.b) | 0.2% to 2.0% |
| Plant-based protein | 0.5% to 40.0% |
| Water | 10.0% to 80.0% |

TABLE 2
EXAMPLE OF MEAT ALTERNATIVE
BURGER FORMULATION

| | Amount |
|---|---|
| INGREDIENT | (weight %) |
| Myoglobin (e.g., bovine myoglobin) (d.b.) | 0.2% to 2.0% |
| Soy protein, canola protein, rice protein, pea protein, | 0.5% to 40.0% |
| mung bean protein, chickpea protein, fava bean | |
| protein, or any combination thereof | |
| Distilled water, deionized water, mineral water, | 10.0% to 80.0% |
| or any combination thereof | |

TABLE 3
EXAMPLE OF MEAT ALTERNATIVE
BURGER FORMULATION

| | Amount |
|---|---|
| INGREDIENT | (weight %) |
| Heme protein (d.b.) | 0.2% to 2.0% |
| Plant-based protein | 0.5% to 40.0% |
| Plant-based fiber | 0.5% to 8% |
| Fat | 1% to 30% |
| Water | 10.0% to 80.0% |

TABLE 4
EXAMPLE OF MEAT ALTERNATIVE
BURGER FORMULATION

| | Amount |
|---|---|
| INGREDIENT | (weight %) |
| Myoglobin (e.g., bovine myoglobin) (d.b.) | 0.2% to 2.0% |
| Soy protein, canola protein, rice protein, pea protein, | 0.5% to 40.0% |
| mung bean protein, chickpea protein, fava bean | |
| protein, or any combination thereof | |
| Inulin, citrus fiber, maltodextrin, or any combination | 0.5% to 8% |
| thereof | |
| Coconut oil, sunflower oil, cocoa butter, palm oil, | 1% to 30% |
| canola oil, or any combination thereof | |
| Distilled water, deionized water, tap water, | 10.0% to 80.0% |
| mineral water, or any combination thereof | |

TABLE 5
EXAMPLE OF MEAT ALTERNATIVE
BURGER FORMULATION

| | Amount |
|---|---|
| INGREDIENT | (weight %) |
| Heme protein (d.b.) | 0.2% to 2.0% |
| Plant-based protein | 0.5% to 40.0% |
| Hydrocolloid | 0.5% to 5% |
| Plant-based fiber | 0.5% to 8% |
| Fat | 1% to 30% |
| Binder | 0.1% to 5% |
| Water | 10.0% to 80.0% |

TABLE 6
EXAMPLE OF MEAT ALTERNATIVE
BURGER FORMULATION

| | Amount |
|---|---|
| INGREDIENT | (weight %) |
| Myoglobin (e.g., bovine myoglobin) (d.b.) | 0.2% to 2.0% |
| Soy protein, canola protein, rice protein, pea protein, | 0.5% to 40.0% |
| mung bean protein, chickpea protein, fava bean | |
| protein, or any combination thereof | |
| Konjac flour, methyl cellulose, gum Arabic, | 0.5% to 5% |
| carrageenan, or any combination thereof | |
| Inulin, citrus fiber, maltodextrin, or any | 0.5% to 8% |
| combination thereof | |
| Coconut oil, sunflower oil, cocoa butter, palm oil, | 1% to 30% |
| canola oil, or any combination thereof | |
| Corn starch, potato starch, or any combination thereof | 0.1% to 5% |
| Distilled water, deionized water, mineral water, | 10.0% to 80.0% |
| or any combination thereof | |

TABLE 7
EXAMPLE OF MEAT ALTERNATIVE
BURGER FORMULATION

| | Amount |
|---|---|
| INGREDIENT | (weight %) |
| Heme protein (d.b.) | 0.2% to 2.0% |
| Plant-based protein | 0.5% to 30.0% |
| Hydrocolloid | 1.5% to 3.5% |
| Plant-based fiber | 1.0% to 6.0% |
| Fat | 5.0% to 20.0% |
| Binder | 0.2% to 2.0% |
| Water | 30.0% to 60.0% |
| Mineral | 0.3% to 2.0% |
| Polyunsaturated fatty acid | 0.3% to 2.0% |

TABLE 8
EXAMPLE OF MEAT ALTERNATIVE
BURGER FORMULATION

| | Amount |
|---|---|
| INGREDIENT | (weight %) |
| Myoglobin (e.g., bovine myoglobin) (d.b.) | 0.2% to 2.0% |
| Soy protein, canola protein, rice protein, pea protein, | 0.5% to 30.0% |
| mung bean protein, chickpea protein, fava bean | |
| protein, or any combination thereof | |
| Konjac flour, methyl cellulose, gum Arabic, and | 1.5% to 3.5% |
| carrageenan, or any combination thereof | |
| Inulin, citrus fiber, maltodextrin, or any combination | 1.0% to 6.0% |
| thereof | |
| Coconut oil, sunflower oil, cocoa butter, palm oil, | 5.0% to 20.0% |
| canola oil, or any combination thereof | |
| Corn starch, potato starch, or any combination thereof | 0.2% to 2.0% |
| Distilled water, deionized water, mineral water, or any | 30.0% to 60.0% |
| combination thereof | |
| Sodium chloride (NaCl), potassium chloride (KCl), | 0.3% to 2.0% |
| potassium iodide (KI), or any combination thereof | |
| Omega-3 fatty acid | 0.3% to 2.0% |

TABLE 9
EXAMPLE OF MEAT ALTERNATIVE
BURGER FORMULATION

| | Amount |
|---|---|
| INGREDIENT | (weight %) |
| Heme protein (d.b.) | 0.2% to 2.0% |
| Plant-based protein | 0.5% to 25.0% |
| Hydrocolloid | 2.0% to 3.0% |
| Plant-based fiber | 2.0% to 4.0% |
| Fat | 12.0% to 17.5% |
| Binder | 0.3% to 0.7% |
| Water | 40.0% to 50.0% |
| Mineral | 0.5% to 1.5% |
| Polyunsaturated fatty acid | 0.5% to 1% |

TABLE 10
EXAMPLE OF MEAT ALTERNATIVE
BURGER FORMULATION

| | Amount |
|---|---|
| INGREDIENT | (weight %) |
| Myoglobin (e.g., bovine myoglobin) (d.b.) | 0.2% to 2.0% |
| Soy protein, canola protein, rice protein, pea protein, | 0.5% to 25.0% |
| mung bean protein, chickpea protein, fava bean | |
| protein, or any combination thereof | |
| Konjac flour, methyl cellulose, gum Arabic, and | 2.0% to 3.0% |
| carrageenan, or any combination thereof | |
| Inulin, citrus fiber, maltodextrin, or any combination | 2.0% to 4.0% |
| thereof | |
| Coconut oil, sunflower oil, cocoa butter, palm oil, | 12.0% to 17.5% |
| canola oil, or any combination thereof | |
| Corn starch, potato starch, or any combination thereof | 0.3% to 0.7% |
| Distilled water, deionized water, mineral water, or any | 40.0% to 50.0% |
| combination thereof | |
| Sodium chloride (NaCl), potassium chloride (KCl), | 0.5% to 1.5% |
| potassium iodide (KI), or any combination thereof | |
| Omega-3 fatty acid | 0.5% to 1% |

### (d) Meat Alternative Nugget Formulations

The meat alternative formulation can be a meat alternative nugget formulation, with physical, sensory, and cooking properties reminiscent of animal meat-based nuggets. The meat alternative nugget formulation can mimic chicken, turkey, ostrich, duck, goose, pork, beef, sheep, goat, bison, deer, elk, or moose-based nuggets. In certain cases, the meat alternative nugget formulation imitates the texture, flavor, appearance, and cooking behavior of bird meat nuggets. In many cases, the meat alternative nugget formulation imitates qualities of chicken meat-based nuggets. Among the aspects of the meat alternative nugget formulation disclosed herein are a 'meat alternative nugget formulation, typically containing relatively and relatively low fat content, and a meat alternative nugget formulation, often comprising a composition similar to those of the meat alternative burger formulation.

(d-i) Meat Alternative Nugget Formulation I

Disclosed herein is a meat alternative nugget formulation. Differing from many instances of the meat alternative burger formulation, which typically contains relatively low plant-based fiber content of less than about 6 wt %, the meat alternative nugget formulation often comprises greater than 30 wt %, and often greater than 40 wt % plant-based ingredient. Conversely, the meat alternative nugget formulation typically contains less than one fifth of the protein and heme content of the meat alternative burger formulation. Furthermore, to reproduce the spongy, pliably texture of associated with nuggets, the meat alternative nugget formulation typically comprises lower connective tissue analog content than the meat alternative burger formulation, with connective tissue analog content often below 0.5 wt %.

The meat alternative nugget formulation can comprise a plant-based fiber and a plant-based protein. In some cases, the meat alternative nugget formulation is provided in dry form. In other cases, the meat alternative nugget formulation comprises water. In some cases, the meat alternative nugget formulation further comprises fat. In some cases, the meat alternative nugget formulation further comprises a hydrocolloid. In some cases, the meat alternative nugget formulation comprises a plant-based fiber, a plant-based protein, and fat. In some cases, the meat alternative nugget formulation comprises a plant-based fiber, a plant-based protein, and a hydrocolloid. In some cases, the meat alternative nugget formulation comprises a plant-based fiber, a plant-based protein, fat, and a hydrocolloid. In some cases, the meat alternative nugget formulation further comprises heme. In some cases, the meat alternative nugget formulation further comprises a flavor enhancer. In some cases, the meat alternative nugget formulation comprises (e.g., is coated in) breading.

Generally, the meat alternative nugget formulation comprises from about 0.02 wt % to about 0.5 wt % heme prep (not d.b.) based on the total weight of the formulation. In various embodiments, the wt % of the heme protein in the meat alternative nugget formulation ranges from about 0.02 wt % to about 0.2 wt %, from about 0.02 wt % to about 0.25 wt %, from about 0.05 wt % to about 0.4 wt %, or from about 0.1 wt % to about 0.3 wt % based on the total weight of the formulation. In one embodiment, the wt % of the heme protein is about 0.2 wt % based on the total weight of the meat alternative nugget formulation. In one example, the heme protein is contained in HEMAMI™ prep (solution) (not d.b.).

In typical embodiments of the meat alternative nugget formulation, the plant-based protein (e.g., a single protein, a plurality of proteins, or a plurality of protein compositions from a plurality of plant sources) in the meat alternative formulation ranges from about 0.5 wt % to about 20 wt % based on the total weight of the meat alternative formulation. In various embodiments, the amount of the plant-based protein in the meat alternative formulation ranges from about 0.5 wt % to about 15 wt %, from about 1 wt % to about 15 wt %, from about 2 wt % to about 15 wt %, from about 3 wt % to about 14 wt %, from about 3.5 wt % to about 13 wt %, or from about 5.5 wt % to about 13 wt % based on the total weight of the meat alternative formulation. In one embodiment, the wt % of the plant-based protein is about 12.5 or 12.33 wt % based on the total weight of the meat alternative nugget formulation. In one example, the meat alternative formulation comprises between about 2 wt % and about 4 wt % of pea protein and between about 2.5 wt % and 4.5 wt % wheat gluten. In one example, the meat alternative nugget formulation comprises about 8.55 wt % pea protein (of which about 5.4 wt % is provided by ROVITARIS VEGAN FIBERS PX 1016), and about 3.78 wt % wheat gluten. The meat alternative nugget formulation may comprise 30 wt % to 55 wt %, 40 wt %, 45 wt %, or 50 wt % ROVITARIS VEGAN FIBERS PX 1016, which may be constituted by 12% plant-based fat (which may be canola oil), 12% plant-based protein (which may be a pea protein), and 3% plant-based fiber (which may be a citrus fiber). ROVITARIS VEGAN FIBERS PX 1016 may comprise water, pea protein isolate (about 12 wt % of the ROVITARIS product), canola oil (about 12 wt % of the ROVITARIS product), sodium alginate, citrus fiber (about 3 wt % of the ROVITARIS product), and calcium chloride. In one example, the meat alternative nugget formulation comprises about 45 wt % ROVITARIS VEGAN FIBERS PX 1016.

The meat alternative nugget formulation can comprise at most 3.2 wt % hydrocolloids (e.g., wt %). In some cases, the meat alternative nugget formulation comprises at most 2.5 wt % hydrocolloids. In some cases, the meat alternative nugget formulation comprises at most 2 wt % hydrocolloids. In some cases, the meat alternative nugget formulation comprises at most 1.2 wt % hydrocolloids. In some cases, the meat alternative nugget formulation comprises between about 0.6 wt % and 3.2 wt %, between about 0.75 wt % and about 2.75 wt %, between about 0.75 wt % and about 2.25 wt %, between about 1 wt % and about 2.5 wt %, between about 1 wt % and about 2.2 wt %, between about 1.2 wt % and about 2.2 wt %, or between about 1.35 wt % and about 1.85 wt % hydrocolloids. In some cases, the meat alternative nugget formulation comprises about 1.63 wt % hydrocolloids.

The meat alternative nugget formulation may comprise between about 1 wt % and about 5 wt % plant-based fiber. The meat alternative nugget formulation may comprise between about 1 wt % and about 3 wt % plant-based fiber. The meat alternative nugget formulation may comprise about 1, 1.05, 1.1, 1.15, 1.20, 1.25, 1.30, 1.35, 1.40, 1.45, 1.50, 1.55, 1.60, 1.65, 1.70, 1.75, 1.80, 1.85, 1.90, 1.95, or 2.00 wt % plant-based fiber, or a range of two of the foregoing values.

In general, the amount of fat in the meat alternative nugget formulation ranges from about 0.3 wt % to about 9 wt % based on the total weight of the meat alternative nugget formulation. In various embodiments, the amount of fat in the meat alternative formulation ranges from about 0.5 wt % to about 4.5 wt %, about 4 wt % to about 8 wt %, or about 5 wt % to about 7 wt % fat based on the total weight of the meat alternative formulation. The meat alternative nugget formulation may comprise about 5.0, 5.5, 6.0, 6.1, 6.2, 6.3, 6.4, 6.5, 6.6, 6.7, 6.8, 6.9, or 7.0 wt % fat, or a range of two of the foregoing values. In one embodiment, the amount of the fat in the meat alternative formulation is about 6.6 wt % based on the total weight of the meat alternative formulation.

When present, the amount of binder in the meat alternative nugget formulation generally ranges from about 0.05 wt % to about 1 wt % based on the total weight of the meat alternative nugget formulation. In various embodiments, the amount of the binder in the meat alternative nugget formulation ranges from about 0.1 wt % to about 0.8 wt %, from about 0.2 wt % to about 0.6 wt %, or from about 0.25 wt % to about 0.5 wt % based on the total weight of the meat alternative nugget formulation. In one embodiment, the amount of the binder in the meat alternative nugget formulation is about 0.1 wt % based on the total weight of the meat alternative nugget formulation. In another embodiment, the meat alternative nugget formulation does not comprise binder.

The amount of the flavor enhancer in the meat alternative nugget formulation, when present, typically ranges from about 0.5 wt % to about 7 wt % based on the total weight of the meat alternative nugget formulation. In various embodiments, the amount of the flavor enhancer in the meat alternative nugget formulation ranges from about 1 wt % to about 5 wt %, from about 1.5 wt % to about 4.5 wt %, from 2 wt % to about 4 wt %, or from about 2.5 wt % to about 3.5 wt % based on the total weight of the meat alternative nugget formulation. In one embodiment, the amount of the flavor enhancer in the meat alternative nugget formulation is about 3.15 wt % based on the total weight of the meat alternative formulation.

Generally, the amount of water in the meat alternative nugget formulation ranges from about 5 wt % to about 70 wt % based on the total weight of the meat alternative nugget formulation. In various embodiments, the amount of the water in the meat alternative nugget formulation ranges from about 8 wt % to about 70 wt %, from about 12 wt % to about 70 wt %, from about 15 wt % to about 70 wt %, or from about 18.5 wt % to about 70 wt % based on the total weight of the meat alternative nugget formulation. In one embodiment, the amount of the water in the meat alternative nugget formulation is about 55 wt % based on the total weight of the meat alternative formulation.

The meat alternative nugget formulation may comprise a connective tissue analog. The connective tissue analog may be comprised of ingredients of the meat alternative nugget formulation, such as the hydrocolloid, the plant-based fiber, or the plant-based protein, as well as portions and combinations thereof. As for the meat alternative burger formulation, the connective tissue analog may have physical and sensory properties reminiscent of animal-based connective tissues. The meat alternative nugget formulation may comprise at least about 0.1 wt %, at least about 0.2 wt %, or at least about 0.3% of a connective tissue analog, or a plurality of connective tissue analogs thereof. The meat alternative nugget formulation may comprise between about 0.1 wt % and about 1 wt %, between about 0.15 wt % and about 0.8 wt %, between about 0.2 wt % and about 0.6 wt %, between about 0.2 wt % and about 0.45 wt %, between about 0.25 wt % and about 0.45 wt %, or between about 0.3 wt % and about 0.4 wt % of a connective tissue analog, or a plurality of connective tissue analogs thereof. The meat alternative nugget formulation may comprise at least 1, at least 2, at least 3, at least 4, or at least 5 connective tissue analogs. The meat alternative nugget formulation may comprise at most 5, at most 4, at most 3, at most 2, or at most 1 connective tissue analog. In some cases, the meat alternative nugget formulation comprises a perimysium analog and a tendon analog. In some cases, the perimysium analog is in at least about 2-fold, at least about 3-fold, at least about 4-fold, or at least about 5-fold excess of the tendon analog. In some cases, the meat alternative nugget formulation does not comprise a cartilage analog.

The meat alternative nugget formulation may be coated in a breading. The breading may provide a coating which crisps during frying or baking, contributing to recognizable nugget appearance and texture in the final cooked product. The dry weight of the breading may comprise between about 4 wt % and 30 wt %, between about 6 wt % and about 30 wt %, between about 6 wt % and about 25 wt %, between about 6 wt % and about 20 wt %, between about 8 wt % and about 30 wt %, between about 8 wt % and about 25 wt %, between about 8 wt % and about 20 wt %, between about 10 wt % and about 25 wt %, between about 10 wt % and about 20 wt %, between about 12 wt % and about 20 wt %, or between about 12 wt % and about 18 wt % of the meat alternative nugget formulation. In specific cases, the dry breading ingredient or ingredients comprise about 15 wt % of the meat alternative nugget formulation. In some cases, the breading comprises about 10% to about 50%, about 15% to about 40%, about 20% to about 35%, or about 25% to about 35% of the water content of the pre-cooked meat alternative nugget formulation.

The meat alternative nugget formulation may also comprise a mineral, a polyunsaturated fatty acid, or a combination thereof.

In specific embodiments, the meat alternative nugget formulation comprises combinations of ingredients as outlined in TABLES 11-18 below.

TABLE 11
EXAMPLE OF MEAT ALTERNATIVE
NUGGET FORMULATION I

| | Amount |
|---|---|
| INGREDIENT | (weight %) |
| Plant-based Fiber | 0.5% to 3% |
| Plant-based protein | 1% to 15% |
| Water | 5% to 70% |

TABLE 12
EXAMPLE OF MEAT ALTERNATIVE
NUGGET FORMULATION I

| | Amount |
|---|---|
| INGREDIENT | (weight %) |
| Inulin, citrus fiber, maltodextrin, fiber provided by | 0.5% to 3% |
| ROVITARIS VEGAN FIBERS PX 1016, or any | |
| combination thereof. | |
| Soy protein, wheat gluten, canola protein, rice protein, pea | 1% to 15% |
| protein, mung bean protein, chickpea protein, fava bean | |
| protein, or any combination thereof | |
| Distilled water, deionized water, tap water, mineral water, | 5% to 70% |
| or any combination thereof | |

TABLE 13
EXAMPLE OF MEAT ALTERNATIVE
NUGGET FORMULATION I

| | Amount |
|---|---|
| INGREDIENT | (weight %) |
| Plant-based Fiber | 1% to 2% |
| Plant-based protein | 3% to 14% |
| Hydrocolloid | 0.75% to 2.75% |
| Fat | 0.5% 8% |
| Water | 8% to 70% |

TABLE 14
EXAMPLE OF MEAT ALTERNATIVE
NUGGET FORMULATION I

| | Amount |
|---|---|
| INGREDIENT | (weight %) |
| Inulin, citrus fiber, maltodextrin, fiber provided by | 1% to 2% |
| ROVITARIS VEGAN FIBERS PX 1016, or any | |
| combination thereof | |
| Soy protein, wheat gluten, canola protein, rice protein, | 3% to 14% |
| pea protein, mung bean protein, chickpea protein, fava | |
| bean protein, or any combination thereof | |
| Konjac flour, methyl cellulose, gum Arabic, | 0.75% to 2.75% |
| carrageenan, or any combination thereof | |
| Coconut oil, sunflower oil, cocoa butter, palm oil, | 0.5% to 7% |
| canola oil, or any combination thereof | |
| Distilled water, deionized water, tap water, | 8% to 70% |
| mineral water, or any combination thereof | |

TABLE 15
EXAMPLE OF MEAT ALTERNATIVE
NUGGET FORMULATION I

| | Amount |
|---|---|
| INGREDIENT | (weight %) |
| Inulin, citrus fiber, maltodextrin, fiber provided by | 1% to 2% |
| ROVITARIS VEGAN FIBERS PX 1016, or any | |
| combination thereof | |
| Wheat gluten, pea protein, or any combination thereof | 3% to 13% |
| Konjac flour, methyl cellulose, gum Arabic, | 0.75% to 2.75% |
| carrageenan, or any combination thereof | |
| Sunflower oil | 0.5% to 4.5% |
| Distilled water, deionized water, tap water, | 8% to 70% |
| mineral water, or any combination thereof | |

TABLE 16
EXAMPLE OF MEAT ALTERNATIVE
NUGGET FORMULATION I

| | Amount |
|---|---|
| INGREDIENT | (weight %) |
| Plant-based Fiber | 0.5% to 3% |
| Plant-based protein | 3.5% to 15% |
| Heme | 0.05% to 0.4% |
| Fat | 1 to 8% |
| Hydrocolloid | 0.75% to 2.75% |
| Breading | 8% to 20% |
| Water | 8% to 70% |

TABLE 17
EXAMPLE OF MEAT ALTERNATIVE
NUGGET FORMULATION I

| | Amount |
|---|---|
| INGREDIENT | (weight %) |
| Inulin, citrus fiber, maltodextrin, fiber provided by | 0.5% to 3% |
| ROVITARIS VEGAN FIBERS PX 1016, or any | |
| combination thereof | |
| Soy protein, wheat gluten, canola protein, rice protein, | 3.5% to 14% |
| pea protein, mung bean protein, chickpea protein, fava | |
| bean protein, or any combination thereof | |
| Myoglobin (e.g., bovine myoglobin) | 0.05% to 0.4% |
| Konjac flour, methyl cellulose, gum Arabic, | 0.85% to 2.5% |
| carrageenan, or any combination thereof | |
| Coconut oil, sunflower oil, cocoa butter, palm oil, | 0.75% to 2.75% |
| canola oil, or any combination thereof | |
| Chicken style predust, batter mix, breader, or any | 8% to 20% |
| combination thereof | |
| Distilled water, deionized water, tap water, | 8% to 70% |
| mineral water, or any combination thereof | |

TABLE 18
EXAMPLE OF MEAT ALTERNATIVE
NUGGET FORMULATION I

| | Amount |
|---|---|
| INGREDIENT | (weight %) |
| Inulin, citrus fiber, maltodextrin, fiber provided by | 0.5% to 2% |
| ROVITARIS VEGAN FIBERS PX 1016, or any | |
| combination thereof | |
| Wheat gluten, pea protein, or any combination thereof | 3.5% to 14% |
| Myoglobin (e.g., bovine myoglobin) | 0.05% to 0.4% |
| Konjac flour, methyl cellulose, gum Arabic, | 0.85% to 2.5% |
| carrageenan, or any combination thereof | |
| Sunflower oil | 0.75% to 2.75% |
| Chicken style predust, batter mix, breader, or any | 8% to 20% |
| combination thereof | |
| Distilled water, deionized water, tap water, | 8% to 35% |
| mineral water, or any combination thereof | |

(d-ii) Meat Alternative Nugget Formulation II

Disclosed herein is a meat alternative nugget formulation. While also mimicking the properties of animal meat nuggets, the meat alternative nugget formulation typically comprises ingredient ratios closer to those of the meat alternative burger formulation than the high fiber meat alternative nugget formulation. In particular, the meat alternative nugget formulation often comprises higher plant-based protein and water content, and lower plant-based fiber content than the high fiber meat alternative nugget formulation. In fact, in certain cases, the meat alternative nugget formulation comprises no plant-based fiber. Further contrasting the high fiber meat alternative nugget formulation, the meat alternative nugget formulation often comprises cartilage, perimysium, and tendon analogs.

The meat alternative nugget formulation may comprise a plant-based protein and a hydrocolloid. In some cases, the meat alternative nugget formulation further comprises fat. In some cases, the meat alternative nugget formulation further comprises a hydrocolloid. In such cases, the meat alternative nugget formulation may comprise a plant-based protein, a hydrocolloid, a fat, and a hydrocolloid. In some cases, the meat alternative nugget formulation comprises a plant-based fiber. In other cases, the meat alternative nugget formulation comprises no plant-based fiber content. In some cases, the meat alternative nugget formulation further comprises a flavor enhancer. The meat alternative nugget formulation may be provided in dry or hydrated form. In some cases, the meat alternative nugget formulation comprises breading.

Generally, the meat alternative nugget formulation comprises from about 0.02 wt % to about 0.5 wt % heme (solution not in d.b.), based on the total weight of the meat alternative formulation. In various embodiments, the wt % of the heme protein in the meat alternative nugget formulation ranges from about 0.02 wt % to about 0.2 wt %, from about 0.02 wt % to about 0.25 wt %, from about 0.05 wt % to about 0.4 wt %, or from about 0.1 wt % to about 0.3 wt % based on the total weight of the meat alternative formulation. In one embodiment, the wt % of the heme protein is about 0.2 wt % based on the total weight of the meat alternative nugget formulation. In one example, the heme protein is contained in HEMAMI™.

The meat alternative nugget formulation may comprise from about 3 wt % to 36 wt % of the plant-based protein (e.g., a single protein, a plurality of proteins, or a plurality of protein compositions from a plurality of plant sources) In various embodiments, the amount of the plant-based protein in the meat alternative nugget formulation ranges from about 6 wt % to about 30 wt %, from about 6 wt % to about 26 wt %, from about 8 wt % to about 30 wt %, from about 8 wt % to about 24 wt %, from about 10 wt % to about 22 wt %, from about 12 wt % to about 20 wt %, from about 13 wt % to about 19 wt %, or from about 14 wt % to about 18 wt % based on the total weight of the meat alternative nugget formulation. In one embodiment, the wt % of the plant-based protein is about 18.4 wt % based on the total weight of the meat alternative nugget formulation. In one example, the meat alternative formulation comprises between about 7 wt % and about 11 wt % of pea protein and between about 7 wt % and 11 wt % wheat gluten.

The meat alternative nugget formulation may comprise at most 3.2 wt % hydrocolloids (e.g., wt %). In some cases, the meat alternative nugget formulation comprises at most 2.5 wt % hydrocolloids. In some cases, the meat alternative nugget formulation comprises at most 2 wt % hydrocolloids. In some cases, the meat alternative nugget formulation comprises at most 1.2 wt % hydrocolloids. In some cases, the meat alternative nugget formulation comprises between about 0.6 wt % and 3.2 wt %, between about 0.75 wt % and about 2.75 wt %, between about 0.75 wt % and about 2.25 wt %, between about 1 wt % and about 2.5 wt %, between about 1 wt % and about 2.2 wt %, between about 1.2 wt % and about 2.2 wt %, or between about 1.35 wt % and about 1.85 wt % hydrocolloids. In some cases, the meat alternative nugget formulation comprises about 1.63 wt % hydrocolloids.

In some cases, the meat alternative nugget formulation comprises no plant-based fiber. In some cases, the meat alternative nugget formulation only comprises plant-based fiber contributed from flavor enhancers. The meat alternative nugget formulation may comprise between about 0.05 wt % and about 5 wt %, between about 0.05 wt % and about 2 wt %, between about 0.1 wt % and about 2 wt %, between about 0.2 wt % and about 1 wt %, or between about between about 0.25 wt % and about 0.5 wt % plant-based fiber.

In general, the amount of fat in the meat alternative nugget formulation ranges from about 0.3 wt % to about 6 wt % based on the total weight of the meat alternative nugget formulation. In various embodiments, the amount of fat in the meat alternative formulation ranges from about 0.6 wt % to about 4.5 wt %, from about 0.8 wt % to about 3.6 wt %, from about 1 wt % to about 2.6 wt %, or from 1.1 wt % to about 1.7 wt % fat based on the total weight of the meat alternative formulation. In one embodiment, the amount of the fat in the meat alternative formulation is about 1.37 wt % based on the total weight of the meat alternative formulation.

When present, the amount of binder in the meat alternative nugget formulation generally ranges from about 0.05 wt % to about 1 wt % based on the total weight of the meat nugget formulation. In various embodiments, the amount of the binder in the meat alternative nugget formulation ranges from about 0.1 wt % to about 0.8 wt %, from about 0.2 wt % to about 0.6 wt %, or from about 0.25 wt % to about 0.5 wt % based on the total weight of the meat alternative nugget formulation. In one embodiment, the amount of the binder in the meat alternative nugget formulation is about 0.1 wt % based on the total weight of the meat alternative nugget formulation. In another embodiment, the meat alternative nugget formulation does not comprise binder.

The amount of the flavor enhancer in the meat alternative nugget formulation, when present, typically ranges from about 0.5 wt % to about 7 wt % based on the total weight of the meat alternative nugget formulation. In various embodiments, the amount of the flavor enhancer in the meat alternative nugget formulation ranges from about 1 wt % to about 5 wt %, from about 1.5 wt % to about 4.5 wt %, from 2 wt % to about 4 wt %, or from about 2.5 wt % to about 3.5 wt % based on the total weight of the meat alternative nugget formulation. In one embodiment, the amount of the flavor enhancer in the meat alternative nugget formulation is about 3.15 wt % based on the total weight of the meat alternative formulation.

Generally, the amount of water in the meat alternative nugget formulation ranges from about 25 wt % to about 75 wt % based on the total weight of the meat alternative nugget formulation. In various embodiments, the amount of the water in the meat alternative nugget formulation ranges from about 25 wt % to about 70 wt %, from about 30 wt % to about 70 wt %, from about 30 wt % to about 65 wt %, from about 35 wt % to about 65 wt %, from about 40 wt % to about 65 wt %, or from about 45 wt % to about 65 wt % water based on the total weight of the meat alternative nugget formulation. In one embodiment, the amount of the water in the meat alternative nugget formulation is about 55.1 wt % based on the total weight of the meat alternative nugget formulation.

The meat alternative nugget formulation may comprise a connective tissue analog. The connective tissue analog may be comprised of ingredients of the meat alternative nugget formulation, such as the hydrocolloid, the plant-based fiber, or the plant-based protein, as well as portions and combinations thereof. The meat alternative nugget formulation may comprise from about 0.3 wt % to about 6 wt %, from about 0.5 wt % to about 5 wt %, from about 0.75 wt % to about 4.5 wt %, from about 0.75 wt % to about 3.5 wt %, from about 0.85 wt % to about 3 wt %, from about 1 wt % to about 2.5 wt %, from about 1 wt % to about 2 wt %, or from about 1.2 wt % to about 1.8 wt % connective tissue analog based on the total weight of the meat alternative nugget formulation. The meat alternative nugget formulation may comprise at least 1, at least 2, at least 3, at least 4, or at least 5 connective tissue analogs. The meat alternative nugget formulation may comprise at most 5, at most 4, at most 3, at most 2, or at most 1 connective tissue analog. In some cases, the meat alternative nugget formulation comprises a cartilage analog, a perimysium analog, and a tendon analog. In such cases, the cartilage analog may be present as less than 30%, less than 25%, less than 22%, or less than 20% of the total connective tissue analog content of the meat alternative nugget formulation. In some cases, the cartilage, perimysium, and tendon analogs are present in an about 1:2:2 ratio.

The meat alternative nugget formulation may be coated in a breading. In dry form, the breading may comprise between about 4 wt % and 30 wt %, between about 6 wt % and about 30 wt %, between about 6 wt % and about 25 wt %, between about 6 wt % and about 20 wt %, between about 8 wt % and about 30 wt %, between about 8 wt % and about 25 wt %, between about 8 wt % and about 20 wt %, between about 10 wt % and about 25 wt %, between about 10 wt % and about 20 wt %, between about 12 wt % and about 20 wt %, or between about 12 wt % and about 18 wt % of the meat alternative nugget formulation. In specific cases, the dry breading ingredient or ingredients comprise about 15 wt % of the meat alternative nugget formulation. The breading comprises about 10% to about 50%, about 15% to about 40%, about 20% to about 35%, or about 25% to about 35% of the water content of the pre-cooked meat alternative nugget formulation.

The meat alternative burger formulation may also comprise a mineral, a polyunsaturated fatty acid, or a combination thereof.

In specific embodiments, the meat alternative nugget formulation comprises combinations of ingredients as outlined in TABLES 19-26 below.

TABLE 19
EXAMPLE OF A MEAT ALTERNATIVE
NUGGET FORMULATION II

| | Amount |
|---|---|
| INGREDIENT | (weight %) |
| Plant-based protein | 10% to 22% |
| Hydrocolloid | 0.75% to 2.75% |
| Water | 30% to 70% |

TABLE 20
EXAMPLE OF A MEAT ALTERNATIVE
NUGGET FORMULATION II

| | Amount |
|---|---|
| INGREDIENT | (weight %) |
| Soy protein, wheat gluten, canola protein, rice protein, | 10% to 22% |
| pea protein, mung bean protein, chickpea protein, | |
| fava bean protein, or any combination thereof | |
| Konjac flour, methyl cellulose, gum Arabic, | 0.75% to 2.75% |
| carrageenan, or any combination thereof | |
| Distilled water, deionized water, tap water, | 30% to 70% |
| mineral water, or any combination thereof | |

TABLE 21
EXAMPLE OF A MEAT ALTERNATIVE
NUGGET FORMULATION II

| | Amount |
|---|---|
| INGREDIENT | (weight %) |
| Plant-based protein | 10% to 22% |
| Hydrocolloid | 0.75% to 2.75% |
| Fat | 0.8% to 3.6% |
| Water | 30% to 70% |

TABLE 22
EXAMPLE OF A MEAT ALTERNATIVE
NUGGET FORMULATION II

| | Amount |
|---|---|
| INGREDIENT | (weight %) |
| Soy protein, wheat gluten, canola protein, rice protein, | 10% to 22% |
| pea protein, mung bean protein, chickpea protein, fava | |
| bean protein, or any combination thereof | |
| Konjac flour, methyl cellulose, gum Arabic, | 0.75% to 2.75% |
| carrageenan, or any combination thereof | |
| Coconut oil, sunflower oil, cocoa butter, palm | 0.8% to 3.6% |
| oil, canola oil, or any combination thereof | |
| Distilled water, deionized water, tap water, | 30% to 70% |
| mineral water, or any combination thereof | |

TABLE 23
EXAMPLE OF A MEAT ALTERNATIVE
NUGGET FORMULATION II

| | Amount |
|---|---|
| INGREDIENT | (weight %) |
| Soy protein, wheat gluten, canola protein, rice protein, | 10% to 22% |
| pea protein, mung bean protein, chickpea protein, fava | |
| bean protein, or any combination thereof | |
| Konjac flour, methyl cellulose, gum Arabic, carrageenan, | 1% to 2.25% |
| or any combination thereof | |
| Coconut oil, sunflower oil, cocoa butter, palm oil, canola | 1% to 2.6% |
| oil, or any combination thereof | |
| Distilled water, deionized water, tap water, mineral water, | 40% to 65% |
| or any combination thereof | |

TABLE 24
EXAMPLE OF A MEAT ALTERNATIVE
NUGGET FORMULATION II

| | Amount |
|---|---|
| INGREDIENT | (weight %) |
| Plant-based protein | 10% to 22% |
| Hydrocolloid | 1% to 2.25% |
| Fat | 1% to 2.6% |
| Heme | 0.05% to 0.4% |
| Breading | 8% to 25% |
| Water | 40% to 65% |

TABLE 25
EXAMPLE OF A MEAT ALTERNATIVE
NUGGET FORMULATION II

| | Amount |
|---|---|
| INGREDIENT | (weight %) |
| Soy protein, wheat gluten, canola protein, rice protein, | 10% to 22% |
| pea protein, mung bean protein, chickpea protein, fava | |
| bean protein, or any combination thereof | |
| Konjac flour, methyl cellulose, gum Arabic, carrageenan, | 1% to 2.25% |
| or any combination thereof | |
| Coconut oil, sunflower oil, cocoa butter, palm oil, | 1% to 2.6% |
| canola oil, or any combination thereof | |
| Myoglobin (e.g., bovine myoglobin) | 0.05% to 0.4% |
| Chicken style predust, batter mix, breader, or any | 8% to 25% |
| combination thereof | |
| Distilled water, deionized water, tap water, | 40% to 65% |
| mineral water, or any combination thereof | |

TABLE 26
EXAMPLE OF A MEAT ALTERNATIVE
NUGGET FORMULATION II

| | Amount |
|---|---|
| INGREDIENT | (weight %) |
| Pea protein, wheat gluten, or any combination thereof | 10% to 22% |
| Konjac flour, methyl cellulose, gum Arabic, | 1% to 2.25% |
| carrageenan, or any combination thereof | |
| Sunflower oil | 1% to 2.6% |
| Bovine myoglobin | 0.05% to 0.4% |
| Chicken style predust, batter mix, breader, or | 10% to 20% |
| any combination thereof | |
| Distilled water, deionized water, tap water, | 40% to 65% |
| mineral water, or any combination thereof | |

### (e) Meat Alternative Sausage Formulations

The meat alternative formulation may be a meat alternative sausage formulation, with physical, sensory, and cooking properties akin to those of animal meat-based sausages. The meat alternative sausage formulation may mimic pork, beef, sheep, bison, deer, elk, moose, goat, chicken, turkey, ostrich, duck, or goose based sausage. In many cases, the meat alternative sausage formulation imitates the texture, flavor, appearance, and cooking behavior of pork sausage, which may be bratwurst. Relative to the meat alternative burger and meat alternative nugget formulations, the meat alternative sausage formulation may comprise relatively high fat and plant-based protein content. To reproduce coalesced fat pockets associated with many animal meat sausages, the meat alternative sausage formulation may comprise high melting point fats, such as coconut oil, which may be better retained and render more slowly during cooking than lower melting point fats, such as olive oil.

The meat alternative sausage formulation may comprise a plant-based protein and a fat. In some cases, the meat alternative sausage formulation further comprises a hydrocolloid. In some cases, the meat alternative sausage formulation further comprises a plant-based fiber. In some cases, the meat alternative sausage formulation further comprises a flavor enhancer. In some cases, the meat alternative sausage formulation does not comprise a plant-based fiber. In some cases, the meat alternative sausage formulation comprises a flavor enhancer.

Generally, the meat alternative sausage formulation comprises from about 0.1 wt % to about 1.1 wt % heme d.b. based on the total weight of the meat alternative sausage formulation. In various embodiments, the wt % of the heme protein in the meat alternative sausage formulation ranges from about 0.2 wt % to about 0.9 wt %, from about 0.25 wt % to about 0.85 wt %, from about 0.3 wt % to about 0.6 wt %, from about 0.35 wt % to about 0.55 wt %, or from about 0.4 wt % to about 0.5 wt %. In one embodiment, the heme protein is present at about 0.44 wt %. In one example, the heme protein is contained in HEMAMI™, of which the meat alternative sausage formulation comprises about 5.55 wt % HEMAMI™ solution.

In typical embodiments, the meat alternative sausage formulation comprises from about 8 wt % to about 40 wt %, from about 8 wt % to about 36 wt %, from about 11 wt % to about 33 wt %, from about 12 wt % to about 30 wt %, from about 14 wt % to about 28 wt %, from about 16 wt % to about 28 wt %, from about 18 wt % to about 28 wt %, from about 20 wt % to about 28 wt %, or from about 22 wt % to about 26 wt % of the plant-based protein (e.g., a single protein, a single protein composition, or a plurality of protein compositions from a plurality of plant sources) based on the total weight of the meat alternative formulation. In one example, the plant-based protein comprises about 24% of the total weight of the meat alternative sausage formulation. In another example, the meat alternative sausage formulation comprises between about 16 wt % and about 22 wt % of soy protein (e.g., textured soy protein) and between about 3 wt % and 7 wt % wheat gluten.

The meat alternative sausage formulation may comprise at most about 7 wt % hydrocolloids. In some cases, the meat alternative sausage formulation comprises at most about 5.5 wt % hydrocolloids. In some cases, the meat alternative sausage formulation comprises at most about 4 wt % hydrocolloids. In some cases, the meat alternative sausage formulation comprises at most about 3.5 wt % hydrocolloids. In some cases, the meat alternative sausage formulation comprises between about 1 wt % and 7 wt %, between about 1.5 wt % and about 6 wt %, between about 2 wt % and about 5 wt %, between about 2.5 wt % and about 4.5 wt %, between about 3 wt % and about 4 wt %, or between about 3.2 wt % and about 3.8 wt %, hydrocolloids. In some cases, the meat alternative sausage formulation comprises about 3.5 wt % hydrocolloids. In some cases, at least about 20%, at least about 30%, at least about 40%, at least about 50%, or at least about 60% of the hydrocolloids are provided as connective tissue analogs. In some cases, at most about 60%, at most about 50%, at most about 40%, at most about 30%, or at most about 20% of the hydrocolloids are provided as connective tissue analogs. In some cases, the meat alternative sausage formulation comprises no plant-based fiber.

In general, the amount of fat in the meat alternative sausage formulation ranges from about 4 wt % to about 26 wt % based on the total weight of the meat alternative sausage formulation. In various embodiments, the amount of fat in the meat alternative sausage formulation ranges from about 6 wt % to about 24 wt %, from about 7 wt % to about 22 wt %, from about 8 wt % to about 18 wt %, from 9 wt % to about 16 wt %, from 10 wt % to about 15 wt %, or from 11 wt % to about 15 wt % fat based on the total weight of the meat alternative formulation. In one example, the amount of the fat in the meat alternative sausage formulation is about 13 wt % based on the total weight of the meat alternative formulation. In another example, the meat alternative sausage formulation comprises between about 6 wt % and 10 wt % canola oil and between about 3 wt % and about 7 wt % coconut oil. In some cases, at least about 5%, at least about 10%, at least about 20%, at least about 25%, or at least about 30% of the fat in the meat alternative sausage comprises a melting point above about 20° C. (e.g., coconut oil).

When present, the amount of binder in the meat alternative sausage formulation generally ranges from about 0.05 wt % to about 1 wt % based on the total weight of the meat alternative sausage formulation. In various embodiments, the amount of the binder in the meat alternative sausage formulation ranges from about 0.1 wt % to about 0.8 wt %, from about 0.2 wt % to about 0.6 wt %, or from about 0.25 wt % to about 0.5 wt % based on the total weight of the meat alternative sausage formulation. In one embodiment, the amount of the binder in the meat alternative sausage formulation is about 0.1 wt % based on the total weight of the meat alternative sausage formulation. In another embodiment, the meat alternative sausage formulation does not comprise binder.

The amount of the flavor enhancer in the meat alternative sausage formulation, when present, typically ranges from about 1.5 wt % to about 12 wt % based on the total weight of the meat alternative sausage formulation. In various embodiments, the amount of the flavor enhancer in the meat alternative sausage formulation ranges from about 2 wt % to about 10 wt %, from about 2.5 wt % to about 9 wt %, from 3.5 wt % to about 8 wt %, or from about 4 wt % to about 7 wt % based on the total weight of the meat alternative sausage formulation. In one embodiment, the amount of the flavor enhancer in the meat alternative sausage formulation is about 6 wt % based on the total weight of the meat alternative formulation.

Generally, the amount of water in the meat alternative sausage formulation ranges from about 20 wt % to about 70 wt % based on the total weight of the meat alternative sausage formulation. In various embodiments, the amount of the water in the meat alternative sausage formulation ranges from about 25 wt % to about 65 wt %, from about 35 wt % to about 60 wt %, from about 40 wt % to about 55 wt %, or from about 42.5 wt % to about 52.5 wt % based on the total weight of the meat alternative sausage formulation. In one embodiment, the amount of the water in the meat alternative sausage formulation is about 47.9 wt % based on the total weight of the meat alternative formulation.

The meat alternative sausage formulation may comprise a connective tissue analog. The connective tissue analog may be comprised of ingredients of the meat alternative sausage formulation, such as the hydrocolloid, the plant-based fiber, or the plant-based protein, as well as portions and combinations thereof. The connective tissue analog may have physical and sensory properties reminiscent of animal-based connective tissues. The meat alternative sausage formulation may comprise at least about 0.25 wt %, at least about 0.5 wt %, at least about 0.75% of a connective tissue analog, at least about 1% of a connective tissue analog, or at least about 1.5% of a connective tissue analog or a plurality of connective tissue analogs thereof. The meat alternative sausage formulation may comprise between about 0.4 wt % and about 4.5 wt %, between about 0.6 wt % and about 3.5 wt %, between about 0.8 wt % and about 3 wt %, between about 1 wt % and about 2 wt %, between about 1.2 wt % and about 1.8 wt %, or between about 1.4 wt % and about 1.6 wt % of a connective tissue analog, or a plurality of connective tissue analogs thereof. The meat alternative sausage formulation may comprise at least 1, at least 2, at least 3, at least 4, or at least 5 connective tissue analogs. The meat alternative sausage formulation may comprise at most 5, at most 4, at most 3, at most 2, or at most 1 connective tissue analog. In some cases, the meat alternative sausage formulation comprises a perimysium analog and a tendon analog. In some cases, the perimysium analog is in at least about 2-fold, at least about 3-fold, at least about 4-fold, or at least about 5-fold excess of the tendon analog in the meat alternative sausage formulation. In one example, the meat alternative sausage formulation comprises about 1 wt % of a tendon analog, about 0.5 wt % of a cartilage analog, and about 0.5% of a perimysium analog. In another example, the meat alternative sausage formulation comprises about 0.75 wt % of a cartilage analog and about 0.75 wt % of a tendon analog. In a further example, the meat alternative sausage formulation comprises about 1.5 wt % of a tendon analog. In some cases, the meat alternative sausage formulation does not comprise a cartilage analog.

The meat alternative sausage formulation may comprise a casing. In addition to mimicking the recognizable coating of many animal meat sausages, the casing may seal in water, fat, and flavors during cooking, and help yield a food product reminiscent of animal meat sausages. The casing may comprise a hydrocolloid gel, such as calcium-precipitated sodium alginate.

The meat alternative sausage formulation may also comprise a mineral, a polyunsaturated fatty acid, or a combination thereof.

In specific embodiments, the meat alternative sausage formulation comprises combinations of ingredients as outlined in TABLES 27-31 below.

TABLE 27
EXAMPLE OF A MEAT ALTERNATIVE
SAUSAGE FORMULATION

| | Amount |
|---|---|
| INGREDIENT | (weight %) |
| Plant-based protein | 16% to 40% |
| Fat | 8% to 30% |
| Water | 25% to 60% |

TABLE 28
EXAMPLE OF A MEAT ALTERNATIVE
SAUSAGE FORMULATION

| | Amount |
|---|---|
| INGREDIENT | (weight %) |
| Soy protein, wheat gluten, canola protein, rice protein, pea | 16% to 28% |
| protein, mung bean protein, chickpea protein, fava bean | |
| protein, or any combination thereof | |
| Coconut oil, sunflower oil, cocoa butter, palm oil, | 8% to 18% |
| canola oil, or any combination thereof | |
| Distilled water, deionized water, tap water, | 25% to 60% |
| mineral water, or any combination thereof | |

TABLE 29
EXAMPLE OF A MEAT ALTERNATIVE
SAUSAGE FORMULATION

| | Amount |
|---|---|
| INGREDIENT | (weight %) |
| Soy protein, wheat gluten, or any combination thereof | 16% to 28% |
| Coconut oil, canola oil, or any combination thereof | 8% to 18% |
| Distilled water, deionized water, tap water, mineral water, | 25% to 60% |
| or any combination thereof | |

TABLE 30
EXAMPLE OF A MEAT ALTERNATIVE
SAUSAGE FORMULATION

| | Amount |
|---|---|
| INGREDIENT | (weight %) |
| Plant-based protein | 16% to 28% |
| Fat | 8% to 18% |
| Hydrocolloid | 2.5% to 4.5% |
| Water | 25% to 60% |

TABLE 30
EXAMPLE OF A MEAT ALTERNATIVE
SAUSAGE FORMULATION

| | Amount |
|---|---|
| INGREDIENT | (weight %) |
| Soy protein, wheat gluten, canola protein, rice | 16% to 28% |
| protein, pea protein, mung bean protein, chickpea | |
| protein, fava bean protein, or any combination thereof | |
| Coconut oil, sunflower oil, cocoa butter, palm oil, | 8% to 18% |
| canola oil, or any combination thereof | |
| Konjac flour, methyl cellulose, gum Arabic, | 2.5% to 4.5% |
| carrageenan, or any combination thereof | |
| Distilled water, deionized water, tap water, mineral | 25% to 60% |
| water, or any combination thereof | |

TABLE 31
EXAMPLE OF A MEAT ALTERNATIVE
SAUSAGE FORMULATION

| | Amount |
|---|---|
| INGREDIENT | (weight %) |
| Plant-based protein | 16% to 28% |
| Fat | 8% to 18% |
| Hydrocolloid | 2.5% to 4.5% |
| Flavor Enhancer | 3.5% to 8% |
| Water | 25% to 60% |

### II. Ingredients

(a) Heme protein

The meat alternative formulation may include a heme protein. As used herein, ‘heme protein’ may refer to a protein with comprises or is configured to bind to a heme prosthetic group. Heme prosthetic groups typically comprise one or more highly conjugated rings complexed to an iron. For example, a heme prosthetic group (which may be referred to interchangeably as ‘heme’ or ‘heme moiety’) may denote iron (e.g., Fe⁺², Fe⁺³, or Fe⁺⁴) bound to a porphyrin ring. Examples of heme moieties include, but are not limited to, heme a, heme b, heme c, heme d, heme d1, heme I, heme s, heme o, heme m, and siroheme. In some cases, a heme moiety comprises a porphyrin, porphyrinogen, corrin, corrinoid, chlorin, bacteriochlorophyll, corphin, chlorophyllin, bacteriochlorin, or isobacteriochlorin moiety complexed to an iron ion. A heme protein may possess one or several iron porphyrins. In nature, heme proteins carry out a range of processes, including oxygen transport, catalytic oxidation, catalytic oxygenation, peroxide generation, hypochlorite generation, electron transfer, oxygen reduction, and proton pumping. In nature, there are number of different iron porphyrin variants, such as heme a, heme b, heme c and heme d. Well-studied heme proteins include myoglobin, hemoglobin, horseradish peroxidase, cytochrome b5, and cytochrome P450. Other related applications disclosing preparations and uses of compositions comprising a heme protein are U.S. Provisional Application Ser. No. 63/133,055, filed Dec. 31, 2020, U.S. Provisional Application Ser. No. 63/157,305, filed Mar. 5, 2021, and U.S. Provisional Application Ser. No. 63/271,423, filed Oct. 25, 2021, the entire contents of which are hereby incorporated by reference in their entirety.

A heme moiety may comprise an additional ligand coupled to the iron. The additional ligand may be donated by the heme protein, for example an imidazole, thiol, or thioether of a protein-derived histidine, cysteine, or methionine. The additional ligand may also be non-protein derived, for example a water, hydroxide, or dioxygen molecule bound to heme iron. The iron may be coupled to one or more than one additional ligand, each of which may be reversibly (e.g., superoxide) or irreversibly (e.g., carbon monoxide) bound to the iron. The one or more than one additional ligand may alter a heme property, such as flavor, color, reactivity (e.g., propensity to promiscuously oxidize other species present in a mixture), and stability.

A heme moiety may be covalently or non-covalently bound to a protein. The heme moiety may be bound to a non-peptidic polymer or other macromolecule such as a liposome, a polyethylene glycol, a carbohydrate, a polysaccharide, a cyclodextrin, a polyethyleneimine, a polyacrylate, or derivatives thereof; a siderophore (i.e., an iron chelating compound); or a heme moiety bound to a solid support (e.g., beads) composed of a chromatography resin, cellulose, graphite, charcoal, or diatomaceous earth.

As used herein, the term “heme protein” can be used interchangeably with “heme-containing protein,” “heme-containing polypeptide,” “hemoprotein,” and “heme polypeptide,” and includes any polypeptide that can covalently or noncovalently bind a heme moiety. Accordingly, a heme protein may be provided in apo-form, in which it is not bound to a heme moiety, or in holo-form, in which it is bound to a heme moiety. A heme protein may comprise multiple heme binding sites, each of which may independently be bound or not bound to a heme moiety.

In some embodiments, the heme-containing polypeptide is a globin and can include a globin fold, which comprises a series of seven to nine alpha helices. Globin type proteins can be of any class (e.g., class I, class II, or class III), and in some embodiments, can transport or store oxygen. For example, a heme-containing protein can be a non-symbiotic type of hemoglobin or a myoglobin. A heme-containing polypeptide can be a monomer, i.e., a single polypeptide chain, or can be a dimer, a trimer, tetramer, and/or higher order oligomers. The lifetime of the oxygenated Fe⁺² state of a heme-containing protein can be similar to that of myoglobin or can exceed it by 10%, 20%, 30% 50%, 100% or more under conditions in which the heme-protein-containing consumable is manufactured, stored, handled or prepared for consumption. The lifetime of the unoxygenated Fe⁺² state of a heme protein can be similar to that of myoglobin or can exceed it by 10%, 20%, 30% 50%, 100% or more under conditions in which the heme-protein-containing consumable is manufactured, stored, handled or prepared for consumption.

The heme protein may comprise an oxygen affinity of at most about 1 mM (e.g., 1 mM or higher dissociation constant (K_{d}) for molecular oxygen). The heme protein may comprise an oxygen affinity of at most about 500 μM. The heme protein may comprise an oxygen affinity of at most about 100 μM. As heme proteins change color upon molecular oxygen desorption, a heme protein with a high molecular oxygen affinity may lose color slowly during cooking and may thus may fail to adopt a similar color as cooked meat upon heating.

Non-limiting examples of heme-containing polypeptides include an androglobin, a cytoglobin, a globin E, a globin X, a globin Y, a hemoglobin, a myoglobin, an erythrocruorin, a beta hemoglobin, an alpha hemoglobin, a protoglobin, a cyanoglobin, a cytoglobin, a histoglobin, a neuroglobin, a chlorocruorin, a truncated hemoglobin (e.g., HbN or HbO), a truncated 2/2 globin, a hemoglobin 3 (e.g., Glb3), a cytochrome, a peroxidase, or a combination thereof. A heme protein may be a truncated or mutant form of a known heme protein. For example, a heme protein may comprise at least 80, 85, 90, 95, 98, or 99% sequence similarity with a wild-type heme protein. A heme protein may comprise an additional sequence, such as an N- or C-terminal tag. A heme protein may be provided as a fusion or chimera comprising sequences from two or more polypeptides. A heme protein may comprise an additional cofactor, such as a copper ion, a flavin, or a pterin moiety. A heme protein may comprise a posttranslational modification, such as a tyrosine-histidine crosslink, glycosylation, or phosphorylation.

In particular, the heme protein may comprise a lower glycosylation frequency than its natively expressed counterpart. One example includes a myoglobin, such as bovine myoglobin. Such low glycosylation rates may destabilize the heme protein, thereby enhancing the rates at which it denatures and changes color during cooking. The heme protein of the meat alternative formulation may comprise a glycosylation rate that is at least 25% lower, at least 50% lower, at least 70% lower, at least 90% lower, or at least 95% lower than its natively expressed counterpart. In some cases, less than 50%, less than 30%, less than 10%, less than 5%, or less than 2% of the heme protein of the meat alternative formulation comprises glycosylation.

Myoglobin is a water-soluble heme b protein which is present in many animal meats and is often responsible for meat color. Within the 8 α-helices (often labeled as A-H) of myoglobin, a prosthetic heme group containing a centrally located iron atom is positioned in the protein's hydrophobic core. Of the six bonds associated with this iron atom, four connect iron to the heme ring, the 5th attaches to an axial histidine, and the 6th site is available to reversibly bind ligands including diatomic oxygen, carbon monoxide, water, and nitric oxide. The ligand present at the 6th coordination site and the valence state of iron determine meat color, which can change from purple to red to brown. As myoglobin undergoes a cooking process, it loses the ability to bind oxygen, producing a color change from red to brown. Other reactions in the system occur when heating including Maillard reaction, the chemical reaction between amino acids and reducing sugars that give browned food a distinct cooked flavor.

Hemoglobin is a heme protein present in the red blood cell of vertebrates. In its ferrous state, hemoglobin forms a reversible bond with molecular oxygen in which the iron formally reduces the molecular oxygen to superoxide. In the oxygenated state, it is called oxyhemoglobin and is bright red; in the reduced state, it is purplish blue. Excessive oxygenation of hemoglobin used in the meat alternative formulation leads to formation of metmyoglobin which is brown and undesirable.

The heme protein may be expressed in and/or purified or isolated from a plant, an animal, or a microbe (e.g., a bacterial or yeast expression system). In one example the heme protein is expressed in Pichia pastoris. The heme protein may comprise one or more of bovine myoglobin and hemoglobin produced in a yeast fermentation system. General steps of making a protein from a microbial fermentation system may comprise one or more of sequencing, gene programming and gene assembly, and protein production. In a sequencing step, protein (e.g., a heme protein) expression genes are identified from a natural source of interest. In the present methods, any source of a naturally occurring heme protein is suitable. A plant such as soy and alfalfa, or an animal such as a feedstock animal (cow, pig, chicken, sheep, or lamb), that produces a heme protein of interest may be a suitable source. A gene that encodes a protein (e.g., a heme) of interest may be identified and isolated. In a gene programming and assembly step, the gene may be cloned or chemically synthesized and ligated into a host expression system, such as a yeast expression system. In a heme protein production step, cells (e.g., yeast cells) with the exogenous DNA are maintained for a time and under culture conditions sufficient to activate expression of the desired heme protein. After fermentation, heme proteins are isolated from host cells through routine steps, such as washing to separate cells, disrupting cells, lysate treatment to separate proteins, then isolating desired heme proteins by microfiltration, ultrafiltration, and/or diafiltration. Isolation and purification steps may optionally comprise membrane concentrating. Fermentation-produced heme protein can be formulated and/or stabilized with suitable excipients, and/or stored in suitable conditions for use later, such as storing in frozen temperature for later use. Fermentation-produced proteins can thus produce significant quantities of plant or animal proteins, such as heme proteins, without relying on extraction of the protein directly from animal tissue or animal tissue cells.

Heme-containing proteins that can be used in meat alternative formulation described herein can be expressed in and/or isolated or purified from a plant or an animal such as mammals (e.g., farms animals such as cows, goats, sheep, pigs, ox, or rabbits), birds, algae, fungi (e.g., yeast or filamentous fungi), ciliates, or bacteria. For example, a heme-containing protein can be from a mammal such as a cow, goat, sheep, pig, ox, or rabbit, or from a bird such as a turkey or chicken. Heme-containing proteins can be isolated from or expressed by a plant such as Nicotiana tabacum or Nicotiana sylvestris (tobacco); Zea mays (corn), Arabidopsis thaliana, a legume such as Glycine max (soybean), Cicer arietinum (garbanzo or chick pea), Pisum sativum (pea) varieties such as garden peas or sugar snap peas, Phaseolus vulgaris varieties of common beans such as green beans, black beans, navy beans, northern beans, or pinto beans, Vigna unguiculata varieties (cow peas), Vigna radiata (Mung beans), Lupinus albus (lupin), or Medicago sativa (alfalfa); Brassica napus (canola); Triticum ssp. (wheat, including wheat berries, and spelt); Gossypium hirsutum (cotton); Oryza sativa (rice); Zizania ssp. (wild rice); Helianthus annuus (sunflower); Beta vulgaris (sugarbeet); Pennisetum glaucum (pearl millet); Chenopodium ssp. (quinoa); Sesamum ssp. (sesame); Linum usitatissimum (flax); or Hordeum vulgare (barley). Heme-containing proteins can be isolated from fungi such as Saccharomyces cerevisiae, Pichia pastoris, Magnaporthe oryzae, Fusarium graminearum, Aspergillus oryzae, Trichoderma reesei, Myceliopthera thermophile, Kluyvera lactis, or Fusarium oxysporum. Heme-containing proteins can be isolated from bacteria such as Escherichia coli, Bacillus subtilis, Bacillus licheniformis, Bacillus megaterium, Synechocistis ssp., Aquifex aeolicus, Methylacidiphilum infernorum, or thermophilic bacteria such as Thermophilus. The sequences and structure of numerous heme-containing proteins are known. See for example, Reedy, et al., Nucleic Acids Research, 2008, Vol. 36, Database issue D307-D313 and the Heme Protein Database Available on the world wide web at hemeprotein.infolheme.php. For example, a non-symbiotic hemoglobin can be from a plant selected from the group consisting of soybean, sprouted soybean, alfalfa, golden flax, black bean, black eyed pea, northern, garbanzo, mung bean, cowpeas, pinto beans, pod peas, quinoa, sesame, sunflower, wheat berries, spelt, barley, wild rice, or rice.

In some cases, a heme protein is isolated and optionally purified from a source organism. As used herein, the term “isolated and purified” indicates that the preparation of heme-containing protein is at least 60% pure, e.g., greater than 65%, 70%, 75%, 80%, 85%, 90%, 95%, or 99% pure. Without being bound by theory, isolating and purifying proteins can allow the food products to be made with greater consistency and greater control over the properties of the food product as unwanted material is eliminated. Proteins can be separated on the basis of their molecular weight, for example, by size exclusion chromatography, ultrafiltration through membranes, density centrifugation, or by modulating pH. In some embodiments, the proteins can be separated based on their surface charge, for example, by isoelectric precipitation, anion exchange chromatography, or cation exchange chromatography. Proteins also can be separated on the basis of their solubility, for example, by ammonium sulfate precipitation, isoelectric precipitation, surfactants, detergents, or solvent extraction. Proteins also can be separated by their affinity to another molecule, using, for example, hydrophobic interaction chromatography, reactive dyes, or hydroxyapatite. Affinity chromatography also can include using antibodies having specific binding affinity for the heme-containing protein, nickel NTA for His-tagged recombinant proteins, lectins to bind to sugar moieties on a glycoprotein, or other molecules which specifically binds the protein.

Heme-containing proteins also can be recombinantly produced using polypeptide expression techniques (e.g., heterologous expression techniques using bacterial cells, insect cells, fungal cells, yeast cells (e.g., Pichia pastoris), plant cells such as tobacco, soybean, or Arabidopsis, or mammalian cells). In some cases, standard polypeptide synthesis techniques (e.g., liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

In one embodiment, the heme protein is a myoglobin, which may be expressed in a cell. The cell may be cultured, and may be a bacterial cell, a yeast cell, a plant cell, or a mammalian cell. In one example, the yeast cell is Pichia pastoris. In another embodiment, the heme protein is a recombinantly expressed bovine myoglobin (e.g., expressed in a Pichia pastoris yeast cell). Bovine myoglobin offers several advantages for meat alternative formulations. First, bovine myoglobin is naturally found in beef, and therefore comprises a flavor and color profile associated with a readily familiar meat. Second, bovine myoglobin, with a sequence spanning 154 amino acids, is a relatively small heme protein, and therefore disproportionately imparts flavor based on its heme cofactor relative to larger heme proteins. Furthermore, bovine myoglobin does not comprise additional cofactors beyond the heme, such as the additional copper cofactors of cytochrome c oxidase and is therefore more readily recombinantly expressed as a holoprotein. Finally, bovine myoglobin comprises a relatively low reactivity for a heme protein, imparting minimal oxidative and cross-linking damage to other constituents within formulations. Accordingly, bovine myoglobin is well suited to impart meat flavor and physical profiles while generating minimal side products (often associated with off-flavors). In one example, the bovine myoglobin is contained in HEMAMI™, which may be a solution comprising bovine myoglobin, which may be produced in Pichia pastoris. In particular, the meat alternative formulation may comprise 1, 2, 3, 4, 5, 6, 7, 8, 9, 10, 11, 12, 13, 14, 15, 16, 17, 18, 19, or 20% HEMAMI, or a range defined by two of the foregoing values.

The heme proteins used in the present invention may be in the form of a solution, a frozen solution, a powder, a particle, a chunk, a crumble, or an emulsion, an isolate or concentrate form, or any combinations thereof. When heme protein is formulated into solution form, the heme protein may be from about 1.0% to about 10.0% in the solution. In some embodiments, heme-containing proteins are isolated and purified from other components of the source material (e.g., other animal, plant, fungal, algal, or bacterial proteins). As used herein, the term “isolated and purified” indicates that the preparation of heme-containing protein is at least 60% pure, e.g., greater than 65%, 70%, 75%, 80%, 85%, 90%, 95%, or 99% pure. Without being bound by theory, isolating and purifying proteins can allow the food products to be made with greater consistency and greater control over the properties of the food product as unwanted material is eliminated. Proteins can be separated on the basis of their molecular weight, for example, by size exclusion chromatography, ultrafiltration through membranes, or density centrifugation. In some embodiments, the proteins can be separated based on their surface charge, for example, by isoelectric precipitation, anion exchange chromatography, or cation exchange chromatography. Proteins also can be separated on the basis of their solubility, for example, by ammonium sulfate precipitation, isoelectric precipitation, surfactants, detergents, or solvent extraction. Proteins also can be separated by their affinity to another molecule, using, for example, hydrophobic interaction chromatography, reactive dyes, or hydroxyapatite. Affinity chromatography also can include using antibodies having specific binding affinity for the heme-containing protein, nickel NTA for His-tagged recombinant proteins, lectins to bind to sugar moieties on a glycoprotein, or other molecules which specifically binds the protein.

Heme-containing proteins also can be recombinantly produced using polypeptide expression techniques (e.g., heterologous expression techniques using bacterial cells, insect cells, fungal cells, yeast cells, plant cells such as tobacco, soybean, or Arabidopsis, or mammalian cells). In some cases, standard polypeptide synthesis techniques (e.g., liquid-phase polypeptide synthesis techniques or solid-phase polypeptide synthesis techniques) can be used to produce heme-containing proteins synthetically. In some cases, in vitro transcription-translation techniques can be used to produce heme-containing proteins.

The protein used in the meat alternative formulation may be soluble in a solution. In some embodiments, the isolated and purified proteins are soluble in solution at greater than 1, 5, 10, 15, 20, 25, 50, 100, 150, 200, or 250 g/L.

In some embodiments, the isolated and purified heme protein is substantially in its native fold and water soluble. In some cases, the heme protein is more than 50, 60, 70, 80, or 90% in its native fold. In some cases, less than 25%, less than 20%, less than 15%, less than 10%, less than 5%, less than 2%, or less than 1% of the heme protein is denatured. In some embodiments, the isolated and purified protein is more than 50, 60, 70, 80, or 90% water soluble.

In certain cases, recombinant heme expression can be limited by heme moiety incorporation into translated protein. While an expression system may generate high protein titers, low intracellular heme availability and poor heme chaperone amenability for a recombinantly expressed heme protein can result in a low rate of heme moiety binding to the heme protein. For example, similar g/L titers of recombinant heme protein from two Pichia pastoris strains may differ in holo (heme-bound) to apo (heme-free) ratio by more than one order of magnitude. For some meat alternative formulations, the percentage of holo heme protein can be important for flavor, color, and texture. Accordingly, a heme protein of the present disclosure may comprise more than 50, 60, 70, 80, 90, 95, 98, or 99% of the holo-form of the heme protein.

While many heme proteins are highly stable, heme moieties may undergo a range of transformations that can affect their color, flavor, and other physical properties. Heme moiety oxidation, porphyrin cleavage, and irreversible substrate binding during heme protein production (e.g., recombinant expression), purification, or storage can irreversibly alter its properties. For example, nitric oxide generated during plant tissue homogenization can irreversibly bind to ferrous heme iron, diminishing its deep red color to a diffuse pink and limiting its ability to brown during cooking, while hydrogen peroxide liberated during cell lysis can react with ferrous heme to impart green coloration. Accordingly, the meat alternative formulation may comprise heme protein with greater than 65%, 70%, 75%, 80%, 85%, 90%, 95%, or 99% of heme moieties in a native form. For example, greater than 65%, 70%, 75%, 80%, 85%, 90%, 95%, or 99% of heme moieties may be oxyheme or deoxyheme (rather than metheme, for example).

Heme protein denaturation and degradation can lead to non-protein-bound iron in a formulation. While the iron may still be coupled to the heme or a heme degradation product (e.g., a cleaved porphyrin ring such as bilirubin), the non-protein-bound iron may enable reaction with other species. For example, non-protein-bound iron can mediate biopolymer degradation, including saccharide and disulfide bond hydrolysis, thereby generating free monosaccharides and degraded protein. Non-protein bound iron can also generate reactive oxygen species, which may react with a formulation to permanently alter its texture, appearance (which may include color), and flavor. Accordingly, as a measure to protect formulation flavor and properties, the meat alternative formulation may comprise greater than 65%, 70%, 75%, 80%, 85%, 90%, 95%, or 99% intact (e.g., non-denatured) heme protein, corresponding to little or negligible non-protein-bound iron.

When heme protein is formulated into solution form, the heme protein may be from about 1.0% to about 10.0% in the solution. For example, the heme protein content may be from about 1% to 1.5%, from about 1.5% to 2.0%, from about 2.0% to 2.5%, from about 2.5% to 3.0%, from about 3.0% to 3.5%, from about 3.5% to 4.0%, from about 4.0% to 4.5%, from about 4.5% to 5.0%, from about 5.0% to 5.5%, from about 5.5% to 6.0%, from about 6.0% to 6.5%, from about 6.5% to 7.0%, from about 7.0% to 7.5%, from about 7.5% to 8.0%, from about 8.0% to 8.5%, from about 8.5% to 9.0%, from 9.0% to 9.5%, from 9.5% to 10.0%.

### (b) Plant-Based Protein

The meat alternative formulation can include a plant-based protein. As used herein, plant-based protein may refer to a protein-rich composition isolated from a plant source. In one example, the plant source may be a single soybean species or a collection of rapeseed species. For example, a plant-based protein may be a collection of proteins isolated from soybeans. The plant-based protein may be contained in a plant extract, a plant meal, a plant-derived flour, a plant protein isolate, a plant protein concentrate, or a combination thereof. The plant-based protein may be isolated from a particular portion of a plant, such as the leaves, stems, roots, fruits, seeds, grains, flowers, or segments thereof. For example, the plant-based protein may be isolated from whole, dehulled soybeans. The plant-based protein may comprise two or more plant-based proteins (e.g., a first protein or collection of proteins isolated from a first plant and a second protein or collection of proteins isolated from a second plant).

The plant-based protein comprises a food grade proteinaceous material isolated or derived from a plant source. The plant-based protein may be isolated or purified from a plant, for example from vegetables, nuts, peas, beans, seeds, barks, leaves, trunks, and fruits. For example, the plant-based protein may be isolated or derived from wheat, pea, soy, potato, chickpea, lentil, chickpea, fava bean, mung bean, rice, corn, sorghum, quinoa, canola, vegetables, seaweed, or a combination thereof. The plant-based protein may also be recombinantly expressed in bacteria, yeast, mushrooms, or a combination thereof. In some cases, the plant-based protein is isolated or purified from plant-based connective tissue, such plant protein fibrils. The protein may include an isolated protein, a protein fraction, a protein-containing material, or a combination thereof. In an exemplary connective tissue analog including a protein, the protein is a pea protein, a soy protein, a corn protein, a rice protein, or any combination thereof. These plant-based proteins may be isolated from their plant sources and may be further treated to remove allergens and other sensitivity-provoking components, and as such are FDA GRAS (Generally Recognized as Safe). In various aspects of the present disclosure, a connective tissue analog comprises commercially available plant-based protein such as any of AXIOM® Oryzatein® Rice Protein, AXIOM® Oryzatein® Silk 80, AXIOM® Oryzatein® Silk 90, AXIOM®VegOtein P™ Pea Protein, Puritan's Pride® Soy Protein Isolate, and Myvegan Soy Protein Isolate. The plant-based protein may comprise a seed storage protein, such as gluten. Gluten refers to the purified protein product yielded from the purification of proteins stored in the endosperms of certain grains. Typically, gluten comprises gliadin in a mixture with glutenin. Another suitable protein may be isolated from a genetically modified plant or obtained through biosynthesis or bio-expression systems involving yeast or bacteria.

The plants from which the plant-based protein is sourced may be grown conventionally or organically, and may be bioengineered. By way of non-limiting examples, suitable plants include amaranth, arrowroot, barley, buckwheat, cassava, canola, channa (garbanzo, chickpea), corn, kamut, lentil, lupin, millet, mung bean, oat, pea, peanut, potato, quinoa, rice, rye, sorghum, soy, sunflower, tapioca, triticale, wheat (e.g., wheat gluten), or a mixture thereof. In some cases, the plant-based protein is isolated from soy. The soy-isolated protein may comprise soy flour, which typically comprises about 50% protein by weight along with carbohydrates and lipids; soy concentrate, which typically comprises at least 70% protein by weight and is free of lipids and soluble carbohydrates (such that the carbohydrates present in soy concentrates are typically dietary fibers); soy isolate, which typically comprises at least 90% protein by weight and is substantially free 'of lipids and carbohydrates; an isolated soy protein; or a combination thereof. In some cases, the plant-based protein is isolated from rapeseeds (e.g., canola). In some cases, the plant-based protein is isolated from rice grains.

The plant-based protein may be purified. The plant-based protein may be isolated from other constituents of the plant from which it is isolated, such as lipids (e.g., fats), carbohydrates, and secondary metabolites. Accordingly, the plant-based protein may be at least 50% protein (e.g., dry weight percentage), at least 60% protein, at least 70% protein, at least 80% protein, at least 90% protein, at least 95% protein, at least 98% protein, or at least 99% protein. The plant-based protein may comprise less than 50%, less than 40%, less than 30%, less than 20%, less than 10%, less than 5%, less than 2%, or less than 1% fats and carbohydrates by weight. The plant-based protein may comprise a single type of protein, such as wheat glutenin, or a mixture of proteins, such as soybean lipophilic protein isolate. The plant-based protein may comprise low aqueous solubility proteins (e.g., soybean proteins extracted in an organic solvent), high aqueous solubility proteins (e.g., soybean proteins extracted with a mild aqueous acid, or a mixture thereof. The plant-based protein may be dried, lyophilized, crystalline, hydrated, or any combination thereof.

In some cases, the plant-based protein comprises at least two proteins. For example, the plant-based protein may comprise a collection of proteins isolated from a first plant and a collection of proteins isolated from a second plant, or a single protein isolated from a first plant and a collection of proteins isolated from a second plant.

### (c) Hydrocolloid

A hydrocolloid (hereinafter interchangeably referred to as a hydrocolloid) is a substance that forms a gel in the presence of water, such as pectin or gelatin. While the meat alternative formulations of the present disclosure can support a wide range of hydrocolloid additives, the hydrocolloids used herein are preferably of plant origin, and may include one or more of a konjac gum, gum Arabic, carrageenan, agar-agar, pectin, alginate, gellan gum, konjac glucomannan, xanthan gum, modified starch, methyl cellulose, hydroxypropyl methyl cellulose, carboxymethyl cellulose, methyl cellulose, guar gum, locust bean gum, tara gum, gum tragacanth, gum ghatt, their derivatives, or a combination thereof. The term “carrageenan” may refer to linear sulfated polysaccharides and oligosaccharides isolated from edible seaweeds, and encompasses but is not limited to kappa-carrageenan (K-carrageenan), iota-carrageenan, lambda-carrageenan, and any combination thereof. In particular, the carrageenan may be κ-carrageenan, which may be suitable for use in connective tissue analogs disclosed herein. In one aspect, the hydrocolloid may include one or more hydrocolloids, which may comprise carboxymethyl cellulose, methyl cellulose and hydroxypropyl methyl cellulose, guar gum, locust bean gum, tara gum, konjac flour, konjac glucomannan, konjac gum, gum tragacanth, gum ghatt, gum Arabic, xanthan gum, or any combination thereof. In another aspect of the instant invention, any of the hydrocolloids may be included as one or more additional hydrocolloids. In some cases, an alternative meat formulation of the present disclosure comprises a hydrocolloid selected from the group consisting of konjac flour, methyl cellulose, gum Arabic, and carrageenan.

In some cases, an alternative meat formulation comprises multiple hydrocolloids. In some cases, an alternative meat formulation comprises at least two hydrocolloids selected from the group consisting of konjac flour, methyl cellulose, gum Arabic, and carrageenan. In some cases, an alternative meat formulation comprises at least three hydrocolloids selected from the group consisting of konjac flour, methyl cellulose, gum Arabic, and carrageenan. In some cases, an alternative meat formulation comprises konjac flour, methyl cellulose, gum Arabic, and carrageenan. In one example, at least some of the hydrocolloids are contained in APPETEX™, which is a plant-based connective tissue analog formulation described herein, which may comprise one or more of carrageenan, konjac flour (i.e., konjac glucomannan), gum Arabic, and rice protein (e.g., brown rice protein) concentrate. The alternative meat formulation may comprise 0.5-5.0, 0.5-3.0, 0.5-2.0, 1.0-3.0, or about 0.5, 0.8, 1.0, 1.2, or 1.5 wt % APPETEX™.

### (d) Plant-Based Fiber

A plant-based fiber additive may comprise an oligosaccharide, a polysaccharide, a lignin, or a combination of species thereof which is resistant to enzymatic digestion in the human gut. The plant-based fiber additive may comprise a fiber isolated from a plant or portion of a plant, such as a fruit, a vegetable, a grain, a root, bark, a trunk, a branch, a leaf, a nut, or a seed. Examples of plant-based fibers include, but are not limited to, fibers isolated from legumes (peas, soybeans, and other beans), oats, corn, rye, and barley, fruits such as apples, plums, and berries (e.g., strawberries, raspberries, and blackberries), and vegetables such as broccoli, carrots, green beans, cauliflower, zucchini, celery, potatoes, sweet potatoes, psyllium seed husk, oat bran, wheat bran and beet pulp, cellulose, and sugar cane-based fibers. Fiber may comprise glucomannan (konjac), guar gum, gum Arabic, xanthan gum, psyllium, chitin, inulin, pectin, dextrin, maltodextrin, starches, celluloses, hemicelluloses, lignins, citrus fiber extracts, or any combination thereof.

The meat alternative formulation may comprise a plant-based fiber selected from the group consisting of inulin, gum Arabic, citrus fiber, and maltodextrin. The meat alternative formulation may comprise at least two plant-based fibers selected from the group consisting of inulin, gum Arabic, citrus fiber, and maltodextrin. The meat alternative formulation may comprise at least three plant-based fibers selected from the group consisting of inulin, gum Arabic, citrus fiber, and maltodextrin. The meat alternative formulation may comprise inulin, gum Arabic, citrus fiber, and maltodextrin.

### (e) Fat

The meat alternative formulation may include a fat. As used herein, ‘fat’ refers to a fat or an oil present in a living organism, as well as derivatives thereof. A fat may comprise a monoglyceride, a polyglyceride (e.g., a di- or triglyceride), a long chain amine or alcohol, a sterol, a lipid such as a fatty acid or an amide or ester thereof, or a combination thereof. The fat may be a saturated fat, an unsaturated fat, or a combination thereof. The fat may not be isolated or purified from an animal, and may not be naturally produced by an animal cell. The fat may be isolated from a plant, such as sunflower oil, coconut oil, or palm oil.

Reproducing meat-like fat melting temperature can be critical for producing animal meat-mimetic meat alternative formulations. Animal fat tends to partially liquify during cooking, releasing poorly water soluble (e.g., lipophilic metabolites) species, providing a medium for cooking or rendering retained meat components, and remaining incorporated in the meat in sufficient quantities to provide juiciness, softness, and flavor in the cooked product. For example, beef hamburgers typically release about 25% of their fat content during cooking, some of which coats the burger to augment sizzling, browning, and flavor retention. A challenge with using non-animal-based fats, such as those disclosed herein, can be low melting temperatures which lead to excessive release during cooking.

To address this issue, the meat alternative formulation may utilize a fat with (i) a high melting temperature, and/or (ii) an affinity for other ingredients present in the meat alternative formulation, thereby preventing excessive fat loss during cooking. The meat alternative formulation may be configured to lose between about 5% and about 50%, between about 5% and about 15%, between about 5% and about 20%, between about 8% and about 25%, between about 10% and about 25%, between about 10% and about 30%, between about 12% and about 30%, between about 15% and about 35%, between about 20% and about 40% or between about 25% and about 50% of its fat content during cooking. The meat alternative formulation may be configured to lose at least about 5%, at least about 10%, at least about 15%, at least about 20%, at least about 25%, at least about 30%, at least about 35%, at least about 40%, at least about 45%, or at least about 50% of its fat content during cooking. The meat alternative formulation may be configured to lose at most about 50%, at most about 45%, at most about 40%, at most about 35%, at most about 30%, at most about 25%, at most about 20%, at most about 15%, at most about 10%, or at most about 5% of its fat content during cooking.

In other aspects, the fat is selected from a group consisting of an algal oil, a fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, alpha linoleic acid, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, rice bran oil; margarine, other hydrogenated fats, and a combination thereof. In one aspect, the fat is selected from a group consisting of coconut oil, sunflower oil, and a combination thereof.

### (f) Binder

The meat alternative formulation may include a binder. The binder may increase the firmness of the meat alternative formulation, as well as help to maintain and stabilize heme and plant-based proteins along with other ingredients. The binder may be an emulsifier. The binder may be selected from a group consisting of a starch, a gum, a methyl cellulose, a lecithin, or any combination thereof. Examples of suitable binders include, without limit, starches (e.g., corn starch, potato starch, wheat starch, rice starch, and the like), pregelatinized starch, hydrolyzed starch, cellulose, microcrystalline cellulose, cellulose derivatives (e.g., methylcellulose, ethylcellulose, hydroxypropylcellulose, hydroxypropylmethylcellulose, sodium carboxymethylcellulose, and the like), alginates (e.g., alginic acid, alginate, sodium alginate, and so forth), gums (e.g., gum Arabic, guar gum, gellan gum, xanthan gum, and the like), pectins, gelatin, C₁₂-C₁₈ fatty acid alcohols, polyvinylpyrrolidine, polyethylene oxide, polyethylene glycol, polyvinyl alcohols, waxes (e.g., candelilla wax, carnauba wax, beeswax, and so forth), or combinations of any of the foregoing. In some cases, a binder in the meat alternative formulation may be corn starch, potato starch, or a combination thereof.

### (g) Flavor Enhancer

The meat alternative formulation may also include a flavor enhancer to add a flavor to or accentuate a flavor of the meat alternative formulation. A flavor enhancer can be a food additive which imparts an aroma or taste. In one aspect, the flavor enhancer may be a naturally occurring species, such as those isolated, extracted or derived from plants, herbs, spices, nuts, vegetables, animals, or microbial fermentations. Essential oils and oleoresins are two examples of such naturally occurring species. In another aspect, the flavor enhancer may be a synthetic chemical that imitates a natural flavor. Some examples of the synthetic flavor enhancers include alcohols that have a bitter and medicinal taste, esters render fruity taste, ketones and pyrazines provide caramel flavors, and phenolic compounds have a smoky flavor. In yet another aspect, the flavoring additive is a combination of more than one natural flavoring agents, more than one synthetic flavoring agents, or natural and synthetic flavoring agents. It is discovered that inclusion of flavoring additive in the plant-based meat alternative composition may render a unique aroma or taste desirable to the meat alternatives. The quantity of flavoring additives used may be at the lowest level necessary to achieve the intended flavoring effect

As will be appreciated by a skilled artisan, the selection of flavor enhancer added to the meat alternative formulation can and will depend upon the desired flavor and physical characteristics of the meat alternative formulation to be produced. In many cases, the flavor enhancer comprises a salt (sodium chloride), a spice, a spice extract, a spice oil, an herb, an herb extract, a natural smoke solution, a natural smoke extract, a yeast extract, or combinations thereof. Additional flavoring agents may include onion flavor, garlic flavor, herb flavors, a natural smoke solution, a natural smoke extract, a yeast extract, or combinations thereof. Examples of flavor enhancers that may be used include salt, glutamic acid salts (e.g., monosodium glutamate), glycine salts, guanylic acid salts, inosinic acid salts, 5′-ribonucleotide salts, hydrolyzed proteins, and hydrolyzed vegetable proteins. Herbs or spices that may be added include allspice, basil, bay leaves, black pepper, caraway seeds, cayenne, celery leaves, chervil, chili pepper, chives, cilantro, cinnamon, cloves, coriander, cumin, dill, fennel, ginger, marjoram, mustard, nutmeg, paprika, parsley, oregano, rosemary, saffron, sage, savory, tarragon, thyme, and white pepper. In one embodiment, the flavor enhancer is salt.

### (h) Water

The meat alternative formulation may include water. The water may interact with the above components to provide an alternative meat formulation which retains a significant amount of moisture after cooking. Animal meats typically lose between about 20% and 35% of their water content during cooking, and about 20% to 40% of their overall mass (primarily corresponding to water loss, fat liquification, and volatilized small organic molecules; U.S. Department of Agriculture, Agricultural Research Service. 2012. USDA Table of Cooking Yields for Meat and Poultry). To reproduce this cooking behavior, the meat alternative formulation may comprise hydrated components, such as gelled hydrocolloids, with appropriate hygroscopicity to retain sufficient water during cooking to ensure meat-reminiscent juiciness and texture in the cooked meat alternative formulation, while simultaneously providing sufficient water release to recreate animal meat cooking behavior.

The meat alternative formulation may be configured to lose between about 5% and about 50%, between about 5% and about 15%, between about 5% and about 20%, between about 8% and about 25%, between about 10% and about 25%, between about 10% and about 30%, between about 12% and about 30%, between about 15% and about 35%, between about 20% and about 40%, or between about 25% and about 50% of its water content during cooking. The meat alternative formulation may be configured to lose at least about 5%, at least about 10%, at least about 15%, at least about 20%, at least about 25%, at least about 30%, at least about 35%, at least about 40%, at least about 45%, or at least about 50% of its water content during cooking. The meat alternative formulation may be configured to lose at most about 50%, at most about 45%, at most about 40%, at most about 35%, at most about 30%, at most about 25%, at most about 20%, at most about 15%, at most about 10%, or at most about 5% of its water content during cooking. The cooking may be complete when the internal temperature of the meat alternative formulation is at least 165° F.

The meat alternative formulation may be configured to lose between about 5% and about 50%, between about 5% and about 15%, between about 5% and about 20%, between about 8% and about 25%, between about 10% and about 25%, between about 10% and about 30%, between about 12% and about 30%, between about 15% and about 35%, between about 20% and about 40% or between about 25% and about 50% of its total mass during cooking. The meat alternative formulation may be configured to lose at least about 5%, at least about 10%, at least about 15%, at least about 20%, at least about 25%, at least about 30%, at least about 35%, at least about 40%, at least about 45%, or at least about 50% of its total mass during cooking. The meat alternative formulation may be configured to lose at most about 50%, at most about 45%, at most about 40%, at most about 35%, at most about 30%, at most about 25%, at most about 20%, at most about 15%, at most about 10%, or at most about 5% of its total mass during cooking.

### (i) Free Amino Acids and Free Sugars

Aspects of the present disclosure provide selective omission of ingredients from meat alternative formulations. While the present disclosure demonstrates that meat-like qualities can be generated with relatively few ingredients, these qualities can be altered or masked by even trace amounts of certain off-flavor ingredients. In particular, the addition of free amino acids and free sugars can impart strong flavor, color, and textural qualities which mask and detract from otherwise discernible meat-like qualities. For example, even low quantities of cysteine can impart earthy, bitter notes capable of dominating meat alternative formulation flavor profiles. Furthermore, as iron-mediated reactions (either heme-bound or liberated from heme during cooking) can generate products from certain ingredients with undesirable flavor profiles, selective ingredient omission may include omission of off-flavor precursors, such as readily oxidizable (e.g., sulfur containing) amino acids and certain fatty acids which, upon oxidation, can confer rancid flavor notes.

Accordingly, the careful omission of select ingredients can be critical for generating meat-like qualities. In some cases, the meat alternative formulation does not include one or more, or any, free amino acids. In some cases, the meat alternative formulation does not include one or more, or any free sugars (i.e., monosaccharides and disaccharides). In some cases, the meat alternative formulation does not include one or more, or any, free amino acids or free sugars.

As used herein, “does not include” or “lacks/lacking” may denote that an ingredient was not added to a composition or mixture during formulation. For example, a composition with a polysaccharide comprising a slow rate of monosaccharide-liberating hydrolysis may be taken to not include free sugar, so long as no monosaccharides or disaccharides were added during formulation. Alternatively, or in addition to the preceding, “does not include” or “lacks” may denote an amount below a concentration or weight percentage threshold. For example, as many sugars are not perceptible in millimolar and sub-millimolar concentrations, a formulation may be taken to not include free sugars if its total free sugar concentration is less than 10 or less than 1 millimolar. Alternatively, or in addition to the preceding, “does not include” or “lacks” may denote that an ingredient is not present at a perceptible level. For example, a formulation may be taken to not include a glucosinolate if its presence does not alter the flavor, texture, appearance, or other qualities of the formulation.

As used herein, “free” may denote that a species is not bound or incorporated into the structure of another component in a formulation. For example, free sugar may denote a monosaccharide or disaccharide not bound to another biomolecule, but does not denote a monosaccharide subunit of a polysaccharide. Similarly, while free amino acid may denote an amino acid which is not bound to another biomolecule, the term ‘free’ does not apply to an amino acid residue in a polypeptide or an amino acid coupled to an amino acid side chain of a polypeptide through an isopeptide bond. Alternatively, or addition to the preceding, the term “free” may exclude unbound amino acid and/or sugar molecules that are contained in a composition that is a mixture, such as in a plant-based flour (e.g., pea flour).

In some cases, the meat alternative formulation may not include one or more, or any, free amino acids; one or more, or any, free sugars; or a combination thereof. In particular, the meat alternative formulation may not include free amino acids. The amino acids that are not included may include one or more, or all, of free alanine, arginine, asparagine, aspartate, cystine, cysteine, glutamate, glutamine, glycine, histidine, isoleucine, leucine, lysine, methionine, phenylalanine, proline, serine, threonine, tryptophan, tyrosine, valine, N-acyl homologs thereof, hydroxy homologs thereof, and a combination thereof. In one example, the meat alternative formulation lacks free cysteine. In another example, the meat alternative formulation lacks free amino acids with heteroatom-containing side chains. In a further example, the meat alternative formulation lacks free amino acids with sulfur- or nitrogen-containing side chains. In another example, the meat alternative formulation lacks free amino acids with sulfur-containing side chains. In particular, the meat alternative formulation may not include one or more of free cysteine, cystine, selenocysteine, or methionine, or any of the foregoing. In a further example, the meat alternative formulation lacks any free amino acids. The meat alternative formulation may also not include free added thiamin.

The sugars that are not included may comprise one or more, or all, of free ribose, xylose, mannose, fructose, arabinose, galactose, glucose-6-phosphate, lactose, maltose, dextrose, and sucrose. In one example, the meat alternative formulation does not include one of free glucose, ribose, fructose, lactose, xylose, arabinose, glucose-6-phosphate, maltose, dextrose, or galactose, or a mixture of two or more thereof. In one example, the meat alternative formulation does not include free ribose or glucose. In another, the meat alternative formulation does not include any free sugars.

In some cases, the meat alternative formulation may comprise low quantities of free amino acids or free sugars. While inclusion of such ingredients can adversely impact the flavor of certain meat alternative formulation, in some cases, the meat alternative formulation may retain its intended flavor, texture, and appearance with controlled levels of free amino acids, free sugars, and combinations thereof. In such cases, the meat alternative formulation may comprise between about 1 mM and about 100 mM free sugars, between about 1 mM and about 10 mM free sugars, between about 1 mM and about 20 mM free sugars, between about 5 mM and about 25 mM free sugars, between about 5 mM and about 40 mM free sugars, between about 10 mM and about 50 mM free sugars, between about 20 mM and about 60 mM free sugars, between about 25 mM and about 75 mM free sugars, or between about 3 mM and about 100 mM free sugars. In some cases, the meat alternative formulation comprises at least about 1 mM, at least about 2 mM, at least about 3 mM, at least about 5 mM, at least about 8 mM, at least about 12 mM, at least about 15 mM, at least about 20 mM, at least about 25 mM, at least about 30 mM, at least about 40 mM, or at least about 50 mM free sugars. In some cases, the meat alternative formulation comprises at most about 50 mM, at most about 40 mM, at most about 30 mM, at most about 25 mM, at most about 20 mM, at most about 15 mM, at most about 12 mM, at most about 10 mM, at most about 8 mM, at most about 5 mM, at most about 3 mM, at most about 2 mM, or at most about 1 mM free sugars.

In some cases, the meat alternative formulation comprises between about 0.1 wt % and about 2 wt %, between about 0.1 wt % and about 0.35 wt %, between about 0.2 wt % and about 0.5 wt %, between about 0.25 wt % and about 0.75 wt %, between about 0.3 wt % and about 0.8 wt %, between about 0.4 wt % and about 0.8 wt %, between about 0.5 wt % and about 0.8 wt %, between about 0.5 wt % and about 1 wt %, between about 0.5 wt % and about 1.5 wt %, between about 0.6 wt % and about 1.2 wt %, between about 0.75 wt % and about 1.5 wt %, or between about 1 wt % and about 2 wt % free sugar content. In some cases, the meat alternative formulation comprises at most about 2 wt %, at most about 1.5 wt %, at most about 1.2 wt %, at most about 1 wt %, at most about 0.75 wt %, at most about 0.5 wt %, at most about 0.4 wt %, at most about 0.3 wt %, at most about 0.2 wt %, or at most about 0.1 wt % free sugar content. In some cases, the free sugar content denotes monosaccharides and disaccharides added to the meat alternative formulation. In some cases, the free sugar content denotes monosaccharides and disaccharides present in the meat alternative formulation prior to cooking. In some cases, the free sugar content denotes monosaccharides and disaccharides present in the meat alternative formulation subsequent to cooking (e.g., including free sugars liberated and subtracting free sugars reacted during cooking).

In certain cases, the meat alternative formulation contains no free sugars or free amino acids except those sourced in low amounts from flavor enhancers. Differing from meat alternative formulations into which free sugars and free amino acids have been directly added (e.g., wherein powdered or granulated sucrose and monosodium glutamate are mixed into a formulation not of this disclosure), certain cases of the meat alternative formulation include free sugar and/or free amino acid content exclusively derived from a flavor enhancer. In some cases, the meat alternative formulation comprises about 0.01 wt % to about 1.0 wt % of the flavor enhancer. The flavor enhancer may itself comprise 0.1 wt % to 75 wt %, 1 wt % to 25 wt %, 5 wt % to 40 wt %, 10 wt % to 60 wt %, 15 wt % to 75 wt %, or 25 wt % to 75 wt % free sugar. Alternatively or in addition thereto, the flavor enhancer may comprise 0.1 wt % to 75 wt %, 1 wt % to 25 wt %, 5 wt % to 40 wt %, 10 wt % to 60 wt %, 15 wt % to 75 wt %, or 25 wt % to 75 wt % free amino acids. In some cases, the flavor enhancer comprises free amino acids, but lacks free cysteine, cystine, selenocysteine, or methionine. In some cases, the flavor enhancer comprises free amino acids, but lacks free amino acids with heteroatom-containing side chains. In some cases, the flavor enhancer comprises free amino acids, but lacks free amino acids with sulfur- or nitrogen-containing side chains. In some cases, the flavor enhancer comprises free amino acids, but lacks free amino acids with sulfur-containing side chains. In some cases, the flavor enhancer comprises free sugars and lacks free amino acids. In some cases, the flavor enhancer lacks free sugars and comprises free amino acids. In some cases, the flavor enhancer comprises free sugars and free amino acids. In some cases, the flavor enhancer lacks free sugars and free amino acids.

### (j) Connective Tissue Analogs

In some embodiments disclosed herein, a meat alternative formulation comprises a “connective tissue analog,” or “plant-based connective tissue analog,” which may be a plant-based analog of an animal connective tissue such as a cartilage-, perimysium, tendon-, ligament-, or elastin-like product. Connective tissue analogs may be foods which are made using types of ingredients disclosed herein and which mimic naturally occurring connective tissues, such as those described above, in terms of flavor, texture, and/or mouthfeel. For example, a connective tissue analog can comprise a hydrocolloid, a plant-based fiber, and optionally a plant-based protein. While multiple connective tissue analogs may share similar formulations with hydrocolloids, plant-based fibers, plant-based proteins, and other ingredients disclosed herein, they may nonetheless have distinct physical and sensory properties based on their method of preparation (e.g., baking vs air frying, degree of hydration or desiccation).

A surprising observation demonstrated herein (e.g., in Example 3) is that minor changes in amounts and ratios of connective tissue analogs may strongly impact meat alternative formulation texture, appearance, and flavor. Even when present in small amounts, such as 1 to 3 wt %, changes in connective tissue analog ratios may discernibly affect sensory and textural properties of the meat alternative formulation. Further to this observation, combinations of connective tissue analogs may act synergistically to impart desirable and meat-mimetic properties, such as enhanced cohesion and chewiness.

The connective tissue analog can be added to the plant-based meat alternative composition in a percentage sufficient to impart desirable texture, color, mouthfeel, chewing experience and appearance to the meat alternative composition. In some aspects, the amount of a connective tissue analog in the plant-based meat alternative is, from about 0.1 wt % to about 10 wt %, from about 0.2 wt % to about 5 wt %, from about 0.3 wt % to about 4 wt %, from about 0.4 wt % to about 3 wt %, from about 0.5 wt % to about 2 wt %, from about 0.5 wt % to about 1.5 wt %, from about 1 wt % to about 2 wt %, from about 1.5 wt % to about 2.0 wt %, from about 1.5 wt % to about 2.5 wt %, from about 2 wt % to about 3 wt %, from about 2.5 wt % to about 3 wt %, from about 2.5 wt % to about 3.5 wt %, from about 3 wt % to about 4 wt %, from about 3.5 wt % to about 4.5 wt %, from about 4 wt % to about 5 wt %, from about 0.1 wt % to about 0.5 wt %, from about 0.5 wt % to about 1 wt %, from about 1 wt % to about 1.5 wt %, from about 1.5 wt % to about 2 wt %, from about 2 wt % to about 2.5 wt %, from about 2.5 wt % to about 3 wt %, from about 3 wt % to about 3.5 wt %, from about 3.5 wt % to about 4 wt %, from about 4 wt % to about 4.5 wt %, from about 4.5 wt % to about 5 wt %, less than about 5 wt % of the meat analog product, less than about 4 wt %, less than about 3 wt %, less than about 2.5 wt %, less than about 2 wt %, less than about 1.5 wt %, less than about 1 wt %, or less than about 0.5 wt % of the meat analog product. The meat alternative formulation can comprise about 0.1 wt %, about 0.2 wt %, about 0.3 wt %, about 0.4 wt %, about 0.5%, about 0.6 wt %, about 0.7 wt %, about 0.8 wt %, about 0.9 wt %, about 1 wt %, about 1.2 wt %, about 1.5 wt %, about 1.7 wt %, about 2 wt %, about 2.5 wt %, about 3 wt %, about 4 wt %, about 5 wt %, about 6 wt %, about 8 wt %, or about 10 wt % of a connective tissue analog (or a plurality of connective tissue analogs thereof). For example, in some specific aspects the inclusion rate is preferably between about 0.5 wt % to about 2 wt %. It is noted that in certain cases, including too high a percentage of a connective tissue analog in the meat alternative formulation may provide undesirable toughness, hardness, and cohesion, whereas in other meat alternative compositions such (e.g., in certain meat alternative jerky or sausage formulations) a relatively high degree of toughness or chewiness may be desirable.

In certain aspects disclosed herein, the connective tissue analog comprises micron or millimeter-sized gel particles or pieces (e.g., pieces shredded from a thin gel sheet). The particles or pieces may be partially or fully desiccated. The connective tissue analog may comprise varying degrees of hydration. The connective tissue analog may contain greater than about 80%, greater than about 70%, greater than about 60%, greater than about 50%, greater than about 40%, greater than about 30%, greater than about 25%, greater than about 20%, greater than about 15%, greater than about 10%, or greater than about 5% water content (weight/weight). The connective tissue analog may be hydrated or dehydrated so as to contain less than 5%, less than 10%, less than 15%, less than 20%, less than 25%, less than 30%, less than 40%, less than 50%, less than 60%, less than 70%, or less than 80% water content (weight/weight). A desiccated connective tissue analog may be rehydrated prior to addition to the meat alternative formulation.

The connective tissue analog may also comprise varying degrees of hygroscopicity. For example, the connective tissue analog may be configured to absorb an at least about 5%, at least about 10%, at least about 15%, at least about 20%, at least about 25%, at least about 30%, at least about 40%, at least about 50%, at least about 60%, at least about 80%, at least about 90%, at least about 100%, at least about 125%, at least about 150%, at least about 200%, at least about 250%, or at least about 300%, at most about 250%, at most about 200%, at most about 150%, at most about 100%, at most about 90%, at most about 80%, at most about 60%, at most about 50%, at most about 40%, at most about 30%, at most about 25%, at most about 20%, at most about 15%, at most about 10%, or at most about 5% of its weight in water content (in addition to water already present in the connective tissue analog).

In certain cases, the particles or pieces have a maximum width or diameter in a range from about 0.1 mm to about 10 mm, about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 to about 0.3 mm, about 0.75 mm to about 2 mm, about 0.75 mm to about 2.5 mm, about 0.75 mm to about 3 mm, about 1 mm to about 2 mm, about 2 mm to about 3 mm, about 3 mm to about 4 mm, about 4 mm to about 5 mm, about 5 mm to about 6 mm, about 6 mm to about 7 mm, about 7 mm to about 8 mm, about 8 mm to about 9 mm, or about 9 mm to about 10 mm. The connective tissue analog particles or pieces may have a maximum width or diameter of less than about 10 mm, less than about 9 mm, less than about 8 mm, less than about 7 mm, less than about 6 mm, less than about 5 mm, less than about 4 mm, less than about 3 mm, less than about 2 mm, less than about 1.5 mm, less than about 1 mm, less than about 0.5 mm, less than about 0.25 mm, more than about 0.5 mm, more than about 0.75 mm, more than about 1 mm, more than about 1.25 mm, more than about 1.5 mm, more than about 1.75 mm, more than about 2 mm, more than about 2.5 mm, more than about 3 mm, more than about 4 mm, more than about 5 mm, more than about 6 mm, more than about 7 mm, more than about 8 mm, more than about 9 mm, or more than about 10 mm.

The particles or pieces may have an average width or diameter in a range from about 0.1 mm to about 10 mm, about 0.1 mm to about 5 mm, about 0.1 mm to about 4 mm, about 0.1 mm to about 3 mm, about 0.1 mm to about 2 mm, about 0.1 mm to about 1 mm, about 0.1 mm to about 0.5 mm, about 0.1 to about 0.3 mm, about 0.75 mm to about 2 mm, about 0.75 mm to about 2.5 mm, about 0.75 mm to about 3 mm, about 1 mm to about 2 mm, about 2 mm to about 3 mm, about 3 mm to about 4 mm, about 4 mm to about 5 mm, about 5 mm to about 6 mm, about 6 mm to about 7 mm, about 7 mm to about 8 mm, about 8 mm to about 9 mm, or about 9 mm to about 10 mm. The connective tissue analog particles or pieces may have an average width or diameter of less than about 10 mm, less than about 9 mm, less than about 8 mm, less than about 7 mm, less than about 6 mm, less than about 5 mm, less than about 4 mm, less than about 3 mm, less than about 2 mm, less than about 1.5 mm, less than about 1 mm, less than about 0.5 mm, less than about 0.25 mm, more than about 0.5 mm, more than about 0.75 mm, more than about 1 mm, more than about 1.25 mm, more than about 1.5 mm, more than about 1.75 mm, more than about 2 mm, more than about 2.5 mm, more than about 3 mm, more than about 4 mm, more than about 5 mm, more than about 6 mm, more than about 7 mm, more than about 8 mm, more than about 9 mm, or more than about 10 mm.

The particles or pieces may be size-uniform or heterogeneous. At least 50%, at least 67%, at least 80%, at least 95%, or at least 99% of the particles or pieces may have a diameter or width within about 0.1 mm, within about 0.2 mm, within about 0.3 mm, within about 0.4 mm, within about 0.5 mm, within about 0.75 mm, within about 1 mm, within about 1.25 mm, within about 1.5 mm, within about 1.75 mm, within about 2 mm, within about 2.5 mm, within about 3 mm, within about 4 mm, or within about 5 mm of a mean width or diameter. For example, 95% of gel particles in a connective tissue analog may have diameters between about 0.75 mm and about 2.5 mm.

The meat alternative formulation disclosed herein may comprise at least about 0.1 wt %, at least about 0.25 wt %, at least about 0.5 wt %, at least about 0.75 wt %, at least about 1 wt %, at least about 1.5 wt %, at least about 2 wt %, at least about 2.5 wt %, at least about 3 wt %, at least about 3.5 wt %, at least about 4 wt %, at least about 4.5 wt %, or at least about 5 wt % of a connective tissue analog or a plurality of connective tissue analogs thereof. The meat alternative formulation may comprise at most about 5 wt %, at most about 4.5 wt %, at most about 4 wt %, at most about 3.5 wt %, at most about 3 wt %, at most about 2.5 wt %, at most about 2 wt %, at most about 1.5 wt %, at most about 1 wt %, at most about 0.75 wt %, at most about 0.5 wt %, at most about 0.25 wt %, or at most about 0.1 wt % of a connective tissue analog or a plurality of connective tissue analogs thereof. In one example, the meat alternative formulation comprises about 1 wt % of the connective tissue analog.

The meat alternative formulation may comprise a connective tissue analog selected from the group consisting of (i) a perimysium analog, (ii) a cartilage analog, (iii) a tendon analog, (iv) an elastin analog, (v) a ligament analog, and (vi) a collagen analog. The meat alternative formulation may comprise a connective tissue analog selected from the group consisting of (i) a perimysium analog, (ii) a cartilage analog, and (iii) a tendon analog, or a combination thereof. The connective tissue analog may comprise a mixture of the perimysium analog, the cartilage analog, and the tendon analog.

As demonstrated in Example 3, multiple types of connective tissue analogs may act synergistically to enhance the texture, flavor, and/or appearance of a meat alternative formulation. Accordingly, the meat alternative formulation may comprise at least two, at least three, at least four, at least five, or at least six connective tissue analogs. The meat alternative formulation may comprise at most five, at most four, at most three, or at most two connective tissue analogs. The meat alternative formulation may comprise at least two, at least three, at least four, at least five, or all six connective tissue analogs selected from the group consisting of (i) a perimysium analog, (ii) a cartilage analog, (iii) a tendon analog, (iv) an elastin analog, (v) a ligament analog, and (vi) a collagen analog. The meat alternative formulation may comprise at least two connective tissue analogs selected from the group consisting of (i) a perimysium analog, (ii) a cartilage analog, and (iii) a tendon analog. The meat alternative formulation may comprise (i) a perimysium analog, (ii) a cartilage analog, and (iii) a tendon analog.

The cartilage analog and the perimysium analog may comprise carrageenan (which may be κ-carrageenan), glucomannan (which may be konjac glucomannan), and gum Arabic, which may be present in the analog at a weight-based ratio of 10:1:1, respectively. The tendon analog may comprise a plant protein (which may be a rice protein or a brown rice protein), K-carrageenan, and glucomannan, which may be present at a weight percentage ratio of 1:1:1, respectively. The connective tissue analog may be hydrated with water at a ratio of 1 part connective tissue to 2 parts water, by wt %.

A further surprising observation demonstrated herein is that a single hydrocolloid formulation may be utilized to generate a range of connective tissue analogs with disparate physical and sensory profiles, and that these profiles may be retained throughout dispersal and cooking in meat alternative formulations. In particular, by varying hydration, cooking, and piece or particle size, certain hydrocolloid and plant-based fiber formulations may achieve diverse textures and flavors reminiscent of multiple distinct connective tissues. Accordingly, a meat alternative formulation may comprise at least 2, at least 3, at least 4, at least 5, or at least 6 connective tissue analogs with similar (e.g., within at least about 80%, within at least about 85%, within at least about 90%, within at least about 95%, within at least about 98%, or within at least about 99%) or identical ingredients on a dry weight basis.

In particular, the meat alternative formulation may comprise the cartilage analog (“PBA”), the perimysium analog (“PBB”), and the tendon analog (“PBC”) at different amounts. Exemplary amounts expressed as ratios of PBA:PBB:PBC as a wt % in the meat alternative formulation include 3:0:0, 0:3:0, 0:0:3, 1.5:1.5:0, 1.5:0:1.5, 0:1.5:1.5, 2:0.5:0.5, 0.5:2:0.5, 0.5:0.5:2, 1:1:1. Additional ratios include 0.5:0.3:0.2, 0.5:0:0.5, 1.5:0:1.5, 0:0:3, 0.54:0.54:1.92, 1.92:0.54:0.54, 0.54:1.92:0.54, which may in particular be suitable for a burger formulation. Further ratios include 0:0.08:0.3 and 0.3:0.6:0.6, which may in particular be suitable for a nugget formulation. Ratios also include 2:0:0, 0:2:0, 0:0:2, and 0.25:0.25:1.0, which may in particular be suitable for a sausage formulation. Each of the foregoing mixtures of connective tissue analog types may be hydrated with twice as much water on a weight basis as compared to the total amount of the connective tissue analogs.

### Methods of Making Connective Tissue Analogs

In one aspect, a connective tissue analog comprises a dehydrated or partially dehydrated gel. The composition, thickness, and manner of cooking the gel may render it with properties spanning from chewy and pliable (e.g., elastin-like) to soft and silky (e.g., akin to cooked perimysium). The gel may be sliced, comminuted, or broken into pieces ranging from sub-millimeter to multi-centimeter sizes (e.g., thin strips), which in turn may be dispersed or homogenized within a meat alternative formulation. The gel may be provided in desiccated or partially desiccated form and may optionally be rehydrated prior to addition to the meat alternative formulation.

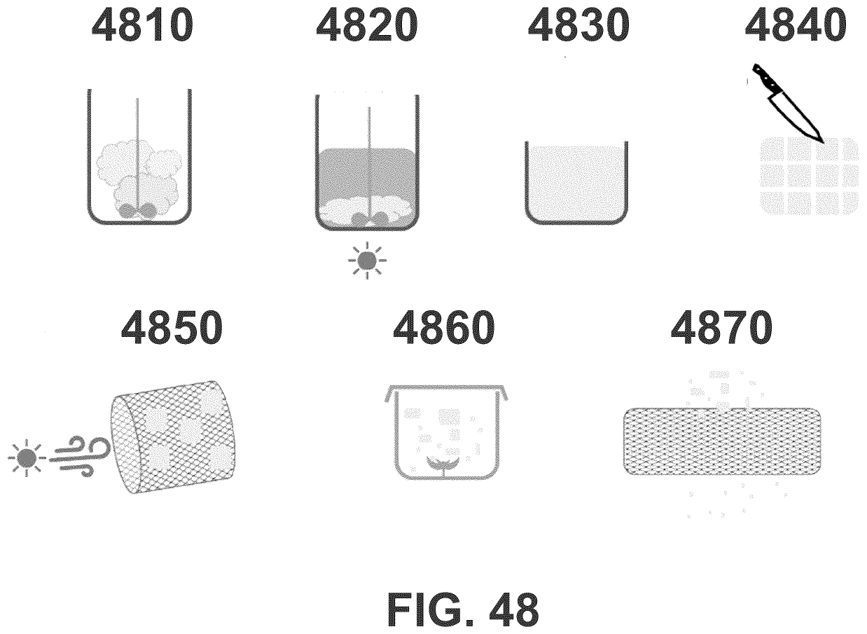

A connective tissue analog may be prepared as outlined in FIG. 48. The process may comprise the steps of combining the ingredients 4810, hydrating the combined ingredients 4820, gelling the ingredients 4830, cutting or shredding the resultant gel 4840, at least partially dehydrating the gel 4850, optionally grinding, comminuting, or further shredding the gel 4860, and optionally sizing-selecting pieces or particles 4870 resultant from the grinding, comminuting, or further shredding 4860. One step, preferably the first step of the process, comprises combining/mixing the ingredients as described herein sufficiently to obtain a substantially homogenous mixture 4810. At this stage, the ingredients are preferably in a solid, dry form such as a powder (e.g., a lyophilized powder), particles, or chunks. However, in certain cases, the mixing is amenable to damp or hydrated ingredients. The next step, preferably the step after combining/mixing, comprises hydrating 4820 the substantially homogenous mixture obtained from the mixing step. The hydrating may be achieved by stirring, blending, or otherwise adding water or aqueous fluid to the substantially homogenous mixture. In certain cases, the hydrating comprises a further addition of fat (e.g., a plant-based oil) to the mixture. The water and optional fat may be added to the mixture at room temperature, or at elevated temperature, such as at a temperature anywhere between about 30.0-99.9° C. The hydrating step may optionally comprise a heating step, which may precede, be concomitant with, or follow the addition of water to the substantially homogenous mixture from 4810. Following hydrating, the resulting composition may be set at room temperature to form a gel 4830. Next, the resultant gelled composition may optionally be partitioned 4840, for example sliced, shattered, smashed, shredded, torn, or cut (e.g., to form pieces or strips). Alternatively, or in addition thereto, the gel may be dehydrated 4850, for example at 49° C. for 6-24 hours, until an at least partial dehydration is achieved. In this step, the gel may lose at least 5%, at least 10%, at least 15%, at least 20%, at least 25%, at least 30%, at least 40%, at least 50%, at least 60%, at least 70%, at least 80%, at least 90%, or at least 95% of its water content. Alternatively, or in addition thereto, the gel may lose at most 95%, at most 90%, at most 80%, at most 70%, at most 60%, at most 50%, at most 40%, at most 30%, at most 25%, at most 20%, at most 15%, at most 10%, or at most 5% of its water content. The dehydrated or partially dehydrated gel may then optionally be shredded to form a collection of pieces or comminuted to form a collection of particles 4860, which may further be sorted (e.g., extruded) 4870 to select for pieces or particles of desired sizes. As a further optional step, the resultant pieces or particles may be crosslinked.

### Cartilage Analog

A cartilage analog (e.g., PBA as defined elsewhere herein) may comprise dried hydrocolloid gel particles with about 0.75 to 2.5 mm or about 0.75 to 2.0 mm diameters. The cartilage analog may be generated as outlined in FIG. 48. Briefly, a hydrocolloid optionally containing a plant-based fiber, optionally containing a plant-based protein, and optionally containing a further ingredient disclosed herein may be thoroughly mixed in dry form. The composition may then be slowly hydrated with hot water (e.g., at about 70° C.) and cast to generate a smooth gel sheet with low air content. The gel sheet may be cut into about 1-2 cm cubes before complete dehydration under 4-6 hours mild heating (e.g., about 40-50° C.). The resultant desiccated cubes may be roughly comminuted to form irregularly shaped particles, preferably ranging in size from about 0.75 to 2.5 mm or from about 0.75 to 2.0 mm. The particles may be sifted (e.g., through a mesh) to select for desired sizes and size uniformities. In certain cases, the hydrocolloid formulation is or comprises APPETEX™

### Perimysium Analog

A perimysium analog (e.g., PBB as defined elsewhere herein) may comprise pieces of dried hydrocolloid gel sheets ranging from about 0.75 to 2.5 mm in size. The perimysium analog may be generated as outlined in FIG. 48. A hydrocolloid formulation optionally containing a plant-based fiber, optionally containing a plant-based protein, and optionally containing a further ingredient disclosed herein may be hydrated, stirred at elevated temperature (e.g., at about 70° C.) and cast into a gel sheet. The resultant gel sheet may be cut into relatively large (e.g., 20-30 cm) pieces and dehydrated for about 4 to 6 hours under mild heating (e.g., about 40-50° C.), and shredded (e.g., in a bladed coffee grinder) to yield irregularly shaped millimeter-sized pieces. Size sorting (e.g., with a series of mesh screens) may be used to select for 0.75 to 2.5 mm pieces, or 0.5 to 2.5 mm pieces, thereby yielding a perimysium analog with, when hydrated, a mouthfeel similar to a sheet of connective tissue with distinctive slide between teeth sensation associated with perrimysium. In certain cases, the hydrocolloid formulation is or comprises APPETEX™.

### Tendon Analog

A tendon analog (e.g., PBC as defined elsewhere herein) may be generated as outlined in FIG. 48. A hydrocolloid formulation optionally containing a plant-based fiber, optionally containing a plant-based protein, and optionally containing a further ingredient disclosed herein may be hydrated, stirred at elevated temperature (e.g., at about 70° C.) and cast into a gel sheet. The resultant gel sheet may be cubed and dehydrated for about 4-6 hours under mild heating (e.g., about 40-50° C.) to yield firm pieces with similar textural properties as elastin. The cubes may be comminuted and size-sorted (e.g., with a mesh screen), which may be through a 0.75 mm mesh and a 2.5 mm mesh, to yield a tendon analog. In certain cases, the hydrocolloid formulation is or comprises APPETEX™.

### Elastin Analog

An elastin analog may be generated as outlined in FIG. 48. A formulation optionally containing a ratio of about 10:1 of a plant-based protein and a hydrocolloid (e.g., 20 parts soy or pea protein with 1 part carrageenan and 1 part gum Arabic) may be hydrated, stirred at elevated temperature (e.g., at about 70° C.), cast into a gel sheet, and dehydrated overnight under mild heating (e.g., about 40-50° C.). The resultant dried sheet may be comminuted, and size sorted to yield particles ranging in size from about 0.5 mm to about 2 mm.

### Collagen Analog

A collagen analog may be generated as outlined in FIG. 48. A formulation containing close to 100% hydrocolloid (e.g., 10 parts K-carrageenan with 1 part konjac flour and 1 part gum Arabic) may be hydrated, stirred at elevated temperature (e.g., at about 70° C.), cast into a gel sheet, dehydrated overnight under mild heating (e.g., about 40-50° C.), and comminuted and size sorted to yield particles ranging in size from about 0.5 mm to about 2 mm.

### (k) Minerals

The meat alternative formulation may include one or more minerals. Non-limiting examples of minerals include, without limitation, sodium chloride, potassium chloride, potassium iodide, calcium carbonate, iron salts, copper salts, zinc salts, magnesium salts, manganese salts, molybdenum salts, phosphates, and selenium. Suitable forms of any of the foregoing minerals include soluble mineral salts, slightly soluble mineral salts, insoluble mineral salts, chelated minerals, mineral complexes, non-reactive minerals such as carbonyl minerals, and reduced minerals, and combinations thereof. In some cases, the mineral comprises sodium chloride, potassium chloride, potassium iodide, or any combination thereof.

The meat alternative formulation may comprise a mineral. In certain cases, the meat alternative formulation comprises from about 0.1 wt % to about 4 wt % of the mineral, from about 0.1 wt % to about 3 wt % of the mineral, from about 0.2 wt % to about 2.5 wt % of the mineral, from about 0.3 wt % to about 2 wt % of the mineral, from about 0.2 wt % to about 1 wt % of the mineral, from about 0.1 wt % to about 0.5 wt %, from about 0.05 wt % to about 0.25 wt %, or from about 0.5 wt % to about 1.5 wt % of the mineral.

### (I) Polyunsaturated Fatty Acids (PUFA)

The meat alternative formulation may include one or more polyunsaturated fatty acids (PUFAs), each of which may be a fatty acid having at least two carbon-carbon double bonds generally in the cis-configuration. The PUFA may be a long chain fatty acid having at least 18 carbons atoms. In an embodiment, the PUFA may be an omega-3 fatty acid in which the first double bond occurs in the third carbon-carbon bond from the methyl end of the carbon chain (i.e., opposite the carboxyl acid group). Examples of omega-3 fatty acids include alpha-linolenic acid (18:3, ALA), stearidonic acid (18:4), eicosatetraenoic acid (20:4), eicosapentaenoic acid (20:5; EPA), docosatetraenoic acid (22:4), n−3 docosapentaenoic acid (22:5; n−3DPA), and docosahexaenoic acid (22:6; DHA). The PUFA may also be an omega-6 fatty acid, in which the first double bond occurs in the sixth carbon-carbon bond from the methyl end. Examples of omega-6 fatty acids include linoleic acid (18:2), gamma-linolenic acid (18:3), eicosadienoic acid (20:2), dihomo-gamma-linolenic acid (20:3), arachidonic acid (20:4), docosadienoic acid (22:2), adrenic acid (22:4), and n−6 docosapentaenoic acid (22:5). The fatty acid may also be an omega-9 fatty acid, such as oleic acid (18:1), eicosenoic acid (20:1), mead acid (20:3), erucic acid (22:1), and nervonic acid (24:1).

### (m) Breading

The meat alternative formulation may include breading, particularly for a nugget formulation (e.g., a poultry-like nugget such as a chicken nugget-like formulation). The breading may be partitioned from other components of the meat alternative formulation (e.g., coated around the remaining components) or interspersed therethrough. The breading may provide structural integrity to a meat alternative formulation, aiding in shape retention during storage and cooking.

### (n) Casing

The meat alternative formulation may include a casing. The casing may cover and/or encompass the meat alternative formulation, providing a coating similar to common sausage casings in appearance and texture. The casing may comprise a hydrocolloid, such as sodium alginate, and may be precipitated (for example with calcium) to form gel or gel-like layers.

### (o) Coloring Additives

The meat alternative formulation can also comprise a food grade coloring additive. “Food grade” as used herein refers to any compounds or compositions suitable for human and/or animal consumption. Suitable food grade coloring additives, or colorants as used herein refers to any food grade compounds or compositions that impart a color change to the plant-based meat alternative composition. Examples of food grade colorants include, but are not limited to, caramel, iron oxide, red blood cells, beet root extract, turmeric, carotenoids, and other organic or inorganic dye or pigments such as turmeric, riboflavin, quinoline yellow, sunset yellow FCF, carminic acid, allura red AC, brilliant blue FCF, chlorophyll, green S, fast green FCF, caramels, brilliant black BN or brilliant black PN, brown HT, carotene, annatto extracts, lycopene, beet red, anthocyanins or grape skin extract or blackcurrant extract, titanium dioxide, iron oxide, tannic acid, and tannins. These colors or dyes, along with their corresponding lakes, and certain natural and derived colorants, may be suitable for use in various aspects of the present disclosure. In one aspect of the invention, the composition is devoid of any coloring additives.

### (p) Binding Agents

The meat alternative formulation can further comprise a binding agent. As used herein, the term ‘binding agent’ can refer to an edible agent capable of binding and holding together ingredients in a composition or mixture. The binding agent can comprise a starch, a gum, a methyl cellulose, a lecithin, plant fibers or any combination thereof. A binding agent may comprise, for example, konjac, xanthan, locust bean gum, methyl cellulose, citrus fiber, or a lecithin isolated or derived from potato, corn, canola, or sunflower seed, or any combination thereof. In some cases, the starch is selected from the group consisting of potato starch, tapioca, sago, high amylopectin starch, corn starch, wheat starch, and any combination thereof. The starch can be pregelatinized.

### II. Method of Producing the Meat Alternative Formulation

In yet another aspect, the present disclosure encompasses methods of producing the meat alternative formulation. The methods may comprise any number of the following steps: (a) preprocessing ingredients, (b) combining water with the hydrocolloid, the plant-based fiber, the plant-based protein, or any combination thereof to obtain a hydrated composition; (c) combining the heme protein with one or more species selected from the group consisting of water, the hydrocolloid, the plant protein, the plant-based fiber, the fat, the mineral, or a combination thereof to form a heme composition; (d) combining the hydrated composition and heme composition optionally along with the fat; and (e) packing and storing the meat alternative formulation; wherein the method does not include a step of adding one or more, or any, free amino acids, and optionally also does not include a step of adding one or more, or any, free sugars.

### (a) Preprocessing Ingredients

Ingredients may be processed prior to addition to the meat alternative formulation. The processing may involve cooking, hydrating, desiccating, comminuting, grinding, crosslinking, or in other ways altering ingredient properties prior to their addition to the meat alternative formulation. As the processed ingredients may retain these properties upon incorporation into the meat alternative product, ingredient preprocessing may impart textural and sensory properties important for reproducing meat-like properties. As covered further in Section III below, the processing may include generating a connective tissue analog from an ingredient disclosed herein.

The pre-processing may comprise combining water with the hydrocolloid, the plant-based fiber, the plant-based protein, or any portion or combination thereof to form a hydrated composition. The hydrated composition can be cooked (e.g., baked or fried), partially or fully desiccated, and/or partitioned (e.g., comminuted) prior to addition to the meat alternative burger. As demonstrated herein, the hydrated composition can retain its properties upon mixing into the meat alternative formulation to thereby impart unique physical and sensory profiles. For example, the pre-processing can comprise forming a connective tissue analog. In certain cases, between about 10 wt % and about 60 wt %, between about 25 wt % and about 75 wt %, between about 40 wt % and about 80 wt %, between about 60 wt % and about 100 wt %, between about 10 wt % and about 40 wt %, between about 40 wt % and about 60 wt %, or between about 50 wt % and about 90 wt % of the hydrocolloid in the meat alternative formulation is hydrated prior to addition to the meat alternative formulation. In some cases, between about 10 wt % and about 60 wt %, between about 25 wt % and about 75 wt %, between about 40 wt % and about 80 wt %, between about 60 wt % and about 100 wt %, between about 10 wt % and about 40 wt %, between about 40 wt % and about 60 wt %, or between about 50 wt % and about 90 wt % of the plant-based fiber in the meat alternative formulation is hydrated prior to addition to the meat alternative formulation. between about 1 wt % and about 6 wt %, between about 3 wt % and about 10 wt %, between about 4 wt % and about 15 wt %, between about 10 wt % and about 60 wt %, between about 25 wt % and about 75 wt %, between about 40 wt % and about 80 wt %, between about 60 wt % and about 100 wt %, between about 10 wt % and about 40 wt %, between about 40 wt % and about 60 wt %, or between about 50 wt % and about 90 wt % of the plant-based protein in the meat alternative formulation is hydrated prior to addition to the meat alternative formulation.

In certain cases, the hydrocolloid, or combinations or portions thereof are formed into a connective tissue analog. The connective tissue analog may be provided in dried form, and optionally may be rehydrated prior to addition to the meat alternative formulation. In certain cases, the connective tissue analog comprises millimeter-scale pieces (e.g., segments shredded from a sheet) or particles. The combined mass of the hydrocolloid, the plant-based fiber, and the plant-based protein may be comparable to (e.g., within 50%, within 25%, or within 10%) the mass of the water. The hydrated composition may be stirred, homogenized, or mixed. The hydrated composition may be left to rest for at least 2 minutes, at least 3 minutes, at least 4 minutes, at least 5 minutes, at least 6 minutes, at least 8 minutes, at least 10 minutes, at least 15 minutes, at least 20 minutes, or at least 30 minutes before further use (e.g., mixing with other ingredients). The hydrated composition may be left to rest for at most 30 minutes, at most 20 minutes, at most 15 minutes, at most 10 minutes, at most 8 minutes, at most 6 minutes, at most 5 minutes, at most 4 minutes, at most 3 minutes, or at most 2 minutes before further use. The hydrated composition may have a cookie dough-like consistency.

As used herein, “hydrating” may generally refer to the process of introducing a hydrating agent to a dry phase. The hydration agent may be a water, an ionized water, a buffered water, a non-water solvent, or any combination thereof. The water used may be a tap water, a distilled water, a water processed by reverse osmosis, and a filtered water, such as those from Millipore filtration. The water may be cold water, hot water, warm water, or introduced to the plant/vegetable protein composition as a steam. Hydrating may be achieved by adding the hydration agent, mixing, stirring, heating, cooling, setting, any combinations thereof, or any other means or maneuvers to allow dispersing of the plant/vegetable protein composition to the hydration agent and forming the hydrated plant protein base. The tools and instrumentations in hydrating may comprise volumetric flasks to measure out the hydration agent, stir bar, whisk wire or mixers to facilitate mixing and hydrating, and oven/heater to heat up the hydration agent, or refrigerator/freezer to cool down the hydration agent.

### (b) Generating a Heme Protein Composition

The method of making the meat alternative formulation may comprise forming a heme protein composition. The heme protein may be combined with one or more species selected from the group consisting of water, the hydrocolloid, the plant-based protein, the plant-based fiber, the fat, the mineral, or a combination thereof to form a heme composition. The species may be added in a single step, or in a series of steps. Two or more species may be mixed prior to the combining with the heme protein. For example, the hydrocolloid and the fat may be combined to form a gel before subsequently being added to the heme protein. Each step may comprise, mixing, stirring, homogenizing, emulsifying, or other forms of agitation. The method may comprise solubilizing the heme protein, for example by combining the heme protein with a saline (e.g., mineral-containing) aqueous solution. The plant-based protein may be hydrated with a solution of the heme protein, and this mixture may be combined with the multiphase colloidal gel. As an example, the method may comprise:
(i) solubilizing the heme protein in a saline solution;
(ii) combining the heme protein with a plant-based protein, the plant-based fiber, and the hydrocolloid; and
(iii) combining the composition of (ii) with a gel comprising a second hydrocolloid and the fat.

Combining the plant-based protein and the heme protein solution may be achieved through any commonly used means such as blending, stirring, whisking, rotating, breaking, pounding, grinding, milling, rolling, chopping, cutting, pulverizing, or any other physical means or maneuvers to allow the even distribution of ingredients in the mixture. The tools or instrumentations used in the combining may include, but not limited to scales to measure out the ingredients, mixing bowls for holding and mixing the ingredients, and stir bars, whisk wires or mixers to facilitate the combining to form the substantially homogenous mixture.

(c) Combining the Hydrated Composition of (a) with the Heme Composition of (b) and Remaining Ingredients

The method of making the meat alternative formulation may comprise forming a meat alternative formulation by combining the hydrated composition of (a) with the heme composition of (b) and any remaining ingredients. The combining can comprise multiple steps. For example, a method of making the meat alternative formulation can comprise first mixing hydrated hydrocolloid and plant-based fiber with the heme composition, then adding in plant-based protein, and then adding in remaining ingredients, such as the fat. The meat alternative formulation may be shaped (e.g., formed into patties), and optionally may be frozen and stored until use.

Adding and blending is for adding additional ingredients, such as the second additional plant-based protein, the fat, the binder, the flavor enhancer, and the hydrocolloid, the plant-based fiber, and the plant-based protein, to the mixed solution and blending sufficiently to obtain a substantially homogeneous meat alternative formulation. Adding is to put in additional ingredients to the mixed liquid of hydrated composition and the heme protein. Blending is to mix and combine these additional ingredients with the mixed liquid sufficient so that the constituent parts are indistinguishable from one another, thus forming a substantially homogenous mixture. Means for adding and blending may be any commonly used methods such as pouring, stirring, whisking, rotating, breaking, pounding, grinding, milling, rolling, chopping, cutting, pulverizing, or any other physical means or maneuvers to allow the even distribution of ingredients in the mixture. The tools or instrumentations used in the adding or blending may include, but not limited to, scales to measure out the additional ingredients, mixing bowls for holding the additional ingredients and the mixed liquid, and stir bars, whisk wires or mixers to facilitate the blending to form the substantially homogenous plant-based meat formulation.

### (d) Packing and Storing the Meat Alternative Formulation

The method of making the meat alternative formulation may comprise packaging (e.g., sealing in an air or watertight container) and storing the meat alternative formulation for later use.

The method of preparing the meat alternative formulation may also comprise a step of safely packaging and storing the formulation obtained through the above steps. The obtained formulation may be packaged using routine procedures into a container or a bag suitable for holding food and facilitating its stability. In one aspect, the container or bag may have a setup to prevent air or water diffusion into the meat alternative formulation. The container or bag used may also possess a setup to prevent microorganisms, such as bacteria entering the container or bag. In one aspect, the container or bag suitable for holding the composition may be a disposable, airtight, zippered, sealable, or configured with vacuum sealing valves or other apparatus. In another aspect, a packaged meat alternative formulation may be stored sealed at room temperature, in a refrigerator, or in a freezer. The packaged meat alternative formulation may be cooked according to routine methods used for cooking real meat and may be cooked after thawed from frozen.

### Method of Making a Meat Alternative Burger

A method of making a meat alternative burger can comprise:
(i) combining heme and a plant-based protein to form a mixture;
(ii) combine a first hydrocolloid and a second fat to form a gel;
(iii) combine the mixture from (i) and the gel from (ii) to produce the meat alternative burger formulation; and
(iv) form a meat alternative burger from the meat alternative burger formulation.

In some cases, the plant-based protein of (i) comprises at least two plant-based proteins. In some cases, (i) further comprises hydrating the plant-based protein. In some cases, (i) further comprises adding a desiccated or partially desiccated hydrocolloid (e.g., a connective tissue analog) to the mixture. In such cases, the desiccated or partially desiccated hydrocolloid may comprise at least two hydrocolloid compositions (e.g., at least two connective tissue analogs). In some cases, the desiccated or partially desiccated hydrocolloid is hydrated prior to being added to the mixture. In some cases, (i) further comprises adding a plant-based fiber or a binder to the mixture. In some cases, the plant-based protein comprises at least about 40 wt %, at least about 50 wt %, or at least about 60 wt % of the mixture prior to the combining of (iii).

In some cases, (ii) further comprises adding water to the gel. In some such cases, the water is added subsequent to the hydrocolloid and the fat. In some cases, the fat is in at least about 2-fold, at least about 3-fold, at least about 4-fold, or at least about 5-fold excess of the hydrocolloid (weight/weight).

In some cases, (iii) comprises dispersing or homogenizing the gel within the mixture. In some cases, (iii) further comprises adding a plant-based fiber. In some cases, the plant-based fiber is hydrated prior to the adding.

In some cases, the meat alternative burger formed during (iv) comprises between about 15 g and about 400 g, between about 70 and about 150 g, between about 20 and about 250 g, between about 30 and about 200 g, between about 60 and about 180 g, between about 70 and about 160 g, between about 80 and about 140 g, or between about 90 and about 130 g. In some cases, the meat alternative burger is frozen prior following (iv).

### Method of Making a High Fiber Meat Alternative Nugget

A method of making a high fiber meat alternative nugget can comprise:
(i) partitioning a plant-based fiber into pieces;
(ii) adding water, heme, and a plant-based protein to the plant-based fiber pieces of (i) to form a mixture;
(iii) combining a hydrocolloid and a fat to form a gel;
(iv) combining the first mixture and the gel to form a high fiber meat alternative nugget formulation; and
(v) forming a high fiber meat nugget from the high fiber meat alternative nugget formulation.

In some cases, the partitioning of (i) comprises separating the plant-based fiber into millimeter scale chunks. The chunks may be from about 0.5 to about 50 mm, from about 1 to about 30 mm, from about 2 to about 25 mm, from about 4 to about 18 mm, from about 5 to about 12 mm, from about 1 to about 5 mm, from about 2 to about 4 mm, or from about 2 to about 8 mm as defined by diameter or greatest dimension. In some cases, the partitioning of (i) comprises forming a powder of the plant-based fiber. In some cases, the partitioning of (i) comprises forming centimeter sized chunks of the plant-based fiber.

In some cases, the adding of (ii) comprises adding the heme to the plant-based fiber pieces of (i) prior to adding the plant-based protein. In some cases, the heme is dispersed throughout the plant-based fiber pieces of (i). In some cases, (ii) further comprises adding a flavor enhancer to the plant-based fiber pieces of (i).

In some cases, the combining of (iii) comprises homogenizing (e.g., blending) the hydrocolloid and the fat. In some cases, the combining of (iii) further comprises adding water. In some cases, the gel is semi-solid or solid. In some cases, the gel is homogenous.

In some cases, the combining of (iv) comprises stirring. In some cases, the high fiber meat alternative nugget formulation formed in (iv) comprises a dough-like texture. In some cases, (iv) comprises adding a desiccated or partially desiccated hydrocolloid with the first mixture and the gel. In some cases, the desiccated or partially desiccated hydrocolloid is a connective tissue analog. In some cases, the desiccated or partially desiccated hydrocolloid comprises at least two hydrocolloid compositions (e.g., at least two connective tissue analogs).

In some cases, the nugget formed in (v) is between about 4 and about 50 g, between about 5 and about 35 g, between about 7 and about 25 g, between about 10 and about 20 g, or between about 12 and about 25 g. In some cases, the forming of (iv) comprises kneading.

In some cases, the method of making the high fiber meat alternative nugget further comprises (vi) coating the high fiber meat alternative nugget formed in (v). In some cases, the high fiber meat alternative nugget is coated with a chicken style predust. In some cases, the high fiber meat alternative nugget is coated with a batter. In some cases, the high fiber meat alternative nugget is coated with a breader. In some cases, the high fiber meat alternative nugget is frozen for at least 1 minute prior to (vi).

In some cases, the method of making the high fiber meat alternative nugget further comprises (vii) frying the high fiber meat alternative nugget of (v) or (vi). The frying may be complete or partial frying. In many cases, the frying only partially cooks the high fiber meat alternative nugget, such that the nugget can be stored and cooked to completion at a later time. In some cases, the frying is performed for at most 4 minutes, at most 3 minutes, at most 2 minutes, at most 1.5 minutes, or at most 1 minute. In some cases, the frying comprises a temperature of between about 300 and about 450° F., between about 350 and about 425° F., or between about 375 and about 400° F.

The resultant high fiber meat alternative nugget of (v), (vi), or (vii) may be frozen and optionally may be packaged.

### Method of Making a Spongy Meat Alternative Nugget

A method of making a spongy meat alternative nugget can comprise:
(i) hydrating a desiccated or partially desiccated hydrocolloid (e.g., a connective tissue analogue;
(ii) combining heme, and a plant-based protein, and water to form a mixture;
(iii) combining the hydrated hydrocolloid of (i) with the mixture of (ii) to form a spongy meat alternative nugget formulation; and
(iv) forming the spongy meat alternative nugget formulation of (iii) into a spongy meat alternative nugget.

In some cases, the hydrating of (i) comprises partially rehydrating the desiccated or partially desiccated hydrocolloid. In some cases, the hydrating of (i) comprises combining more than one hydrocolloid composition. In some cases, the desiccated or partially desiccated hydrocolloid of (i) comprises a connective tissue analog. In some cases, the desiccated or partially desiccated hydrocolloid of (i) comprises a plurality of connective tissue analogs.

In some cases the combining of (ii) further comprises a fat. In some cases, the combining of (ii) further comprises a hydrocolloid. In some cases, the hydrocolloid in hydrated. In some cases, the combining of (ii) comprises blending. In some cases, the combining of (ii) comprises partially or fully dispersing the heme throughout the plant-based protein. In some cases, the plant-based protein is in at least 5-fold, at least 8-fold, at least 10-fold, or at least 15-fold excess of the hydrocolloid and the fat.

In some cases, the nugget formed in (iv) is between about 4 and about 50 g, between about 5 and about 35 g, between about 7 and about 25 g, between about 10 and about 20 g, or between about 12 and about 25 g. In some cases, the forming of (iv) comprises kneading.

In some cases, the method of making the spongy meat alternative nugget further comprises (v) coating the spongy meat alternative nugget formed in (iv). In some cases, the spongy meat alternative nugget is coated with a chicken style predust. In some cases, the spongy meat alternative nugget is coated with a batter. In some cases, the spongy meat alternative nugget is coated with a breader. In some cases, the spongy meat alternative nugget is frozen for at least 1 minute prior to (v).

In some cases, the method of making the spongy meat alternative nugget further comprises (vi) frying the spongy meat alternative nugget of (iv) or (v). The frying may be complete or partial frying. In many cases, the frying only partially cooks the spongy meat alternative nugget, such that the nugget can be stored and cooked to completion at a later time. In some cases, the frying is performed for at most 4 minutes, at most 3 minutes, at most 2 minutes, at most 1.5 minutes, or at most 1 minute. In some cases, the frying comprises a temperature of between about 300 and about 450° F., between about 350 and about 425° F., or between about 375 and about 400° F.

The resultant spongy meat alternative nugget of (iv), (v), or (vi) may be frozen and optionally may be packaged.

### Method of Making a Meat Alternative Sausage

A method of making a meat alternative sausage can comprise:
(i) combining heme and a plant-based protein to form a mixture;
(ii) combining a hydrocolloid and a fat to form a gel;
(iii) combining the first mixture and the gel to form a meat alternative sausage formulation; and
(iv) forming a meat alternative sausage from the meat alternative sausage formulation.

In some cases, (i) comprises hydrating the plant-based protein. In some cases, (i) comprises dispersing the heme throughout the plant-based protein. In some cases, (i) comprises stirring.

In some cases, (ii) comprises saturating the hydrocolloid with the fat. In some cases, (ii) further comprises adding water. In such cases, the fat can be added before the water.

In some cases, (iii) further comprises adding a dry ingredient, such as a powdered flavor enhancer. In some cases, (iii) further comprises adding a second fat. In such cases, the second fat can be different than the fat of (ii). In some cases, (iii) comprises blending. In some cases, the blending comprises partially homogenizing. In some cases, the blending comprises fully homogenizing. In some cases, the meat alternative formulation of (iii) is refrigerated prior to (iv).

In some cases, (iii) comprises adding a desiccated or partially desiccated hydrocolloid with the mixture and the gel. In some cases, the desiccated or partially desiccated hydrocolloid is a connective tissue analog. In some cases, the desiccated or partially desiccated hydrocolloid comprises at least two hydrocolloid compositions (e.g., at least two connective tissue analogs).

In some cases, the meat alternative sausage is between about 10 and about 300 g, between about 20 and about 250 g, between about 30 and about 200 g, between about 40 and about 100 g, between about 60 and about 150 g, between about 50 and about 110 g, or between about 65 and about 95 g. In some cases, the meat alternative sausage is partially frozen following (iv).

In some cases, the method further comprises (v) casing the meat alternative sausage. In such cases, the casing can comprise a hydrocolloid. In a specific example, the casing comprises alginate.

In some cases, the meat alternative sausage of (iv) or (v) is packaged. In some cases, the meat alternative sausage of (iv) or (v) is frozen.

### Definitions

Unless defined otherwise, all technical and scientific terms used herein have the meaning commonly understood by a person skilled in the art to which this invention belongs. The following references provide one of skill with a general definition of many of the terms used in the present disclosure: Dictionary of Food Ingredients (Igoe et al, 2011); The Cambridge Dictionary of Science and Technology (Walker ed., 1988); Essentials of Food Science (Vickie A. et al, 2013), The Professional Chef (2011), A Consumer's Dictionary of Food Additives (Winter, 2009), and Merriam-Webster Dictionary and Thesaurus (2020). As used herein, the following terms have the meanings ascribed to them unless specified otherwise.

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

The term “comprising” means “including, but not necessarily limited to”; and specifically indicates open-ended inclusion or membership in a so-described combination, group, series, and the like. The terms “comprising” and “including” as used herein are inclusive and/or open-ended and do not exclude additional, unrecited elements or method processes. The term “consisting essentially of” is more limiting than “comprising” but not as restrictive as “consisting of.” Specifically, the term “consisting essentially of” limits membership to the specified materials or steps and those that do not materially affect the essential characteristics of the claimed invention. The various characteristics described in more detail below, will be readily apparent to those skilled in the art with the aid of this disclosure including examples, detailed description, claims, drawings and abstract.

All numbers and ranges disclosed may vary by some amount. Whenever a numerical range with a lower limit and an upper limit is disclosed, any number and any included range falling within the range is specifically disclosed. In particular, every range of values (of the form, “from about a to about b,” or equivalently, “from approximately a to b,” or, equivalently, “from approximately a-b”) disclosed herein is to be understood to set forth every number and range encompassed within the broader range of values.

As various changes could be made in the products, compositions and methods without departing from the scope and the spirit of the invention, it is intended that all matter contained in the above description and in the examples given below, shall be interpreted as illustrative and not in a limiting sense.

As various changes could be made in the above-described methods without departing from the scope of the invention, it is intended that all matter contained in the above description and in the examples given below, shall be interpreted as illustrative and not in a limiting sense.

### EXAMPLES

The publications and descriptions above are provided solely for their disclosure before the filing date of the present application. Nothing herein is to be construed as an admission that the invention is not entitled to antedate such disclosure by virtue of prior invention.

Various examples and embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. The following examples are included to demonstrate the disclosure, rather than limit the scope of the invention. It should be appreciated by those of skill in the art that the compositions, methods, and steps disclosed in the following examples represent techniques discovered by the inventors to function well in the practice of the current invention. Those of skill in the art should, however, in light of the present disclosure, appreciate that many changes could be made in the disclosure and still obtain a like or similar result without departing from the spirit and scope of the current disclosure, therefore all matter set forth is to be interpreted as illustrative and not in a limiting sense.

Examples 1-14 detailed below provide illustrative embodiments and aspects of the present invention. They demonstrate the successful implementation of the current invention of making and obtaining a plant-based meat alternative with comparable taste, color and texture to their animal meat counterparts.

### Example 1: Ingredient List and Preparation of a Meat Alternative Burger

This example covers a formulation and recipe for a meat alternative burger. TABLE 32 provides amounts of ingredients used to prepare the meat alternative burger.

TABLE 32

| Ingredient | Ingredient Classification | Weight Percentage (wt %) |
|---|---|---|
| Bovine Myoglobin Solution | Heme protein | 11.1% |
| (HEMAMI ™) | | (providing 1 wt % d.b.) |
| Methyl Cellulose, Citrus | Hydrocolloid, the plant- | 2.9% |
| Fiber, Corn Starch, | based fiber, the additional | (includes 1% APPETEX ™, |
| Maltodextrin, Carrageenan, | plant-based protein | which contains the |
| Konjac Flour, Gum Arabic, | | carrageenan, konjac flour, |
| Rice Protein Concentrate | | gum Arabic, and rice |
| | | protein concentrate) |
| Textured Soy Protein | Plant-Based Protein | 19.5% |
| Canola Protein, Inulin | Second Additional Plant | 1.3% |
| | Based Protein and Plant- | |
| | Based Fiber, respectively | |
| Potato Starch | Binder | 0.5% |
| Sunflower Oil, Coconut Oil | Fat | 15.0% |
| Water | X | 44% |

### Preparation of the Meat Alternative Burger

The following procedure was used to prepare a meat alternative burger.
1. Citrus fiber was hydrated with 2% water, set aside until step 8. Allow to hydrate for 5 minutes.
2. Add textured soy protein and canola protein to bowl of stand mixer and mix 30 sec at speed 2 to combine.
3. Combine 3.8% water and bovine myoglobin. Stir for 30 sec until dissolved.
4. Add solution from step #3 to textured soy protein and canola protein. Mix for 1 min on speed 4 until all protein is well-covered. Turn off mixer and rest to hydrate 5 min.
5. Combine corn starch and potato starch, inulin, and APPETEX™ (carrageenan, konjac flour, gum Arabic, and rice protein concentrate). Then, add this mixture to the hydrated textured soy protein, canola protein, and citrus fiber. Blend for 1 min at speed 4 until homogeneous.
6. Add sunflower oil to bowl of robot coupe, then add methylcellulose. Pulse and scrape down bowl until methylcellulose is incorporated in sunflower oil forming a methylcellulose gel. Add rest of water in several additions, pulsing and scraping down bowl after each addition. Process until mixture is semi-solid and homogenous.
7. Add methylcellulose gel from step #6 to the mixture from step #5 and mix at speed 4 for 2 minutes.
8. Add coconut oil fat inclusions and hydrated citrus fiber. Mix for 30 sec at speed 2 to combine.
9. Form meat alternative burger patties with 113 g burger in 3.5” ring mold. Store in freezer overnight until ready to use.
10. Thaw patties overnight or over the counter for 1 hour
11. Heat non-stick pan on induction burner set to 250° C.
12. Cook patties for 2 min 15 sec on each side.
13. Allow patties to rest for 2 min after cooking prior to consumption or analysis.

### Example 2: Evaluation of a Meat Alternative Burger by a Sensory Panel

The meat alternative formulation as a meat alternative burger patty was prepared as described above. The meat alternative burger was thawed on the countertop overnight and then cooked on an induction burner at 250° C. for approximately 2 minutes 15 seconds per side. After setting at room temperature for 2 minutes, the cooked meat alternative burger was evaluated by a sensory panel.

To compare the meat alternative burger, a ground meat burger (80/20 ground beef and a similar size to the cooked meat alternative burger) was prepared by grilling the burger on a 168° C. heated pan on each side until done. After preparation, the cooked meat burger was evaluation by the panel consisting of 10 individuals, 5 males and 5 females ranging from 16 years of age to 60 years of age.

In the table below, the sensory panel was asked to rank each burger for aroma, beefy flavor, taste, color, and the texture profile of two burgers. The table below shows this comparison.

### Example 3: Effects of Plant-Based Fiber Additives on Meat Alternative Burger Appearance, Flavor and Physical Properties

This example covers the effects of plant-based fiber formulation on meat alternative burger appearance, flavor and physical properties as determined by an expert sensory panel. Multiple plant-based fiber compositions were tailored to mimic different meat components, namely cartilage (PBA), perimysium (PBB), and tendon (PBC). Each of these three compositions was prepared with APPETEX™ containing carrageenan, konjac flour, acacia gum, and brown rice protein, and produced with different cooking methods.

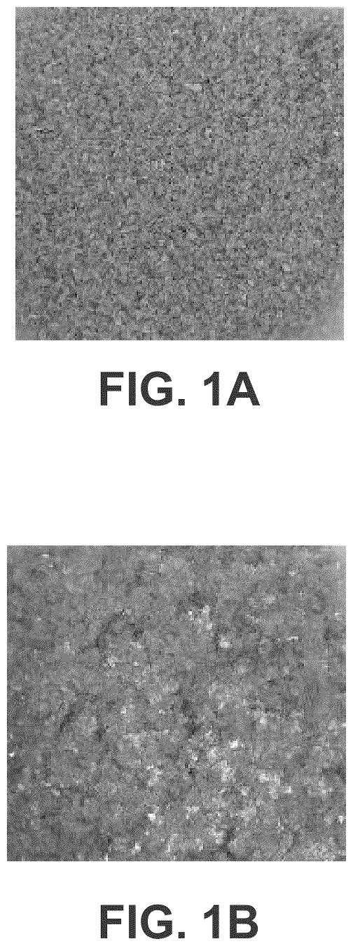

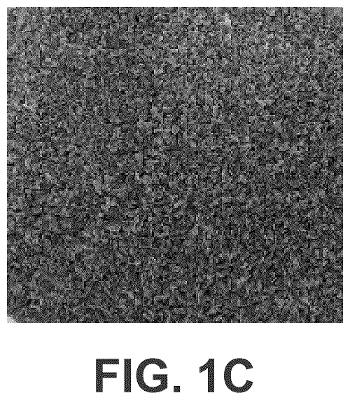

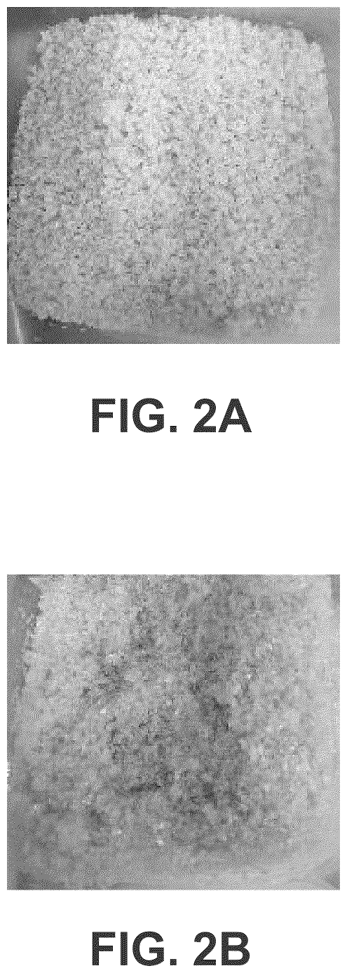

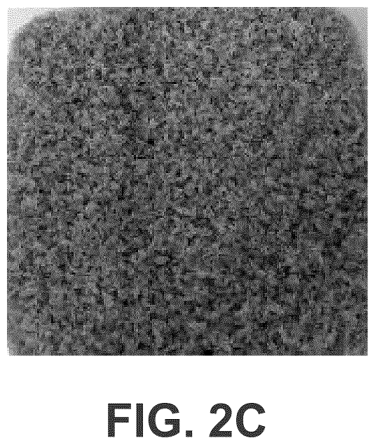

FIGS. 1A-C provide images of PBA (FIG. 1A), PBB (FIG. 1B), and PBC (FIG. 1C) in dry form. FIGS. 2A-C provide images of PBA (FIG. 2A), PBB (FIG. 2B), and PBC (FIG. 2C) in hydrated form, with two-parts water to one-part plant fiber. These images illustrate differences in color and texture of the three formulations, as well as the retention of these properties following hydration. PBC is darker than either PBA or PBB in dry and hydrated forms, while PBB consists of larger clumps than either PBA or PBC.

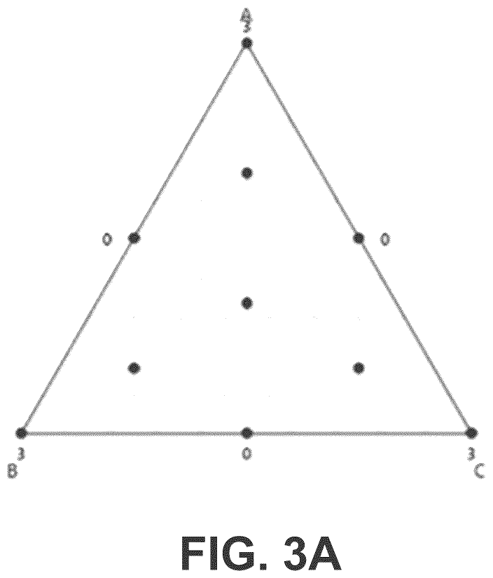

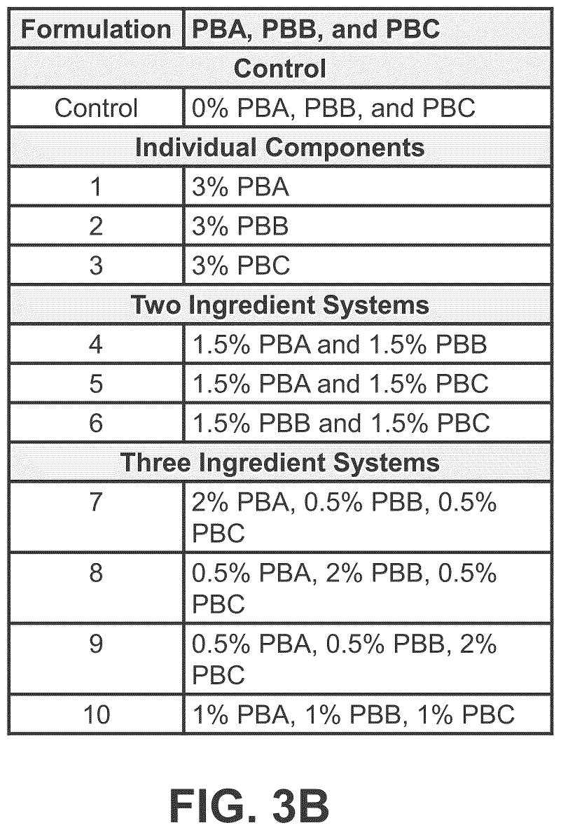

Meat alternative burgers were prepared according to TABLE 33 and Example 1, with varying amounts of PBA, PBB, and PBC, and identical remaining ingredients. The ratios of PBA, PBB, and PBC in each formulation are summarized in the ternary plot of FIG. 3A and table of FIG. 3B. PBA, PBB, and PBC were provided in hydrated form (WATER II in TABLE 33) and totaled either 1 or 3 weight percent in each formulation. A formulation lacking PBA, PBB, and PBC was utilized as a control standard for textural analyses described below.

TABLE 33

| | Variable | Variable | Variable | Variable | Variable | Variable |
|---|---|---|---|---|---|---|
| | 1 | 2 | 3 | 4 | 5 | 6 |
| WATER I | 35.54% | 35.54% | 31.54% | 31.54% | 31.54% | 31.54% |
| NATUREX | 0.50% | 0.50% | 0.50% | 0.50% | 0.50% | 0.50% |
| VEGGIBRITE RED | | | | | | |
| COLOR | | | | | | |
| TEXTURED SOY | 21.67% | 21.67% | 19.67% | 19.67% | 19.67% | 19.67% |
| PROTEIN, MINCED | | | | | | |
| (70%) | | | | | | |
| COCONUT OIL | 7.00% | 7.00% | 7.00% | 7.00% | 7.00% | 7.00% |
| INULIN | 0.80% | 0.80% | 0.80% | 0.80% | 0.80% | 0.80% |
| METHYL- | 25.90% | 25.90% | 25.90% | 25.90% | 25.90% | 25.90% |
| CELLULOSE GEL | | | | | | |
| FLAVOR SYSTEM - | 2.00% | 2.00% | 2.00% | 2.00% | 2.00% | 2.00% |
| WT | | | | | | |
| FLAVOR SYSTEM - | 1.98% | 1.98% | 1.98% | 1.98% | 1.98% | 1.98% |
| IV | | | | | | |
| FLAVOR SYSTEM - | 1.06% | 1.06% | 1.06% | 1.06% | 1.06% | 1.06% |
| DO | | | | | | |
| FLAVOR SYSTEM - | 0.55% | 0.55% | 0.55% | 0.55% | 0.55% | 0.55% |
| OK | | | | | | |
| APPETEX ™ - PBA | 0.50% | 0.50% | 1.50% | 0.50% | 1.00% | 0.00% |
| APPETEX ™ - PBB | 0.30% | 0.00% | 0.00% | 0.50% | 1.00% | 0.00% |
| APPETEX ™ - PBC | 0.20% | 0.50% | 1.50% | 2.00% | 1.00% | 3.00% |
| WATER II (1:2 ratio) | 2.00% | 2.00% | 6.00% | 6.00% | 6.00% | 6.00% |
| TOTAL SUM | 100.00% | 100.00% | 100.00% | 100.00% | 100.00% | 100.00% |

### Appearance

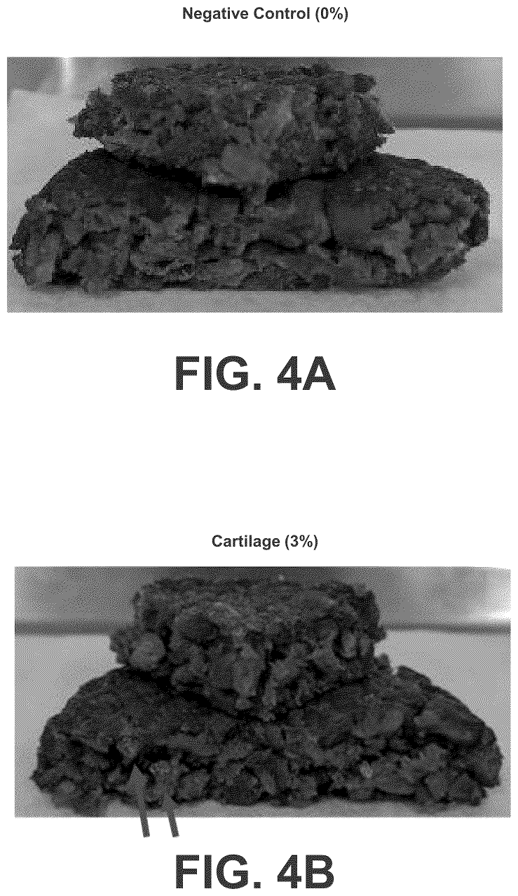

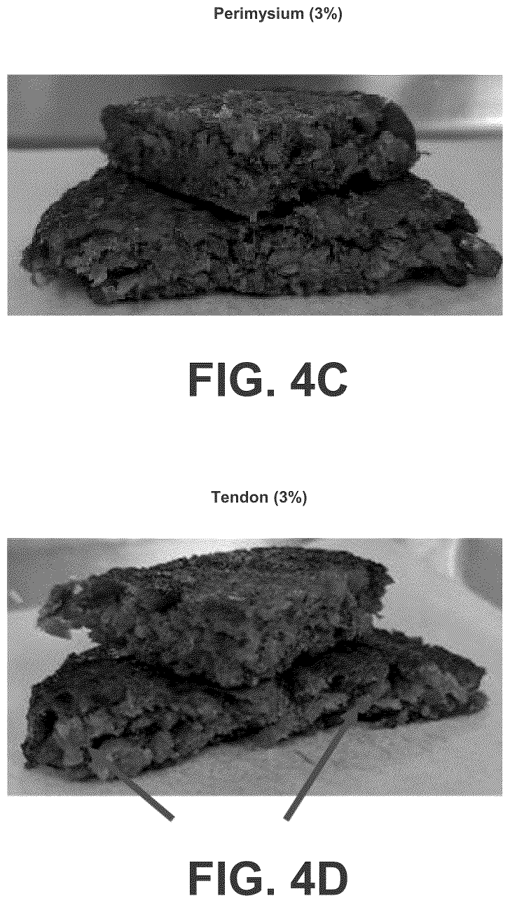

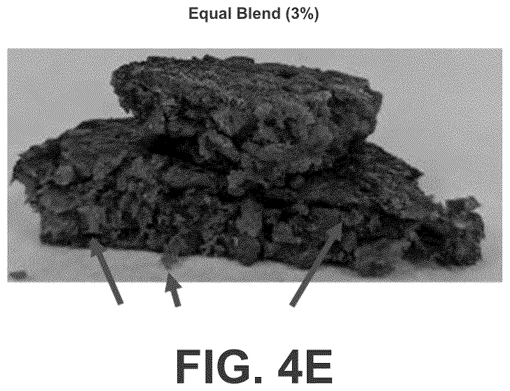

FIGS. 4A-E provide images of cooked meat alternative burgers corresponding to the control (FIG. 4A); 3 weight % PBA (FIG. 4B); 3 weight % PBB (FIG. 4C); 3 weight % PBC (FIG. 4D); and equal parts PBA, PBB, and PBC (each 1 weight %, FIG. 4E) formulations. Arrows in FIGS. 4B, 4D, and 4E indicate crumbles.

### Sensory Evaluations

The 11 burger formulations were compared by a sensory evaluation panel for springiness, hardness, particulate level, juiciness, and density. For each sensory evaluation, the meat alternative burger formulations were refrigerated for one week prior to cooking and testing.

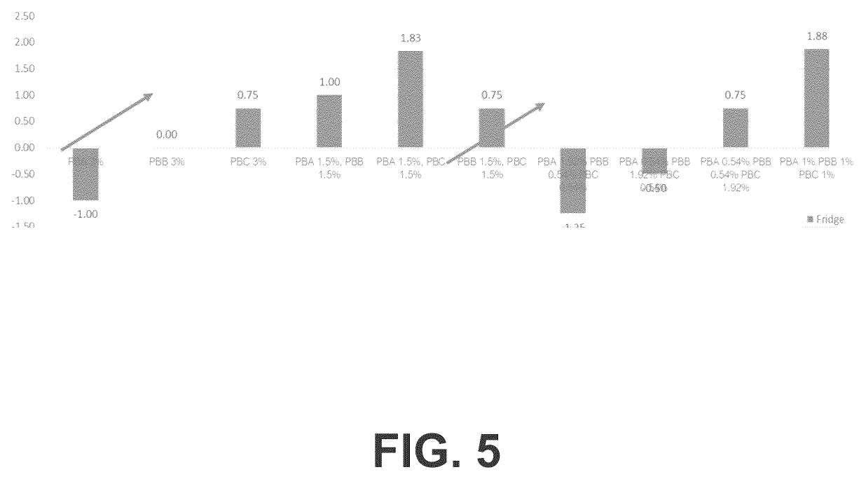

FIG. 5 provides mean springiness levels for each of the ten APPETEX™—containing formulations relative to the APPETEX™—free control formulation. The sensory panelists indicated that formulations with PBC (a tendon-mimetic plant-based fiber formulation) exhibited increased springiness relative to other formulations, while formulations with PBA (cartilage-mimetic plant-based fiber formulation) provided the lowest levels of springiness.

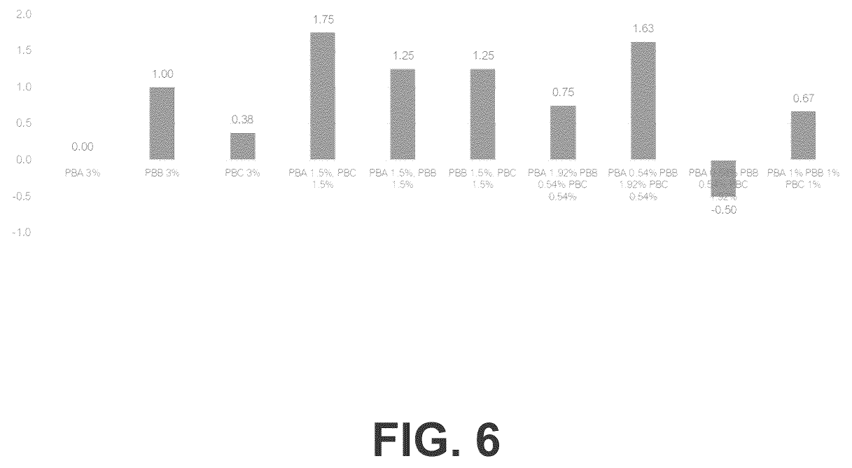

FIG. 6 provides mean hardness levels for each of the ten APPETEX™—containing formulations relative to the APPETEX™—free control formulation. Sensory panelists indicated that most APPETEX™—containing formulations exhibited slight increases in hardness compared to the APPETEX™—free control formulation.

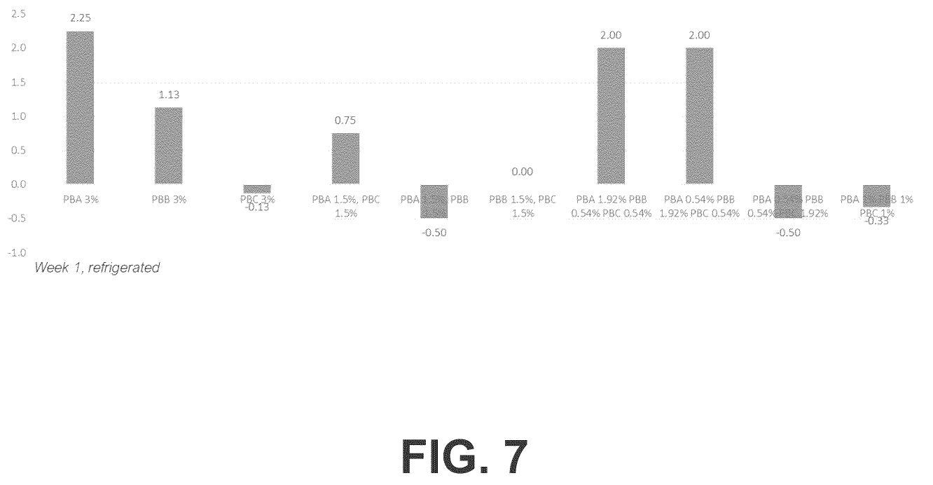

FIG. 7 provides mean particulate levels for each of the ten APPETEX™—containing formulations relative to the APPETEX™—free control formulation. The sensory panel indicated higher particulate levels in formulations with high PBA and PBB (perimysium-mimetic plant-based fiber formulation) relative to the APPETEX™—free control formulation. The sensory panel further determined that formulations with high quantities of PBC exhibited relatively low particulate levels.

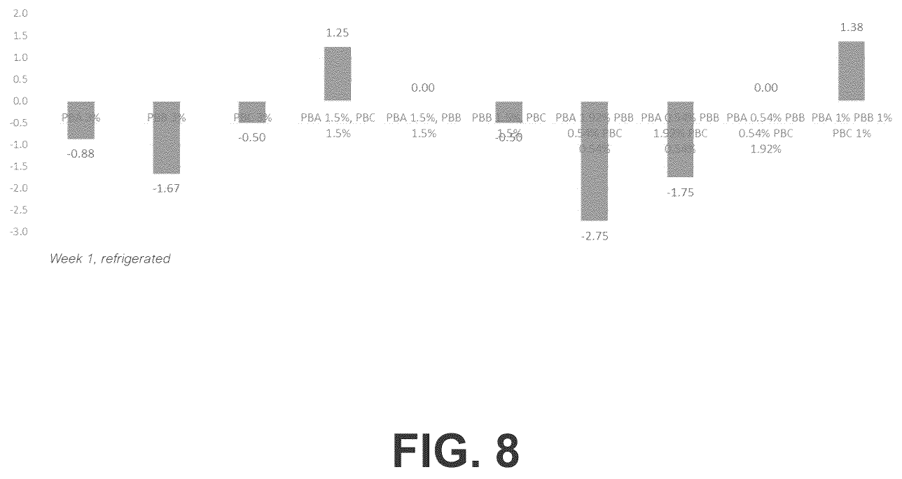

FIG. 8 provides mean juiciness levels for each of the ten APPETEX™—containing formulations relative to the APPETEX™—free control formulation. The sensory panel identified two formulations with improved juiciness compared to the APPETEX™—free control formulation, namely (1) equal parts PBA and PBB, and (2) equal parts PBA, PBB, and PBC, indicating synergistic effects between the separate APPETEX™ formulations. Conversely, the lowest juiciness level was provided by the 1.92% PBA, 0.54% PBB, and 0.54% PBC formulation, with panelists noting that the meat alternative burger was dry and course.

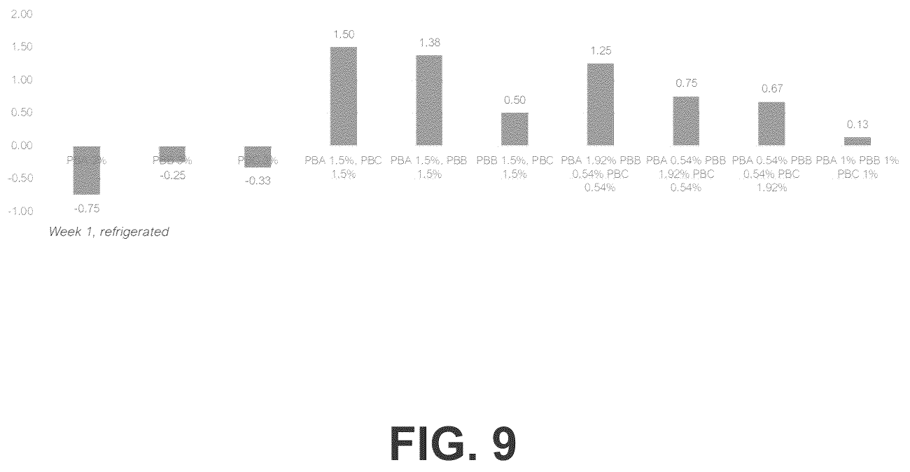

FIG. 9 provides mean densities for each of the ten APPETEX™—containing formulations relative to the APPETEX™—free control formulation. While formulations with single APPETEX™ components displayed decreased densities relative to the APPETEX™—free control formulation, blend formulations with at least two of PBA, PBB, and PBC exhibited density increases beyond those associated with any of the individual connective tissue analog components, indicating desirable synergistic effects from combinations of the APPETEX™ formulations.

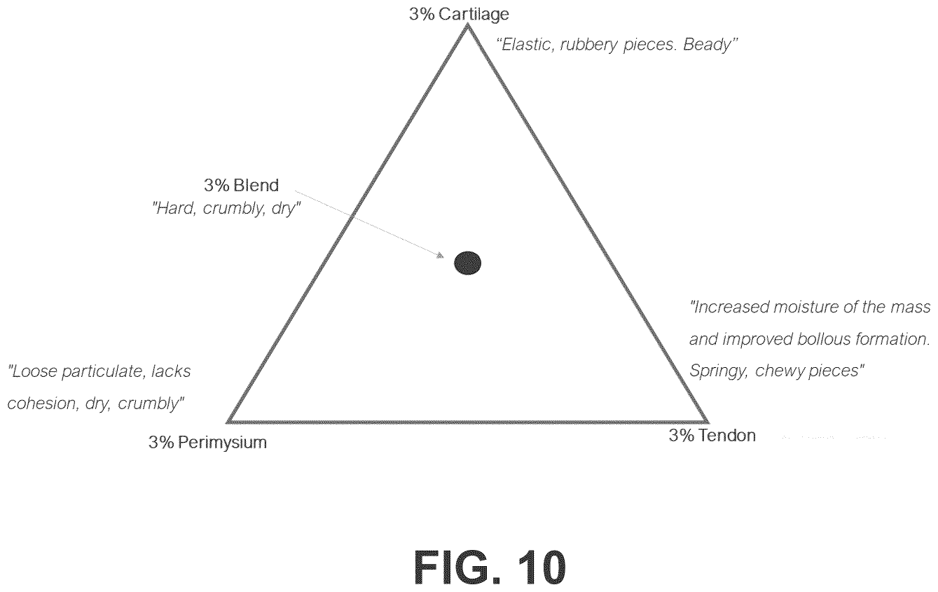

FIG. 10 summarizes descriptive sensory panel findings for the 3% PBA (‘3% Cartilage’); 3% PBB (‘3% Perimysium’); 3% PBC (‘3% Tendon’); and equal parts PBA, PBB, and PBC (‘3% Blend’) formulations. The sensory panel described the 3% PBA formulation as elastic and beady with rubbery pieces, the 3% PBB formulation as loose particulate lacking cohesion, dry, and crumbly, the 3% Blend formulation as hard, crumbly and dry, and the 3% PBC formulation as having increased moisture of the mass and improved bolus formation, with springy and chewy pieces.

### Cook Loss

Cook loss was compared between meat alternative burgers made with variable APPETEX™ formulations. 113 g burgers were molded with 3.5” rings and stored for 1 or 2 weeks prior to thawing and cooking. Cook loss levels indicate aggregate weight loss following 2 minutes and 15 seconds of 250° C. cooking on each side of the meat alternative burger (providing a total of 4 minutes 30 seconds of cooking) in a non-stick pan.

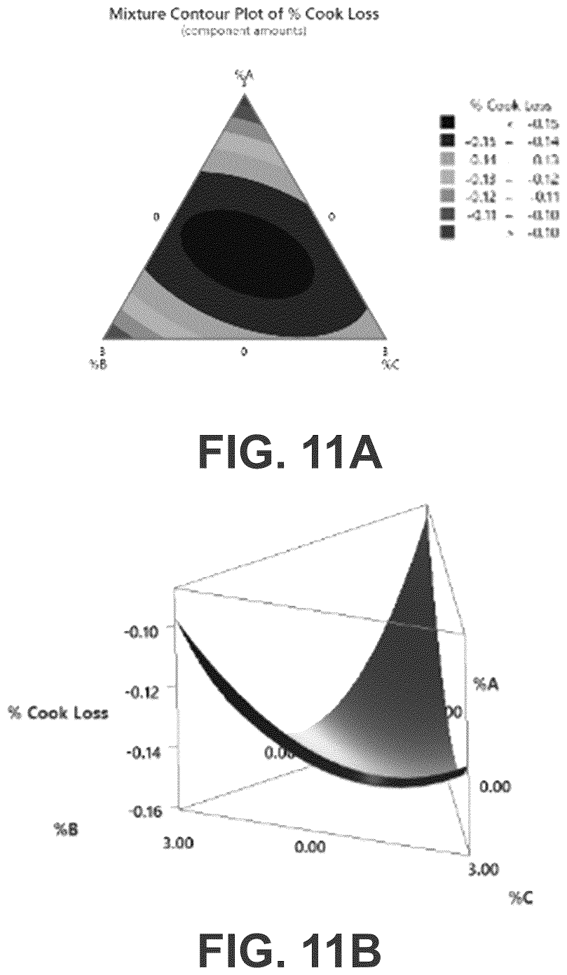

FIGS. 11A-B provide 2-dimensional (2D, FIG. 11A) and 3-dimensional (3D, FIG. 11B) ternary plots summarizing cook loss for meat alternative burgers made with variable APPETEX™ formulations following one week of storage, with axes showing amounts of PBA, PBB, and PBC in the meat alternative burger formulations. In these plots, cook loss is provided as percentage of mass lost during cooking. As displayed in FIGS. 11A-B, formulations with high amounts of PBA and PBC exhibited the lowest levels of cook loss, while PBC content correlated with high cook loss.

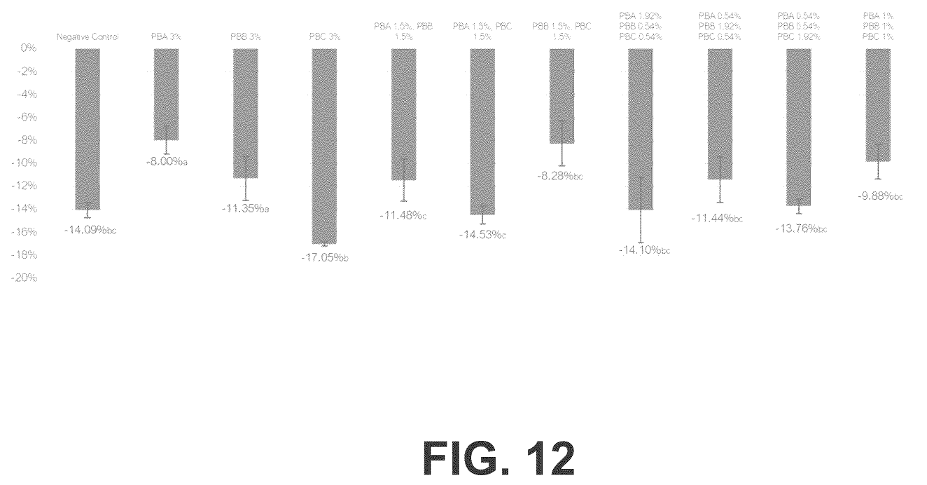

FIG. 12 provides cook loss values for meat alternative burgers made with the variable APPETEX™ and APPETEX™—free control formulations following one week of storage. While some PBA- and PBB-containing meat alternative formulations exhibited lower cook loss than the meat alternative burger made with the APPETEX™—free control formulation, high PBC formulations exhibited the highest levels of cook loss.

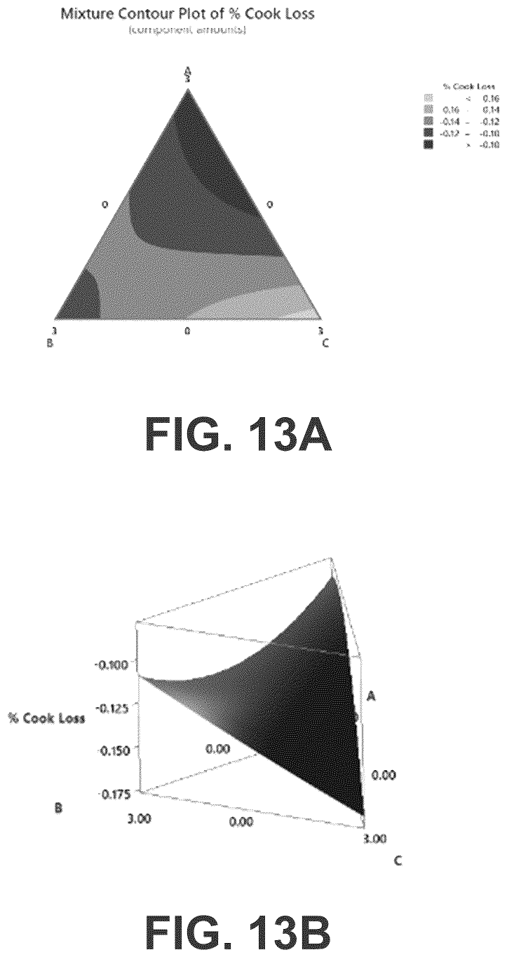

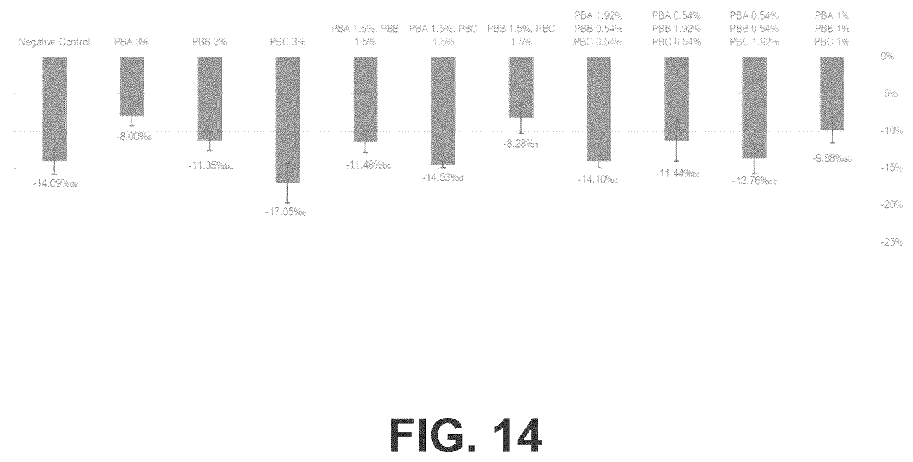

Cook loss studies were repeated following two weeks of storage prior to cooking. As shown in FIGS. 13A-B, which provide 2-dimensional (2D, FIG. 13A) and 3-dimensional (3D, FIG. 13B) ternary plots summarizing cook loss, and FIG. 14, which provides cook loss values for APPETEX™—containing and APPETEX™—free control formulations, cook loss levels were identical for each formulation following one and two weeks of storage, indicating high levels of storage tolerance for all formulations tested.

### Hardness

Meat alternative burgers made with APPETEX™—containing and APPETEX™—free formulations were tested for hardness. The burgers were prepared as summarized in EXAMPLE 1, and were stored for one or two weeks prior to cooking and analysis. The meat alternative burgers were tested for hardness through texture profile analysis (TPA), with results summarized for the first and ninth TPA strokes. While first TPA stroke provides a strong indicator for hardness at the time of first bite, the ninth TPA stroke serves as an analog for hardness following chewing.

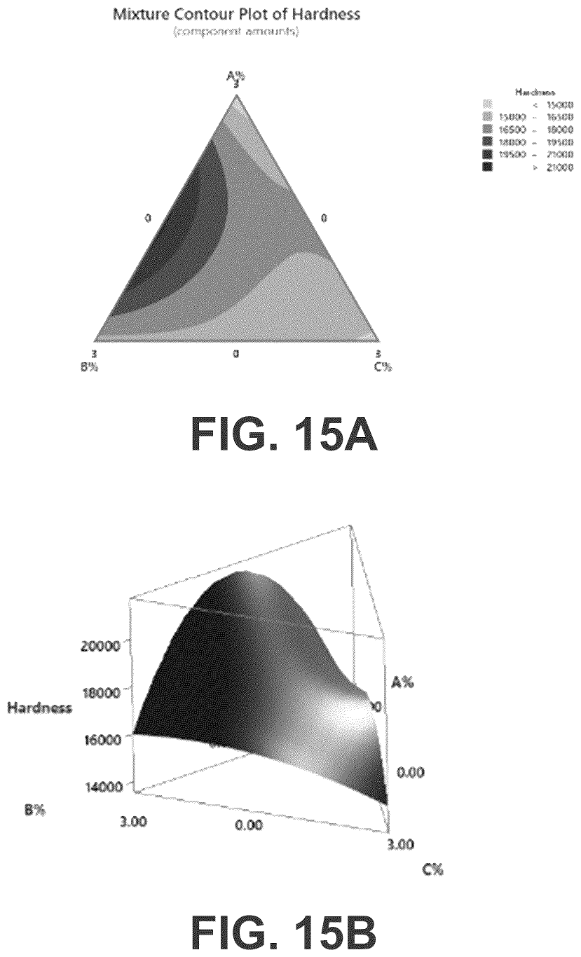

FIGS. 15A-B provide 2D (FIG. 15A) and 3D (FIG. 15B) ternary plots summarizing hardness at first TPA stroke for meat alternative burgers made with variable APPETEX™ formulations following one week of storage, with axes showing amounts of PBA, PBB, and PBC in the meat alternative burger formulations. As provided in these plots, the highest hardness levels were observed for combined PBA and PBB formulations, while the lowest hardness levels were exhibited by the PBA- and PBC-only formulation. High hardness levels were measured for many of the combined PBA, PBB, and PBC mixtures, demonstrating synergistic effects for the three APPETEX™ preparations.

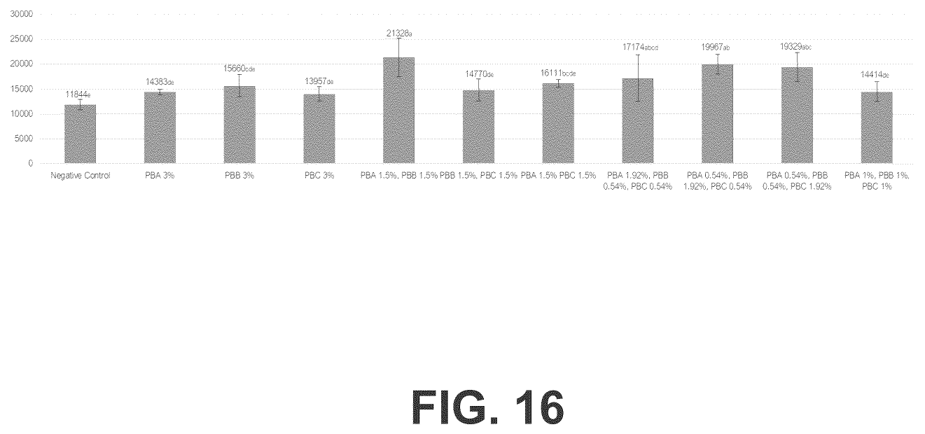

FIG. 16 provides hardness levels at first TPA stroke for burgers made with APPETEX™—containing and APPETEX™—free formulations following one week of storage. All APPETEX™—containing formulations exhibited higher hardness levels than the APPETEX™—free formulation. Of these formulations, 1.5% PBA and PBB, 1.92% PBA with 0.54% PBB and PBC, 1.92% PBB with 0.54% PBA and PBC, and 1.92% PBC with 0.54% PBA and PBB were harder than the APPETEX™—free formulation with statistical significance.

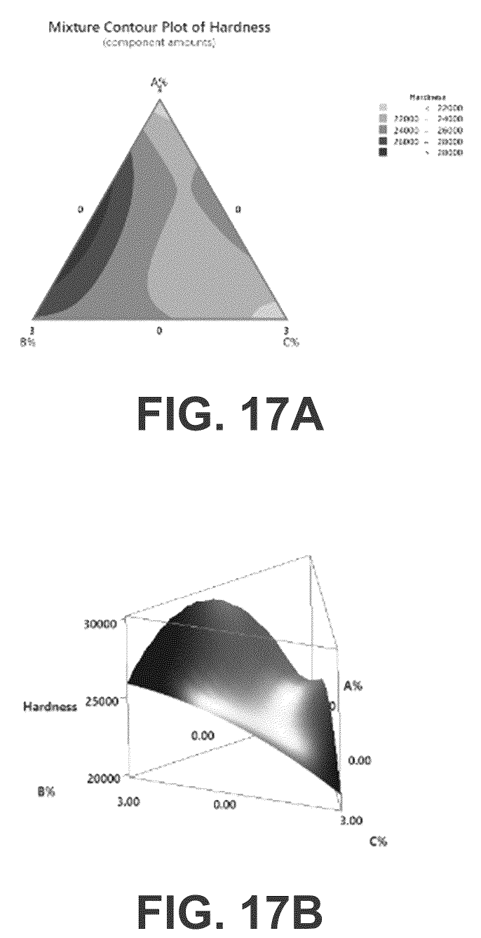

FIGS. 17A-B provide 2D (FIG. 17A) and 3D (FIG. 17B) ternary plots summarizing hardness at ninth TPA stroke for meat alternative burgers made with variable APPETEX™ formulations following one week of storage, with axes showing amounts of PBA, PBB, and PBC in the meat alternative burger formulations. As observed for the first stroke TPA analyses, combined PBA and PBB formulations exhibited the highest levels of hardness, while PBA- and PBC-only formulations exhibited relatively low hardness levels.

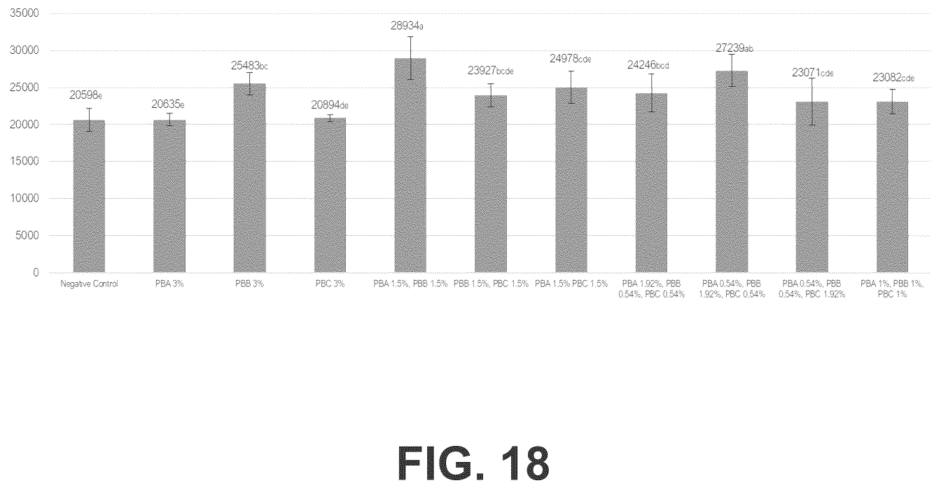

FIG. 18 provides hardness levels at ninth TPA stroke for burgers made with APPETEX™—containing and APPETEX™—free formulations following one week of storage. The hardness levels of the PBA- and PBC-only formulations were closer to the APPETEX™—free formulation at the ninth TPA stroke than at the first TPA stroke. The formulations with 3% PBB, 1.5% PBA and PBB, 1.92% PBA with 0.54% PBB and PBC, and 1.92% PBB with 0.54% PBA and PBC were harder than the APPETEX™—free formulation with statistical significance.

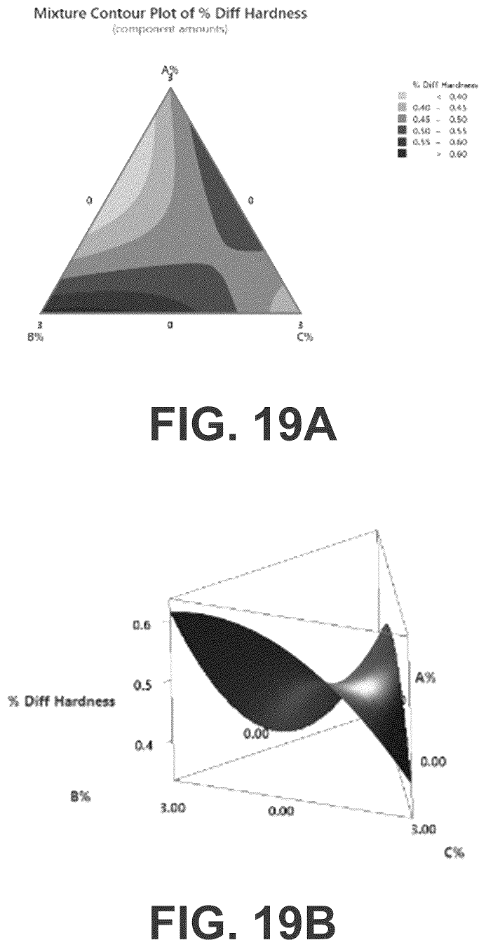

FIGS. 19A-B summarize changes in hardness between the first and ninth TPA strokes for the meat alternative burgers made with one-week stored APPETEX™—containing formulations. Axes in these plots provide amounts of PBA, PBB, and PBC in the meat alternative burger formulations. While no statistically significant relationships were identified between the PBA, PBB, and PBC components, the PBB-only formulation exhibited the greatest hardness retention between first and ninth TPA strokes, while PBC-only and combined PBA and PBB formulations exhibited the lowest hardness retention.

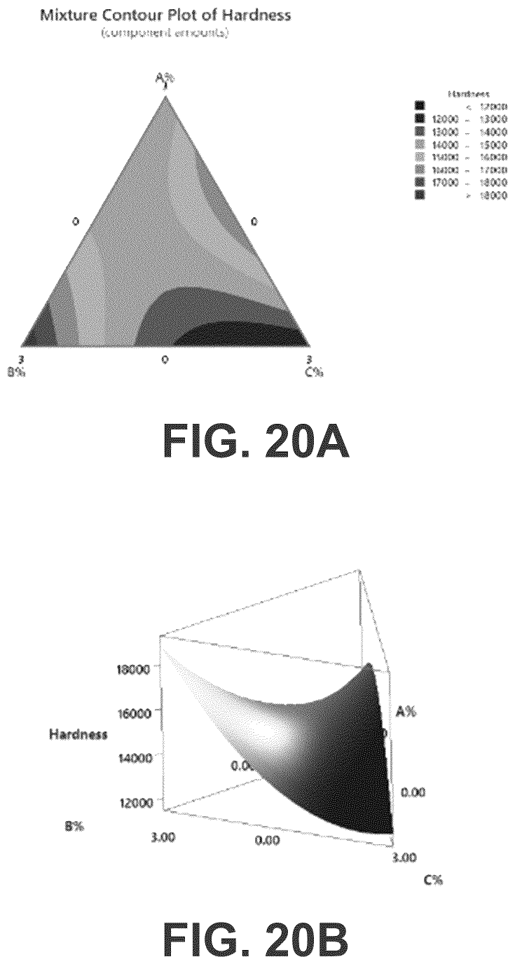

FIG. 20A-B provide 2D (FIG. 20A) and 3D (FIG. 20B) ternary plots summarizing hardness at first TPA stroke for meat alternative burgers made with variable APPETEX™ formulations following two weeks of storage, with axes showing amounts of PBA, PBB, and PBC in the meat alternative burger formulations. The meat alternative burgers exhibited about 3000 g lower hardness levels than the meat alternative burgers made following one week of storage, with average hardness levels ranging from about 12000 to about 18000 g. While PBA- and PBC-only formulations exhibited among the lowest hardnesses, mixed PBA and PBC formulations exhibited relatively high hardnesses, evidencing synergism between these formulations.

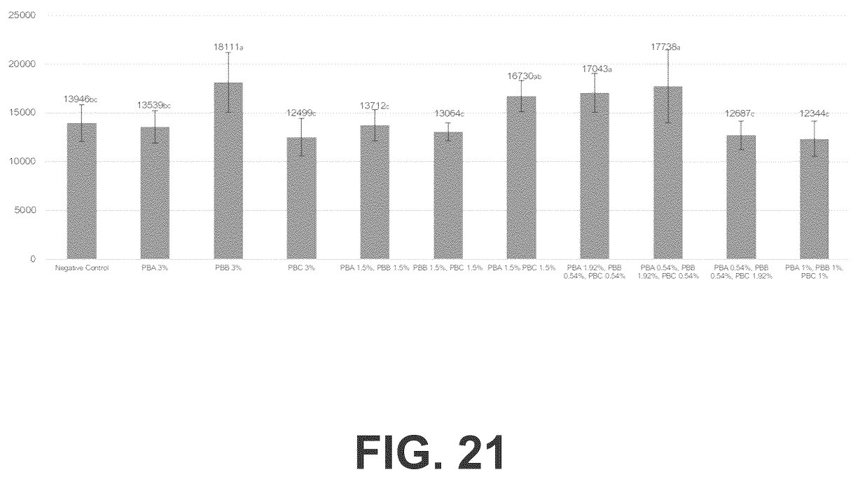

FIG. 21 provides hardness levels at first TPA stroke for meat alternative burgers made with APPETEX™—containing and APPETEX™—free formulations stored for two weeks prior to cooking. Most formulations decreased in first TPA stroke hardness between one and two weeks of storage, differing from the APPETEX™—free formulation, which exhibited an increase in hardness following increased storage length. The formulations with 3% PBB, 1.92% PBA with 0.54% PBB and PBC, and 1.92% PBB with 0.54% PBA and PBC were statistically significantly harder than the APPETEX™—free formulation.

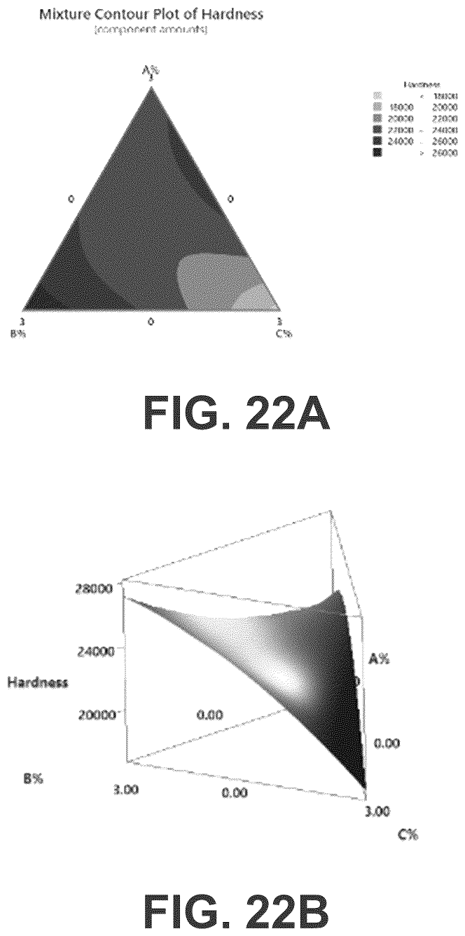

FIG. 22A-B provide 2D (FIG. 22A) and 3D (FIG. 22B) ternary plots summarizing hardness at ninth TPA stroke for meat alternative burgers made with variable APPETEX™ formulations following two weeks of storage, with axes showing amounts of PBA, PBB, and PBC in the meat alternative burger formulations. The 2-week and 1-week stored meat alternative burgers exhibited similar average hardness levels. Some formulations (such as PBB-only) were harder following two weeks of storage, while others (such as PBA- and PBC-only) decreased in hardness following an additional week of storage. The burgers also exhibited similar APPETEX™—type dependencies for ninth TPA stroke hardness, with PBA and PBC exhibiting a strong synergistic relationship for hardness, and PBB-level appearing to correlate with total hardness.

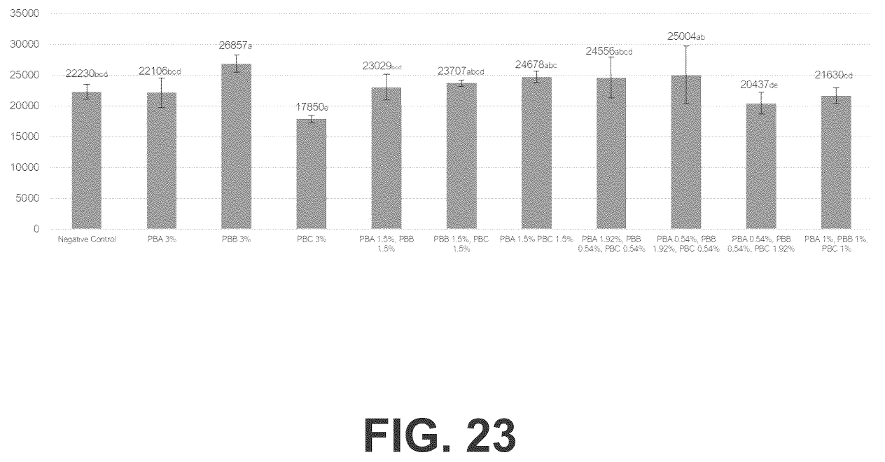

FIG. 23 provides hardness levels at ninth TPA stroke for meat alternative burgers made with APPETEX™—containing and APPETEX™—free formulations stored for two weeks prior to cooking. While the PBB-only formulation was significantly harder after 9 sequential strokes than the APPETEX™—free formulation, the PBC-only burger was significantly softer than the APPETEX™—free and PBB-only burgers.

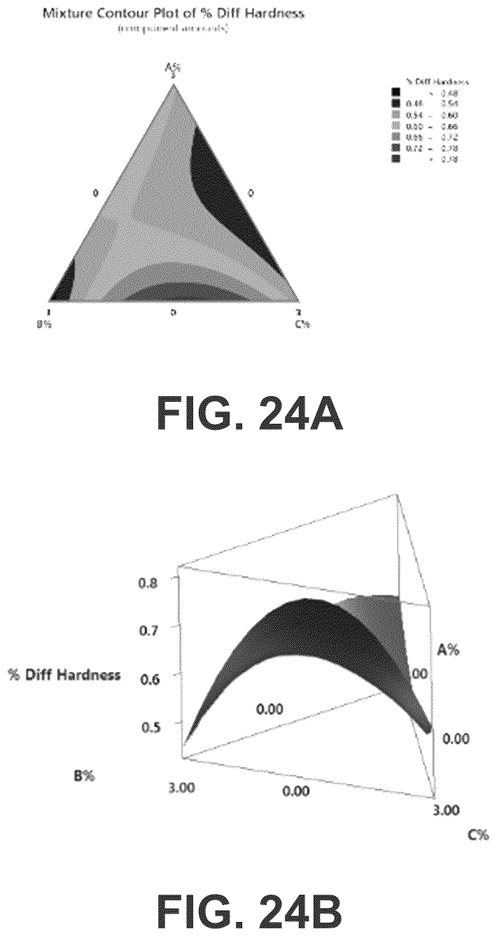

FIGS. 24A-B summarize changes in hardness between the first and ninth TPA strokes for the meat alternative burgers made with two-week stored APPETEX™—containing formulations, with axes showing amounts of PBA, PBB, and PBC in the meat alternative burger formulations. While PBB and PBC displayed little synergy for hardness at either first or ninth TPA stroke, PBB and PBC displayed a significant synergistic relationship for hardness difference between the first and ninth strokes. The two-week stored formulations exhibited different APPETEX™—type dependencies than the one-week stored formulations for change in hardness, with PBA and PBC exhibiting a strong positive synergy and PBA and PBB exhibiting a strong negative synergy for the one-week stored formulations.

### Resilience

Meat alternative burgers made with APPETEX™—containing and APPETEX™—free formulations were tested for resilience, which provides a measure of propensity of a food product to regain shape following deformation. The burgers were prepared as summarized as described above, and were stored for one or two weeks prior to cooking and analysis. Resilience was measured with TPA, with results summarized for the first and ninth TPA strokes. Changes in resilience between the first and ninth TPA strokes can evidence potential loss of elasticity and springiness during chewing.

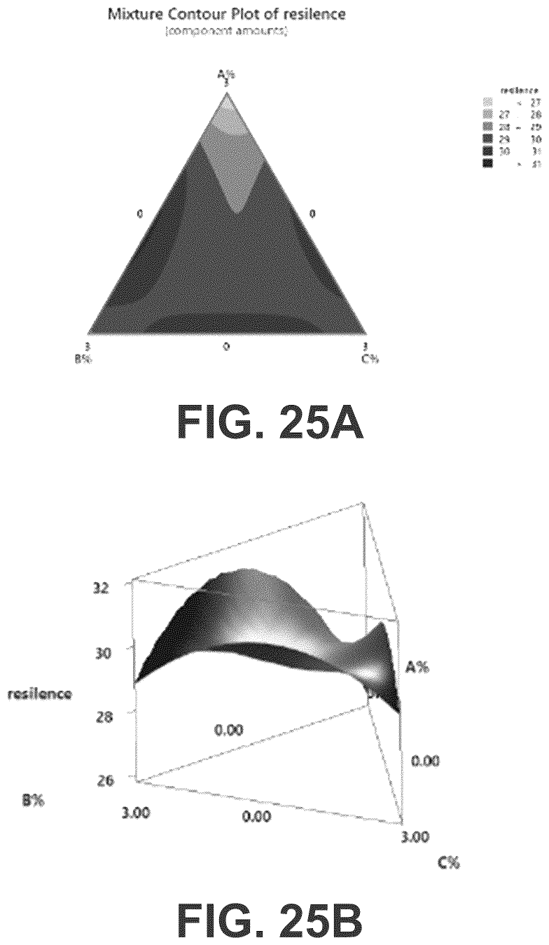

FIGS. 25A-B provide 2D (FIG. 25A) and 3D (FIG. 25B) ternary plots summarizing resilience at first TPA stroke for meat alternative burgers made with variable APPETEX™ formulations stored for one week prior to cooking, with axes showing amounts of PBA, PBB, and PBC in the meat alternative burger formulations. Pairwise, PBA, PBB, and PBC exhibited positive synergistic relationships for hardness, with PBA and PBB exhibiting the strongest synergistic relationship. However, formulations with all three APPETEX™ compositions exhibited lower resilience than APPETEX™ formulations containing only two.

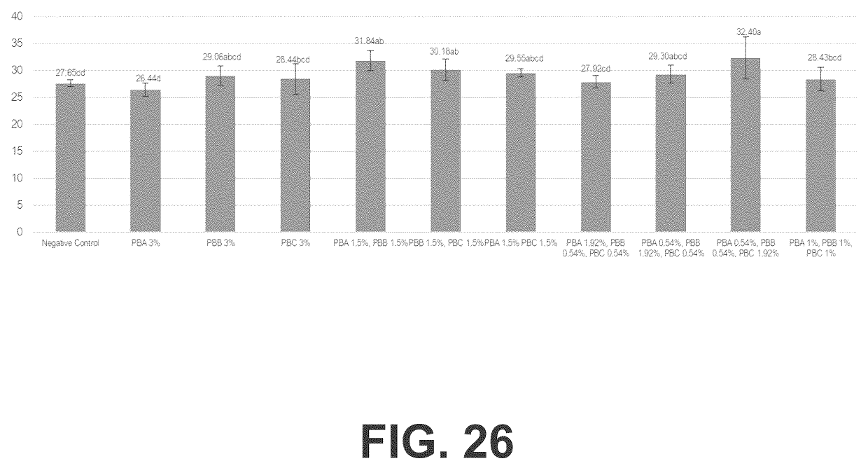

FIG. 26 provides resilience values at first TPA stroke for meat alternative burgers made with APPETEX™—containing and APPETEX™—free formulations stored for one week prior to cooking. The formulations with 1.5% PBA and PBB, with 1.5% PBB and PBC, and with 1.92% PBC and 0.54% PBA and PBB had statistically significant higher resiliencies than the APPETEX™—free formulation.

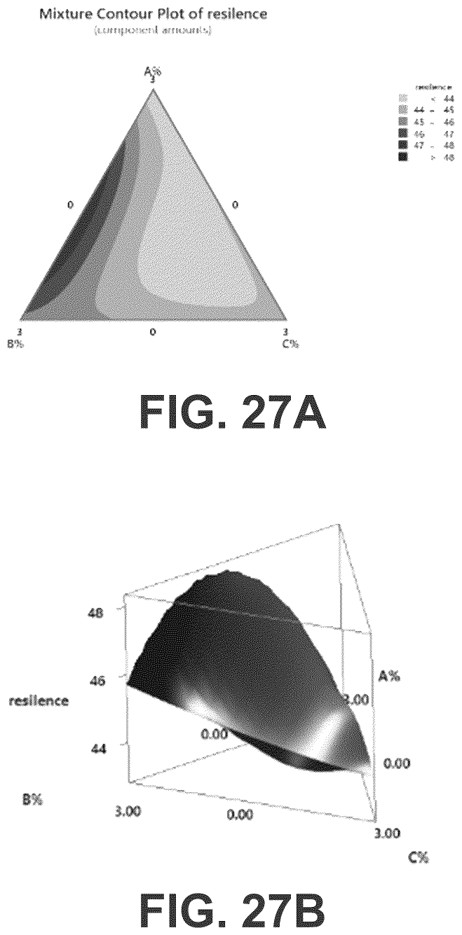

FIG. 27A-B provide 2D (FIG. 27A) and 3D (FIG. 27B) ternary plots summarizing resilience at ninth TPA stroke for meat alternative burgers made with variable APPETEX™ formulations following one week of storage, with axes showing amounts of PBA, PBB, and PBC in the meat alternative burger formulations. PBA and PBB exhibited a strong synergistic relationship, with the mixed PBA and PBB formulations exhibiting the highest resilience values. Similar to the first stroke TPA analyses, lower resiliencies were observed for formulations with all three APPETEX™ than for formulations containing only one or two of PBA, PBB, and PBC.

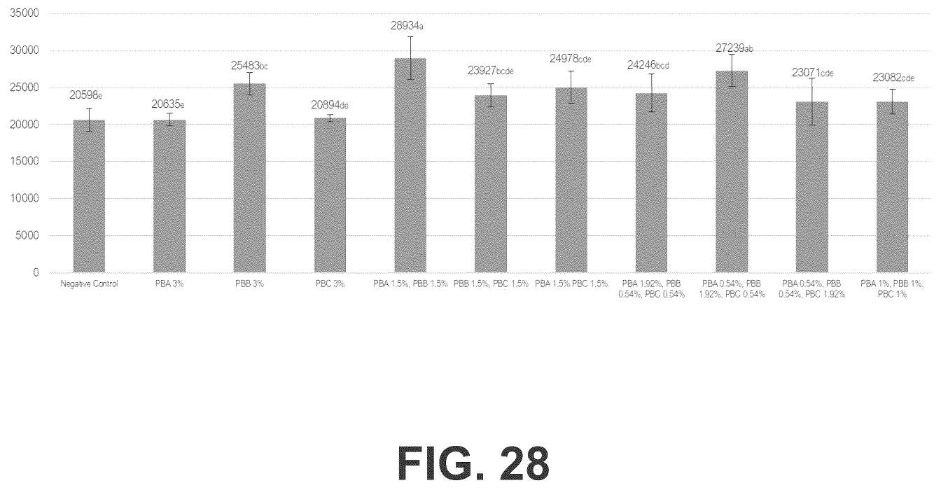

FIG. 28 provides resilience values at ninth TPA stroke for meat alternative burgers made with APPETEX™—containing and APPETEX™—free formulations stored for one week prior to cooking. Unlike for the one TPA stroke resiliencies, only one formulation, 1.5% PBA and PBB, exhibited significantly higher resilience than the APPETEX™—free control formulation, suggesting that APPETEX™ may enhance resilience for unchewed and partially chewed alternative meat formulations, but may also converge towards similarly low resiliencies as APPETEX™—free meat alternative formulations upon chewing.

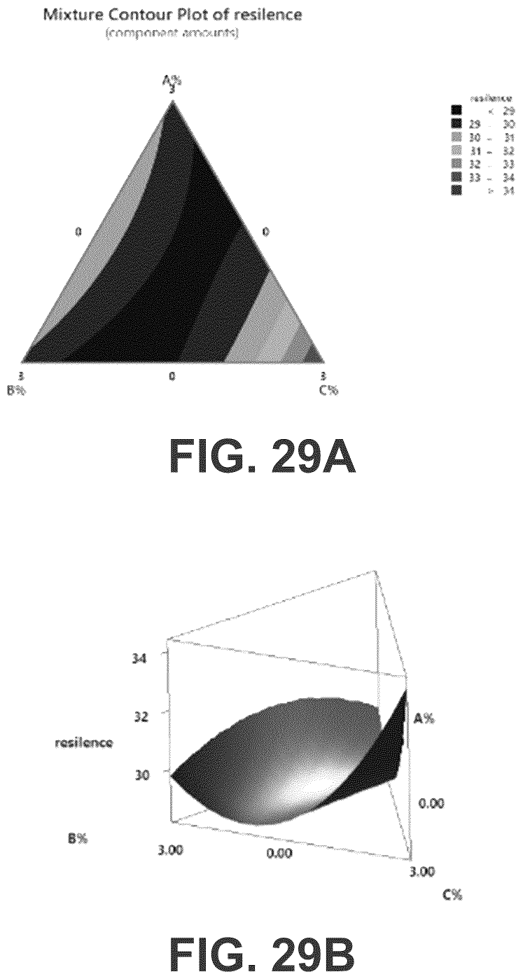

FIGS. 29A-B provide 2D (FIG. 29A) and 3D (FIG. 29B) ternary plots summarizing resilience at first TPA stroke for meat alternative burgers made with variable APPETEX™ formulations stored for two weeks prior to cooking, with axes showing amounts of PBA, PBB, and PBC in the meat alternative burger formulations. Whereas all three components exhibited small positive synergistic relationships for resilience following one week of storage, only PBA and PBB exhibited a small positive synergistic relationship for resilience, while PBC exhibited negative relationships for resilience with both PBA and PBB.

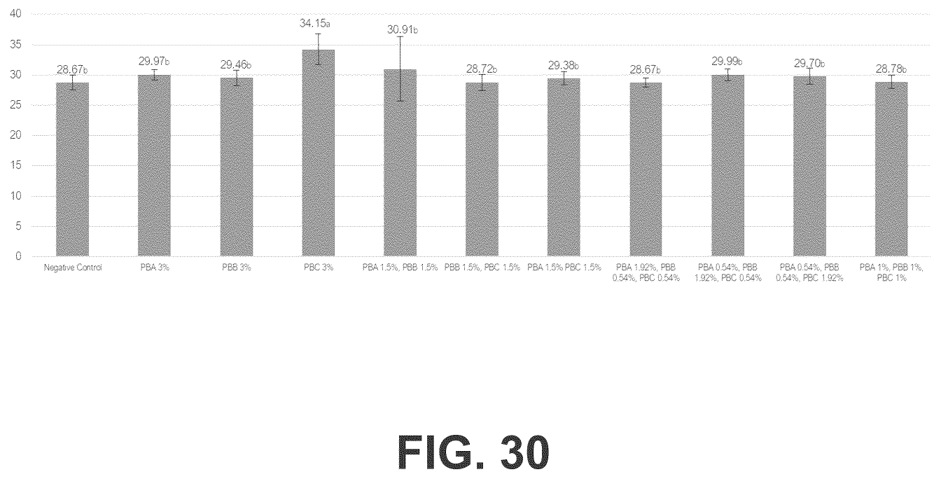

FIG. 30 provides first TPA stroke resilience values for meat alternative burgers made with APPETEX™—containing and APPETEX™—free formulations stored for two weeks prior to cooking. Whereas three formulations (1.5% PBA and PBB; 1.5% PBB and PBC; and 1.92% PBC and 0.54% PBA and PBB) exhibited higher first TPA stroke resilience following only one week of storage, only 3% PBC exhibited a statistically significant higher resilience than the APPETEX™—free formulation when stored for two weeks.

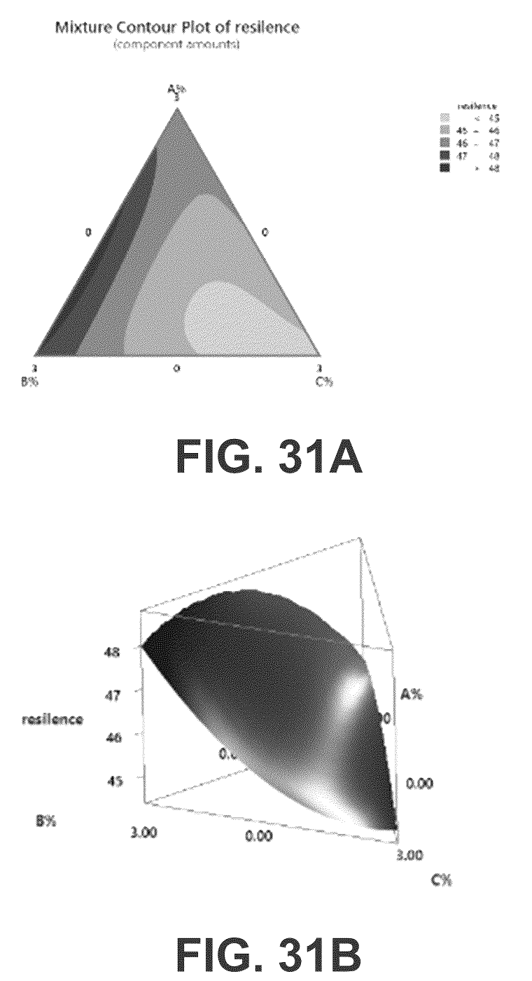

FIGS. 31A-B provide 2D (FIG. 31A) and 3D (FIG. 31B) ternary plots summarizing resilience at ninth TPA stroke for meat alternative burgers made with variable APPETEX™ formulations stored for two weeks prior to cooking, with axes showing amounts of PBA, PBB, and PBC in the meat alternative burger formulations. While no significant relationships were identified between the APPETEX™ components, PBA and PBB appeared to correlate with higher resilience, while the PBC-only formulation provided the lowest resilience value.

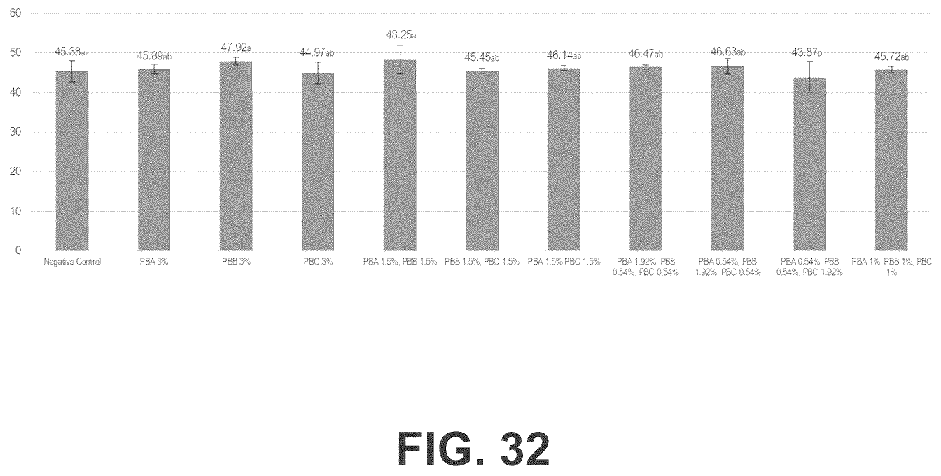

FIG. 32 provides ninth TPA stroke resilience values for meat alternative burgers made with APPETEX™—containing and APPETEX™—free formulations stored for two weeks prior to cooking. No statistically significant differences were identified among the three APPETEX™ connective tissue analogs relative to the APPETEX™—free control formulation.

### Cohesion

Meat alternative burgers made with APPETEX™—containing and APPETEX™—free formulations were tested for cohesion, which indicates the amount of energy required to break apart and make a food swallowable. The burgers were prepared as summarized above, and were stored for one or two weeks prior to cooking and analysis. Cohesion was measured with TPA, with results summarized for the first and ninth TPA strokes. Moderate decreases in cohesion between the first and ninth TPA strokes likely indicate proper break down during chewing, while large or diminutive changes in cohesion between first and ninth TPA strokes can reflect unchewability or excessive friability, respectively.

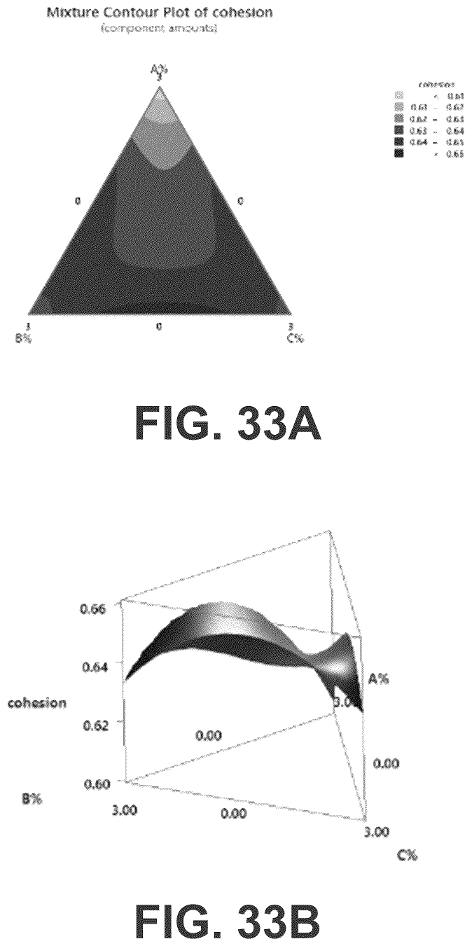

FIGS. 33A-B provide 2D (FIG. 33A) and 3D (FIG. 33B) ternary plots summarizing cohesion at first TPA stroke for meat alternative burgers made with variable APPETEX™ formulations stored for one week prior to cooking, with axes showing amounts of PBA, PBB, and PBC in the meat alternative burger formulations. Although combined PBA, PBB, and PBC formulations appeared to exhibit higher cohesion than single APPETEX™ formulations, no significant relationship was observed between the three connective tissue analogs.

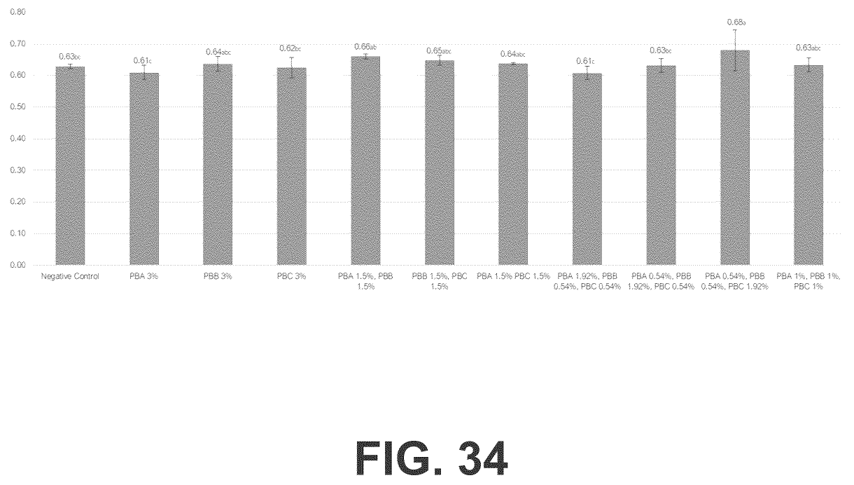

FIG. 34 provides first TPA stroke cohesion values for meat alternative burgers made with APPETEX™—containing and APPETEX™—free formulations stored for one week prior to cooking. Only the 1.92% PBC, 0.54% PBA and 0.54% PBB formulation exhibited statistically significant higher cohesion than the APPETEX™—free formulation.

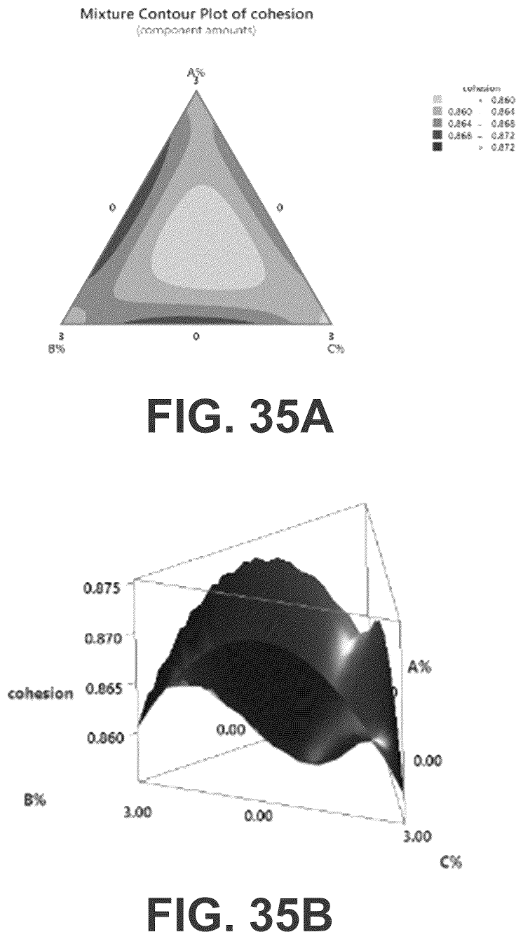

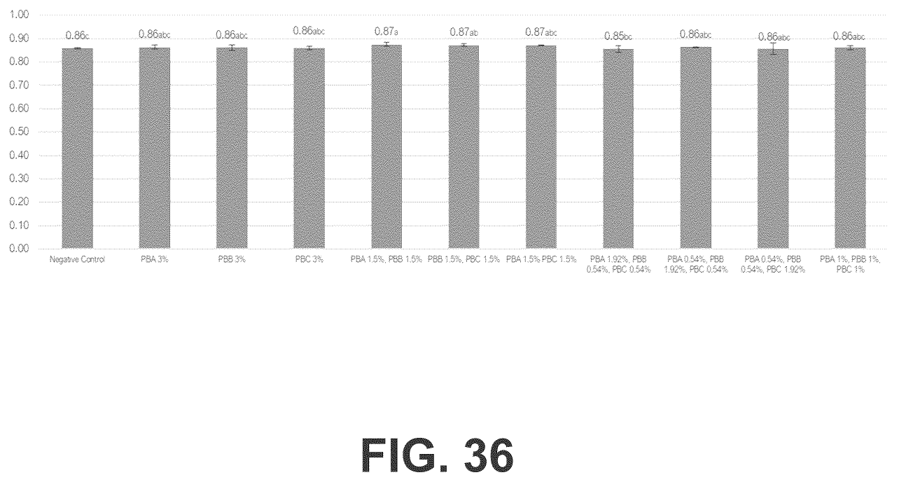

FIGS. 35A-B provide 2D (FIG. 35A) and 3D (FIG. 35B) ternary plots summarizing cohesion at ninth TPA stroke for meat alternative burgers made with variable APPETEX™ formulations stored for one week prior to cooking, with axes showing amounts of PBA, PBB, and PBC in the meat alternative burger formulations. While no statistically significant relationships were identified between the individual APPETEX™ components, the two formulations containing two connective tissue analogs appeared to have higher cohesion than the formulations comprising all three. These potential synergistic relationships are reflected in FIG. 36, which shows that two formulations, 1.5% PBA with 1.5% PBB, and 1.5% PBB with 1.5% PBC, had statistically significantly higher cohesion after nine sequential TPA strokes than the connective tissue-free control formulation.

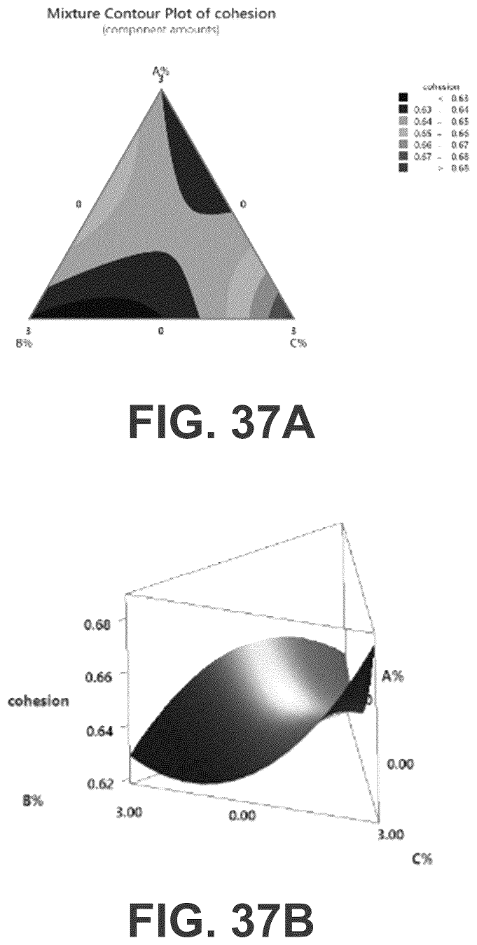

FIGS. 37A-B provide 2D (FIG. 37A) and 3D (FIG. 37B) ternary plots summarizing cohesion at first TPA stroke for meat alternative burgers made with variable APPETEX™ formulations stored for two weeks prior to cooking, with axes showing amounts of PBA, PBB, and PBC in the meat alternative burger formulations. No significant relationships were observed between the individual APPETEX™ components (PBA, PBB, and PBC). However, as cohesion values were similar following one and two weeks of storage, the meat alternative burgers appear to effectively maintain texture during storage.

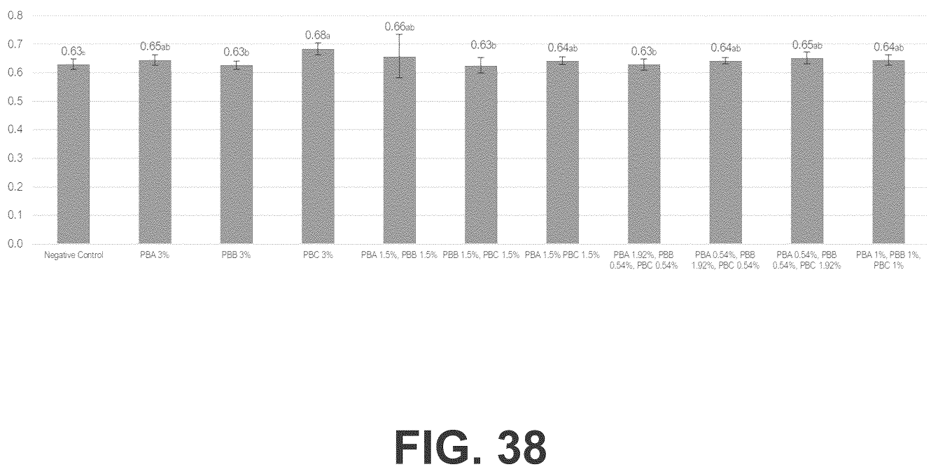

FIG. 38 provides first TPA stroke cohesion values for meat alternative burgers made with APPETEX™—containing and APPETEX™—free formulations stored for two weeks prior to cooking. While only one formulation, 3% PBC, exhibited a statistically significant increase in cohesion relative to the APPETEX™—free control formulation, multiple formulations exhibited higher cohesion values than the control formulation, which may have demonstrated statistical significance had further replicates been performed.

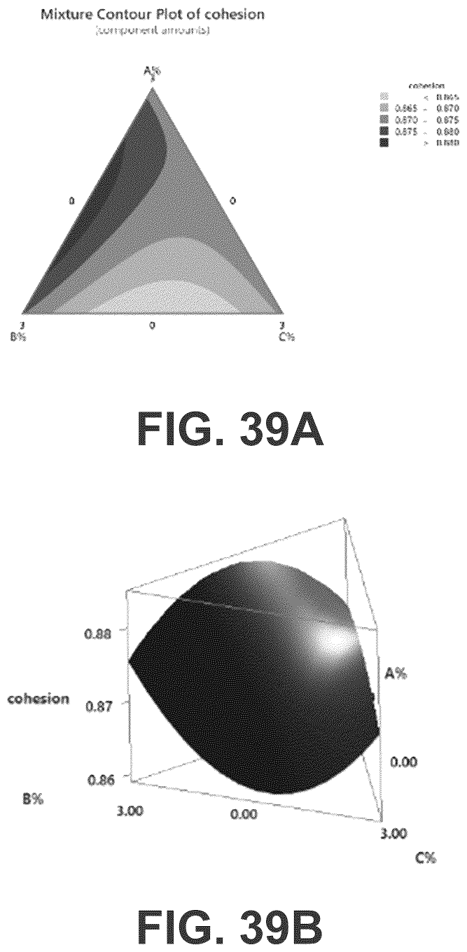

FIGS. 39A-B provide 2D (FIG. 39A) and 3D (FIG. 39B) ternary plots summarizing cohesion at ninth TPA stroke for meat alternative burgers made with variable APPETEX™ formulations stored for two weeks prior to cooking, with axes showing amounts of PBA, PBB, and PBC in the meat alternative burger formulations. No significant differences were observed between the individual connective tissue analogs, indicating that, for certain formulations, cohesion can be independent of connective tissue analog content.

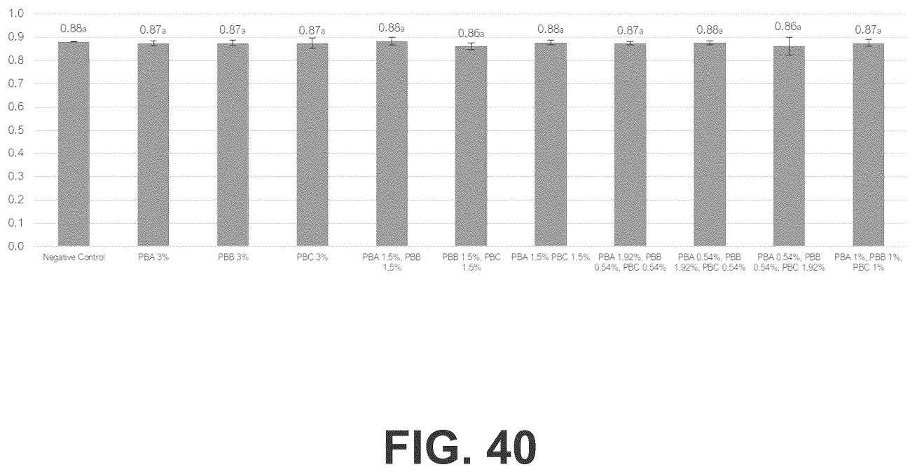

FIG. 40 provides ninth TPA stroke cohesion values for meat alternative burgers made with APPETEX™—containing and APPETEX™—free formulations stored for two weeks prior to cooking. Differing from the one-week stored formulations, for which two meat alternative burgers exhibited statistically significant enhancements in cohesion relative to the APPETEX™—free formulation, no two-week stored formulations exhibited increased cohesion within statistical significance.

### Example 4: High Fiber Meat Alternative Nugget Formulation

This example provides meat alternative nugget formulations with chicken-like texture, flavor, and appearance. As it was surprisingly determined that chicken-mimetic plant-based formulations could be generated using many of the same ingredients as used in some of the meat alternative burger formulations disclosed herein, the meat alternative nugget was formulated by modifying ratios of meat alternative burger ingredients, and then adding ingredients to enhance chicken-like flavor, texture, and appearance. APPETEX™—containing connective tissue analogs were added to the meat alternative nuggets to impart proper texture, consistency, and appearance.

A formulation for a high fiber meat alternative nugget is provided in TABLE 34 below. Differing from the relatively low plant-based fiber meat alternative burger formulation, plant-based fibers constituted nearly 50% of the weight of the meat alternative nugget formulation. Conversely, the high fiber meat alternative nugget contained less than one fifth of the protein, fat and heme content of the meat alternative burger formulation. The high fiber meat alternative nugget also contained less connect tissue analog content than the meat alternative burger formulation.

TABLE 34

| Ingredient | % Weight |
|---|---|
| Rovitaris Vegan Fibers, PX 1016 | 45.00% |
| Water, Distilled, Ambient | 8.93% |
| Heme solution, 9 g, M2-013 | 0.84% |
| Flavor, Nat Masking Flavor | 0.04% |
| Pea Protein 180, 80% Nutra | 3.15% |
| Prolite Meat XT Wheat Gluten | 3.78% |
| Flavor, Nat Chicken (vegetarian) FP | 1.25% |
| Flavor, Nat Meat Type | 0.25% |
| Flavor, Nat Umami BD | 0.25% |
| Flavor, Nat Soy Masker Meat | 0.65% |
| Flavor, Protein Masker (Garlic Oil), 10x dilution | 0.30% |
| Flavor, black pepper | 0.03% |
| TasteEssentials Nat Chicken Flavor Type | 0.38% |
| Water, Distilled, Ambient | 6.57% |
| ROVITARIS MC HS 300 | 1.25% |
| Sunflower oil, high-oleic | 1.20% |
| PBCT, PBB | 0.08% |
| PBCT, PBC | 0.30% |
| Water, Distilled, Ambient | 0.75% |
| Chicken Style Predust | 3.00% |
| Nugget Style Batter Mix | 5.00% |
| Water, Distilled, Ambient | 10.00% |
| Nugget Style Breader | 7.00% |
| SUM | 100.00 |

The high fiber meat alternative nuggets were made with a multiple mixing step process. In a first step, a first plant-based fiber mixture was generated in a first container. In this step, Rovitaris® vegan fibers were chopped into 2-3.5 mm chunks in a food processor to generate a ground chicken texture. Next, distilled water, natural masking flavor, and half of the heme solution were added to the chopped fibers and stirred thoroughly to achieve homogeneous heme dispersion. The resulting mixture was then combined with pea protein, wheat gluten, and a collection of flavoring agents (Flavor, Nat Chicken (vegetarian) FP; Flavor, Nat Meat Type; Flavor, Nat Umami BD; Flavor, Nat Soy Masker Meat; Flavor, Protein Masker (Garlic Oil), 10× dilution; black pepper; and TasteEssentials® Nat Chicken Flavor Type).

A second mixture was then generated in a second container. To generate this second mixture, methylcellulose was pulsed with sunflower oil to form a gel. Heme and water were quickly added during pulsed mixing, which was maintained until the mixture was semi-solid and homogeneous. The second mixture was combined with the first plant-based fiber mixture, and the resulting combination was stirred to form a cohesive dough. Next, hydrated PBB and PBC were mixed into the dough for 5 minutes, and the resulting formulation was formed into 15 g meat alternative nuggets and frozen.

Following freezing, the meat alternative nuggets were coated in a breading comprised of chicken style predust, nugget style batter, and nugget style breader. The nuggets were fried at 350-375° F. for 1 minute to set the breading, and then frozen for storage.

### Example 5: Spongy Meat Alternative Nugget Formulation

This example provides a formulation and associated method of making a spongy meat alternative nugget. By adjusting ratios of ingredients from the high fiber meat alternative nugget formulation outlined in TABLE 34 and adding minor amounts of texture-modifying ingredients, the formulation was adjusted to provide a spongy meat alternative nugget with modified appearance and texture.

TABLE 35 outlines a formulation for a spongy meat alternative nugget. Relative to the high fiber meat alternative nugget formulation of TABLE 34, this formulation contained considerably lower plant-based fiber content and higher water and plant protein content, making it more similar to the meat alternative burger formulations of TABLES 32 and 33. The spongy meat alternative nugget contained PBA, PBB, and PBC, further distinguishing it from the high fiber meat alternative nugget, which contained PBB and PBC only.

TABLE 35

| Ingredient | % Weight |
|---|---|
| Water, Distilled, Ambient | 36.48% |
| Heme solution, 9 g, M2-013 | 0.84% |
| Flavor, Nat Masking Flavor | 0.04% |
| Pea Protein 180, 80% Nutra | 9.19% |
| Prolite Meat XT Wheat Gluten | 9.19% |
| Flavor, Nat Chicken (vegetarian) FP | 1.25% |
| Flavor, Nat Meat Type | 0.25% |
| Flavor, Nat Umami BD | 0.25% |
| Flavor, Nat Soy Masker Meat | 0.65% |
| Flavor, Protein Masker (Garlic Oil), 10x dilution | 0.30% |
| Flavor, black pepper | 0.03% |
| TasteEssentials Nat Chicken Flavor Type | 0.38% |
| Water, Distilled, Ambient | 8.60% |
| ROVITARIS MC HS 300 | 1.68% |
| Sunflower oil, high-oleic | 1.37% |
| PBCT, PBA | 0.30% |
| PBCT, PBB | 0.60% |
| PBCT, PBC | 0.60% |
| Water, Distilled, Ambient | 3.00% |
| Chicken Style Predust | 3.00% |
| Nugget Style Batter Mix | 5.00% |
| Water, Distilled, Ambient | 10.00% |
| Nugget Style Breader | 7.00% |

The spongy meat alternative nuggets were generated through a multiple stage mixing process. In a first step, water, heme, and a first flavor enhancer were blended, and used to hydrate pea protein and wheat gluten. The composition was then combined with multiple additional flavoring agents, a gel comprised of methylcellulose, sunflower oil, and water, and prehydrated PBA, PBB, and PBC. This mixture was kneaded and formed into 15 g nuggets. The nuggets were frozen, coated in a breading containing chicken style predust, nugget style batter, and nugget style breader, fried at 350-375° F. for 1 minute to set the breading, and then frozen for storage.

### Example 6: Effects of Varying Plant-Based Fiber Compositions in Meat Alternative Nuggets

This example covers the effects of varying the amount of connective tissue analog in meat alternative nugget formulations. An APPETEX™ formulation containing a combination of PBA, PBB, and PBC was varied from 0.5 to 5 weight percent in the spongy meat alternative nugget formulation of TABLE 35, and the resulting nuggets were compared to multiple commercial chicken-based nuggets for stiffness, toughness, and firmness.

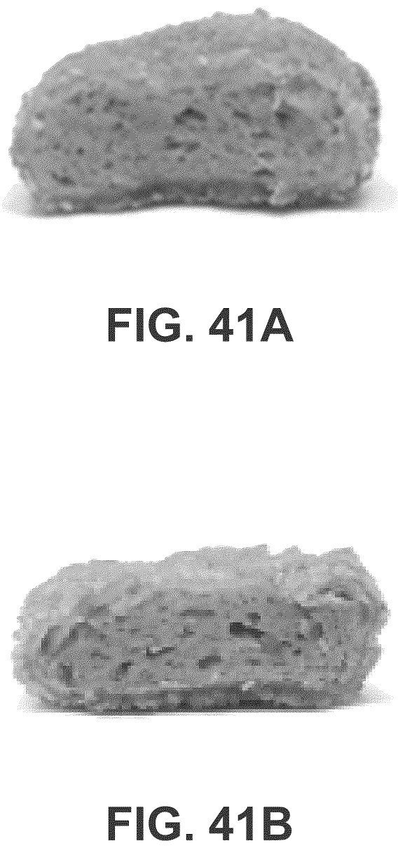

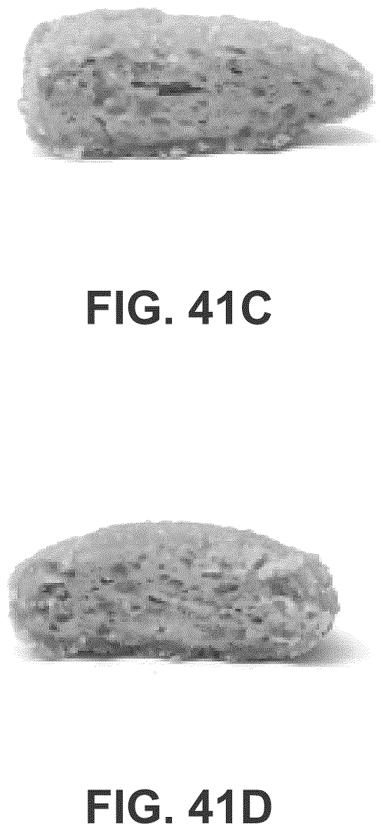

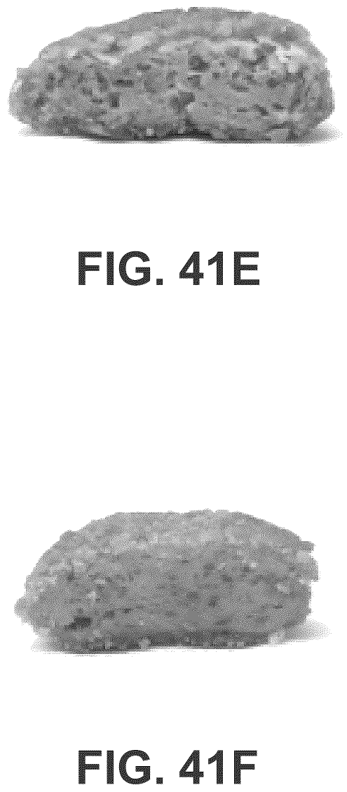

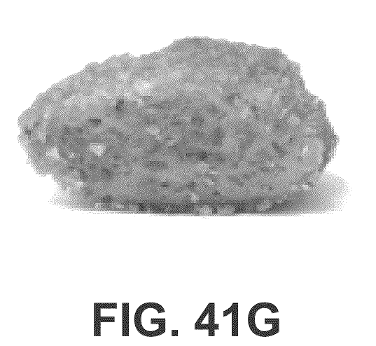

FIGS. 41A-G provide images of nugget cross sections for a 0.5 wt % APPETEX™ nugget (FIG. 41A), a 1 wt % APPETEX™ nugget (FIG. 41B), a 1.5 wt % APPETEX™ nugget (FIG. 41C), a 2 wt % APPETEX™ nugget (FIG. 41D), a 3 wt % APPETEX™ nugget (FIG. 41E), a 4 wt % APPETEX™ nugget (FIG. 41F), and a 5 wt % APPETEX™ nugget (FIG. 41G). As can be seen in these images, the density, flake size, and prevalence of air pockets differed between these formulations.

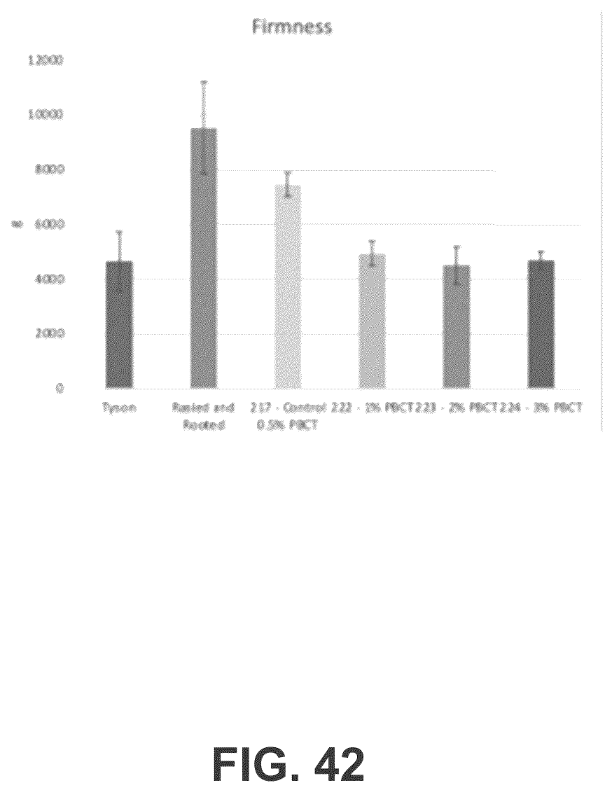

FIG. 42 provides stiffness values (in g/sec) of the variable APPETEX™ spongy meat alternative nugget formulations and those of four commercial chicken nuggets. While three of the four commercial chicken nuggets exhibited higher stiffness than the spongy meat alternative nugget formulations, low and high APPETEX™ spongy meat alternative nugget formulations exhibited similar stiffness as one of the four commercial chicken nuggets. Notably, the spongy meat alternative nugget formulations did not exhibit a linear trend between amount of APPETEX™ and stiffness, but rather exhibited a decrease in stiffness in going from 0.5% to 2.0% APPETEX™ and an increase in stiffness in going from 2.0% APPETEX™ to 5.0% APPETEX™.

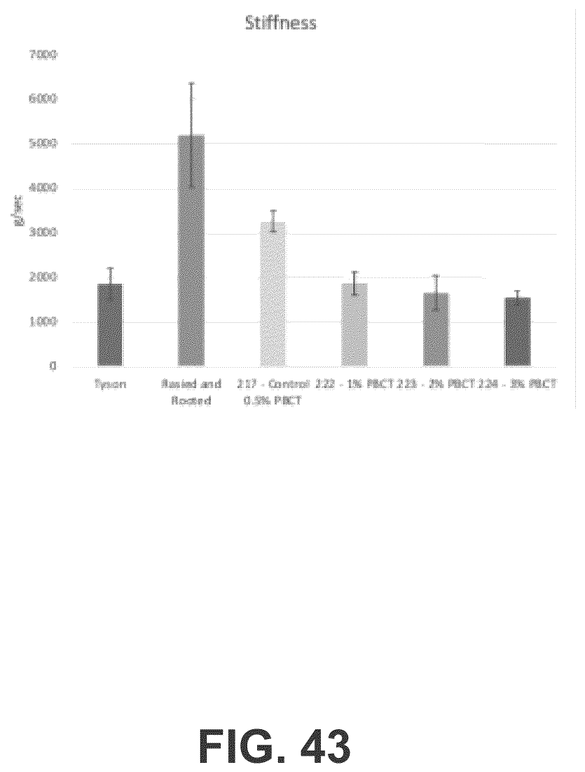

FIG. 43 provides toughness values (in g*sec) of the variable APPETEX™ spongy meat alternative nugget formulations and those of four commercial chicken nuggets. The seven spongy meat alternative nugget formulations exhibited a range of toughness values encompassing the range of toughness values of the commercial chicken nuggets. The spongy meat alternative nugget dough appeared to become saturated at APPETEX™ inclusion levels above 2.0%, likely contributing to the stiffness and toughness levels at 3% and greater APPETEX™.

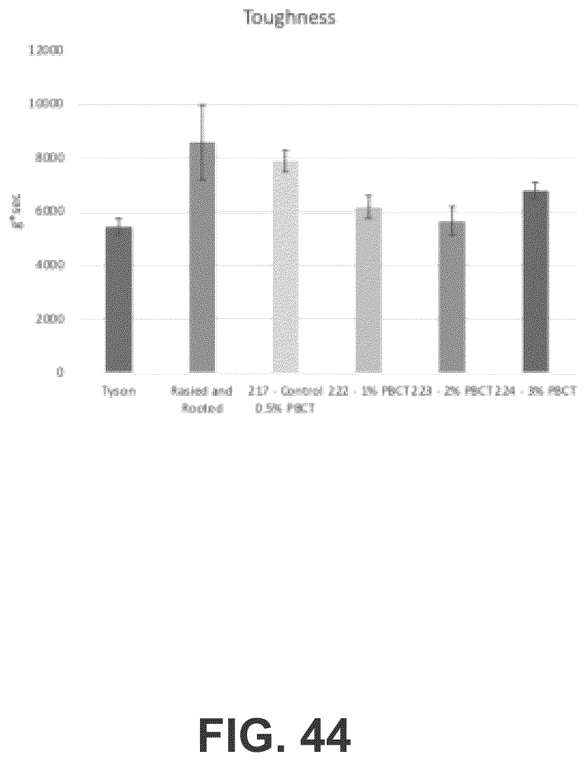

FIG. 44 provides firmness values (in g) of the variable APPETEX™ spongy meat alternative nugget formulations and those of four commercial chicken nuggets. As with stiffness, the meat alternative nuggets exhibited a decrease in firmness in going from 0.5% to 2.0% APPETEX™, and an increase in firmness as APPETEX™ was increased above 2.0%. While the 1.5% and 2.0% APPETEX™ spongy meat alternative nuggets exhibited firmness values which were well below those of the four commercial chicken nuggets, the remaining nuggets had similar firmness as the commercial chicken nuggets.

### Example 7: Meat Alternative Sausage Formulation and Method of Making

This example covers a meat alternative sausage formulation and an associated method of making meat alternative sausages therefrom. Primarily by adjusting ratios of ingredients, the meat alternative burger formulations of TABLES 32-33 and the meat alternative nugget formulations of TABLES 34-35 were modified to provide a sausage-mimetic composition.

This meat alternative sausage formulation is outlined in TABLE 36 below. While this formulation contained high water, plant protein, and plant-based fiber content similar to those of the meat alternative burger and spongy meat alternative nugget formulations, the formulation contained higher colloid by weight than the meat alternative burger formulations, and higher heme than the spongy meat alternative nugget. The formulation also included a food grade alginate casing.

TABLE 36

| Ingredient | % Weight |
|---|---|
| Water | 47.89% |
| Textured Soy Protein (70% ARCON TU Flake 118 | 17.00% |
| ADM)/or Textured Pea Protein | |
| Canola Oil, Refined | 8.00% |
| HEMAMI ™ Myoglobin (Water, Myoglobin, Sodium | 5.55% |
| Phosphate, Sodium Chloride) | |
| Wheat Gluten, (Prolite MeatX ADM) | 5.00% |
| Coconut Oil, Refined | 5.00% |
| Soy Protein Isolate, (SUPRO 515 DUPONT) | 2.00% |
| Methylcellulose (Methylcel A4M, DUPONT) | 2.00% |
| Nat Pork Crusty Fatty (OD-359-413-0 Givaudan) | 1.85% |
| Bratwurst Seasoning (PT-980-814-2 Givaudan) | 1.85% |
| APPETEX ™ (Carrageenan, Konjac Flour, Acacia | 1.50% |
| Gum, Brown Rice Protein | |
| Tallow Fat (TN-604-274-3 Givaudan) | 1.00% |
| Nat Yellow Fat (QV-182-923-0 Givaudan) | 0.66% |
| Nat Soy Meat Masker (SY-610-859-8 Givaudan) | 0.50% |
| Nat Bratwurst Flavor (liq) (OB-731-383-8 Givaudan) | 0.20% |
| TOTAL | 100.00% |

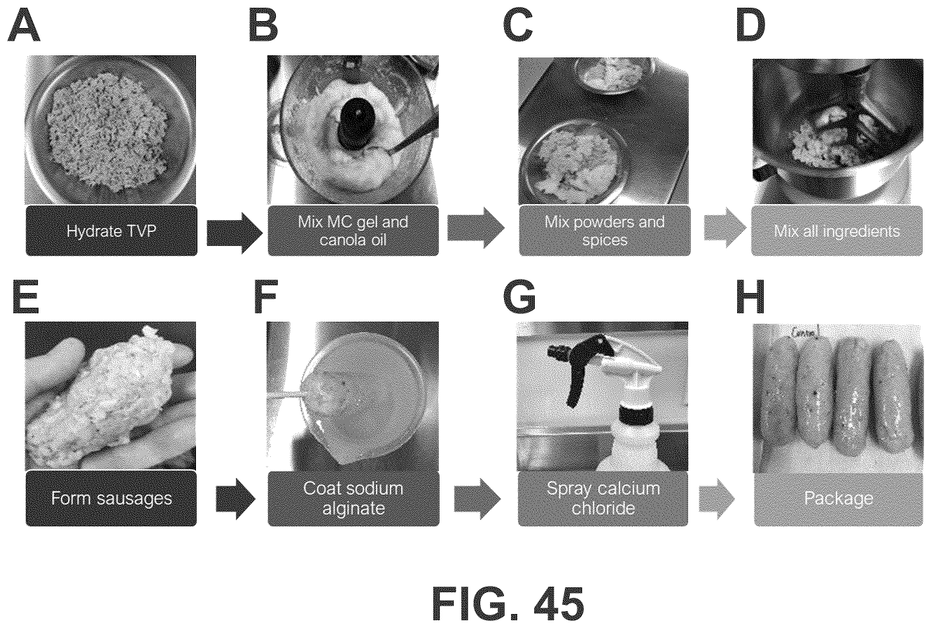

A method of making the meat alternative sausages is outlined in FIGS. 45A-H. In a first step, water was added to the heme formulation until the heme fully dissolved. The resulting composition was used to hydrate textured soy protein for 15 minutes under occasional stirring to ensure even hydration (FIG. 45A). In a second container, methylcellulose and canola oil were mixed until the methylcellulose powder fully saturated, at which point water was slowly added with mixing to form a gel (FIG. 45B). In a third container, dry ingredients were mixed for 1 minute until homogeneous (FIG. 45C). The pre-blended dry ingredients (from FIG. 45C), coconut oil, methylcellulose gel (from FIG. 45B), and hydrated textured soy protein (from FIG. 45A) were then blended at low speed for 4 minutes (FIG. 45D). The resulting mixture was refrigerated for 5 minutes in an optional step to increase firmness of the resulting dough.

Next, the dough was formed into 80 g ½ inch meat alternative sausage links (FIG. 45E), and then wrapped in plastic and frozen for 50 minutes to 1 hour to yield firm, but not frozen meat alternative sausage links. The meat alternative sausage links were then unwrapped and pierced about ⅓ of the way through lengthwise with skewers, and then were dipped in 1% sodium alginate casing solution (FIG. 45F) and sprayed with calcium chloride solution (FIG. 45G) to convert the sodium alginate into a semi-solid casing. Excess casing was cleaned off of the meat alternative sausage links, and the products were frozen for at least one hour to achieve high firmness. The meat alternative sausage links were then vacuum sealed (FIG. 45H) for storage and shipping.

The meat alternative sausage links are amenable to multiple cooking methods. The meat alternative sausage links can be cooked for 4 minutes per side under high heat in a pre-heated grill or pan. Alternatively, the meat alternative sausage links can be baked at 400° F. for 10 minutes. Both methods are designed to achieve internal temperatures of 165° F., and require letting the cooked meat alternative sausage links sit for three minutes before cutting and tasting.

### Example 8: Properties of Multiple Meat Alternative Sausages

This example covers properties achievable with the meat alternative sausage formulation outlined in EXAMPLE 7. Meat alternative sausages were made as outlined above, modifying the formulations to include no APPETEX™ (‘No PBCT’), 2% PBA, 2% PBB, or 2% PBC, and to include either pea or soy protein. The meat alternative sausages were compared against Johnsonville brand pork sausages and Beyond Meat brand Beyond Sausage for textual inconsistency, meatiness, hardness, springiness, moistness of mass, cohesiveness of mass, and graininess through a team sensory evaluation.

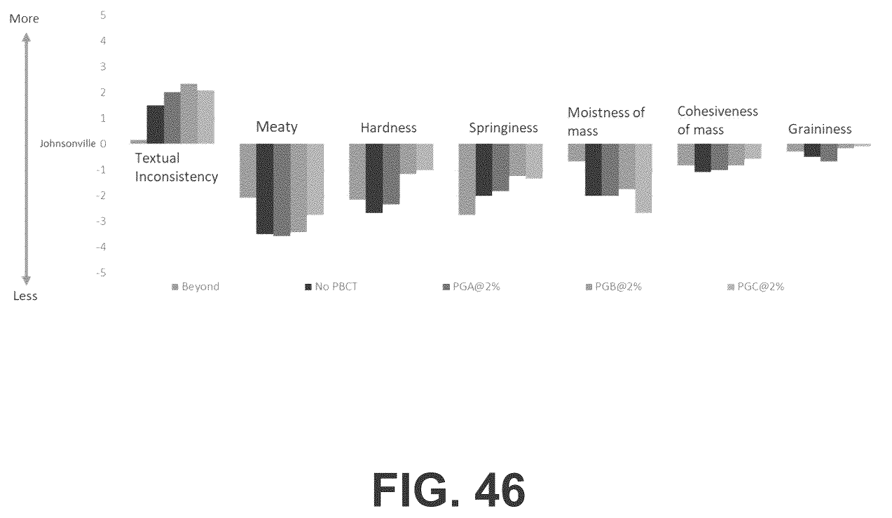

FIG. 46 summarizes properties of the pea protein-containing meat alternative sausages against Johnsonville brand pork sausages and Beyond Meat brand Beyond Sausages. Textual consistency, meatiness, hardness, springiness, moistness of mass, cohesiveness of mass, and graininess (left to right in FIG. 46) values are relative to the Johnsonville brand sausages. The meat alternative sausages were identified as having higher textual inconsistencies, but lower meatiness, hardness, springiness, moistness of mass, cohesiveness of mass, and graininess as compared to the Johnsonville brand sausages. However, the meat alternative sausages were deemed to have higher textual inconsistencies and springiness than the Beyond Meat brand Beyond Sausages, as well as similar meatiness, cohesiveness of mass, and graininess.

Variation of the APPETEX™ constituents demonstrated that PBA, PBB, and PBC can each improve hardness and springiness compared to APPETEX™ free formulations. The APPETEX™—containing formulations also exhibited slight improvements in cohesiveness of mass. However, PBB and PBC provided greater improvement in hardness and springiness than PBA.

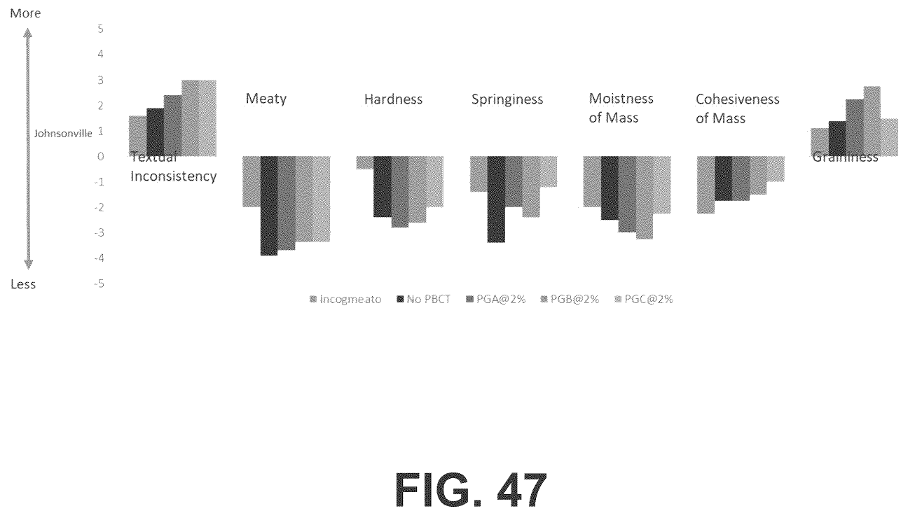

FIG. 47 compares the properties of soy-based meat alternative sausages against Johnsonville brand pork sausages and Beyond Meat brand Beyond Sausages. In this figure, textual consistency, meatiness, hardness, springiness, moistness of mass, cohesiveness of mass, and graininess (left to right in FIG. 47) are shown relative to Johnsonville brand sausages. All meat alternative sausage formulations displayed favorable textural inconsistencies and graininess relative to Johnsonville brand sausages and Beyond Meat brand Beyond Sausages. Across all textural attributes assessed, PBC provided the textural profile most similar to the Johnsonville brand pork sausages. All APPETEX™—based connective tissue analogs appeared to improve springiness. Based on the results of FIGS. 47-48, a 1.5 weight percent APPETEX™ composition with 1 part PBA, 1 part PBB, and 4 parts PBC was recommended for the meat alternative sausage formulation of TABLE 36.

### Example 9: Heme Protein Production and Isolation

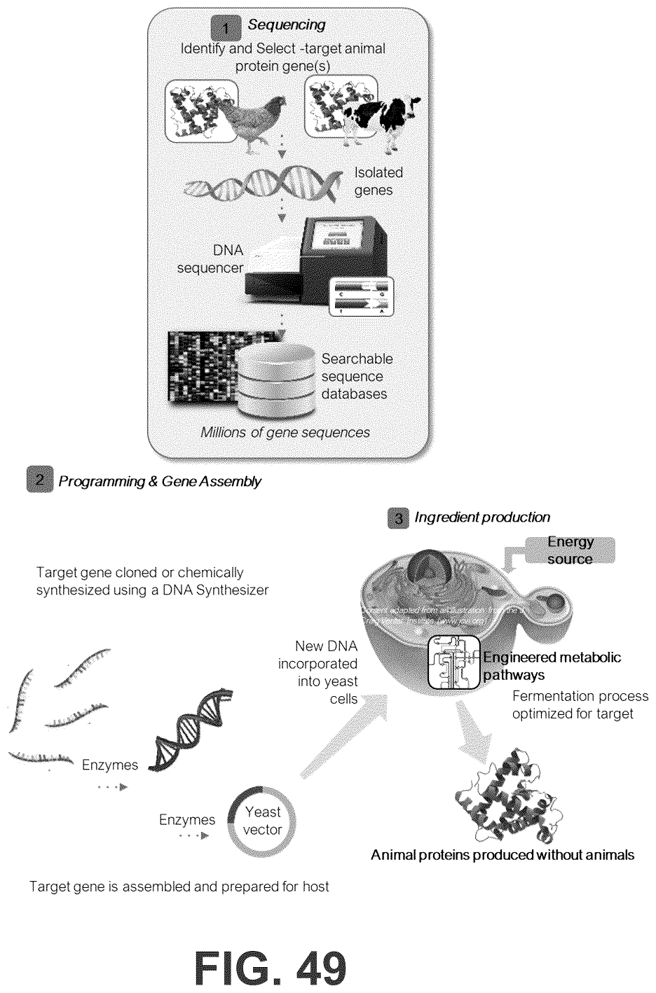

A fermentation-derived heme protein is obtained through microbial fermentation, according to steps illustrated in FIG. 49:
1. Sequencing: from a selected animal or plant source of the heme protein (e.g., chicken, cow, pig or soy), isolate heme-expression genes, identify in sequence database(s), and select gene encoding heme protein of interest.
2. Programming and gene assembly: clone or synthesize selected gene encoding heme protein of interest.
3. Protein production: incorporate DNA/gene of interest into yeast cell expression system, maintain yeast cells under fermentation culture conditions and for a time sufficient to express heme protein(s) of interest.

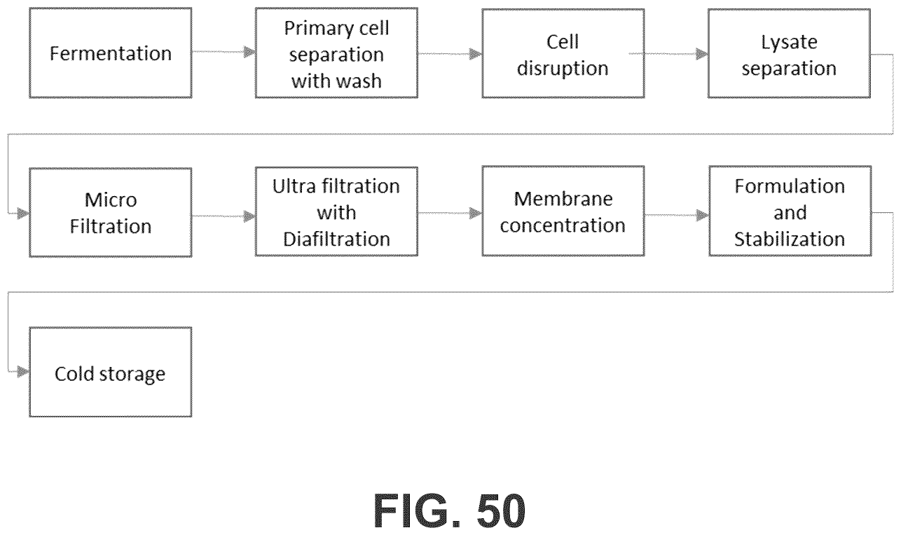

After fermentation, isolate and/or purify the heme protein of interest through steps as shown in FIG. 50, such as washing to separate cells, disrupting cells, lysate treatment to separate proteins, then isolating desired heme proteins by microfiltration, ultrafiltration, diafiltration, and/or membrane concentration. Finally, formulate and/or stabilize the obtained heme proteins with carriers suitable for human or animal consumption, optionally storing under refrigeration or freezing conditions for later use.

### Example 10: Soy Based Meat Alternative Burger Formulations and Characteristics

A heme protein solution was obtained from Sigma-Aldrich Co. and used to formulate a soy-based meat alternative composition. The heme protein solution was shipped frozen and thawed overnight before use, containing 3 grams of heme protein in 100 grams of solution. The ingredients of a soy-based meat alternative include about 21% textured soy protein with 60-70% of protein, about 2.5-4.5% soy protein isolate, and about 14% fat content (coconut oil+canola oil). In a control formula, no heme solution was added. Edible colorant “red burger shade color” and flavor chemicals “grill flavor” and “beef flavor” were used to bring the desired meat flavor and color (see TABLE 37). In the heme formula, heme protein in solution was added instead of colorant and flavor chemicals used in the control formula. The final heme inclusion percentage was about 0.5% to about 1.5% depending on the amount of heme solution added (15 to 50% v/v, see TABLE 38).

TABLE 37

| Ingredient | % Weight |
|---|---|
| Water | 55.60% |
| Textured Soy Protein (70%) | 21.00% |
| Coconut Oil | 6.00% |
| Canola Oil | 8.00% |
| Soy Protein Isolate | 2.50% |
| Methylcellulose | 1.50% |
| Sunflower Lecithin | 1.00% |
| Salt, Granulated | 0.50% |
| Potato Starch | 0.80% |
| Pregel Potato Starch | 0.80% |
| Black Pepper | 0.10% |
| Grill Flavor | 1.10% |
| Beef Flavor | 1.10% |
| Red Burger Shade Color | 0.50% |
| TOTAL | 100.00% |

TABLE 38

| Ingredient | % Weight |
|---|---|
| Water | 5%-55% |
| Textured Soy Protein (70%) | 21.80% |
| Coconut Oil | 6.00% |
| Canola Oil | 8.00% |
| Soy Protein Isolate | 4.50% |
| Methylcellulose | 1.50% |
| Sunflower Lecithin | 1.00% |
| Salt, Granulated | 0.50% |
| Potato Starch | 0.80% |
| Pregel Potato Starch | 0.80% |
| Black Pepper | 0.10% |
| Heme Solution (0.5% Heme to 1.5% Heme) | 15%-50% |
| TOTAL | 100.00% |

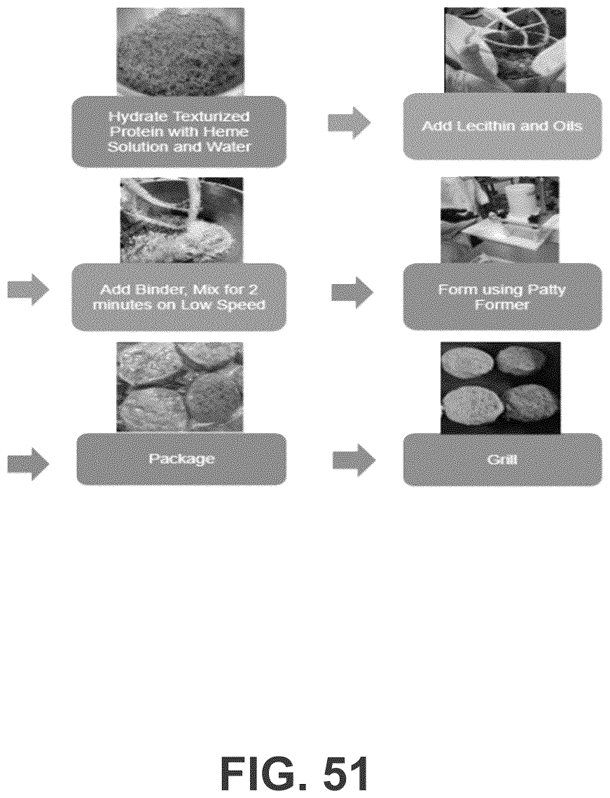

As illustrated in FIG. 51, steps of making the soy-based, meat-alternative burger containing heme protein comprised:
(1) combining water and calculated amount of heme solution with Textured Vegetable (Soy) Protein (TVP); and hydrating for 15-30 minutes;
(2) adding lecithin and fat (oil);
(3) adding binders (methylcellulose and starch), mixing on low speed for 2 minutes;
(4) shaping with patty former to obtain slider medallion-shaped meat alternative burgers patties (30 grams each meat alternative burger);
(5) moving meat alternative burgers to storage rack and keep in deep freezer at −20° C. for at least one hour;
(6) placing frozen meat alternative burgers in a vacuum package container; and
(7) storing meat alternative burgers frozen in deep freezer until use.

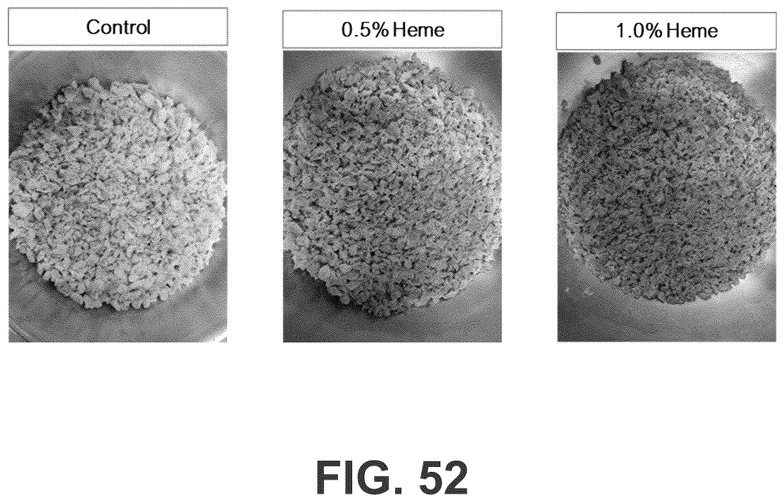

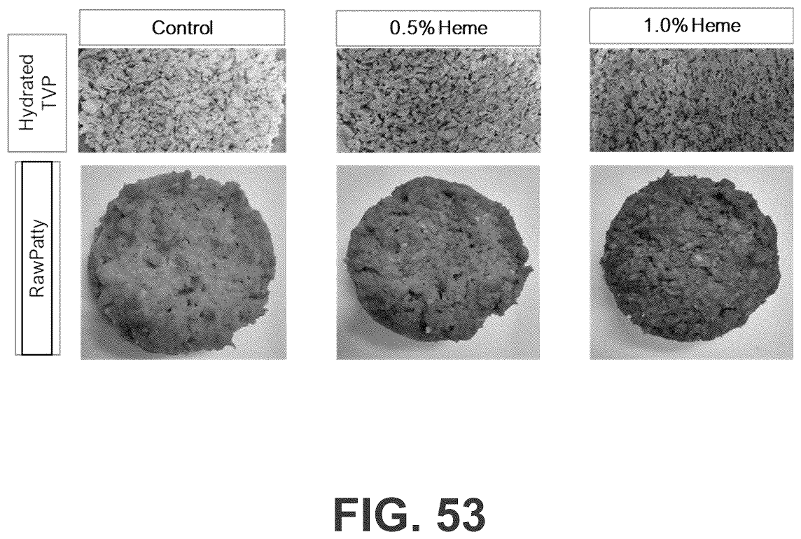

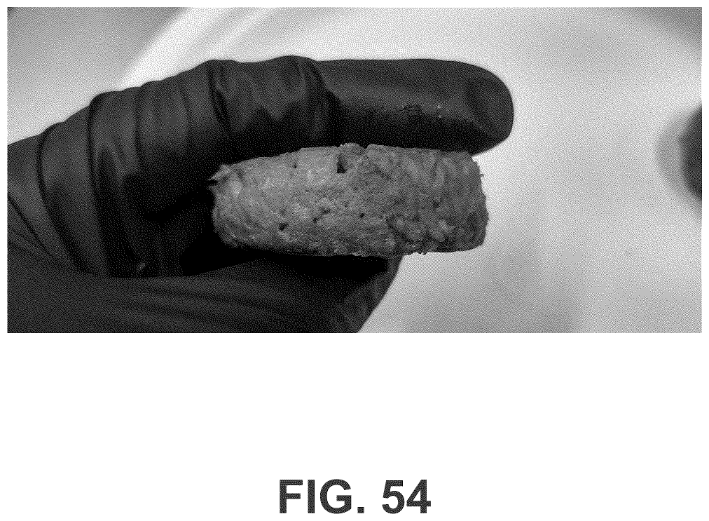

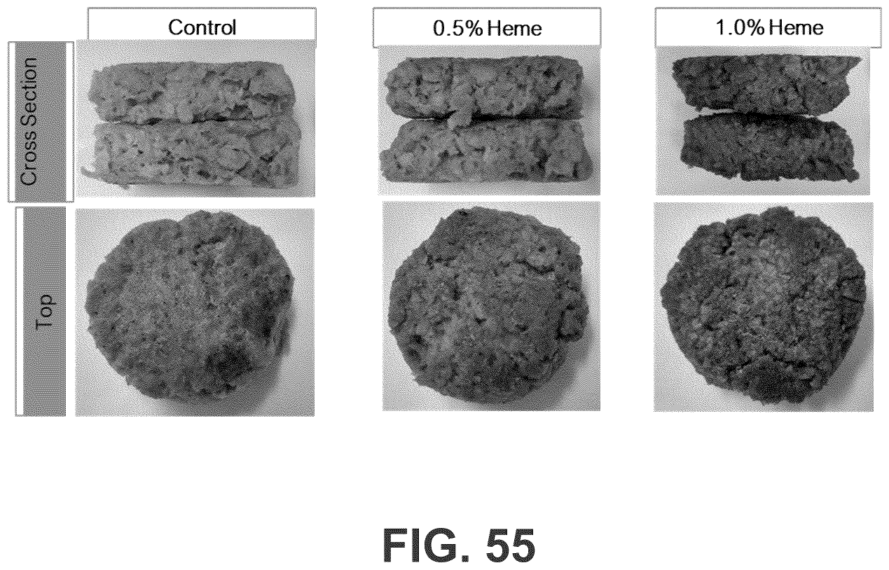

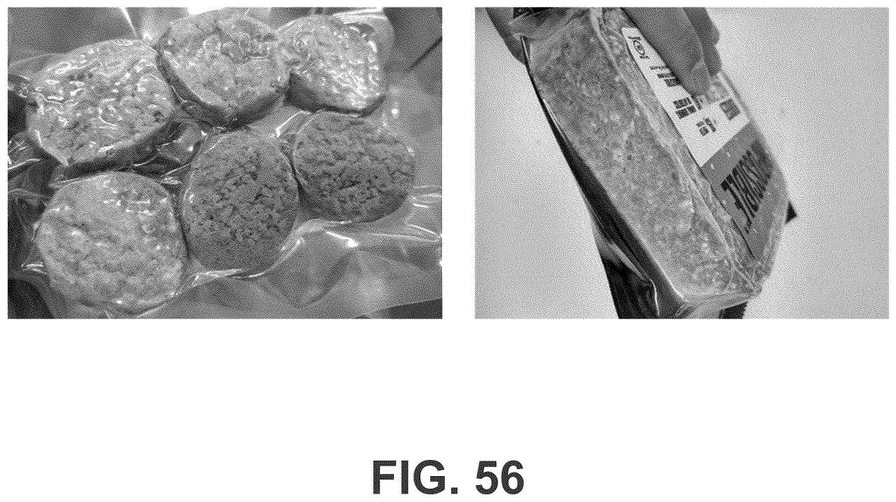

FIG. 52 is a series of photographs of hydrated TVPs with either no heme (control), or including heme at 0.5% or 1.0%. Added heme protein produces a color comparable to real meat color, and adding 1.0% heme produces a color even closer to real meat than that of the samples including 0.5% heme. FIG. 53 further provides color photographs of raw meat alternative burgers formed from these hydrated TVPs, showing similarly that the color of the meat alternative burgers intensified when more heme was added to the meat alternative burger. FIG. 54 shows the gradient texture of a meat alternative burger with heme, when seared on each side. FIG. 55 shows color photographs of the meat alternative burgers after being cooked, showing the color produced by adding the heme protein was conserved upon cooking. Again, intensity of color was directly correlated with the amount of heme added. FIG. 56 shows color photographs of frozen, packaged soy-based meat alternative burgers from the present disclosure (left panel), compared to a consumer brand of frozen, packaged meat alternative burgers currently sold commercially (right panel).

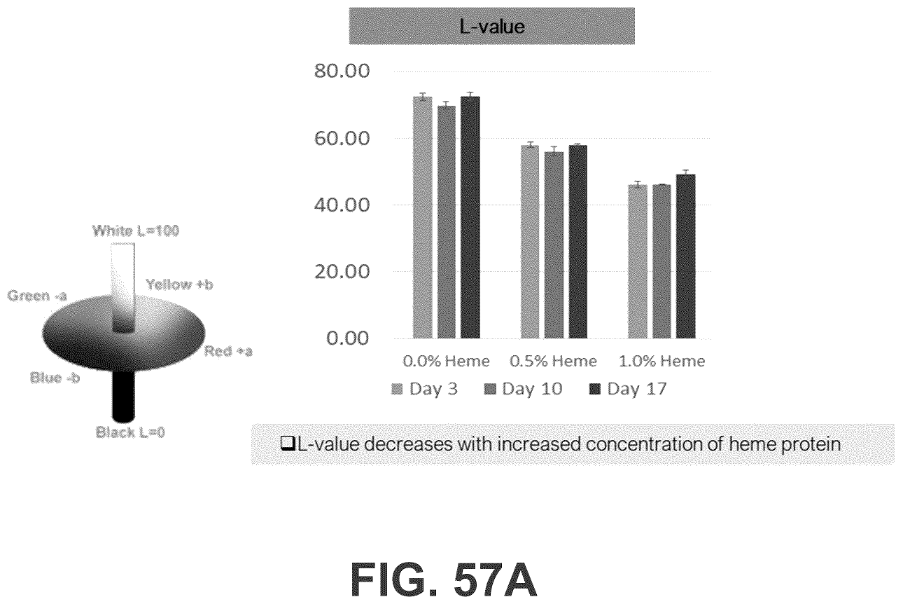

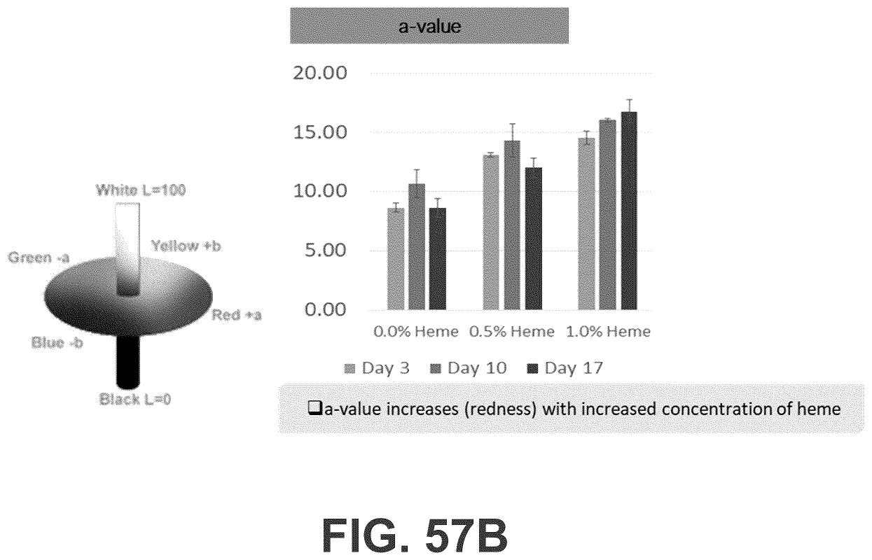

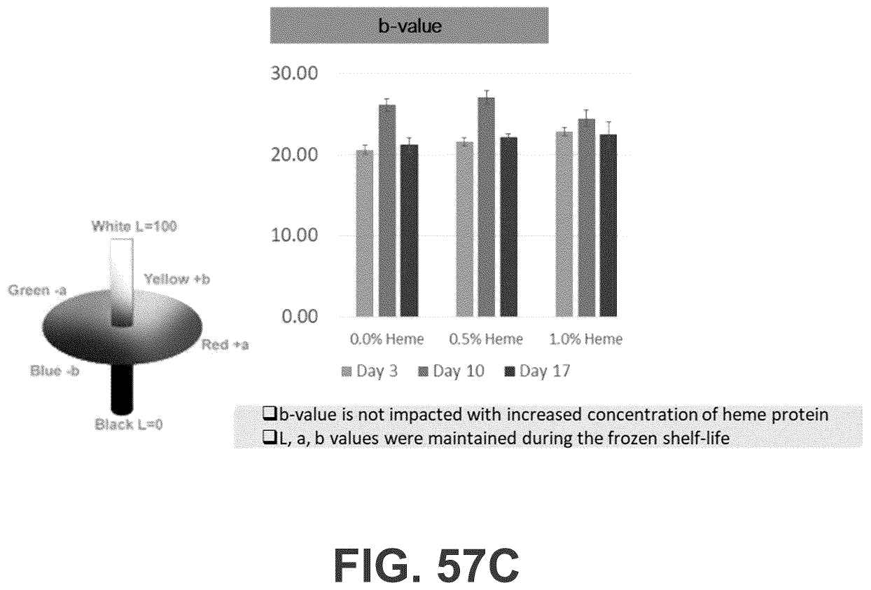

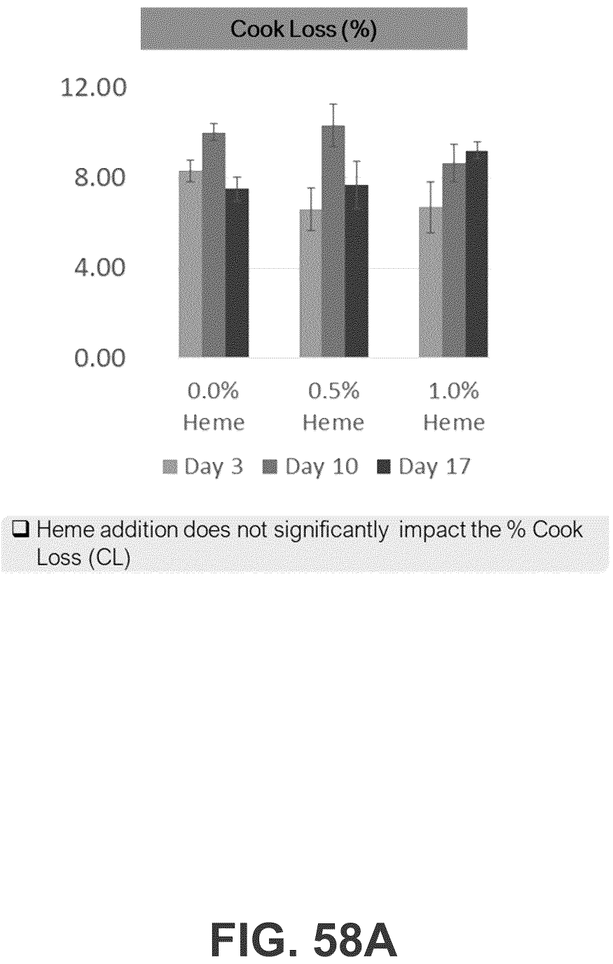

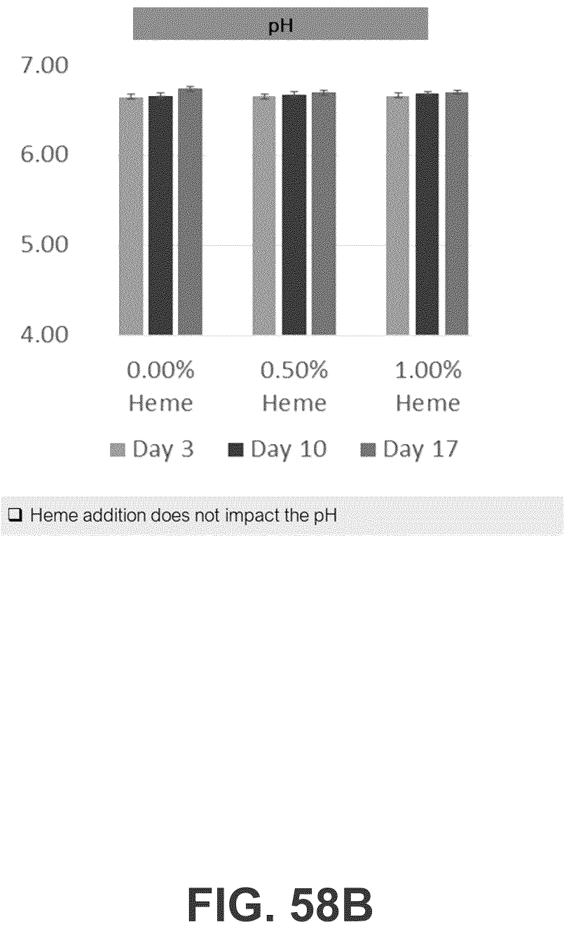

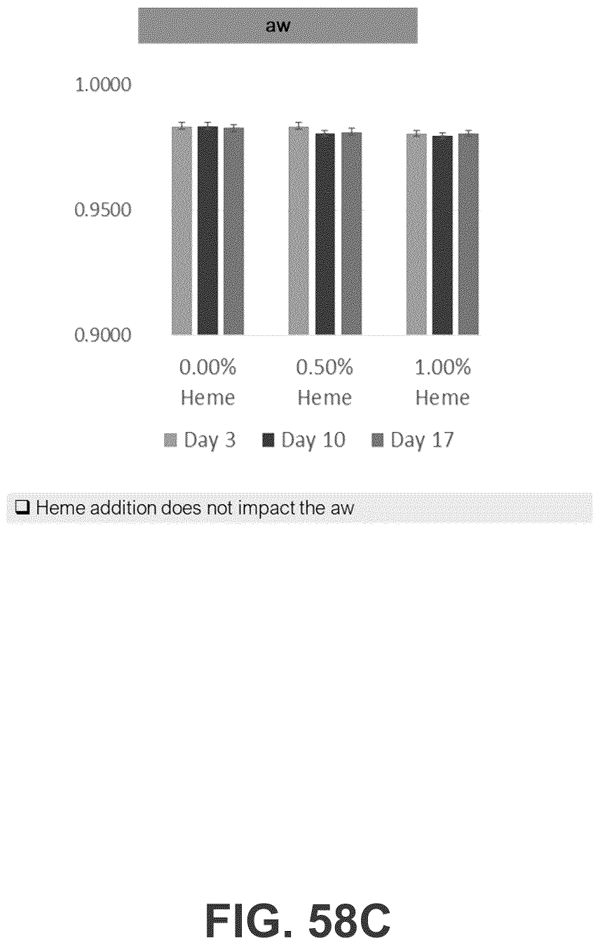

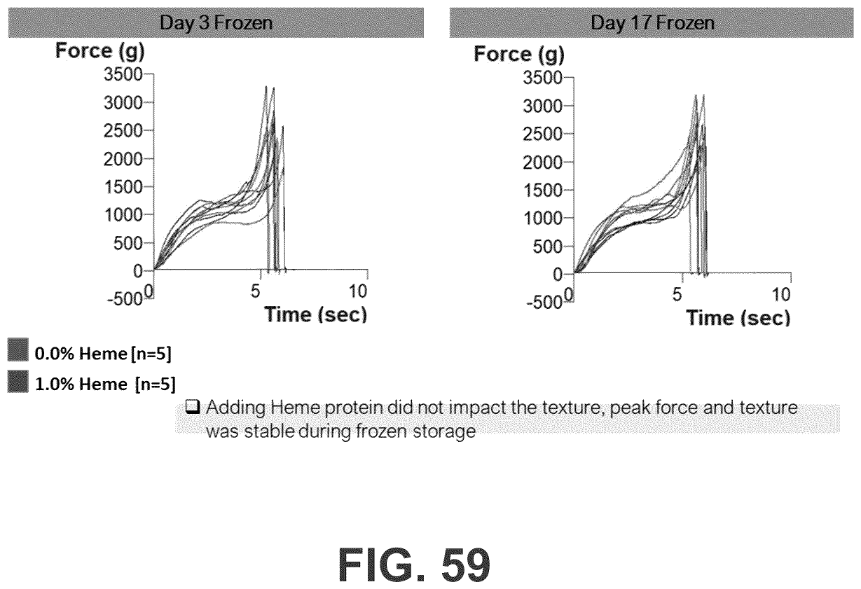

The soy-based meat alternative burgers prepared with varying amounts of heme protein (0.0%, 0.5% and 1.0%, respectively) were further characterized at Day 3, 10 and 17 of the frozen storage period. FIGS. 57A-C provides graphs of color values (L-value, a-value, and b-value) of the meat alternative burgers following 3, 10 and 17 days of frozen storage. The L-value is a measure of the observed color along a black-to-white axis. The “a-value” is a measure of the observed color along a “redness” axis (with positive a-values denoting red coloring and negative a-values denoting green coloring), and the “b-value” is a measure of the observed color along a yellow to blue axis (with positive b-values indicating yellow coloring and negative b-values indicating blue coloring). FIGS. 57A-C shows that the L-value decreased with increased concentration of heme protein (FIG. 57A); while the a-value (redness) increased with increased concentration of heme (FIG. 57B). The b-value did not appear to be impacted by the concentration of heme protein (FIG. 57C). FIG. 57 A-C show that the L, a, and b values were maintained during the frozen storage. FIG. 58 A-C graphs the values of Cook Loss (CL), pH, and aw (water activity) of meat alternative burgers differing in heme amount (0.0%, 0.5% and 1.0%, respectively) over the period of frozen storage at Days 3, 10 and 17. FIG. 58A shows that addition of heme did not significantly impact the percentage of Cook Loss (CL %). The pH values (FIG. 58B) were almost the same for the three different heme additions, and did not change over a storage period up to 17 days. Similarly for aw (water activity), addition of heme did not impact aw values, which remained essentially unchanged during frozen storage (FIG. 58C). Finally, FIG. 59 shows the peak forces of meat alternative burgers with no heme (0.0%) and meat alternative burgers with 1.0 wt % heme addition (total 10 samples, five each), at Day 3 and Day 17 of frozen storage. The left panel (Day 3 data) showed largely overlapped curves of the 10 samples, indicating that heme addition did not impact the peak forces or meat alternative burger textures. The right panel shows the data at Day 17, showing no significant changes were observed. Thus, FIG. 59 shows that peak forces and meat alternative burger textures were not negatively impacted by the addition of heme, and meat alternative burgers with or without heme were both stable during frozen storage.

A panel of tasters was invited to taste both the heme solutions and the soy-based meat alternative burgers containing heme. Panel members noted that the heme solutions possessed brothy, salty and umami notes. After cooking, the meat alternative burgers with heme registered a meaty and umami flavor. Heme also helped to mask the “green” and/or beany flavor of plant proteins. Panelists also claimed that meat alternative burgers with heme tasted “beefier” when compared to the controls of no heme added.

### Example 11: Meat Alternative Burger—Soy Based, Fermentation-Derived Soy LegH

This example describes use of the legume hemoglobin obtained from microbial fermentation (hereafter “Ferm. Soy LegH”). A soy-based meat alternative burger can, in some cases, comprise about 21% to about 22.5% textured soy protein with 70% of protein content, about 12% fat (coconut oil), and about 3% soy protein. Minor ingredients can include lecithin (from sunflower), methylcellulose, starch, salt and pepper. In this example, 0.5% Soy LegH was added to the meat alternative burger (see TABLE 39). For comparison, a meat alternative burger without Soy LegH was also made. In this meat alternative burger, color and flavor chemicals were used to bring the desired meat flavor and color (see TABLE 40). Specifically, edible colorants “red beet powder” and “cocoa powder” were used at about 1.0% total. For flavor, Natural Vegetarian Meaty Beef Flavor from was added at about 0.8%.

TABLE 39

| Ingredients | % weight |
|---|---|
| Water | 57.50 |
| Textured Soy Protein (70%) | 22.30 |
| Coconut Oil | 12.0 |
| Sunflower Lecithin | 1.00 |
| Soy Protein | 3.00 |
| Methylcellulose | 1.00 |
| Salt | 1.00 |
| Potato Starch | 0.80 |
| Pregel Potato Starch | 0.80 |
| Black Pepper | 0.10 |
| Ferm. Soy LegH | 0.50 |
| Total | 100.00 |

TABLE 40

| Ingredients | % weight |
|---|---|
| Water | 57.50 |
| Textured Soy Protein (70%) | 21.00 |
| Coconut Oil | 12.0 |
| Sunflower Lecithin | 1.00 |
| Soy Protein | 3.00 |
| Methylcellulose | 1.00 |
| Salt | 1.00 |
| Potato Starch | 0.80 |
| Pregel Potato Starch | 0.80 |
| Black Pepper | 0.10 |
| Natural Vegetarian Meaty Beef Flavor | 0.80 |
| Red Beet Powder | 0.60 |
| Cocoa Powder | 0.40 |
| Total | 100.00 |

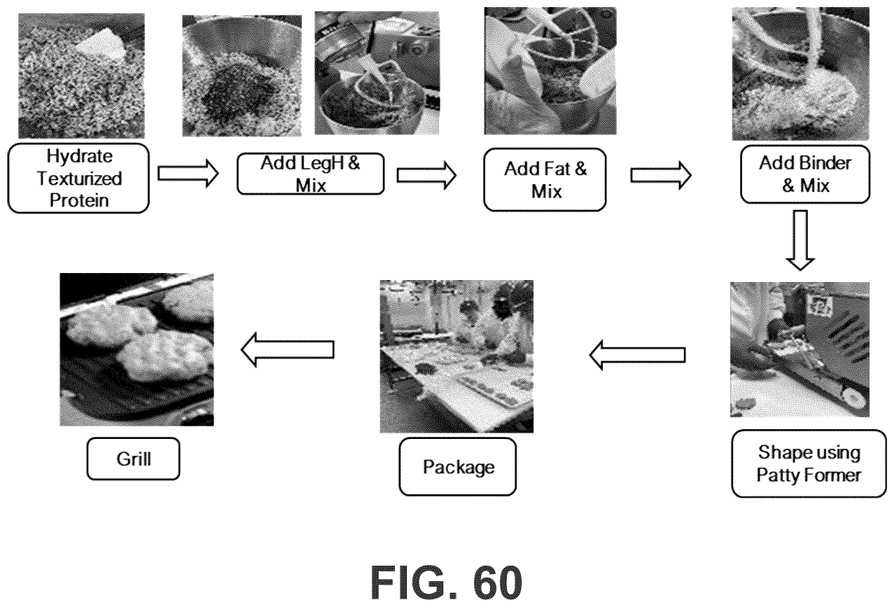

As illustrated in FIG. 60, steps of making soy-based meat alternative burgers with Soy LegH comprised:
(1) combining calculated amount of water with Textured Soy Protein; and allowing hydration of Textured Soy Protein;
(2) adding 0.5% Soy LegH to hydrated Textured Soy Protein, and mixing well;
(3) adding oils and mixing well;
(4) adding starch and mixing well;
(5) shaping meat alternative burger formulation to obtain meat alternative burgers;
(6) moving meat alternative burgers to storage container; and
(7) storing meat alternative burgers frozen until use.

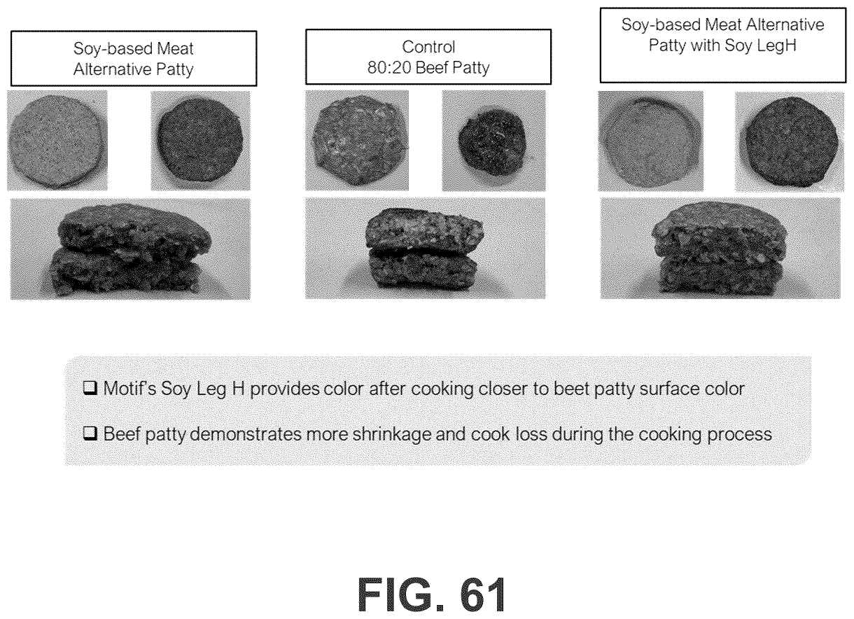

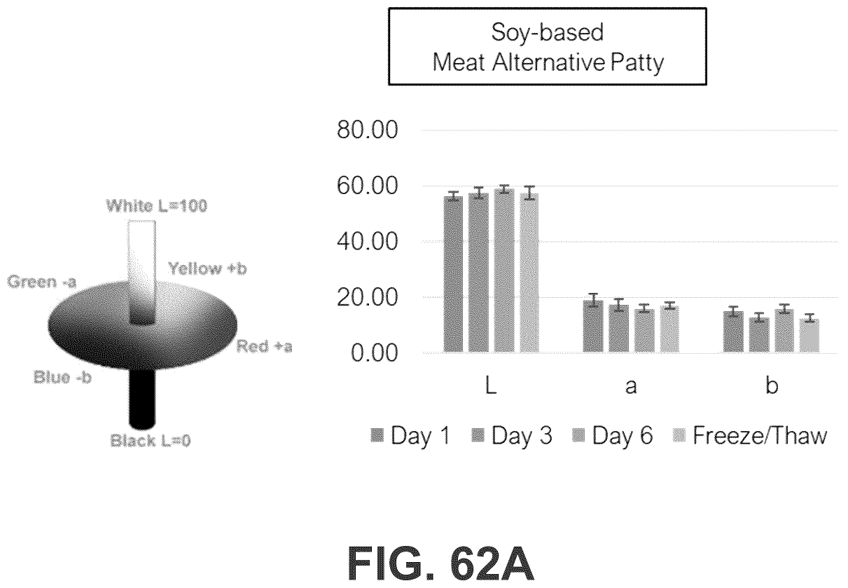

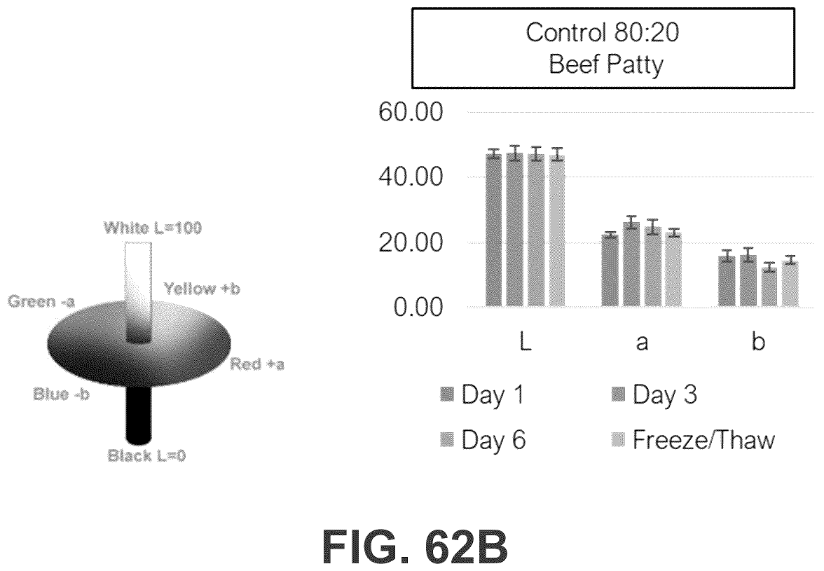

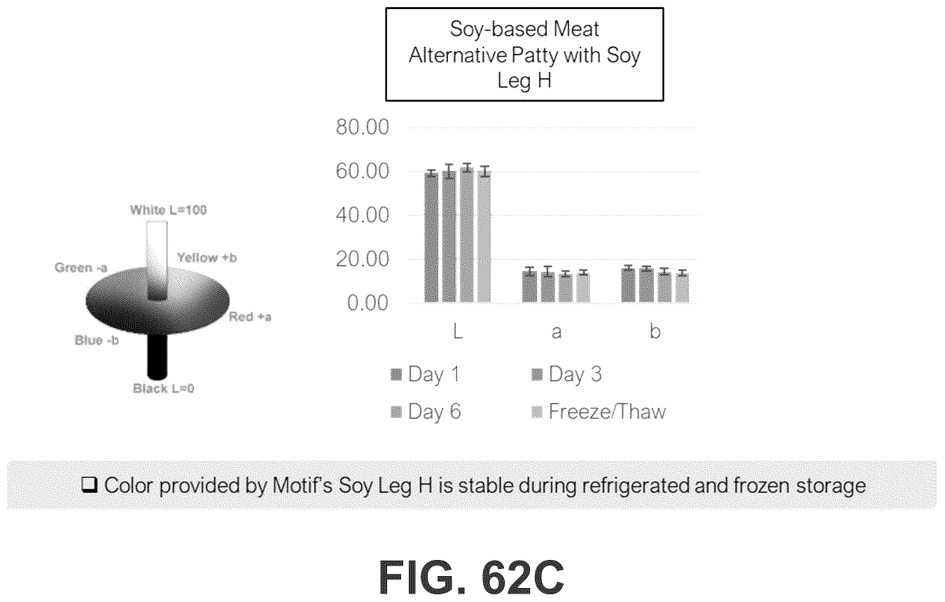

Thus, soy-based meat alternative burgers with or without Soy LegH were obtained, and compared before and after cooking with the control, a beef burger with protein to fat ratio of 80:20. As shown in FIG. 61, Soy LegH (right panel) provided post-cooking color similar to the beef burger surface color, but shrank much less. Among the three, beef burger exhibited the most shrinkage and cook loss in cooking process. A further color comparison was made during refrigerated and frozen storage to determine the color stability. FIG. 62 A-C showed the L-, a- and b-values of the three samples at frozen Day 1, 3, 6 and at the time of freeze to thaw. Comparing L-values (the black to white tone) across the three samples (left panel of each FIGS. 62A-C), the beef burger had the lowest L-values (middle panel), while soy-based meat alternative burgers with or without Soy LegH had similar L-values. The case for a-value was reversed (middle panel of each FIG. 62 A-C), with the beef burger having the highest value, while the a-values for soy-based meat alternative burgers with or without Soy LegH had similar, and lower a-values, indicating the beef burger had the most noticeable red tone among the three. For b-values (right panel of each FIGS. 62A-C), all three samples were similar. Overall, the data show that while the beef burger was the reddest among the three, the meat alternative burgers with or without Soy LegH shared coloring, a slightly darker red tone than the beef burger. Additionally, the plant-based meat alternative burgers with or without Soy LegH had very similar L-, a- and b-color values, indicating that the two types of soy-based meat alternative burgers were very close in objective measure of color. This high degree of color similarity confirmed that the small amount of Soy LegH (0.5%) used in the Soy LegH soy-based meat alternative burgers, effectively replaced the colorants (total 1.8%) used in the soy-based meat alternative burgers lacking Soy LegH. Surprisingly, the soy-based meat alternative burgers containing 0.5% Soy LegH had the least changes in all color values while in frozen (Day 1, 3 and 6) and frozen to thaw, demonstrating that color provided by Soy LegH was stable during storage.

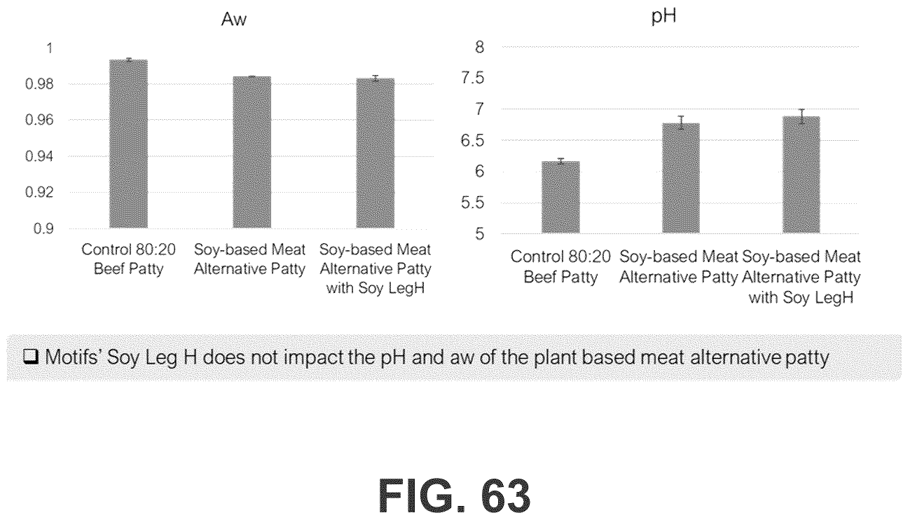

FIG. 63 shows the Aw (water Activity, left panel) and pH (right panel) of the three samples: the control, beef burger with 80:20 protein/fat ratio, soy-based meat alternative burgers without Soy LegH, and the soy-based meat alternative burgers with 0.5% Soy LegH. It showed that meat alternative burgers with Soy LegH had comparable Aw and pH values to the meat alternative burgers without Soy LegH, concluding that the use of Soy LegH did not impact pH and Aw.

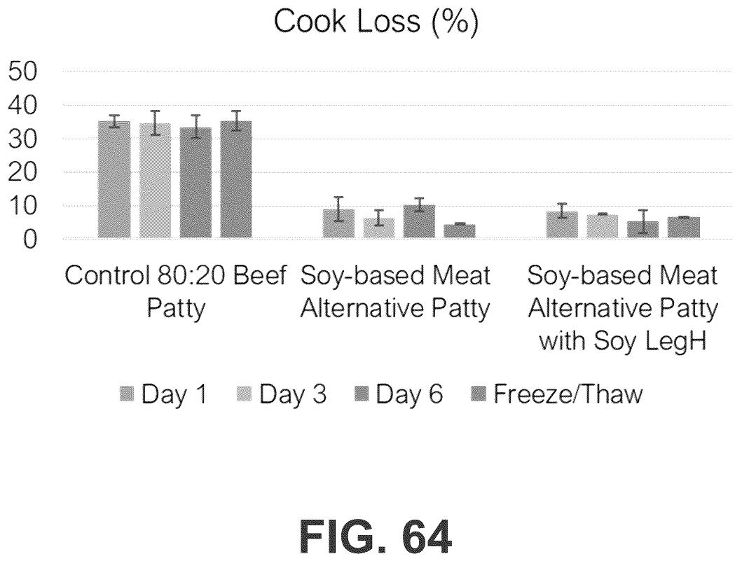

FIG. 64 shows the Cook Loss (%) of the three samples. Samples were stored frozen for 1, 3, 6 days or freeze/thaw, before being cooked and Cook Loss measured. The control sample (left panel, beef burger with 80:20 protein/fat ratio) consistently had about 35% of Cook Loss (%) independent of storage time. The meat alternative burgers with and without Soy LegH had a similar lower percentages (5-10%). Overall, the plant-based meat alternative burgers had reduced cook loss than beef burger, and no significant change in Cook Loss was observed during refrigerated and frozen storage.

### Example 12: Pea-Based Meat Alternative Burger with Soy LegH

A meat alternative burger was also successfully made with textured pea protein and pea protein. In this example, the heme protein was again the legume hemoglobin from microbial fermentation made in-house. This pea-based meat alternative burger comprised about 21% to about 22.5% textured pea protein with 70% of protein content, about 12% fat (coconut oil), and about 3% pea protein, minor amounts of lecithin (from sunflower), methylcellulose, starch, salt and pepper (see TABLE 41), and 0.5% Soy LegH. For comparison, a meat alternative burger without Ferm. Soy LegH was also made (see TABLE 42). In this meat alternative burger, color and flavor chemicals were used to bring the desired meat flavor and color. Specifically, edible colorants “red beet powder” and “cocoa powder” were used at about 1.0% total. For flavor, the Natural Vegetarian Meaty Beef Flavor was added at about 0.8%.

TABLE 41

| Ingredients | % weight |
|---|---|
| Water | 57.50 |
| Textured Pea Protein (70%) | 22.30 |
| Coconut Oil | 12.0 |
| Sunflower Lecithin | 1.00 |
| Pea Protein | 3.00 |
| Methylcellulose | 1.00 |
| Salt | 1.00 |
| Potato Starch | 0.80 |
| Pregel Potato Starch | 0.80 |
| Black Pepper | 0.10 |
| Ferm. Soy LegH | 0.50 |
| Total | 100.00 |

TABLE 42

| Ingredients | % weight |
|---|---|
| Water | 57.50 |
| Textured Pea Protein (70%) | 21.00 |
| Coconut Oil | 12.0 |
| Sunflower Lecithin | 1.00 |
| Pea Protein | 3.00 |
| Methylcellulose | 1.00 |
| Salt | 1.00 |
| Potato Starch | 0.80 |
| Pregel Potato Starch | 0.80 |
| Black Pepper | 0.10 |
| Natural Vegetarian Meaty Beef Flavor | 0.80 |
| Red Beet Powder | 0.60 |
| Cocoa Powder | 0.40 |
| Total | 100.00 |

The steps of making pea-based meat alternative burgers were as described in Example 11 (see FIG. 60), except that the 22.3% Texture Soy Protein of Example 11 was replaced by 22.30% Textured Pea Protein for Example 12, and soy protein of Example 11 was replaced by pea protein, also at 3%.

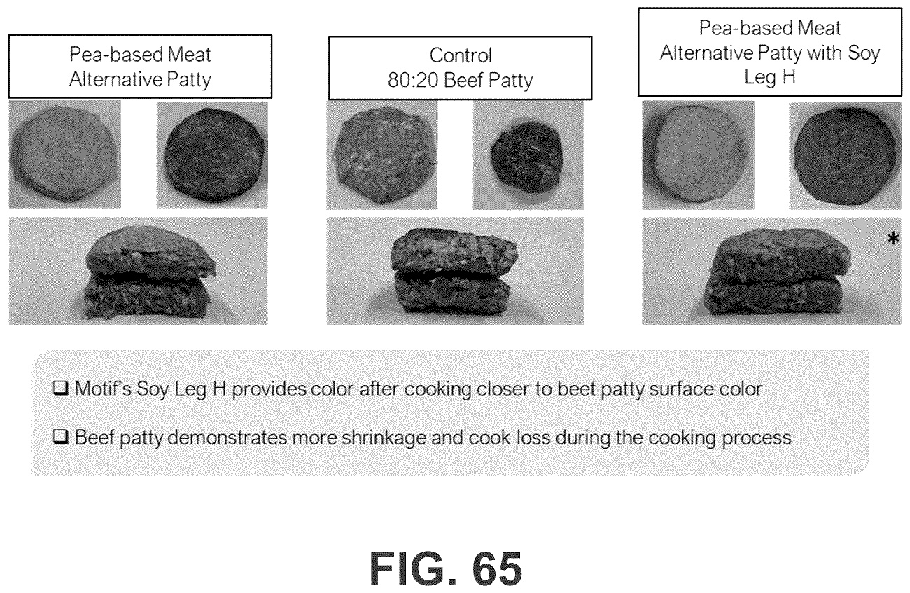

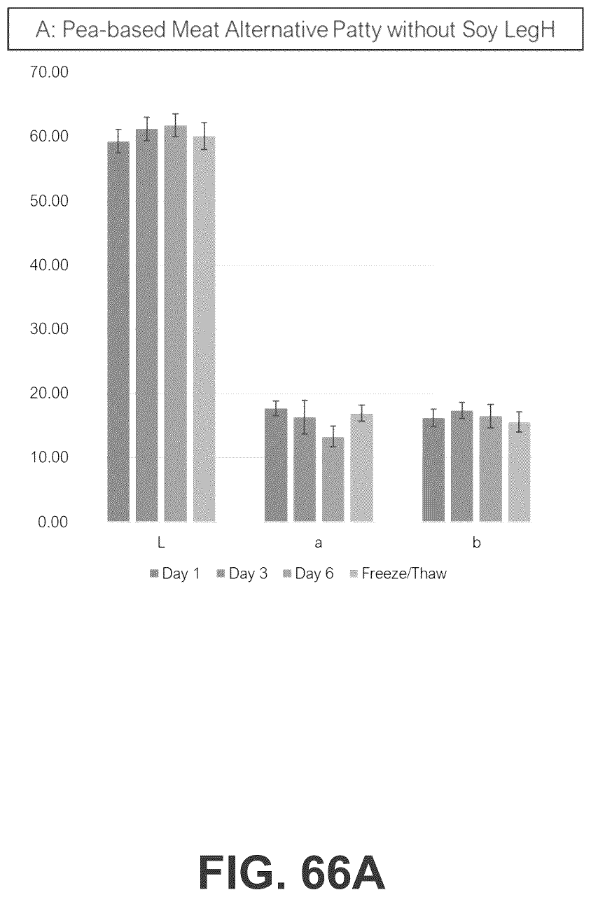

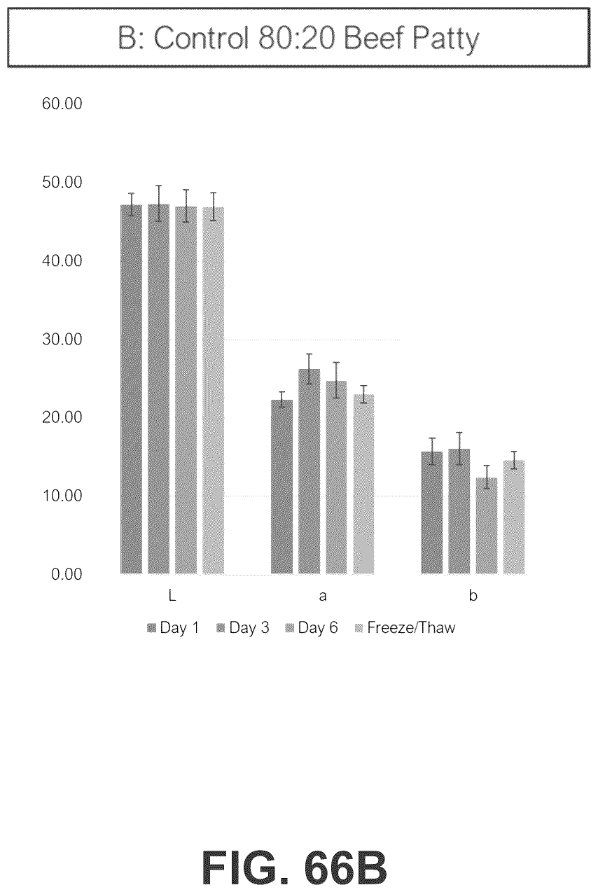

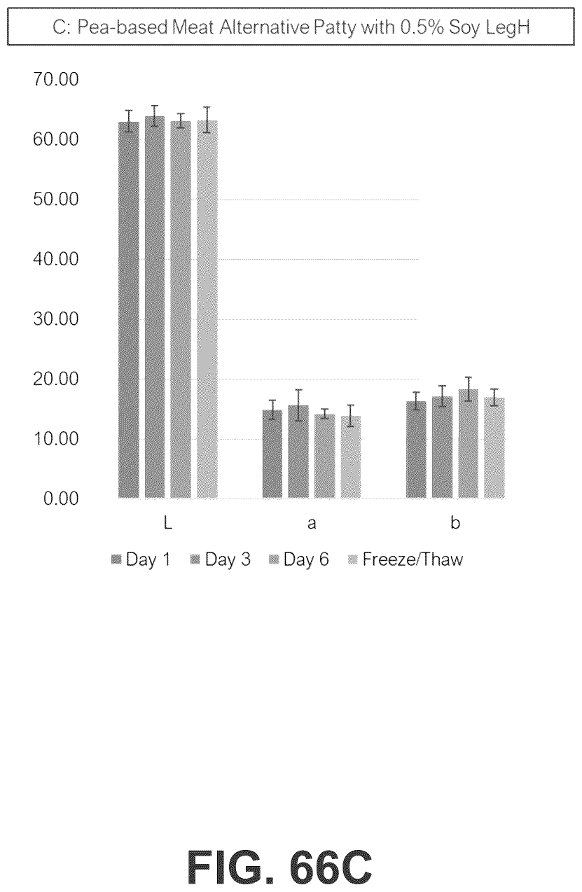

Properties of the pea-based meat alternative burgers with and without Soy LegH were compared before and post-cooking against the control, a beef burger with a protein to fat ratio of 80:20. As shown in FIG. 65, the Soy LegH-containing meat alternative burger (right panel) exhibited post-cooking color similar to the beef burger surface color, but shrank much less. Among the three burgers tested, the beef burger exhibited the most shrinkage and cook loss in cooking process. A further color comparison was made during refrigeration and frozen storage to determine color stability. FIGS. 66A-C show the L-, a- and b-values of the three samples at frozen Day 1, 3, 6 and at the time of freeze to thaw. Comparing L-values (the black to white tone) across the three samples (left panel of each of FIGS. 66A-C), the beef burger had the lowest L-values (middle panel), while pea-based meat alternative burgers with and without Soy LegH had similar L-values. The a-values were reversed (middle panel of each FIGS. 66A-C), such that the beef burger had the highest a-value, while the values for the pea-based meat alternative burgers with or without Soy LegH had similar, lower a-values. Overall, the data and conclusions are similar to those obtained with the soy-based meat alternative burgers with and without Soy LegH to real beef, as described in Example 11, confirming the coloring efficacy of the small amount of Soy LegH (0.5%) added to a pea-based meat alternative compared to the use of colorants (total 1.8%) in the pea-based meat alternative burger lacking Soy LegH; confirming that the color provided by Ferm. Soy LegH was stable during storage.

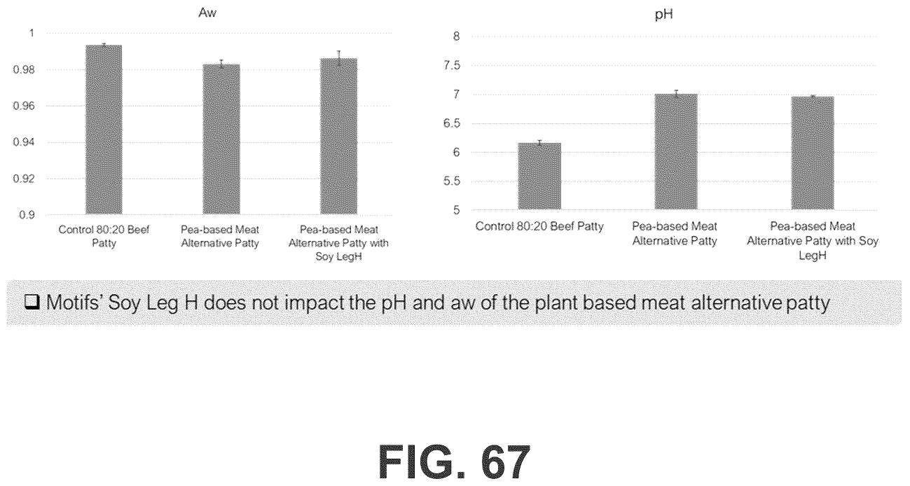

FIG. 67 shows the Aw (water Activity, left panel) and pH (right panel) of the three samples: the control, beef burger with 80:20 protein/fat ratio, pea-based meat alternative burger without Soy LegH, and the pea-based meat alternative burger with 0.5% Soy LegH, showing that meat alternative burgers with soy LegH had comparable Aw and pH values to the pea-based meat alternative burgers without Soy LegH, concluding that the use of Soy LegH did not impact the pH and Aw of plant based meat alternative.

Cook Loss (%) was calculated based on the formula:

$$Cook Loss ( \% ) = \frac{Mass of Product Raw - Mass of Product Cooked}{Mass of Product Raw}$$

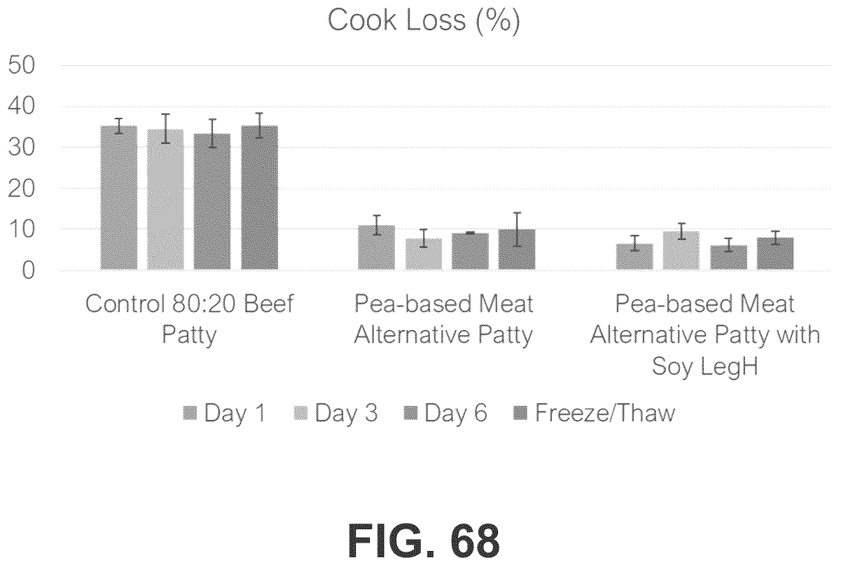

FIG. 68 depicts the Cook Loss (%) of the three samples. Samples were stored frozen for 1, 3, 6 days or freeze/thaw, before being cooked and Cook Loss was calculated. The control sample (left panel, a beef burger with 80:20 protein/fat ratio) consistently had about 35% of Cook Loss (%) independent of storage time. The other two meat alternative burgers, the pea-based meat alternative burgers with and without soy LegH, exhibited cook losses (5-10%) lower than that of the beef burger. While the plant-based meat alternative burger had reduced Cook Loss relative to the beef burger, no significant change in Cook Loss was observed during refrigerated and frozen storage.

### Example 13: Meat Alterative Burger Formulation with Textured Soy Protein and Bovine Myoglobin

A plant-based meat alternative burger was also successfully made with textured soy protein and soy protein isolate together with bovine myoglobin obtained from microbial fermentation. Bovine myoglobin was obtained in solution at a minimum concentration of 3%. Ingredients listed in TABLE 43 were processed through the following steps: textured soy protein was hydrated in water and hydrated for about 30 minutes; bovine myoglobin in solution was diluted to the desired concentration with water; in a separate container, soy protein isolate, methylcellulose, salt, pepper, potato starch, natural flavors were combined to create a pre-mix; coconut oil and canola oil were combined with lecithin and the pre-mix for 30 seconds. The hydrated soy textured protein, bovine myoglobin, pre-mix, and the oils were combined in a mixing bowl and mixed with a mixer on low speed for about two (2) minutes. The resulting product was a solid mass that was portioned and formed into meat alternative burger patties using a patty former. The meat alternative burger patties were and packaged in vacuum sealed plastic until ready for use.

TABLE 43

| Ingredients | % Weight |
|---|---|
| Water | 54.10-56.10% |
| Textured soy protein (Textured | 20.00% |
| Pea Protein can be also used) | |
| Coconut oil | 6.00% |
| Canola oil | 8.00% |
| Soy protein isolate | 2.50% |
| Methylcellulose | 1.50% |
| Sunflower lecithin | 1.00% |
| Salt, granulated | 0.50% |
| Potato starch | 1.60% |
| Black pepper | 0.10% |
| Natural flavors | 2.20% |
| Bovine myoglobin | 0.50%-2.00% |
| Total | 100.00% |

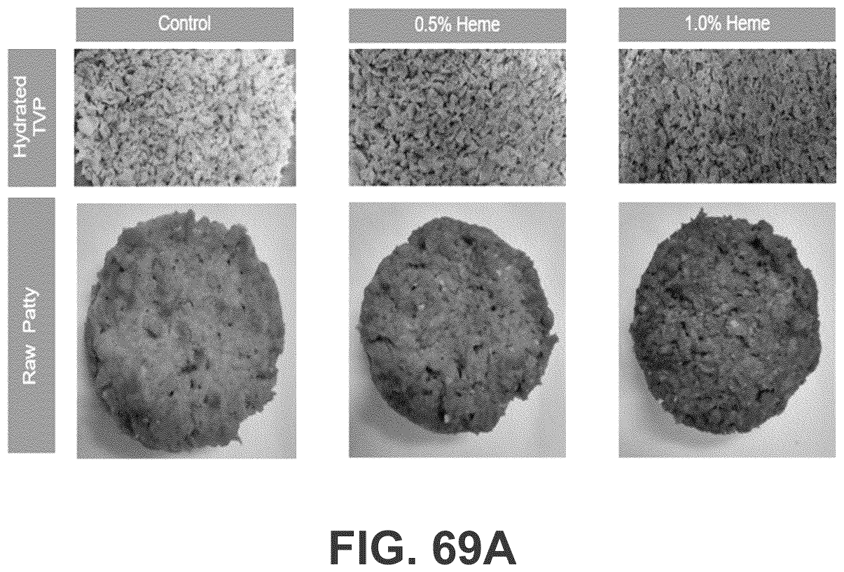

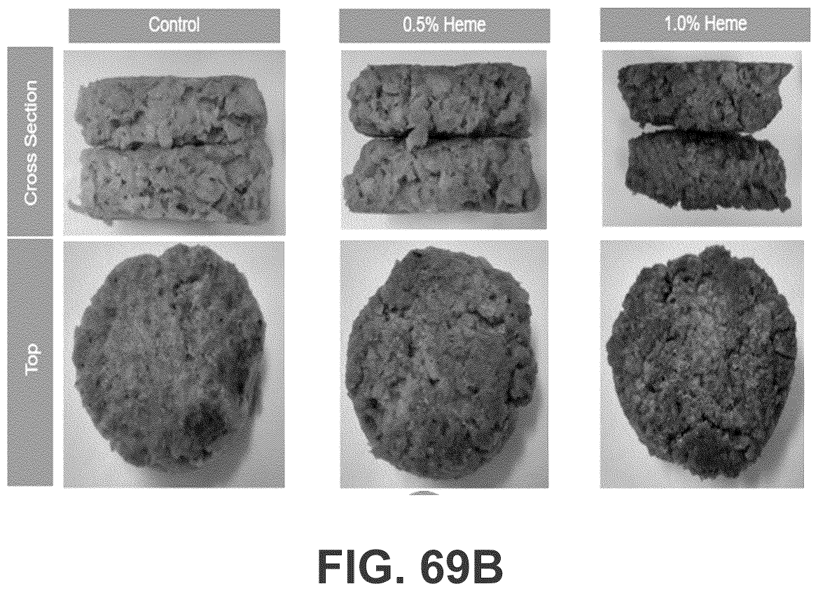

The thus obtained plant-based meat alternative burger had the raw meat appearance of bright red due to the myoglobin interacting with oxygen. Color improved with heme concentration, achieving a bright red when 1% or more of heme protein is added to a plant-based meat alternative (See FIG. 69A). The product had a pH of 7.0 to 8.0, total solids of 3.0-5.0%, purity 60-95%, and concentration of 30 g/ml. The Soy-based meat alternative burger with 1% bovine myoglobin heme protein had L-value (spectrum of white to black) of 33.85, a-value (spectrum of red and green) of 9.89, and b-value (spectrum of yellow and blue) of 16.81. When cooked at temperatures above 140° F., the myoglobin denatured, and the meat alternative burger underwent physiological changes including shifting from bright red to grey-brown (FIG. 69B).

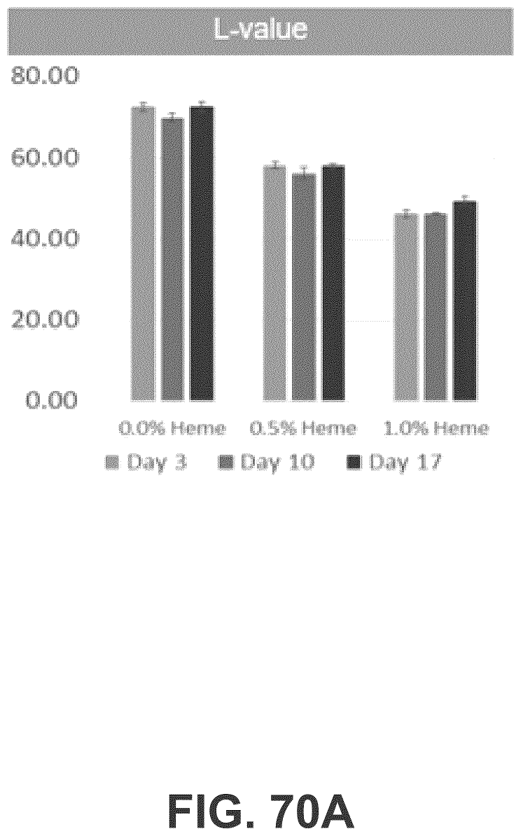

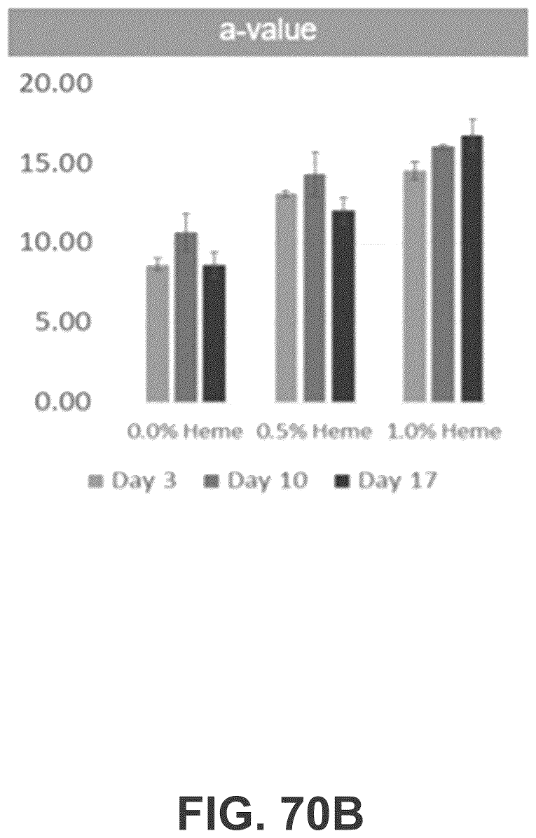

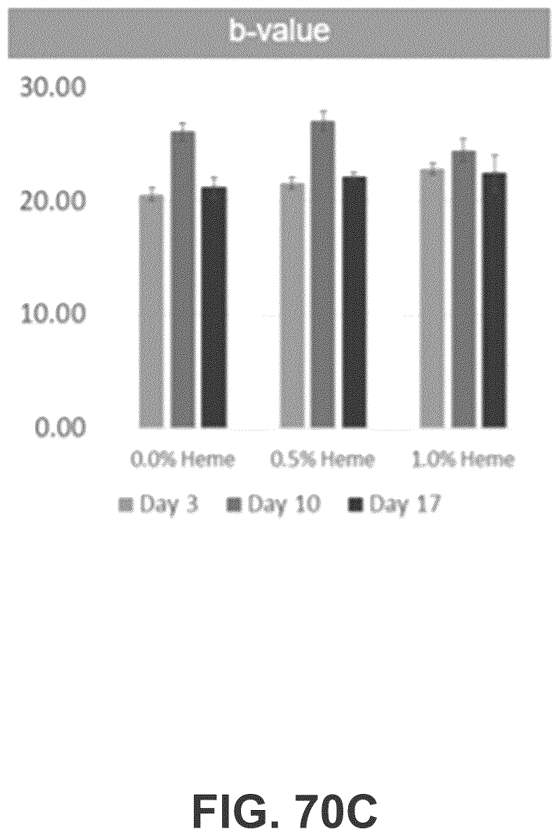

Three additional plant-based meal alternative burgers were made based on ingredients in TABLE 43, with the amount of bovine myoglobin heme protein being at 0%, 0.5% and 1.0%, respectively. The meat alternative burgers were made into thirty-gram patties and stored in frozen temperature (−20° C.) for 17 days. Samples were pulled at day zero, day 10, and day 17 and measured using a Hunter Lab colorimeter, featuring L-, a- and b-values. L-value indicated a spectrum of white and black, a-value indicated a spectrum of red and green, and b-value indicated a spectrum of yellow and blue. As shown in FIG. 70A, L-value decreased with increased concentration of heme protein. As shown in FIG. 70B, a-value increased (redness) with increased concentration of heme. As shown in FIG. 70C, b-value was not impacted by heme concentration. Statistically, there was no significant difference among these values at Day 3, 10 and 17 frozen period, indicating color was maintained and the alternative burgers were stable during the frozen storage.

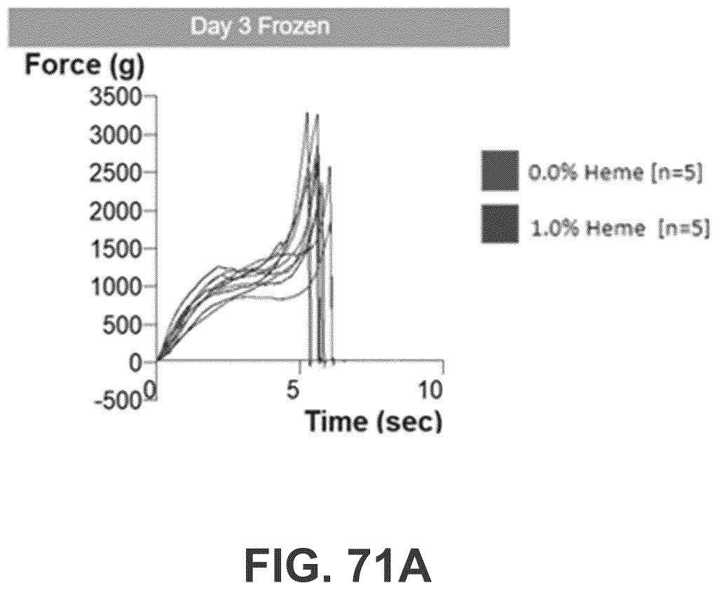

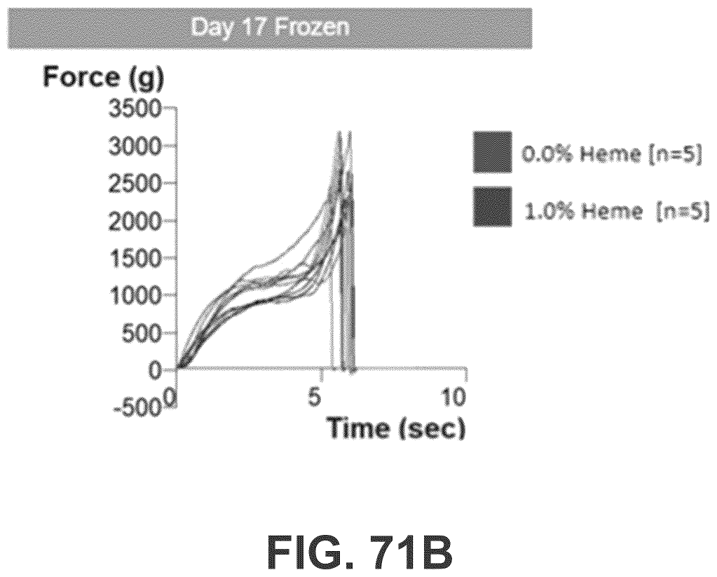

Two meat alternative burgers made according to ingredients in TABLE 43, and containing 0% and 1.0% bovine myoglobin heme protein were also tested for texture. Samples were pulled at Day 3 and Day 17, were cooked on a non-stick skillet for 2 minutes on each side to an internal temperature of 165° F., and were then characterized through textured analysis. A bisectional probe made to cut the meat alternative burgers in half was performed using a texture analyzer and peak force was measured. Peak force data from day 3 and day 17 with 0% heme and 1.0% heme samples were overplayed and presented as FIG. 71A (for Day 3 frozen) and FIG. 71B (for D17 frozen). Both graphs showed that adding heme protein did not impact the peak force, thus texture of the plant-based meat alternative. And the texture was stable during frozen storage.

Three meat alternative burgers made according to ingredients in TABLE 43 and containing 0%, 0.5% and 1.0% bovine myoglobin heme protein were also tested for Cook Loss, pH and water activity (aw). The samples were made into 30-gram burgers and stored in frozen temperature (−20° C.) for 17 days. Samples were pulled at Day 3 and Day 17, and were cooked on a non-stick skillet for 2 minutes on each side to an internal temperature of 165° F. Products were measured with an Accumet pH meter, an Aqualab water activity meter, and calculated for Cook Loss (%) according to the formula:

$$Cook Loss ( \% ) = \frac{Mass of Product Raw - Mass of Product Cooked}{Mass of Product Raw} .$$

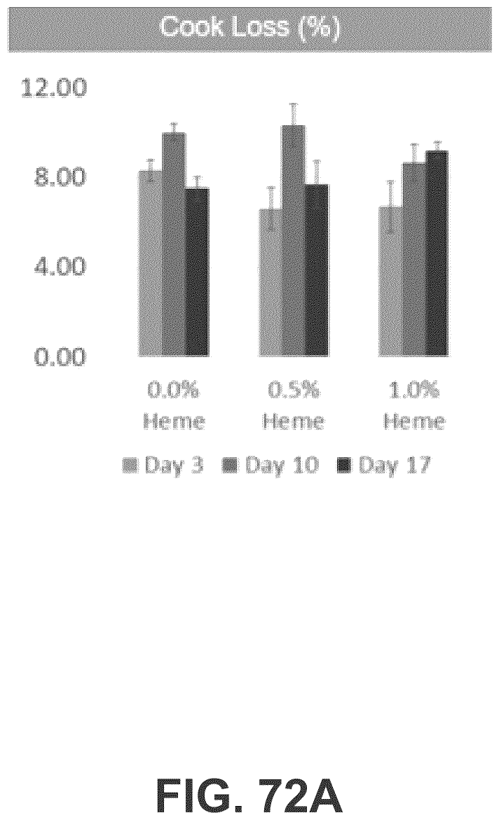

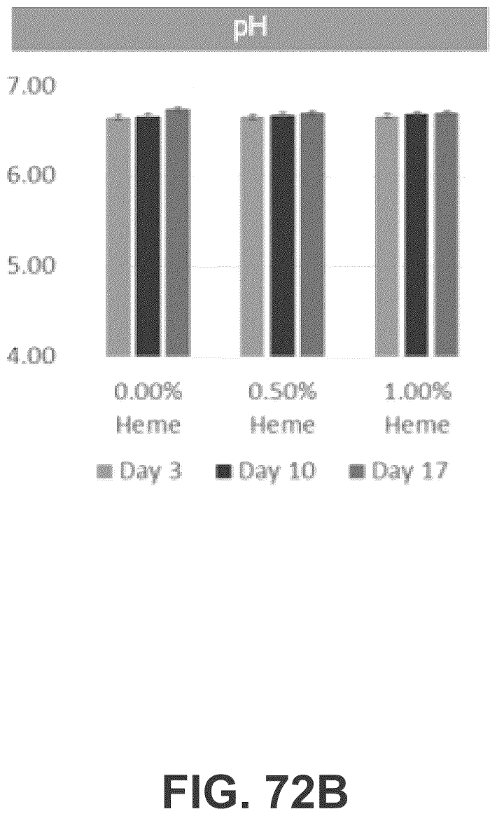

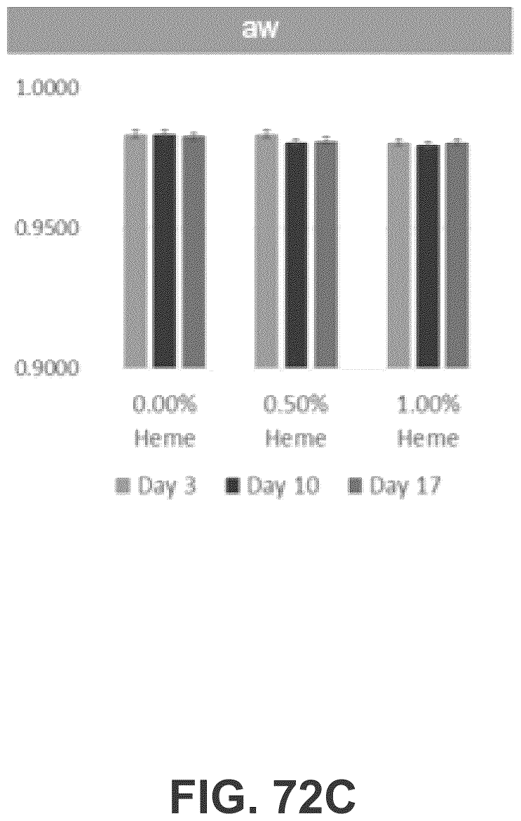

As shown in FIG. 72A, heme amount did not significantly impact Cook Loss (%). For pH and water activity (aw), heme addition does not change pH or aw at all as shown in FIGS. 72B-C.

### Example 14: Meat Alterative Burger with Soy Protein, Flavor Enhancers and Heme Protein

The plant-based meat alternative was further studied to optimize flavor. Ingredients used are listed in TABLE 44. These samples were made by hydrating both 2.5 mm and <1.mm sized Textured Soy Protein (23%) in water and a heme protein solution for 5 minutes. In a high shear mixer, the hydrated mixture was combined with Rotvitaris® MC HS 300 (ICL Food Solutions, St. Louis, MO), the oils, and thoroughly mixed. While mixing on high shear, water was added to the mixture until a gel was formed. Flavoring, inulin, and further Rotvitaris® MC HS 300 gel were added and blended for two minutes until the product was formed into a pliable dough. Dough was portioned into meat alternative burger patties in 113 gram increments using a patty former, frozen at −29° C. for 1 hour, and vacuum sealed until ready for thaw and use.

TABLE 44

| Ingredients | w/w |
|---|---|
| Textured Soy Protein (2.5-4 mm, Arcon TU Crumble) | 20.80% |
| Textured Soy Protein (<1 mm) Arcon TU-Crumble 300 | 2.20% |
| Water | 38.04-37.04% |
| Heme protein (bovine myoglobin from microbial | 0.00-1.00% |
| fermentation) | |
| Instant Inulin (cargill) | 0.80% |
| Hamburger wt flavor | 2.00% |
| Tallow fat flavor | 0.30% |
| Marrow flavor | 0.16% |
| Fat vv flavor | 0.20% |
| Beef (fatty) Flavor | 0.50% |
| Meat (juicy) Flavor | 0.20% |
| Nat beef bd flavor | 0.60% |
| Beef (boiled) Flavor | 0.20% |
| Nat milk flavor | 0.30% |
| Nat grill type Flavor | 0.50% |
| Soybean masker Flavor | 0.20% |
| Protein masker Flavor | 0.10% |
| Sunflower oil, high-oleic | 8.00% |
| Rovitaris ® mc hs 300 | 1.90% |
| Water, distilled | 16.00% |
| Coconut oil 96f frozen | 7.00% |
| Total | 100.00% |

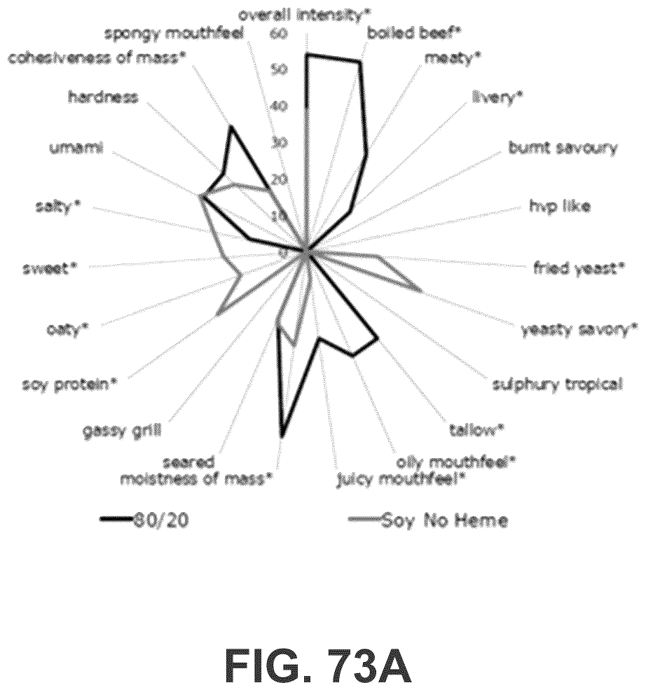

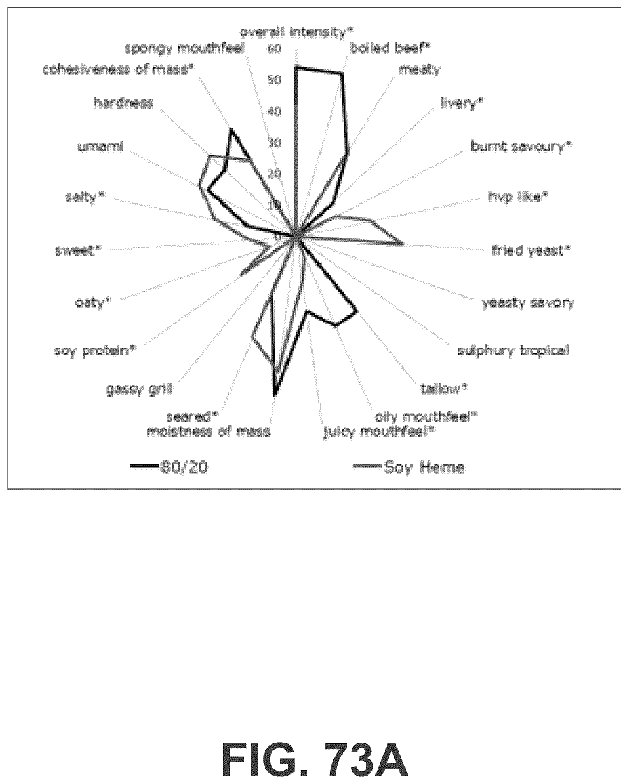

The above samples were tested for sensory profiles together with a negative control wherein no heme (bovine myoglobin) was used, and a positive control of the regular 80/20 beef burger. Ten trained panelists prescreened for sensory acuity using Givaudan's global Sense It® flavor. Panelists individually rated the intensity of the attributes on a 0-100-point scale. Samples were evaluated sequential monadic and labeled with 3-digit random codes, served warm. Individual scores were collected for analysis and data obtained from sensations via smelling, in the mouth and after swallowing. Sensory profiles were graphed as spider charts with statistical significance determined by ANONA at 95% confidence, as shown in FIGS. 73A-B. In a descriptive panel, meat alternative burgers containing heme provided a meatier profile (meaty, burnt savory, yeasty savory, umami, seared) than the plant-based meat alternatives without heme. The meat alternative burgers containing heme also demonstrated better scores for Juiciness (moistness of mass, cohesion, spongy mouthfeel) and a reduction of plant-based notes (oaty, sweet, fried yeast, soy protein). Compared to 80/20 beef, meat alternative burgers with heme protein had a closer flavor profile to 80/20 beef than plant-based meat analogs without heme protein, as shown in FIGS. 73A-B.

Data from Examples 13 and 14 showed that addition of heme protein (0.5%-2.0%), such as bovine myoglobin derived from microbial fermentation, surprisingly markedly improved color, taste and texture in the plant-based meat alternative compositions. In addition, the added heme protein improved the cooking experience as denaturing heme protein turned from a bright red color, to a grey-brown, and the flavor compounds developed via Maillard Reaction delivered savory and meaty notes resembling the natural beef meat. In summary, small inclusion of 0.5-2% heme protein into plant-based meat bases delivered products with an improved color spectrum (both raw and cooked), an improved cooking experience (by turning red to brown), and a sensory profile (beefier, meatier) much closer to the real meat.

What is claimed is:

1. A meat alternative formulation comprising a bovine myoglobin and a plant-based protein,
wherein the meat alternative formulation does not include free amino acids selected from the group consisting of cysteine, cystine, selenocysteine, and methionine.

2. The meat alternative formulation of claim 1, wherein the meat alternative formulation further does not include free sugars in an amount exceeding 1.5 weight percent (wt %).

3. The meat alternative formulation of claim 1 or claim 2, wherein at least 20% of heme moieties of the heme protein are metmyoglobin or metheme.

4. The meat alternative formulation of any one of claims 1-3, wherein the heme protein has a purity of at least 20%.

5. The meat alternative formulation of any one of claims 1-4, wherein at least 95% of the heme protein is in a holo-form.

6. The meat alternative formulation of any one of claims 1-5, wherein the heme protein has a dissociation constant (K_{d}) of at least 500 μM for molecular oxygen.

7. The meat alternative formulation of any one of claims 1-6, wherein the heme protein is 0.2 wt % to 2 wt % of the meat alternative formulation.

8. The meat alternative formulation of any one of claims 1-7, wherein the plant-based protein is isolated or derived from wheat, pea, soy, canola, potato, chickpea, lentil, chickpea, fava bean, mung bean, rice, corn, sorghum, quinoa, vegetables, seaweed, bacteria, yeast, mushrooms, or any combination thereof.

9. The meat alternative formulation of claim 8, wherein the plant-based protein comprises soy protein, rice protein, pea protein, canola protein, or any combination thereof.

10. The meat alternative formulation of any one of claims 1-9, wherein the plant-based protein comprises less than 30% fats and carbohydrates by weight.

11. The meat alternative formulation of claim any one of claims 1-10, wherein the plant-based protein is about 0.5 wt % to about 40 wt % of the meat alternative formulation.

12. The meat alternative formulation of any one of claims 1-11, further comprising a hydrocolloid.

13. The meat alternative formulation of claim 12, wherein the hydrocolloid comprises konjac gum, gum Arabic, carrageenan, agar-agar, pectin, alginate, gellan, konjac glucomannan, xanthan, modified starch, methyl cellulose, hydroxypropyl methyl cellulose, carboxymethyl cellulose, guar gum, locust bean gum, tara gum, gum tragacanth, gum ghatt, their derivatives, or any combination thereof.

14. The meat alternative formulation of claim 13, wherein the hydrocolloid comprises konjac flour, methyl cellulose, gum Arabic, carrageenan, or any combination thereof.

15. The alternative formulation of any one of claims 12-14, wherein the hydrocolloid is about 1 wt % to about 5 wt % of the meat alternative formulation.

16. The meat alternative formulation of any one of claims 1-15, further comprising a plant-based fiber.

17. The meat alternative formulation of claim 16, wherein the plant-based fiber comprises konjac flour, guar gum, xantham gum, psyllium, chitin, inulin, pectin, dextrin, a starch, a cellulose, a hemicellulose, a starch, a lignin, a citrus fiber extract, or any combination thereof.

18. The meat alternative formulation of claim 17, wherein the plant-based fiber comprises inulin, gum Arabic, citrus fiber, maltodextrin, or any combination thereof.

19. The meat alternative formulation of any one of claims 16-18, wherein the plant-based fiber is at least 5 wt % of the meat alternative formulation.

20. The meat alternative formulation of any one of claims 1-19, further comprising a fat.

21. The meat alternative formulation of claim 20, wherein the fat is isolated from a plant.

22. The meat alternative formulation of claim 20 or 21, wherein the fat is selected from the group consisting of algal oil, fungal oil, corn oil, olive oil, soy oil, peanut oil, walnut oil, almond oil, sesame oil, cottonseed oil, rapeseed oil, canola oil, safflower oil, sunflower oil, flax seed oil, palm oil, palm kernel oil, coconut oil, babassu oil, shea butter, mango butter, cocoa butter, wheat germ oil, borage oil, black currant oil, sea-buckhorn oil, macadamia oil, saw palmetto oil, conjugated linoleic oil, alpha linoleic acid, arachidonic acid enriched oil, docosahexaenoic acid (DHA) enriched oil, eicosapentaenoic acid (EPA) enriched oil, palm stearic acid, sea-buckhorn berry oil, macadamia oil, saw palmetto oil, rice bran oil[margarine, and other hydrogenated fats, and any combination thereof.

23. The meat alternative formulation of claim 22, wherein the fat comprises sunflower oil, coconut oil, or a combination thereof.

24. The meat alternative formulation of any one of claims 20-23, wherein the fat is about 1 wt % to about 30 wt % of the meat alternative formulation

25. The meat alternative formulation of any one of claims 1-24, further comprising a binder.

26. The meat alternative formulation of claim 25, wherein the binder comprises starch, gum, methyl cellulose, lecithin, or any combination thereof.

27. The meat alternative formulation of claim 25 or claim 26, wherein the binder is about 0.25 wt % to about 1.5 wt % of the meat alternative formulation.

28. The meat alternative formulation of any one of claims 1-27, wherein the meat alternative formulation comprises from about 30 wt % to about 60 wt % water.

29. The meat alternative formulation of any one of claims 1-28, further comprising a polyunsaturated fatty acid.

30. The meat alternative formulation of any one of claims 1-29, wherein the alternative meat formulation does not comprise an ingredient isolated from an animal, an animal tissue, or an animal cell.

31. The meat alternative formulation of any one of claims 1-30, wherein prior to cooking the meat alternative formulation has a viscosity of at least 1000 cP.

32. The meat alternative formulation of any one of claims 1-31, wherein subsequent to cooking the meat alternative formulation has a hardness of at least 8000 g as determined by texture profile analysis.

33. The meat alternative formulation of any one of claims 1-32, wherein subsequent to cooking the meat alternative formulation has an elasticity of at least 0.8 cm.

34. The meat alternative formulation of any one of claims 1-33, wherein subsequent to cooking the meat alternative formulation has a cohesion of at least 0.7%.

35. The meat alternative formulation of any one of claims 1-34, wherein the meat alternative formulation is homogenous.

36. The meat alternative formulation of any one of claims 1-35, wherein the meat alternative formulation comprises a gel, a paste, or an emulsion.

37. A meat alternative formulation comprising:
(a) a heme protein;
(b) a plant-based protein;
(c) a plant-based fiber;
(d) a fat; and
(e) water;
wherein the meat alternative formulation does not include free amino acids selected from the group consisting of cysteine, cystine, selenocysteine, and methionine.

38. A meat alternative formulation comprising:
(a) a heme protein;
(b) a plant-based protein;
(c) a plant-based fiber;
(d) a plant-based connective tissue analog;
(e) a fat; and
(f) water;
wherein the meat alternative formulation does not include free amino acids selected from the group consisting of cysteine, cystine, selenocysteine, and methionine.

39. A meat alternative formulation comprising:
(a) a heme protein;
(b) a first plant-based protein;
(c) a second plant-based protein, wherein the first plant-based protein and second plant-based proteins are from different plants;
(d) a plant-based connective tissue analog;
(e) a plant-based fiber;
(f) a fat;
(g) a binder; and
(h) water;
wherein the meat alternative formulation does not include free amino acids selected from the group consisting of cysteine, cystine, selenocysteine, and methionine.

40. The meat alternative formulation of any one of claims 37-39, wherein the meat alternative formulation further does not include free sugars in an amount exceeding 1.5 wt %.

41. The meat alternative formulation of any one of claims 37-40, wherein the meat alternative formulation further does not include free sugars in an amount exceeding 0.2 wt %.

42. The meat alternative formulation of any one of claims 37-41, wherein the heme protein is a bovine myoglobin.

43. The meat alternative formulation of any one of claims 37-42, wherein the heme protein is about 0.2 wt % to about 2 wt % of the meat alternative formulation.

44. The meat alternative formulation of any one of claims 37-43, wherein the first plant-based protein is about 0.5 wt % to about 25 wt % of the total weight of the meat alternative formulation.

45. The meat alternative formulation of any one of claims 39-44, wherein the second plant-based protein is about 0.5 wt % to about 1.5 wt % of the meat alternative formulation.

46. The meat alternative formulation of any one of claims 38-45, wherein the plant-based connective tissue analog is about 1 wt % of the meat alternative formulation.

47. The meat alternative formulation of claim 46, wherein about 0.50 wt % of the formulation is a cartilage analog, about 0.3 wt % is a perimysium analog, and about 0.2 wt % is a tendon analog.

48. The meat alternative formulation of any one of claims 39-47, wherein the binder is about 0.3 wt % to about 0.7 wt % of the meat alternative formulation.

49. The meat alternative formulation of any one of claims 37-48, wherein the fat is about 12 wt % to about 17 wt % of the meat alternative formulation.

50. The meat alternative formulation of any one of claims 37-49, wherein the water is about 40 wt % to about 60 wt % of the meat alternative formulation.

51. The meat alternative formulation of any one of claims 37-50, further comprising a mineral, a polyunsaturated fatty acid (PUFA), or a combination thereof.

52. A meat alternative nugget formulation comprising:
(a) a plant-based fiber;
(b) a plant-based protein;
(c) a fat; and
(d) a heme protein;
wherein the meat alternative nugget formulation does not include free amino acids selected from the group consisting of cysteine, cystine, selenocysteine, and methionine.

53. The meat alternative nugget formulation of claim 52, wherein the meat alternative nugget formulation further does not include free sugars in an amount exceeding 1.5 wt %.

54. The meat alternative nugget formulation of either claim 52 or 53, further comprising about 0.3 to about 1.5 wt % of a plant-based connective tissue analog (PBCT).

55. The meat alternative nugget formulation of claim 54 comprising 0.38 wt % PBCT, wherein about 0.08 wt % of the formulation is a perimysium analog and about 0.3 wt % is a tendon analog.

56. The meat alternative nugget formulation of claim 54, comprising 1.5 wt % PBCT, wherein about 0.3 wt % of the formulation is a cartilage analog, about 0.6 wt % is a perimysium analog, and about 0.6 wt % is a tendon analog.

57. The meat alternative nugget formulation of any one of claims 52-56, wherein the plant-based fiber is between about 20 wt % and about 60 wt % of the meat alternative nugget formulation.

58. The meat alternative nugget formulation of any one of claims 52-57, wherein the plant-based protein is between about 3 wt % and 12 wt % of the meat alternative nugget formulation.

59. The meat alternative nugget formulation of any one of claims 52-58, wherein the fat is between about 0.5 wt % and 4.5 wt % of the meat alternative nugget formulation.

60. The meat alternative nugget formulation of any one of claims 54-59, wherein at least a portion of the PBCT is desiccated and optionally rehydrated prior to addition to the meat alternative nugget formulation.

61. A meat alternative sausage formulation comprising:
(a) a plant-based protein;
(b) a fat;
(c) a plant-based connective tissue analog; and
(d) a heme;
wherein the meat alternative sausage formulation does not include free amino acids selected from the group consisting of cysteine, cystine, selenocysteine, and methionine.

62. The meat alternative sausage formulation of claim 61, wherein the meat alternative formulation further does not include free sugars in an amount exceeding 1.5 wt %.

63. The meat alternative sausage formulation of either claim 61 or 62, wherein the plant-based protein is about 12 wt % to about 30 wt % of the meat alternative sausage formulation.

64. The meat alternative sausage formulation of any one of claims 61-63, wherein the fat is about 7 wt % to about 22 wt % of the meat alternative sausage formulation.

65. The meat alternative sausage formulation of any one of claims 61-64, wherein the fat has a melting point above about 20° C.

66. The meat alternative sausage formulation of any one of claims 61-65, wherein the fat comprises at least two different fats.

67. The meat alternative sausage formulation of any one of claims 61-66, wherein the meat alternative sausage formulation does not comprise a plant-based fiber.

68. The meat alternative sausage formulation of any one of claims 61-67 further comprising from about 35 wt % to about 60 wt % water.

69. The meat alternative sausage formulation of any one of claims 61-68, comprising about 1.5 wt % PBCT, wherein about 0.25 wt % of the formulation is a cartilage analog, about 0.25 wt % is a perimysium analog, and about 1 wt % is a tendon analog.

70. A method of producing a meat alternative formulation, the method comprising:
(a) combining a plant-based connective tissue analog, a plant-based fiber, a plant-based protein, or any combination thereof, with water to form a hydrated composition;
(b) combining a plant-based connective tissue analog, a plant-based protein, a plant-based fiber, a fat, a mineral, water, or any combination thereof, with a heme protein to form a heme protein composition, wherein the heme protein comprises a bovine myoglobin;
(c) combining the hydrated composition and the heme protein composition;
wherein the method does not include adding free amino acids selected from the group consisting of cysteine, cystine, selenocysteine, and methionine.

71. The method of claim 70, wherein the method further does not include adding free sugars.

72. The method of claim 70 or 71, wherein water comprises between about 25% and about 75% of the mass of the hydrated composition.

73. The method of any one of claims 70-72, wherein (b) comprises solubilizing the heme protein.

74. The method of any one of claims 70-73, wherein (b) comprises forming a gel from the fat and the plant-based connective tissue analog prior to the combining with the heme protein.

75. The method of any one of claims 70-74, wherein (c) further comprises adding a second fat.

76. A meat alternative formulation comprising a bovine myoglobin, at least one plant-based protein, a plant-based connective tissue analog, and at least one fat; wherein the meat alternative formulation does not include free amino acids selected from the group consisting of cysteine, cystine, selenocysteine, and methionine.

77. The meat alternative formulation of claim 76, wherein the meat alternative formulation further does not include free sugars in an amount exceeding 1.5 wt %.

78. The meat alternative formulation of either claim 76 or 77, wherein the meat alternative formulation further does not include free sugars in an amount exceeding 0.2 wt %.

79. A meat alternative burger formulation comprising:
(a) 0.5-2 wt % bovine myoglobin;
(b) 0.5-40 wt % plant-based protein;
(c) 10-20 wt % plant-based fat;
(d) 1-3 wt % plant-based connective tissue analog (PBCT);
wherein meat alternative burger formulation does not include free amino acids selected from the group consisting of cysteine, cystine, selenocysteine, and methionine.

80. The meat alternative burger formulation of claim 79, wherein the plant-based protein is textured soy protein.

81. The meat alternative burger formulation of claim 80, wherein the textured soy protein is minced.

82. The meat alternative burger formulation of any one of claims 79-81, wherein the plant-based protein is 19.5 wt % of the formulation.

83. The meat alternative burger formulation of any one of claims 79-82, wherein the plant-based fat comprises high oleic sunflower oil and coconut oil.

84. The meat alternative burger formulation of claim 83, wherein the high oleic sunflower oil is 8 wt % of the formulation and the coconut oil is 7 wt % of the formulation.

85. The meat alternative burger formulation of any one of claims 79-84, wherein the PBCT comprises one or more of a cartilage analog, a perimysium analog, and a tendon analog, and wherein the formulation comprises 0-1.5 wt % cartilage analog, 0-1 wt % perimysium analog, and 0-3 wt % tendon analog.

86. The meat alternative burger formulation of claim 85, comprising 0.5 wt % cartilage analog, 0.3 wt % perimysium analog, and 0.2 wt % tendon analog.

87. The meat alternative burger formulation of claim 85 or 86, wherein the PBCT is hydrated with twice as much water as PBCT, as measured by wt % of the formulation.

88. The meat alternative burger formulation of any one of claims 79-87, comprising ≤1.5 wt % free sugars.

89. The meat alternative burger formulation of any one of claims 79-88, comprising
(a) 1 wt % bovine myoglobin;
(b) 19.5 wt % textured soy protein;
(c) 8 wt % high oleic sunflower oil;
(d) 7 wt % coconut oil;
(e) 0.5 wt % cartilage analog;
(f) 0.3 wt % perimysium analog; and
(g) 0.2 wt % tendon analog.
